(19) United States
(12) Patent Application Publication
(10) Pub. No.: US 2024/0427124 A1
(43) Pub. Date: Dec. 26, 2024

(54) VARIABLE MAGNIFICATION OPTICAL SYSTEM AND IMAGING APPARATUS

(71) Applicant: FUJIFILM Corporation, Tokyo (JP)

(72) Inventor: Masato KONDO, Saitama-shi (JP)

(73) Assignee: FUJIFILM Corporation, Tokyo (JP)

(21) Appl. No.: 18/742,283

(22) Filed: Jun. 13, 2024

(30) Foreign Application Priority Data
Jun. 19, 2023 (JP) 2023-100398

(51) Int. Cl. G02B 15/14; G02B 15/16

(52) U.S. Cl. CPC G02B 15/143105; G02B 15/16

(57) ABSTRACT

A variable magnification optical system consists of a front group, a middle group, and a rear group in this order from an object side. The front group consists of two lens groups or less having a positive refractive power. The middle group consists of two lens groups or less having a negative refractive power. The rear group consists of a plurality of lens groups. A lens group of the rear group closest to the object side has a positive refractive power. During changing magnification, a lens group of the front group closest to the object side moves, and spacings between all adjacent lens groups change. The variable magnification optical system satisfies a predetermined conditional expression.

### CROSS-REFERENCE TO RELATED APPLICATIONS

This application claims priority from Japanese Patent Application No. 2023-100398, filed on Jun. 19, 2023, the entire disclosure of which is incorporated herein by reference.

### BACKGROUND

### Technical Field

The disclosed technology relates to a variable magnification optical system and an imaging apparatus.

### Related Art

In the related art, the variable magnification optical system according to JP2022-028060A has been known as a variable magnification optical system usable in an imaging apparatus such as a digital camera.

### SUMMARY

A variable magnification optical system that is configured to have a small size and that has a small F-number in the entire magnification range and favorable optical performance in the entire magnification range is desired. A level of such demands is increased year by year.

The present disclosure provides a variable magnification optical system that is configured to have a small size and that has a small F-number in the entire magnification range and favorable optical performance in the entire magnification range, and an imaging apparatus comprising the variable magnification optical system.

A first aspect of the present disclosure is a variable magnification optical system consisting of a front group, a middle group, and a rear group in this order from an object side to an image side, in which the front group consists of two lens groups or less having a positive refractive power, the middle group consists of two lens groups or less having a negative refractive power, the rear group consists of a plurality of lens groups, a lens group of the rear group closest to the object side has a positive refractive power, during changing magnification, a lens group of the front group closest to the object side moves, and spacings between all adjacent lens groups change, and Conditional Expressions (1), (2), and (3) are satisfied, which are represented by

$$5 < T L w / ( f w \times tan ω w ) < 12 \qquad ( 1 )$$

$$0.5 < Bfw / ( f w \times tan ω w ) < 2.5 \qquad ( 2 )$$

$$18 < Fnot \times ( TLt / ft ) < 5. \qquad ( 3 )$$

Symbols in Conditional Expressions (1), (2), and (3) are defined as follows. A sum of a back focus of an entire system as an air conversion distance and a distance on an optical axis from a lens surface of the front group closest to the object side to a lens surface of the rear group closest to the image side in a state where an infinite distance object is focused on at a wide angle end is denoted by TLw. A focal length of the entire system in the state where the infinite distance object is focused on at the wide angle end is denoted by fw. A maximum half angle of view in the state where the infinite distance object is focused on at the wide angle end is denoted by ww. The back focus of the entire system as the air conversion distance in the state where the infinite distance object is focused on at the wide angle end is denoted by Bfw. An open F-number in a state where the infinite distance object is focused on at a telephoto end is denoted by Fnot. A sum of the back focus of the entire system as the air conversion distance and the distance on the optical axis from the lens surface of the front group closest to the object side to the lens surface of the rear group closest to the image side in the state where the infinite distance object is focused on at the telephoto end is denoted by TLt. The focal length of the entire system in the state where the infinite distance object is focused on at the telephoto end is denoted by ft.

A second aspect of the present disclosure is the variable magnification optical system of the first aspect, in which Conditional Expression (3-1) is satisfied, which is represented by

$$1. 9 < Fnot \times ( TLt / ft ) < 4.6 . \qquad ( 3 - 1 )$$

A third aspect of the present disclosure is the variable magnification optical system of the second aspect, in which Conditional Expression (3-2) is satisfied, which is represented by

$$2 < Fnot \times ( TLt / ft ) < 4.3 . \qquad ( 3 - 2 )$$

A fourth aspect of the present disclosure is the variable magnification optical system of the third aspect, in which Conditional Expression (3-3) is satisfied, which is represented by

$$2.2 < Fnot \times ( TLt / ft ) < 4. \qquad ( 3 - 3 )$$

A fifth aspect of the present disclosure is the variable magnification optical system of the first aspect, in which Conditional Expression (4) is satisfied, which is represented by

$$0.34 < ( fw \times TLw \times Fnot ) / {ft}^{2} < 0.97 . \qquad ( 4 )$$

A sixth aspect of the present disclosure is the variable magnification optical system of the fifth aspect, in which Conditional Expression (4-1) is satisfied, which is represented by

$$0.36 < ( fw \times TLw \times Fnot ) / {ft}^{2} < 0.92 . \qquad ( 4 - 1 )$$

A seventh aspect of the present disclosure is the variable magnification optical system of the sixth aspect, in which Conditional Expression (4-2) is satisfied, which is represented by

$$0.38 < ( fw \times TLw \times Fnot ) / {ft}^{2} < 0.87 . \qquad ( 4 - 2 )$$

An eighth aspect of the present disclosure is the variable magnification optical system of the seventh aspect, in which Conditional Expression (4-3) is satisfied, which is represented by

$$0.41 < ( fw \times TLw \times Fnot ) / f {t}^{2} < 0.8 . \qquad ( 4 - 3 )$$

A ninth aspect of the present disclosure is the variable magnification optical system of the first aspect, in which in a case where the open F-number in the state where the infinite distance object is focused on at the wide angle end is denoted by Fnow, Conditional Expression (5) is satisfied, which is represented by

$$0.075 < tan ω w / Fnow < 0.3 . \qquad ( 5 )$$

A tenth aspect of the present disclosure is the variable magnification optical system of the ninth aspect, in which Conditional Expression (5-1) is satisfied, which is represented by

$$0.0 \; 92 < tan ω w / Fnow < 0.27 . \qquad ( 5 - 1 )$$

An eleventh aspect of the present disclosure is the variable magnification optical system of the tenth aspect, in which Conditional Expression (5-2) is satisfied, which is represented by

$$0.1 \; 05 < tan ω w / Fnow / < 0.25 . \qquad ( 5 - 2 )$$

A twelfth aspect of the present disclosure is the variable magnification optical system of the first aspect, in which Conditional Expression (6) is satisfied, which is represented by

$$1.1 < TLt / TLw < 1.9 . \qquad ( 6 )$$

A thirteenth aspect of the present disclosure is the variable magnification optical system of the twelfth aspect, in which Conditional Expression (6-1) is satisfied, which is represented

$$1.15 < TLt / TLw < 1.48 . \qquad ( 6 - 1 )$$

A fourteenth aspect of the present disclosure is the variable magnification optical system of the twelfth aspect, in which Conditional Expression (3-3) is satisfied, which is represented by

$$2.2 < Fnot \times ( TLt / ft ) < 4. \qquad ( 3 - 3 )$$

A fifteenth aspect of the present disclosure is the variable magnification optical system of the fourteenth aspect, in which Conditional Expression (4-3) is satisfied, which is represented

$$0.41 < ( fw \times TLw \times Fnot ) / {ft}^{2} < 0.8 . \qquad ( 4 - 3 )$$

A sixteenth aspect of the present disclosure is the variable magnification optical system of the fifteenth aspect, in which Conditional Expression (5-2) is satisfied, which is represented by

$$0.105 < tan ω w / Fnow < 0.25 . \qquad ( 5 ‐ 2 )$$

A seventeenth aspect of the present disclosure is the variable magnification optical system of the third aspect, in which in a case where a focal length of the front group in the state where the infinite distance object is focused on at the wide angle end is denoted by fFw, and a focal length of the middle group in the state where the infinite distance object is focused on at the wide angle end is denoted by fMw, Conditional Expression (7) is satisfied, which is denoted

$$0.8 < fFw / ( - fMw ) < 8. \qquad ( 7 )$$

An eighteenth aspect of the present disclosure is the variable magnification optical system of the seventeenth aspect, in which Conditional Expression (7-1) is satisfied, which is represented by

$$1.1 < fFw / ( - fMw ) < 5.3 . \qquad ( 7 ‐ 1 )$$

A nineteenth aspect of the present disclosure is the variable magnification optical system of the eighteenth aspect, in which Conditional Expression (8) is satisfied, which is represented by

$$0.8 < TLw / ft < 1.5 . \qquad ( 8 )$$

A twentieth aspect of the present disclosure is the variable magnification optical system of the nineteenth aspect, in which Conditional Expression (6-1) is satisfied, which is represented

$$1.15 < TLt / TLw < 1.48 . \qquad ( 6 ‐ 1 )$$

A twenty-first aspect of the present disclosure is the variable magnification optical system of the twentieth aspect, in which Conditional Expression (4-2) is satisfied, which is represented by

$$0.38 < ( f w \times T Lw \times Fnot ) / {ft}^{2} < 0.87 . \qquad ( 4 ‐ 2 )$$

A twenty-second aspect of the present disclosure is the variable magnification optical system of the twenty-first aspect, in which Conditional Expression (5-1) is satisfied, which is represented by

$$0.092 < tan ω w / Fnow < 0.27 . \qquad ( 5 ‐ 1 )$$

A twenty-third aspect of the present disclosure is the variable magnification optical system of the second aspect, in which Conditional Expression (4-1) is satisfied, which is represented by

$$0.36 < ( f w \times T Lw \times Fnot ) / {ft}^{2} < 0.92 . \qquad ( 4 ‐ 1 )$$

A twenty-fourth aspect of the present disclosure is the variable magnification optical system of the twenty-third aspect, in which Conditional Expression (5-1) is satisfied, which is represented by

$$0.092 < tan ω w / Fnow < 0.27 . \qquad ( 5 ‐ 1 )$$

A twenty-fifth aspect of the present disclosure is the variable magnification optical system of the twenty-third aspect, in which Conditional Expression (5-2) is satisfied, which is represented by

$$0.105 < tan ω w / Fnow < 0.25 . \qquad ( 5 ‐ 2 )$$

A twenty-sixth aspect of the present disclosure is the variable magnification optical system of the twenty-fifth aspect, in which the rear group includes an Lp1 lens having a positive refractive power and an Ln1 lens that is disposed adjacent to the image side of the Lp1 lens and that has a negative refractive power. A surface of the Lp1 lens on the image side has an aspherical shape in which a refractive power at a position of a maximum effective diameter is shifted in a negative direction compared to a refractive power in a paraxial region. A surface of the Ln1 lens on the object side has an aspherical shape in which a refractive power at a position of a maximum effective diameter is shifted in a positive direction compared to a refractive power in the paraxial region.

A twenty-seventh aspect of the present disclosure is the variable magnification optical system of the twenty-fourth aspect, in which the rear group includes an Ln2 lens having a negative refractive power and an Lp2 lens that is disposed adjacent to the image side of the Ln2 lens and that has a positive refractive power. A surface of the Ln2 lens on the object side has an aspherical shape in which a refractive power at a position of a maximum effective diameter is shifted in a negative direction compared to a refractive power in a paraxial region. A surface of the Ln2 lens on the image side has an aspherical shape in which a refractive power at a position of a maximum effective diameter is shifted in a positive direction compared to a refractive power in the paraxial region.

A twenty-eighth aspect of the present disclosure is the variable magnification optical system of the first aspect, in which Conditional Expression (9) is satisfied, which is represented by

$$2.1 < ft / fw < 6. \qquad ( 9 )$$

A twenty-ninth aspect of the present disclosure is the variable magnification optical system of the first aspect, in which in a case where a focal length of the lens group of the front group closest to the object side is denoted by fF1, Conditional Expression (10) is satisfied, which is represented by

$$1.5 < fF 1 / fw < 12. \qquad ( 10 )$$

A thirtieth aspect of the present disclosure is the variable magnification optical system of the first aspect, in which in a case where a focal length of the lens group of the front group closest to the object side is denoted by fF1, and a focal length of the middle group in the state where the infinite distance object is focused on at the wide angle end is denoted by fMw, Conditional Expression (11) is satisfied, which is denoted by

$$2 < fF 1 / ( - fMw ) < 13. \qquad ( 11 )$$

A thirty-first aspect of the present disclosure is the variable magnification optical system of the first aspect, in which in a case where a focal length of the lens group of the front group closest to the object side is denoted by fF1, Conditional Expression (12) is satisfied, which is represented by

$$0.7 < fF 1 / {( fw \times ft )}^{1 / 2} < 4.7 . \qquad ( 12 )$$

A thirty-second aspect of the present disclosure is the variable magnification optical system of the first aspect, in which in a case where a focal length of the middle group in the state where the infinite distance object is focused on at the wide angle end is denoted by fMw, Conditional Expression (13) is satisfied, which is denoted by

$$0.18 < ( - fMw ) / {( fw \times ft )}^{1 / 2} < 0.8 . \qquad ( 13 )$$

A thirty-third aspect of the present disclosure is the variable magnification optical system of the fifth aspect, in which in a case where a focal length of the lens group of the front group closest to the object side is denoted by fF1, Conditional Expression (14) is satisfied, which is represented by

$$1.3 < fF 1 / ( ft / Fnot ) < 8. \qquad ( 14 )$$

A thirty-fourth aspect of the present disclosure is the variable magnification optical system of the thirty-third aspect, in which Conditional Expression (14-1) is satisfied, which is represented by

$$1.75 < fF 1 / ( ft / Fnot ) < 2.7 . \qquad ( 14 - 1 )$$

A thirty-fifth aspect of the present disclosure is the variable magnification optical system of the thirty-fourth aspect, in which Conditional Expression (2-1) is satisfied, which is represented by

$$0.75 < Bfw / ( fw \times tan ω w ) < 1.84 . \qquad ( 2 - 1 )$$

A thirty-sixth aspect of the present disclosure is the variable magnification optical system of the thirty-fifth aspect, in which Conditional Expression (5-1) is satisfied, which is represented by

$$0.092 < tan ω w / Fnow < 0.27 \qquad ( 5 - 1 )$$

A thirty-seventh aspect of the present disclosure is the variable magnification optical system of the thirty-sixth aspect, in which Conditional Expression (6) is satisfied, which is represented by

$$1.1 < TLt / TLw < 1.9 . \qquad ( 6 )$$

A thirty-eighth aspect of the present disclosure is the variable magnification optical system of the thirty-seventh aspect, in which Conditional Expression (8) is satisfied, which is represented by

$$0.8 < TLw / ft < 1.5 . \qquad ( 8 )$$

A thirty-ninth aspect of the present disclosure is the variable magnification optical system of the first aspect, in which the variable magnification optical system includes an aperture stop disposed on the image side with respect to a lens surface of the middle group closest to the image side, and in a case where a distance on the optical axis from the lens surface of the front group closest to the object side to the aperture stop in the state where the infinite distance object is focused on at the wide angle end is denoted by DDL1STw, and a focal length of the lens group of the front group closest to the object side is denoted by fF1, Conditional Expression (15) is satisfied, which is represented by

$$0.1 < DDL 1 STw / fF 1 < 0.9 . \qquad ( 15 )$$

A fortieth aspect of the present disclosure is the variable magnification optical system of the first aspect, in which the variable magnification optical system includes an aperture stop, and in a case where a distance on the optical axis from the lens surface of the front group closest to the object side to the aperture stop in the state where the infinite distance object is focused on at the wide angle end is denoted by DDL1STw, Conditional Expression (16) is satisfied, which is represented by

$$0.18 < DDL 1 STw / TLw < 0.75 . \qquad ( 16 )$$

A forty-first aspect of the present disclosure is the variable magnification optical system of the first aspect, in which in a case where a focal length of the rear group in the state where the infinite distance object is focused on at the wide angle end is denoted by fRw, Conditional Expression (17) is satisfied, which is represented by

$$0.7 < fw / fRw < 3. \qquad ( 17 )$$

A forty-second aspect of the present disclosure is the variable magnification optical system of the first aspect, in which in a case where a focal length of the rear group in the state where the infinite distance object is focused on at the telephoto end is denoted by fRt, Conditional Expression (18) is satisfied, which is represented by

$$1.1 < ft / fRt < 7 \qquad ( 18 )$$

A forty-third aspect of the present disclosure is the variable magnification optical system of the first aspect, in which in a case where a focal length of the lens group of the rear group closest to the object side is denoted by fR1, Conditional Expression (19) is satisfied, which is represented by

$$0.05 < fR 1 / {( fw \times ft )}^{1 / 2} < 3. \qquad ( 19 )$$

A forty-fourth aspect of the present disclosure is the variable magnification optical system of the first aspect, in which in a case where a focal length of the lens group of the rear group closest to the object side is denoted by fR1, Conditional Expression (20) is satisfied, which is represented by

$$0.05 < fw / fR 1 < 2.5 . \qquad ( 20 )$$

A forty-fifth aspect of the present disclosure is the variable magnification optical system of the first aspect, in which at least one lens group that does not move during changing the magnification is disposed between the front group and a lens group of the rear group closest to the image side.

A forty-sixth aspect of the present disclosure is the variable magnification optical system of the first aspect, in which a vibration-proof group that moves in a direction intersecting with the optical axis during image shake correction is disposed on the image side with respect to the front group, and in a case where a focal length of the vibration-proof group is denoted by fIS, Conditional Expression (21) is satisfied, which is represented by

$$0.07 < \vert fIS / ft \vert < 0.5 . \qquad ( 21 )$$

A forty-seventh aspect of the present disclosure is the variable magnification optical system of the forty-sixth aspect, in which the vibration-proof group is disposed in the middle group.

A forth-eighth aspect of the present disclosure is the variable magnification optical system of the first aspect, in which a focusing group that moves along the optical axis during focusing is disposed in only the rear group.

A forty-ninth aspect of the present disclosure is the variable magnification optical system of the forty-eighth aspect, in which two focusing groups are disposed in the rear group.

A fiftieth aspect of the present disclosure is the variable magnification optical system of the first aspect, the front group includes a cemented lens obtained by bonding a negative meniscus lens having a convex surface toward the object side and a positive lens having a convex surface toward the object side to each other in this order from the object side, and in a case where a refractive index of the negative meniscus lens with respect to a d line is denoted by Ndn, and an Abbe number of the negative meniscus lens based on the d line is denoted by vdn, Conditional Expression (22) is satisfied, which is represented by

$$1.94 < N d n + 0.01 \times v d n < 2.5 . \qquad ( 22 )$$

A fifty-first aspect of the present disclosure is the variable magnification optical system of the fiftieth aspect, in which in a case where a refractive index of the positive lens with respect to the d line is denoted by Ndp, and an Abbe number of the positive lens based on the d line is denoted by vdp, Conditional Expression (23) is satisfied, which is represented by

$$2 < N d p + 0.01 \times v d p < 2.6 . \qquad ( 23 )$$

A fifty-second aspect of the present disclosure is the variable magnification optical system of the first aspect, in which in a case where an average value of Abbe numbers of all positive lenses in the front group based on a d line is denoted by vdFp_ave, Conditional Expression (24) is satisfied, which is represented by

$$55 < vdFp\_ave < 95. \qquad ( 24 )$$

A fifty-third aspect of the present disclosure is the variable magnification optical system of the first aspect, in which in a case where a thickness of the lens group of the front group closest to the object side on the optical axis is denoted by dF1, and a focal length of the lens group of the front group closest to the object side is denoted by fF1, Conditional Expression (25) is satisfied, which is represented by

$$0.03 < dF 1 / fF 1 < 0.35 . \qquad ( 25 )$$

A fifty-fourth aspect of the present disclosure is the variable magnification optical system of the first aspect, in which in a case where an average value of specific gravities of all lenses in the front group is denoted by GFave, Conditional Expression (26) is satisfied, which is represented by

$$2 < GFave < 4.3 . \qquad ( 26 )$$

A fifty-fifth aspect of the present disclosure is the variable magnification optical system of the first aspect, in which the rear group consists of a first subsequent lens group having a positive refractive power, a second subsequent lens group having a negative refractive power, and a third subsequent lens group having a positive refractive power in this order from the object side to the image side.

A fifty-sixth aspect of the present disclosure is the variable magnification optical system of the fifty-fifth aspect, in which in a case where a focal length of the first subsequent lens group is denoted by fR1, and a focal length of the third subsequent lens group is denoted by fR3, Conditional Expression (27) is satisfied, which is represented by

$$0.05 < fR 1 / fR 3 < 0.6 ( 27 ) . \qquad ( 27 )$$

A fifty-seventh aspect of the present disclosure is the variable magnification optical system of the fifty-fifth aspect, in which in a case where a focal length of the first subsequent lens group is denoted by fR1, and a focal length of the second subsequent lens group is denoted by fR2, Conditional Expression (28) is satisfied, which is represented by

$$0.2 < fR 1 / ( - fR 2 ) < 1. \qquad ( 28 )$$

A fifty-eighth aspect of the present disclosure is the variable magnification optical system of the first aspect, in which the rear group consists of a first subsequent lens group having a positive refractive power, a second subsequent lens group having a positive refractive power, and a third subsequent lens group having a negative refractive power in this order from the object side to the image side.

A fifty-ninth aspect of the present disclosure is the variable magnification optical system of the fifty-eighth aspect, in which in a case where a focal length of the first subsequent lens group is denoted by fR1, and a focal length of the third subsequent lens group is denoted by fR3, Conditional Expression (29) is satisfied, which is represented by

$$0.5 < fR 1 / ( - fR 3 ) < 1.6 . \qquad ( 29 )$$

A sixtieth aspect of the present disclosure is the variable magnification optical system of the fifty-eighth aspect, in which in a case where a focal length of the second subsequent lens group is denoted by fR2, and a focal length of the third subsequent lens group is denoted by fR3, Conditional Expression (30) is satisfied, which is represented by

$$0.8 < fR 2 / ( - fR 3 ) < 3. \qquad ( 30 )$$

A sixty-first aspect of the present disclosure is the variable magnification optical system of the first aspect, in which the rear group includes at least a first subsequent lens group having a positive refractive power, a second subsequent lens group having a positive refractive power, a third subsequent lens group having a negative refractive power, and a fourth subsequent lens group having a positive refractive power consecutively in this order from a side closest to the object side to the image side.

A sixty-second aspect of the present disclosure is the variable magnification optical system of the sixty-first aspect, in which in a case where a focal length of the first subsequent lens group is denoted by fR1, and a focal length of the third subsequent lens group is denoted by fR3, Conditional Expression (29A) is satisfied, which is represented by

$$0.9 < fR 1 / ( - fR 3 ) < 10. \qquad ( 29 A )$$

A sixty-third aspect of the present disclosure is the variable magnification optical system of the sixty-first aspect, in which in a case where a focal length of the second subsequent lens group is denoted by fR2, and a focal length of the third subsequent lens group is denoted by fR3, Conditional Expression (30A) is satisfied, which is represented by

$$0.1 < fR 2 / ( - fR 3 ) < 1.8 . \qquad ( 30 A )$$

A sixty-fourth aspect of the present disclosure is the variable magnification optical system of the sixty-first aspect, in which in a case where a focal length of the first subsequent lens group is denoted by fR1, and a focal length of the second subsequent lens group is denoted by fR2, Conditional Expression (31) is satisfied, which is represented by

$$1.2 < fR 1 / fR 2 < 11. \qquad ( 31 )$$

A sixty-fifth aspect of the present disclosure is the variable magnification optical system of the sixty-first aspect, in which in a case where a focal length of the second subsequent lens group is denoted by fR2, and a focal length of the fourth subsequent lens group is denoted by fR4, Conditional Expression (32) is satisfied, which is represented by

$$0.1 < fR 2 / fR 4 < 1.5 . \qquad ( 32 )$$

A sixty-sixth aspect of the present disclosure is the variable magnification optical system of the first aspect, in which the rear group includes at least a first subsequent lens group having a positive refractive power, a second subsequent lens group having a negative refractive power, a third subsequent lens group having a positive refractive power, and a fourth subsequent lens group having a negative refractive power consecutively in this order from a side closest to the object side to the image side.

A sixty-seventh aspect of the present disclosure is the variable magnification optical system of the sixty-sixth aspect, in which in a case where a focal length of the first subsequent lens group is denoted by fR1, and a focal length of the third subsequent lens group is denoted by fR3, Conditional Expression (27A) is satisfied, which is represented by

$$0.25 < fR 1 / fR 3 < 6. \qquad ( 27 A )$$

A sixty-eighth aspect of the present disclosure is the variable magnification optical system of the sixty-sixth aspect, in which in a case where a focal length of the second subsequent lens group is denoted by fR2, and a focal length of the fourth subsequent lens group is denoted by fR4, Conditional Expression (32A) is satisfied, which is represented by

$$0.4 < fR 2 / fR 4 < 18. \qquad ( 32 A )$$

A sixty-ninth aspect of the present disclosure is the variable magnification optical system of the sixty-sixth aspect, in which the rear group consists of the first subsequent lens group having a positive refractive power, the second subsequent lens group having a negative refractive power, the third subsequent lens group having a positive refractive power, the fourth subsequent lens group having a negative refractive power, a fifth subsequent lens group having a positive refractive power, and a sixth subsequent lens group having a negative refractive power in this order from the object side to the image side.

A seventieth aspect of the present disclosure is the variable magnification optical system of the sixty-ninth aspect, in which in a case where a focal length of the third subsequent lens group is denoted by fR3, and a focal length of the fifth subsequent lens group is denoted by fR5, Conditional Expression (33) is satisfied, which is represented by

$$0.2 < fR 3 / fR 5 < 2.5 . \qquad ( 33 )$$

A seventy-first aspect of the present disclosure is the variable magnification optical system of the sixty-ninth aspect, in which in a case where a focal length of the fourth subsequent lens group is denoted by fR4, and a focal length of the sixth subsequent lens group is denoted by fR6, Conditional Expression (34) is satisfied, which is represented by

$$0.04 < fR 4 / fR 6 < 4. \qquad ( 34 )$$

A seventy-second aspect of the present disclosure is the variable magnification optical system of the first aspect, in which the rear group includes at least a first subsequent lens group having a positive refractive power, a second subsequent lens group having a positive refractive power, a third subsequent lens group having a positive refractive power, and a fourth subsequent lens group having a negative refractive power consecutively in this order from a side closest to the object side to the image side.

A seventy-third aspect of the present disclosure is the variable magnification optical system of the seventy-second aspect, in which in a case where a focal length of the first subsequent lens group is denoted by fR1, and a focal length of the second subsequent lens group is denoted by fR2, Conditional Expression (31A) is satisfied, which is represented by

$$0.06 < fR 1 / fR 2 < 0.7 . \qquad ( 31 A )$$

A seventy-fourth aspect of the present disclosure is the variable magnification optical system of the seventy-second aspect, in which in a case where a focal length of the second subsequent lens group is denoted by fR2, and a focal length of the third subsequent lens group is denoted by fR3, Conditional Expression (35) is satisfied, which is represented by

$$0.5 < fR 2 / fR 3 < 11. \qquad ( 35 )$$

A seventy-fifth aspect of the present disclosure is the variable magnification optical system of the seventy-second aspect, in which in a case where a focal length of the third subsequent lens group is denoted by fR3, and a focal length of the fourth subsequent lens group is denoted by fR4, Conditional Expression (36) is satisfied, which is represented by

$$0.2 < fR 3 / ( - fR 4 ) < 3. \qquad ( 36 )$$

A seventy-sixth aspect of the present disclosure is the variable magnification optical system of the first aspect, in which the rear group consists of a first subsequent lens group having a positive refractive power, a second subsequent lens group having a positive refractive power, a third subsequent lens group having a negative refractive power, and a fourth subsequent lens group having a negative refractive power in this order from the object side to the image side.

A seventy-seventh aspect of the present disclosure is the variable magnification optical system of the seventy-sixth aspect, in which in a case where a focal length of the first subsequent lens group is denoted by fR1, and a focal length of the second subsequent lens group is denoted by fR2, Conditional Expression (31B) is satisfied, which is represented by

$$0.6 < fR 1 / fR 2 < 4. \qquad ( 31 B )$$

A seventy-eighth aspect of the present disclosure is the variable magnification optical system of the seventy-sixth aspect, in which in a case where a focal length of the third subsequent lens group is denoted by fR3, and a focal length of the fourth subsequent lens group is denoted by fR4, Conditional Expression (37) is satisfied, which is represented by

$$0.05 < fR 3 / fR 4 < 1. \qquad ( 37 )$$

A seventy-ninth aspect of the present disclosure is the variable magnification optical system of the first aspect, in which the rear group includes at least a first subsequent lens group having a positive refractive power, a second subsequent lens group having a negative refractive power, and a third subsequent lens group having a negative refractive power consecutively in this order from a side closest to the object side to the image side.

An eightieth aspect of the present disclosure is the variable magnification optical system of the seventy-ninth aspect, in which in a case where a focal length of the first subsequent lens group is denoted by fR1, and a focal length of the second subsequent lens group is denoted by fR2, Conditional Expression (28A) is satisfied, which is represented by

$$0.2 < fR 1 / ( - fR 2 ) < 1. \qquad ( 28 A )$$

An eighty-first aspect of the present disclosure is the variable magnification optical system of the seventy-ninth aspect, in which in a case where a focal length of the second subsequent lens group is denoted by fR2, and a focal length of the third subsequent lens group is denoted by fR3, Conditional Expression (35A) is satisfied, which is represented by

$$0.2 < fR 2 / fR 3 < 1. \qquad ( 35 A )$$

An eighty-second aspect of the present disclosure is an imaging apparatus comprising the variable magnification optical system of any one of the first to eighty-first aspects.

In the present specification, the expressions “consists of” and “consisting of” intend that a lens substantially not having a refractive power, an optical element other than a lens such as a stop, a filter, and a cover glass, a mechanism part such as a lens flange, a lens barrel, an imaging element, and a camera shake correction mechanism may be included in addition to the illustrated constituents.

The term “group having a positive refractive power” and the expression “a group has a positive refractive power” in the present specification mean that a positive refractive power is provided as a whole group. Similarly, the term “group having a negative refractive power” means that a negative refractive power is provided as a whole group. The term “lens having a positive refractive power” and the term “positive lens” are synonymous with each other. The term “lens having a negative refractive power” and the term “negative lens” are synonymous with each other. The term “group” in the present specification is not limited to a configuration consisting of a plurality of lenses and may be a configuration consisting of only one lens.

A compound aspherical lens (a lens (for example, a spherical lens) and a film of an aspherical shape formed on the lens are configured to be integrated with each other, and the lens functions as one aspherical lens as a whole) is not considered to be a cemented lens and is regarded as one lens. Unless otherwise specified, a sign of a refractive power and a surface shape related to a lens including an aspherical surface in a paraxial region are used.

The term “entire system” in the present specification means the variable magnification optical system. The term “focal length” used in the conditional expressions is a paraxial focal length. Unless otherwise specified, the term “distance on the optical axis” used in the conditional expressions is a geometrical distance. Unless otherwise specified, values used in the conditional expressions are values based on the d line in a state where an infinite distance object is focused on.

According to the present disclosure, a variable magnification optical system that is configured to have a small size and that has a small F-number in the entire magnification range and favorable optical performance in the entire magnification range, and an imaging apparatus comprising the variable magnification optical system can be provided.

### BRIEF DESCRIPTION OF THE DRAWINGS

FIG. 1 is a diagram that corresponds to a variable magnification optical system of Example 1 and that illustrates a cross-sectional view and a moving path of a configuration of a variable magnification optical system according to one embodiment.

FIG. 2 is a diagram for describing symbols of conditional expressions.

FIG. 3 is a diagram for describing a position of a maximum effective diameter.

FIG. 4 is each aberration diagram of the variable magnification optical system of Example 1.

FIG. 5 is a diagram illustrating a cross-sectional view and a moving path of a configuration of a variable magnification optical system of Example 2.

FIG. 6 is each aberration diagram of the variable magnification optical system of Example 2.

FIG. 7 is a diagram illustrating a cross-sectional view and a moving path of a configuration of a variable magnification optical system of Example 3.

FIG. 8 is each aberration diagram of the variable magnification optical system of Example 3.

FIG. 9 is a diagram illustrating a cross-sectional view and a moving path of a configuration of a variable magnification optical system of Example 4.

FIG. 10 is each aberration diagram of the variable magnification optical system of Example 4.

FIG. 11 is a diagram illustrating a cross-sectional view and a moving path of a configuration of a variable magnification optical system of Example 5.

FIG. 12 is each aberration diagram of the variable magnification optical system of Example 5.

FIG. 13 is a diagram illustrating a cross-sectional view and a moving path of a configuration of a variable magnification optical system of Example 6.

FIG. 14 is each aberration diagram of the variable magnification optical system of Example 6.

FIG. 15 is a diagram illustrating a cross-sectional view and a moving path of a configuration of a variable magnification optical system of Example 7.

FIG. 16 is each aberration diagram of the variable magnification optical system of Example 7.

FIG. 17 is a diagram illustrating a cross-sectional view and a moving path of a configuration of a variable magnification optical system of Example 8.

FIG. 18 is each aberration diagram of the variable magnification optical system of Example 8.

FIG. 19 is a diagram illustrating a cross-sectional view and a moving path of a configuration of a variable magnification optical system of Example 9.

FIG. 20 is each aberration diagram of the variable magnification optical system of Example 9.

FIG. 21 is a diagram illustrating a cross-sectional view and a moving path of a configuration of a variable magnification optical system of Example 10.

FIG. 22 is each aberration diagram of the variable magnification optical system of Example 10.

FIG. 23 is a diagram illustrating a cross-sectional view and a moving path of a configuration of a variable magnification optical system of Example 11.

FIG. 24 is each aberration diagram of the variable magnification optical system of Example 11.

FIG. 25 is a diagram illustrating a cross-sectional view and a moving path of a configuration of a variable magnification optical system of Example 12.

FIG. 26 is each aberration diagram of the variable magnification optical system of Example 12.

FIG. 27 is a diagram illustrating a cross-sectional view and a moving path of a configuration of a variable magnification optical system of Example 13.

FIG. 28 is each aberration diagram of the variable magnification optical system of Example 13.

FIG. 29 is a diagram illustrating a cross-sectional view and a moving path of a configuration of a variable magnification optical system of Example 14.

FIG. 30 is each aberration diagram of the variable magnification optical system of Example 14.

FIG. 31 is a diagram illustrating a cross-sectional view and a moving path of a configuration of a variable magnification optical system of Example 15.

FIG. 32 is each aberration diagram of the variable magnification optical system of Example 15.

FIG. 33 is a diagram illustrating a cross-sectional view and a moving path of a configuration of a variable magnification optical system of Example 16.

FIG. 34 is each aberration diagram of the variable magnification optical system of Example 16.

FIG. 35 is a diagram illustrating a cross-sectional view and a moving path of a configuration of a variable magnification optical system of Example 17.

FIG. 36 is each aberration diagram of the variable magnification optical system of Example 17.

FIG. 37 is a diagram illustrating a cross-sectional view and a moving path of a configuration of a variable magnification optical system of Example 18.

FIG. 38 is each aberration diagram of the variable magnification optical system of Example 18.

FIG. 39 is a diagram illustrating a cross-sectional view and a moving path of a configuration of a variable magnification optical system of Example 19.

FIG. 40 is each aberration diagram of the variable magnification optical system of Example 19.

FIG. 41 is a diagram illustrating a cross-sectional view and a moving path of a configuration of a variable magnification optical system of Example 20.

FIG. 42 is each aberration diagram of the variable magnification optical system of Example 20.

FIG. 43 is a diagram illustrating a cross-sectional view and a moving path of a configuration of a variable magnification optical system of Example 21.

FIG. 44 is each aberration diagram of the variable magnification optical system of Example 21.

FIG. 45 is a diagram illustrating a cross-sectional view and a moving path of a configuration of a variable magnification optical system of Example 22.

FIG. 46 is each aberration diagram of the variable magnification optical system of Example 22.

FIG. 47 is a diagram illustrating a cross-sectional view and a moving path of a configuration of a variable magnification optical system of Example 23.

FIG. 48 is each aberration diagram of the variable magnification optical system of Example 23.

FIG. 49 is a diagram illustrating a cross-sectional view and a moving path of a configuration of a variable magnification optical system of Example 24.

FIG. 50 is each aberration diagram of the variable magnification optical system of Example 24.

FIG. 51 is a perspective view of a front surface side of an imaging apparatus according to one embodiment.

FIG. 52 is a perspective view of a rear surface side of the imaging apparatus according to one embodiment.

### DESCRIPTION OF EMBODIMENTS

Hereinafter, an embodiment of the present disclosure will be described with reference to the drawings.

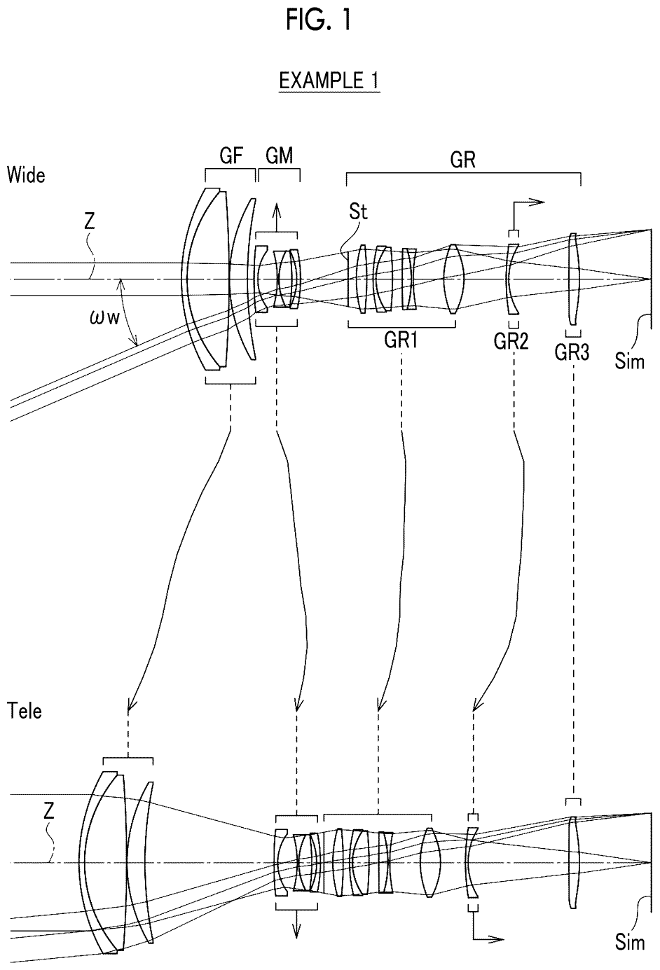

FIG. 1 illustrates a cross-sectional view and a moving path of a configuration of a variable magnification optical system according to one embodiment of the present disclosure. In FIG. 1, a wide angle end state is illustrated in an upper part denoted by “Wide”, and a telephoto end state is illustrated in a lower part denoted by “Tele”. The example illustrated in FIG. 1 corresponds to a variable magnification optical system of Example 1. FIG. 1 illustrates a state where an infinite distance object is focused on, in which a left side is an object side and a right side is an image side. FIG. 1 also illustrates an on-axis luminous flux and a luminous flux of a maximum half angle of view ow at a wide angle end and an on-axis luminous flux and a luminous flux of the maximum half angle of view at a telephoto end.

The variable magnification optical system according to the present disclosure consists of a front group GF, a middle group GM, and a rear group GR in this order from the object side to the image side along an optical axis Z. The front group GF consists of two lens groups or less having a positive refractive power. The middle group consists of two lens groups or less having a negative refractive power. The rear group GR consists of a plurality of lens groups. A lens group of the rear group GR closest to the object side has a positive refractive power. During changing magnification, a lens group of the front group GF closest to the object side moves, and spacings between all adjacent lens groups in the variable magnification optical system change. By the above configuration, an advantage of suppressing various aberrations in the entire magnification range is achieved.

Particularly, by setting the front group GF as a group having a positive refractive power, a total optical length can be reduced. Thus, an advantage of establishing both of size reduction and a high magnification ratio is achieved. In addition, by setting the front group GF as a group having a positive refractive power, a height of a ray incident on the middle group GM from the optical axis Z can be decreased. Thus, an advantage of suppressing fluctuations of aberrations during changing the magnification is achieved. By configuring the front group GF to consist of one or two lens groups having a positive refractive power and configuring the middle group GM to consist of one or two lens groups having a negative refractive power, an advantage of changing the magnification while suppressing various aberrations is achieved. By changing the spacings among the plurality of groups during changing the magnification, an advantage of suppressing various aberrations in the entire magnification range is achieved.

In the present specification, a group of which a spacing with its adjacent group in an optical axis direction changes during changing the magnification is set as one lens group. During changing the magnification, a spacing between adjacent lenses does not change in one lens group. That is, the term “lens group” means a part that constitutes the variable magnification optical system and that includes at least one lens divided by an air spacing which changes during changing the magnification. During changing the magnification, each lens group moves or does not move in lens group units. Not moving during changing the magnification means being fixed with respect to an image plane Sim during changing the magnification. The term “lens group” may include a constituent, for example, an aperture stop St, other than a lens that does not have a refractive power.

For example, each group of the variable magnification optical system illustrated in FIG. 1 is configured as follows. The front group GF consists of one lens group composed of three lenses. The middle group GM consists of one lens group composed of four lenses. The rear group GR consists of three lens groups of a first subsequent lens group GR1 composed of the aperture stop St and six lenses, a second subsequent lens group GR2 composed of one lens, and a third subsequent lens group GR3 composed of one lens in this order from the object side to the image side. The aperture stop St illustrated in FIG. 1 does not indicate a size and a shape and indicates a position on the optical axis. As in the example in FIG. 1, in a case where the front group GF is configured to consist of one lens group, an advantage of size reduction is achieved. In a case where the middle group GM is configured to consist of one lens group, an advantage of size reduction is achieved.

As in the example in FIG. 1, the front group GF preferably includes a cemented lens obtained by bonding a negative meniscus lens having a convex surface toward the object side and a positive lens having a convex surface toward the object side to each other in this order from the object side. In this case, correction of a lateral chromatic aberration at the wide angle end and an axial chromatic aberration at the telephoto end is facilitated.

In the example in FIG. 1, during changing the magnification, the front group GF, the middle group GM, the first subsequent lens group GR1, and the second subsequent lens group GR2 move along the optical axis Z by changing the spacings with their adjacent lens groups, and the third subsequent lens group GR3 does not move. In FIG. 1, a schematic moving path from the wide angle end to the telephoto end during changing the magnification is illustrated by a solid line arrow for each group that moves during changing the magnification, and each group that does not move during changing the magnification is illustrated by a straight dotted line in an up-down direction.

In the variable magnification optical system in the example in FIG. 1, a vibration-proof group that moves in a direction intersecting with the optical axis Z during image shake correction is disposed. The image shake correction is performed by moving the vibration-proof group. In the example in FIG. 1, the vibration-proof group consists of the middle group GM. In FIG. 1, a lens group corresponding to the vibration-proof group is indicated by an arrow in the up-down direction. In a case where the vibration-proof group is disposed in the middle group, an advantage of suppressing a moving amount of the vibration-proof group during the image shake correction is achieved.

In addition, in the variable magnification optical system in the example in FIG. 1, a focusing group that moves along the optical axis Z during focusing is disposed. The focusing is performed by moving the focusing group. In the example in FIG. 1, the focusing group consists of the second subsequent lens group GR2. In FIG. 1, a lens group corresponding to the focusing group is indicated by an arrow in a left-right direction indicating a moving direction during the focusing from the infinite distance object to a nearest object.

Next, preferable configurations and available configurations related to conditional expressions of the variable magnification optical system according to the present disclosure will be described. In the following description related to the conditional expressions, duplicate descriptions of symbols will be omitted by using the same symbol for the same definition in order to avoid redundant description. In addition, hereinafter, the term “variable magnification optical system according to the present disclosure” will be simply referred to as the “variable magnification optical system” in order to avoid redundant description.

The variable magnification optical system preferably satisfies Conditional Expression (1) below. Here, a back focus of an entire system as an air conversion distance in a state where the infinite distance object is focused on at the wide angle end is denoted by Bfw. A sum of the back focus Bfw and a distance on the optical axis from a lens surface of the front group GF closest to the object side to a lens surface of the rear group GR closest to the image side in the state where the infinite distance object is focused on at the wide angle end is denoted by TLw. In addition, a focal length of the entire system in the state where the infinite distance object is focused on at the wide angle end is denoted by fw. A maximum half angle of view in the state where the infinite distance object is focused on at the wide angle end is denoted by ww. TLw denotes a total length in the state where the infinite distance object is focused on at the wide angle end. In Conditional Expression (1), tan is a tangent, and the same representation applies to other conditional expressions. By not causing a corresponding value of Conditional Expression (1) to be less than or equal to its lower limit, an advantage of suppressing various aberrations in the entire magnification range is achieved. By not causing the corresponding value of Conditional Expression (1) to be greater than or equal to its upper limit, an advantage of reducing a size of the entire optical system is achieved.

$$5 < TLw / ( fw \times tan ω w ) < 12 \qquad ( 1 )$$

In order to obtain more favorable characteristics, it is preferable to set the lower limit of Conditional Expression (1) to any of 5.5, 6, 6.5, and 7 instead of 5. In addition, it is preferable to set the upper limit of Conditional Expression (1) to any of 11, 10.5, 10, and 9.5 instead of 12.

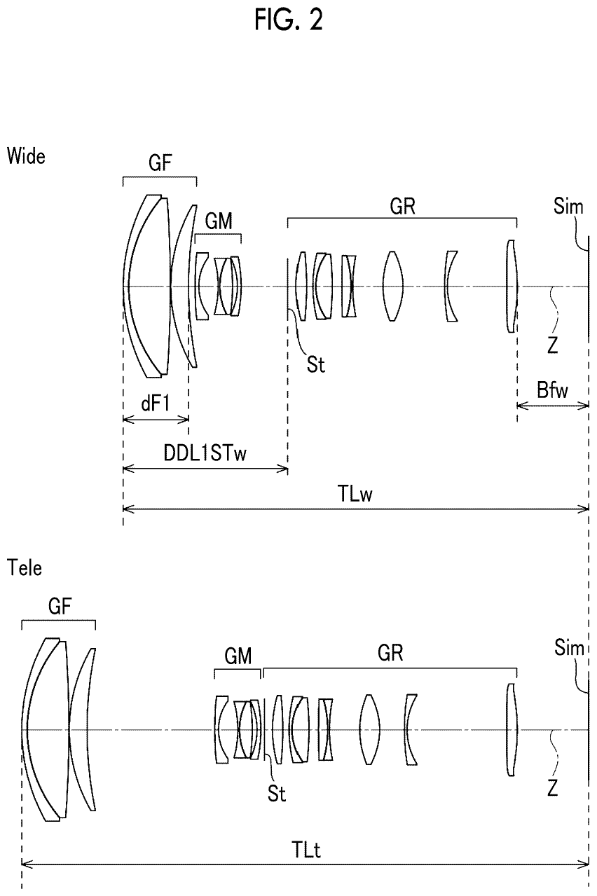

FIG. 2 illustrates a cross-sectional view of the variable magnification optical system in FIG. 1. For example, the back focus Bfw and the total length TLw in the variable magnification optical system are illustrated. In FIG. 2, the wide angle end state is illustrated in an upper part denoted by “Wide”, and the telephoto end state is illustrated in a lower part denoted by “Tele”.

In a case where the back focus of the entire system as the air conversion distance in the state where the infinite distance object is focused on at the wide angle end is denoted by Bfw, the variable magnification optical system preferably satisfies Conditional Expression (2) below. The back focus as the air conversion distance is an air conversion distance on the optical axis from the lens surface of the rear group GR closest to the image side to the image plane Sim. By not causing a corresponding value of Conditional Expression (2) to be less than or equal to its lower limit, the back focus Bfw defined above is not excessively decreased. Thus, attachment of a mount replacement mechanism is facilitated. By not causing the corresponding value of Conditional Expression (2) to be greater than or equal to its upper limit, the back focus Bfw defined above is not excessively increased. Thus, size reduction is facilitated.

$$0.5 < Bfw / ( fw \times tan ω w ) < 2.5 \qquad ( 2 )$$

In order to obtain more favorable characteristics, it is preferable to set the lower limit of Conditional Expression (2) to any of 0.6, 0.68, 0.75, and 0.8 instead of 0.5. In addition, it is preferable to set the upper limit of Conditional Expression (2) to any of 2.3, 2.1, 1.84, and 1.7 instead of 2.5. For example, the variable magnification optical system more preferably satisfies Conditional Expression (2-1) below.

$$0.75 < Bfw / ( fw \times tan ω w ) < 1.84 \qquad ( 2 - 1 )$$

The variable magnification optical system preferably satisfies Conditional Expression (3) below. Here, an open F-number in a state where the infinite distance object is focused on at the telephoto end is denoted by Fnot. A sum of the back focus of the entire system as the air conversion distance and a distance on the optical axis from the lens surface of the front group GF closest to the object side to the lens surface of the rear group GR closest to the image side in the state where the infinite distance object is focused on at the telephoto end is denoted by TLt. The focal length of the entire system in the state where the infinite distance object is focused on at the telephoto end is denoted by ft. TLt denotes a total length in the state where the infinite distance object is focused on at the telephoto end. For example, FIG. 2 illustrates the total length TLt. By not causing a corresponding value of Conditional Expression (3) to be less than or equal to its lower limit, an advantage of suppressing various aberrations in the entire magnification range is achieved. By not causing the corresponding value of Conditional Expression (3) to be greater than or equal to its upper limit, an advantage of reducing the total length while decreasing the F-number at the telephoto end is achieved.

$$1.8 < Fnot \times ( TLt / ft ) < 5 \qquad ( 3 )$$

In order to obtain more favorable characteristics, it is preferable to set the lower limit of Conditional Expression (3) to any of 1.9, 2, 2.1, and 2.2 instead of 1.8. In addition, it is preferable to set the upper limit of Conditional Expression (3) to any of 4.6, 4.3, 4.1, and 4 instead of 5. For example, the variable magnification optical system more preferably satisfies Conditional Expression (3-1) below, further preferably satisfies Conditional Expression (3-2) below, and still more preferably satisfies Conditional Expression (3-3) below.

$$1.9 < Fnot \times ( TLt / ft ) < 4.6 \qquad ( 3 - 1 )$$

$$2 < Fnot \times ( TLt / ft ) < 4.3 \qquad ( 3 - 2 )$$

$$2.2 < Fnot \times ( TLt / ft ) < 4 \qquad ( 3 - 3 )$$

The variable magnification optical system preferably satisfies Conditional Expression (4) below. By not causing a corresponding value of Conditional Expression (4) to be less than or equal to its lower limit, an advantage of suppressing various aberrations in the entire magnification range is achieved. By not causing the corresponding value of Conditional Expression (4) to be greater than or equal to its upper limit, an advantage of decreasing the F-number at the telephoto end is achieved. In addition, since the total optical length at the wide angle end is not excessively increased, an advantage of size reduction is achieved.

$$0.34 < ( fw \times TLw \times Fnot ) / {ft}^{2} < 0.97 \qquad ( 4 )$$

In order to obtain more favorable characteristics, it is preferable to set the lower limit of Conditional Expression (4) to any of 0.36, 0.38, 0.4, 0.41, and 0.42 instead of 0.34. In addition, it is preferable to set the upper limit of Conditional Expression (4) to any of 0.92, 0.87, 0.83, 0.8, and 0.77 instead of 0.97. For example, the variable magnification optical system more preferably satisfies Conditional Expression (4-1) below, further preferably satisfies Conditional Expression (4-2) below, and still more preferably satisfies Conditional Expression (4-3) below.

$$0.36 < ( fw \times TLw \times Fnot ) / {ft}^{2} < 0.92 \qquad ( 4 - 1 )$$

$$0.38 < ( fw \times TLw \times Fnot ) / {ft}^{2} < 0.87 \qquad ( 4 - 2 )$$

$$0.41 < ( fw \times TLw \times Fnot ) / {ft}^{2} < 0.8 \qquad ( 4 - 3 )$$

In a case where the open F-number in the state where the infinite distance object is focused on at the wide angle end is denoted by Fnow, the variable magnification optical system preferably satisfies Conditional Expression (5) below. By not causing a corresponding value of Conditional Expression (5) to be less than or equal to its lower limit, it is facilitated to decrease the open F-number at the wide angle end while increasing an angle of view at the wide angle end. By not causing the corresponding value of Conditional Expression (5) to be greater than or equal to its upper limit, an advantage of suppressing an increase in the number of lenses and suppressing size increase of the optical system while obtaining favorable optical performance is achieved.

$$0.075 < tan ω w / Fnow < 0.3 \qquad ( 5 )$$

In order to obtain more favorable characteristics, it is preferable to set the lower limit of Conditional Expression (5) to any of 0.092 and 0.105 instead of 0.075. In addition, it is preferable to set the upper limit of Conditional Expression (5) to any of 0.27 and 0.25 instead of 0.3. For example, the variable magnification optical system more preferably satisfies Conditional Expression (5-1) below and further preferably satisfies Conditional Expression (5-2) below.

$$0.092 < tan ω w / Fnow < 0.27 \qquad ( 5 - 1 )$$

$$0.105 < tan ω w / Fnow < 0.25 \qquad ( 5 - 2 )$$

The variable magnification optical system preferably satisfies Conditional Expression (6) below. By not causing a corresponding value of Conditional Expression (6) to be less than or equal to its lower limit, an advantage of suppressing various aberrations in the entire magnification range is achieved. By not causing the corresponding value of Conditional Expression (6) to be greater than or equal to its upper limit, the total optical length at the telephoto end is not excessively increased. Thus, an advantage of size reduction is achieved.

$$1.1 < TLt / TLw < 1.9 \qquad ( 6 )$$

In order to obtain more favorable characteristics, it is preferable to set the lower limit of Conditional Expression (6) to any of 1.13 and 1.15 instead of 1.1. In addition, it is preferable to set the upper limit of Conditional Expression (6) to any of 1.68 and 1.48 instead of 1.9. For example, the variable magnification optical system more preferably satisfies Conditional Expression (6-1) below.

$$1.15 < TLt / TLw < 1.48 \qquad ( 6 - 1 )$$

The variable magnification optical system preferably satisfies Conditional Expression (7) below. Here, a focal length of the front group GF in the state where the infinite distance object is focused on at the wide angle end is denoted by fFw. A focal length of the middle group GM in the state where the infinite distance object is focused on at the wide angle end is denoted by fMw. By not causing a corresponding value of Conditional Expression (7) to be less than or equal to its lower limit, a refractive power of the middle group GM is not excessively decreased. Thus, it is facilitated to suppress a moving amount of the middle group GM during changing the magnification. By not causing the corresponding value of Conditional Expression (7) to be greater than or equal to its upper limit, a refractive power of the front group GF is not excessively decreased. Thus, it is facilitated to suppress size increase of the front group GF.

$$0.8 < fFw / ( - fMw ) < 8 \qquad ( 7 )$$

In order to obtain more favorable characteristics, it is preferable to set the lower limit of Conditional Expression (7) to any of 0.9, 1, and 1.1 instead of 0.8. In addition, it is preferable to set the upper limit of Conditional Expression (7) to any of 7, 6, and 5.3 instead of 8. For example, the variable magnification optical system more preferably satisfies Conditional Expression (7-1) below.

$$1.1 < fFw / ( - fMw ) < 5.3 \qquad ( 7 - 1 )$$

The variable magnification optical system preferably satisfies Conditional Expression (8) below. By not causing a corresponding value of Conditional Expression (8) to be less than or equal to its lower limit, it is facilitated to suppress various aberrations at the wide angle end. By not causing the corresponding value of Conditional Expression (8) to be greater than or equal to its upper limit, it is facilitated to reduce the total optical length at the wide angle end.

$$0.8 < TLw / ft < 1.5 \qquad ( 8 )$$

In order to obtain more favorable characteristics, it is preferable to set the lower limit of Conditional Expression (8) to any of 0.83 and 0.85 instead of 0.8. In addition, it is preferable to set the upper limit of Conditional Expression (8) to any of 1.3 and 1.2 instead of 1.5.

The variable magnification optical system preferably satisfies Conditional Expression (9) below. By not causing a corresponding value of Conditional Expression (9) to be less than or equal to its lower limit, a magnification ratio is not excessively decreased. Thus, value of the variable magnification optical system can be sufficiently exhibited. By not causing the corresponding value of Conditional Expression (9) to be greater than or equal to its upper limit, the magnification ratio is not excessively increased. Thus, an excessive increase in a moving amount of a lens group can be prevented. Accordingly, an advantage of reducing the size of the entire optical system is achieved.

$$2.1 < ft / fw < 6 \qquad ( 9 )$$

In order to obtain more favorable characteristics, it is preferable to set the lower limit of Conditional Expression (9) to any of 2.3, 2.5, and 2.6 instead of 2.1. In addition, it is preferable to set the upper limit of Conditional Expression (9) to any of 5.5, 5, and 4.7 instead of 6.

In a case where a focal length of the lens group of the front group GF closest to the object side is denoted by fF1, the variable magnification optical system preferably satisfies Conditional Expression (10) below. By not causing a corresponding value of Conditional Expression (10) to be less than or equal to its lower limit, the refractive power of the front group GF is not excessively increased. Thus, an advantage of suppressing fluctuations of aberrations during changing the magnification is achieved. By not causing the corresponding value of Conditional Expression (10) to be greater than or equal to its upper limit, the refractive power of the front group GF is not excessively decreased. Thus, an advantage of reducing a size of the front group GF is achieved.

$$1.5 < fF 1 / fw < 12 \qquad ( 10 )$$

In order to obtain more favorable characteristics, it is preferable to set the lower limit of Conditional Expression (10) to any of 1.7, 1.9, 2, and 2.05 instead of 1.5. In addition, it is preferable to set the upper limit of Conditional Expression (10) to any of 11, 10, 9, and 8 instead of 12.

The variable magnification optical system preferably satisfies Conditional Expression (11) below. By not causing a corresponding value of Conditional Expression (11) to be less than or equal to its lower limit, the refractive power of the middle group is not excessively decreased. Thus, in a case where the middle group moves during changing the magnification, an advantage of suppressing a moving amount of the front group GF during changing the magnification is achieved. By not causing the corresponding value of Conditional Expression (11) to be greater than or equal to its upper limit, the refractive power of the front group GF is not excessively decreased. Thus, an advantage of suppressing size increase of the front group GF is achieved.

$$2 < fF 1 / ( - fMw ) < 13 \qquad ( 11 )$$

In order to obtain more favorable characteristics, it is preferable to set the lower limit of Conditional Expression (11) to any of 2.2, 2.4, 2.5, and 2.6 instead of 2. In addition, it is preferable to set the upper limit of Conditional Expression (11) to any of 12.5, 12, 11.5, and 11 instead of 13.

The variable magnification optical system preferably satisfies Conditional Expression (12) below. By not causing a corresponding value of Conditional Expression (12) to be less than or equal to its lower limit, the refractive power of the front group GF is not excessively increased. Thus, an advantage of suppressing fluctuations of aberrations during changing the magnification is achieved. By not causing the corresponding value of Conditional Expression (12) to be greater than or equal to its upper limit, the refractive power of the front group GF is not excessively decreased. Thus, an advantage of reducing the size of the front group GF is achieved.

$$0.7 < fF 1 / {( fw \times ft )}^{1 / 2} < 4.7 \qquad ( 12 )$$

In order to obtain more favorable characteristics, it is preferable to set the lower limit of Conditional Expression (12) to any of 0.9, 1, and 1.05 instead of 0.7. In addition, it is preferable to set the upper limit of Conditional Expression (12) to any of 4.3, 4, and 2 instead of 4.7.

The variable magnification optical system preferably satisfies Conditional Expression (13) below. By not causing a corresponding value of Conditional Expression (13) to be less than or equal to its lower limit, the refractive power of the middle group is not excessively increased. Thus, an aberration amount of a field curvature occurring in the middle group can be suppressed. Accordingly, an advantage of correcting aberrations during changing the magnification is achieved. By not causing the corresponding value of Conditional Expression (13) to be greater than or equal to its upper limit, the refractive power of the middle group is not excessively decreased. Thus, the moving amount of the middle group during changing the magnification can be suppressed. Accordingly, since the total optical length is not excessively increased, an advantage of size reduction is achieved.

$$0.18 < ( - fMw ) / {( fw \times ft )}^{1 / 2} < 0.8 \qquad ( 13 )$$

In order to obtain more favorable characteristics, it is preferable to set the lower limit of Conditional Expression (13) to any of 0.2 and 0.22 instead of 0.18. In addition, it is preferable to set the upper limit of Conditional Expression (13) to any of 0.7 and 0.6 instead of 0.8.

The variable magnification optical system preferably satisfies Conditional Expression (14) below. By not causing a corresponding value of Conditional Expression (14) to be less than or equal to its lower limit, an advantage of high performance is achieved. By not causing the corresponding value of Conditional Expression (14) to be greater than or equal to its upper limit, the refractive power of the front group GF is not excessively decreased. Thus, an advantage of reducing the size of the front group GF is achieved.

$$1.3 < fF 1 / ( ft / Fnot ) < 8 \qquad ( 14 )$$

In order to obtain more favorable characteristics, it is preferable to set the lower limit of Conditional Expression (14) to any of 1.5, 1.7, and 1.75 instead of 1.3. In addition, it is preferable to set the upper limit of Conditional Expression (14) to any of 7, 6, and 2.7 instead of 8. For example, the variable magnification optical system more preferably satisfies Conditional Expression (14-1) below.

$$1.75 < fF 1 / ( ft / Fnot ) < 2.7 \qquad ( 14 - 1 )$$

In a configuration in which the variable magnification optical system includes the aperture stop St disposed on the image side with respect to a lens surface of the middle group GM closest to the image side, the variable magnification optical system preferably satisfies Conditional Expression (15) below. Here, a distance on the optical axis from the lens surface of the front group GF closest to the object side to the aperture stop St in the state where the infinite distance object is focused on at the wide angle end is denoted by DDL1STw. For example, FIG. 2 illustrates the distance DDL1STw. By not causing a corresponding value of Conditional Expression (15) to be less than or equal to its lower limit, a movable range of the middle group GM is not excessively reduced. Thus, an advantage of a high magnification ratio is achieved. Alternatively, since the refractive power of the front group GF is not excessively decreased, an advantage of establishing both of size reduction and a high magnification ratio is achieved. By not causing the corresponding value of Conditional Expression (15) to be greater than or equal to its upper limit, a distance from the lens surface of the front group GF closest to the object side to an entrance pupil position on a wide angle side is not excessively increased. Thus, size increase of the front group GF can be suppressed. Accordingly, an advantage of size reduction is achieved. Alternatively, by not causing the corresponding value of Conditional Expression (15) to be greater than or equal to its upper limit, the refractive power of the front group GF is not excessively increased. Thus, an advantage of high performance is achieved.

$$0.1 < DDL 1 STw / fF 1 < 0.9 \qquad ( 15 )$$

In order to obtain more favorable characteristics, it is preferable to set the lower limit of Conditional Expression (15) to any of 0.13 and 0.15 instead of 0.1. In addition, it is preferable to set the upper limit of Conditional Expression (15) to any of 0.75 and 0.66 instead of 0.9.

In the configuration in which the variable magnification optical system includes the aperture stop St, the variable magnification optical system preferably satisfies Conditional Expression (16) below. By not causing a corresponding value of Conditional Expression (16) to be less than or equal to its lower limit, a distance between the aperture stop St and the front group GF on the wide angle side is not excessively decreased. Thus, the distance from the lens surface of the front group GF closest to the object side to the entrance pupil position is not excessively decreased. Accordingly, it is facilitated to suppress fluctuations of aberrations during changing the magnification. By not causing the corresponding value of Conditional Expression (16) to be greater than or equal to its upper limit, the distance between the aperture stop St and the front group GF on the wide angle side is not excessively increased. Thus, the distance from the lens surface of the front group GF closest to the object side to the entrance pupil position is not excessively increased. Accordingly, since size increase of the front group GF can be suppressed, an advantage of size reduction is achieved.

$$0.18 < DDL 1 STw / TLw < 0.75 \qquad ( 16 )$$

In order to obtain more favorable characteristics, it is preferable to set the lower limit of Conditional Expression (16) to any of 0.2 and 0.22 instead of 0.18. In addition, it is preferable to set the upper limit of Conditional Expression (16) to any of 0.6 and 0.52 instead of 0.75.

In a case where a focal length of the rear group GR in the state where the infinite distance object is focused on at the wide angle end is denoted by fRw, the variable magnification optical system preferably satisfies Conditional Expression (17) below. By not causing a corresponding value of Conditional Expression (17) to be less than or equal to its lower limit, it is facilitated to reduce the total optical length at the wide angle end. Thus, an advantage of size reduction is achieved. By not causing the corresponding value of Conditional Expression (17) to be greater than or equal to its upper limit, an advantage of suppressing a spherical aberration at the wide angle end is achieved.

$$0.7 < fw / fRw < 3 \qquad ( 17 )$$

In order to obtain more favorable characteristics, it is preferable to set the lower limit of Conditional Expression (17) to any of 0.8 and 0.9 instead of 0.7. In addition, it is preferable to set the upper limit of Conditional Expression (17) to any of 2.5 and 2.3 instead of 3.

In a case where the focal length of the rear group GR in the state where the infinite distance object is focused on at the telephoto end is denoted by fRt, the variable magnification optical system preferably satisfies Conditional Expression (18) below. By not causing a corresponding value of Conditional Expression (18) to be less than or equal to its lower limit, it is facilitated to reduce the total optical length at the telephoto end. Thus, an advantage of size reduction is achieved. By not causing the corresponding value of Conditional Expression (18) to be greater than or equal to its upper limit, an advantage of suppressing the spherical aberration at the telephoto end is achieved.

$$1.1 < ft / fRt < 7 \qquad ( 18 )$$

In order to obtain more favorable characteristics, it is preferable to set the lower limit of Conditional Expression (18) to any of 1.3 and 1.5 instead of 1.1. In addition, it is preferable to set the upper limit of Conditional Expression (18) to any of 6 and 5.2 instead of 7.

In a case where a focal length of the lens group of the rear group GR closest to the object side is denoted by fR1, the variable magnification optical system preferably satisfies Conditional Expression (19) below. By not causing a corresponding value of Conditional Expression (19) to be less than or equal to its lower limit, a refractive power of the lens group of the rear group GR closest to the object side is not excessively increased. Thus, an advantage of suppressing fluctuations of aberrations during changing the magnification is achieved. By not causing the corresponding value of Conditional Expression (19) to be greater than or equal to its upper limit, the refractive power of the lens group of the rear group GR closest to the object side is not excessively decreased. Thus, an advantage of size reduction is achieved.

$$0.05 < fR 1 / {( fw \times ft )}^{1 / 2} < 3 \qquad ( 19 )$$

In order to obtain more favorable characteristics, it is preferable to set the lower limit of Conditional Expression (19) to any of 0.15, 0.25, and 0.3 instead of 0.05. In addition, it is preferable to set the upper limit of Conditional Expression (19) to any of 2, 1.5, and 1 instead of 3.

The variable magnification optical system preferably satisfies Conditional Expression (20) below. By not causing a corresponding value of Conditional Expression (20) to be less than or equal to its lower limit, a positive refractive power of the lens group of the rear group GR closest to the object side is not excessively decreased. Thus, an advantage of correcting the spherical aberration particularly at the wide angle end is achieved. By not causing the corresponding value of Conditional Expression (20) to be greater than or equal to its upper limit, the positive refractive power of the lens group of the rear group GR closest to the object side is not excessively increased. Thus, an advantage of suppressing fluctuations of the spherical aberration during changing the magnification is achieved.

$$0.05 < fw / fR 1 < 2.5 \qquad ( 20 )$$

In order to obtain more favorable characteristics, it is preferable to set the lower limit of Conditional Expression (20) to any of 0.3, 0.45, and 0.57 instead of 0.05. In addition, it is preferable to set the upper limit of Conditional Expression (20) to any of 2.1, 1.8, and 1.1 instead of 2.5.

In a configuration in which the vibration-proof group is disposed on the image side with respect to the front group GF, the variable magnification optical system preferably satisfies Conditional Expression (21) below. Here, a focal length of the vibration-proof group is denoted by fIS. By not causing a corresponding value of Conditional Expression (21) to be less than or equal to its lower limit, an advantage of reducing the total optical length is achieved. By not causing the corresponding value of Conditional Expression (21) to be greater than or equal to its upper limit, a refractive power of the vibration-proof group can be secured. Thus, it is facilitated to suppress the moving amount of the vibration-proof group during the image shake correction. Accordingly, an advantage of size reduction is achieved.

$$0.07 < \vert fIS / ft \vert < 0.5 \qquad ( 21 )$$

In order to obtain more favorable characteristics, it is preferable to set the lower limit of Conditional Expression (21) to any of 0.09 and 0.1 instead of 0.07. In addition, it is preferable to set the upper limit of Conditional Expression (21) to any of 0.4 and 0.35 instead of 0.5.

In the configuration in which the front group GF includes a cemented lens obtained by bonding a negative meniscus lens having a convex surface toward the object side and a positive lens having a convex surface toward the object side to each other in this order from the object side, the variable magnification optical system preferably satisfies Conditional Expression (22) below. Here, a refractive index of the negative meniscus lens included in the front group GF with respect to a d line is denoted by Ndn. An abbe number of the negative meniscus lens included in the front group GF based on the d line is denoted by vdn. By not causing a corresponding value of Conditional Expression (22) to be less than or equal to its lower limit, a material other than a material having a low refractive index and a small Abbe number can be selected. Thus, it is facilitated to correct the lateral chromatic aberration at the wide angle end. By not causing the corresponding value of Conditional Expression (22) to be greater than or equal to its upper limit, a material other than a material having a high refractive index and a large Abbe number can be selected. Thus, a material of which a specific gravity is not large can be selected, and weight reduction is facilitated. Alternatively, since a difference between Abbe numbers of the positive lens and the negative lens constituting the front group GF is not excessively decreased, a refractive power of each lens constituting the front group GF is not increased. Consequently, it is facilitated to correct high-order aberrations of the spherical aberration at the telephoto end. In the present specification, the term “high-order” related to aberrations means a fifth order or higher.

$$1.94 < Ndn + 0.01 \times vdn < 2.5 \qquad ( 22 )$$

In order to obtain more favorable characteristics, it is preferable to set the lower limit of Conditional Expression (22) to any of 2 and 2.04 instead of 1.94. In addition, it is preferable to set the upper limit of Conditional Expression (22) to any of 2.35 and 2.3 instead of 2.5.

In the configuration in which the front group GF includes a cemented lens obtained by bonding a negative meniscus lens having a convex surface toward the object side and a positive lens having a convex surface toward the object side to each other in this order from the object side, the variable magnification optical system preferably satisfies Conditional Expression (23) below. Here, a refractive index of the positive lens included in the front group GF with respect to the d line is denoted by Ndp. An abbe number of the positive lens included in the front group GF based on the d line is denoted by vdp. By not causing a corresponding value of Conditional Expression (23) to be less than or equal to its lower limit, a material other than a material having a low refractive index and a small Abbe number can be selected. Thus, an increase in high-order aberrations of the spherical aberration at the telephoto end can be suppressed. Accordingly, it is facilitated to achieve high performance. Alternatively, insufficient correction of the axial chromatic aberration at the telephoto end can be suppressed. By not causing the corresponding value of Conditional Expression (23) to be greater than or equal to its upper limit, a material other than a material having a high refractive index and a large Abbe number can be selected. Thus, a material of which a specific gravity is not large can be selected, and weight reduction is facilitated. Alternatively, excessive correction of the axial chromatic aberration at the telephoto end can be suppressed.

$$2 < Ndp + 0.01 \times vdp < 2.6 \qquad ( 23 )$$

In order to obtain more favorable characteristics, it is preferable to set the lower limit of Conditional Expression (23) to any of 2.1 and 2.16 instead of 2. In addition, it is preferable to set the upper limit of Conditional Expression (23) to any of 2.45 and 2.4 instead of 2.6. In a case where an average value of Abbe numbers of all positive lenses in the front group GF based on the d line is denoted by vdFp_ave, the variable magnification optical system preferably satisfies Conditional Expression (24) below. By not causing a corresponding value of Conditional Expression (24) to be less than or equal to its lower limit, an advantage of correcting the axial chromatic aberration particularly at the telephoto end is achieved. By not causing the corresponding value of Conditional Expression (24) to be greater than or equal to its upper limit, an advantage of correcting various aberrations other than a chromatic aberration is achieved.

$$55 < vdFp\_ave < 95 \qquad ( 24 )$$

In order to obtain more favorable characteristics, it is preferable to set the lower limit of Conditional Expression (24) to any of 60 and 63 instead of 55. In addition, it is preferable to set the upper limit of Conditional Expression (24) to any of 90 and 88.5 instead of 95.

In a case where a thickness of the lens group of the front group GF closest to the object side on the optical axis is denoted by dF1, the variable magnification optical system preferably satisfies Conditional Expression (25) below. For example, FIG. 2 illustrates the thickness dF1. By not causing a corresponding value of Conditional Expression (25) to be less than or equal to its lower limit, an advantage of securing strength of the lens group of the front group GF closest to the object side is achieved. By not causing the corresponding value of Conditional Expression (25) to be greater than or equal to its upper limit, an advantage of weight reduction of the front group GF is achieved.

$$0.03 < dF 1 / fF 1 < 0.35 \qquad ( 25 )$$

In order to obtain more favorable characteristics, it is preferable to set the lower limit of Conditional Expression (25) to any of 0.035 and 0.04 instead of 0.03. In addition, it is preferable to set the upper limit of Conditional Expression (25) to any of 0.3 and 0.27 instead of 0.35.

In a case where an average value of specific gravities of all lenses in the front group GF is denoted by GFave, the variable magnification optical system preferably satisfies Conditional Expression (26) below. By not causing a corresponding value of Conditional Expression (26) to be less than or equal to its lower limit, a material that is easily obtainable can be used. Thus, an advantage of implementing a variable magnification optical system in which the spherical aberration and the axial chromatic aberration are suppressed is achieved. By not causing the corresponding value of Conditional Expression (26) to be greater than or equal to its upper limit, an advantage of weight reduction of the front group GF is achieved.

$$2 < GFave < 4.3 \qquad ( 26 )$$

In order to obtain more favorable characteristics, it is preferable to set the lower limit of Conditional Expression (26) to any of 2.5 and 2.75 instead of 2. In addition, it is preferable to set the upper limit of Conditional Expression (26) to any of 4 and 3.7 instead of 4.3.

The example illustrated in FIG. 1 is merely an example, and various modifications can be made without departing from the gist of the disclosed technology. For example, the number of lens groups included in each group of the front group GF, the middle group GM, and the rear group GR, the number of lenses included in each lens group, the number of lenses included in the vibration-proof group, and the number of lenses included in the focusing group may be different from the numbers in the example in FIG. 1. The lens group corresponding to the vibration-proof group and the lens group corresponding to the focusing group may be groups different from those in the example in FIG. 1. While an example in the variable magnification optical system is a zoom lens is illustrated in FIG. 1, the variable magnification optical system according to the present disclosure may be a zoom lens or a varifocal lens.

While there is only one focusing group included in the variable magnification optical system in the example in FIG. 1, the variable magnification optical system according to the present disclosure may include a plurality of focusing groups, for example, two focusing groups. In a case where two focusing groups are disposed in the rear group GR, a moving amount of each focusing group during the focusing can be suppressed. In a case where one or a plurality of focusing groups included in the variable magnification optical system are disposed in only the rear group GR, breathing caused by the focusing can be suppressed.

The lens group that does not move during changing the magnification may be a lens group different from that in the example in FIG. 1, or all lens groups may move during changing the magnification. For example, it may be configured to dispose at least one lens group that does not move during changing the magnification between the front group GF and a lens group of the rear group GR closest to the image side. In this case, a cam for moving the lens group can be removed. Thus, simplification of a drive mechanism of the lenses can be implemented.

The front group GF may be configured to consist of two lens groups. In this case, an advantage of suppressing fluctuations of aberrations during changing the magnification is achieved.

The middle group GM may be configured to consist of two lens groups. In this case, an advantage of suppressing fluctuations of aberrations during changing the magnification is achieved.

The rear group GR may be configured to consist of three lens groups, may be configured to consist of four lens groups, may be configured to consist of five lens groups, or may be configured to consist of six lens groups. By setting the number of lens groups constituting the rear group GR to be greater than or equal to four, it is facilitated to suppress fluctuations of aberrations during changing the magnification. More specifically, for example, the rear group GR can be configured as follows.

The rear group GR may be configured to consist of the first subsequent lens group GR1 having a positive refractive power, the second subsequent lens group GR2 having a negative refractive power, and the third subsequent lens group GR3 having a positive refractive power in this order from the object side to the image side. By limiting the number of lens groups included in the rear group GR to three, it is facilitated to reduce the total optical length.

In the configuration in which the rear group GR consists of the first subsequent lens group GR1 having a positive refractive power, the second subsequent lens group GR2 having a negative refractive power, and the third subsequent lens group GR3 in this order from the object side to the image side, the variable magnification optical system preferably satisfies at least one of Conditional Expression (27) or (28) below. Symbols in Conditional Expressions (27) and (28) are defined as follows. A focal length of the first subsequent lens group GR1 is denoted by fR1. A focal length of the second subsequent lens group GR2 is denoted by fR2. A focal length of the third subsequent lens group GR3 is denoted by fR3.

$$0.05 < fR 1 / fR 3 < 0.6 \qquad ( 27 )$$

$$0.2 < fR 1 / ( - fR 2 ) < 1 \qquad ( 28 )$$

By not causing a corresponding value of Conditional Expression (27) to be less than or equal to its lower limit, the refractive power of the first subsequent lens group GR1 is not excessively increased. Thus, an advantage of suppressing excessive correction of the spherical aberration at the telephoto end is achieved. By not causing the corresponding value of Conditional Expression (27) to be greater than or equal to its upper limit, the positive refractive power of the third subsequent lens group GR3 is not excessively increased. Thus, an advantage of securing an appropriate length of the back focus is achieved.

In order to obtain more favorable characteristics, it is preferable to set the lower limit of Conditional Expression (27) to any of 0.08, 0.1, 0.12, and 0.14 instead of 0.05. In addition, it is preferable to set the upper limit of Conditional Expression (27) to any of 0.5, 0.45, 0.4, and 0.35 instead of 0.6.

By not causing a corresponding value of Conditional Expression (28) to be less than or equal to its lower limit, the refractive power of the second subsequent lens group GR2 is not excessively decreased. Thus, an advantage of suppressing fluctuations of aberrations during changing the magnification is achieved. By not causing the corresponding value of Conditional Expression (28) to be greater than or equal to its upper limit, the refractive power of the first subsequent lens group GR1 is not excessively decreased. Thus, an advantage of suppressing the spherical aberration at the telephoto end is achieved.

In order to obtain more favorable characteristics, it is preferable to set the lower limit of Conditional Expression (28) to any of 0.3, 0.4, 0.45, and 0.5 instead of 0.2. In addition, it is preferable to set the upper limit of Conditional Expression (28) to any of 0.9, 0.8, 0.75, and 0.7 instead of 1.

Alternatively, the rear group GR may be configured to consist of the first subsequent lens group GR1 having a positive refractive power, the second subsequent lens group GR2 having a positive refractive power, and the third subsequent lens group GR3 having a negative refractive power in this order from the object side to the image side. By limiting the number of lens groups included in the rear group GR to three, it is facilitated to reduce the total optical length.

In the configuration in which the rear group GR consists of the first subsequent lens group GR1 having a positive refractive power, the second subsequent lens group GR2 having a positive refractive power, and the third subsequent lens group GR3 having a negative refractive power in this order from the object side to the image side, the variable magnification optical system preferably satisfies at least one of Conditional Expression (29) or (30) below. Symbols in Conditional Expressions (29) and (30) are defined as follows. The focal length of the first subsequent lens group GR1 is denoted by fR1. The focal length of the second subsequent lens group GR2 is denoted by fR2. The focal length of the third subsequent lens group GR3 is denoted by fR3.

$$0.5 < fR 1 / ( - fR 3 ) < 1.6 \qquad ( 29 )$$

$$0.8 < fR 2 / ( - fR 3 ) < 3 \qquad ( 30 )$$

By not causing a corresponding value of Conditional Expression (29) to be less than or equal to its lower limit, the refractive power of the third subsequent lens group GR3 is not excessively decreased. Thus, an advantage of suppressing fluctuations of aberrations during changing the magnification is achieved. By not causing the corresponding value of Conditional Expression (29) to be greater than or equal to its upper limit, the refractive power of the first subsequent lens group GR1 is not excessively decreased. Thus, an advantage of suppressing the spherical aberration at the telephoto end is achieved.

In order to obtain more favorable characteristics, it is preferable to set the lower limit of Conditional Expression (29) to any of 0.6, 0.7, 0.8, and 0.9 instead of 0.5. In addition, it is preferable to set the upper limit of Conditional Expression (29) to any of 1.5, 1.4, 1.3, and 1.2 instead of 1.6.

By not causing a corresponding value of Conditional Expression (30) to be less than or equal to its lower limit, the refractive power of the third subsequent lens group GR3 is not excessively decreased. Thus, an advantage of suppressing fluctuations of aberrations during changing the magnification is achieved. By not causing the corresponding value of Conditional Expression (30) to be greater than or equal to its upper limit, the refractive power of the second subsequent lens group GR2 is not excessively decreased. Thus, an advantage of suppressing the spherical aberration at the telephoto end is achieved.

In order to obtain more favorable characteristics, it is preferable to set the lower limit of Conditional Expression (30) to any of 1, 1.1, 1.2, and 1.3 instead of 0.8. In addition, it is preferable to set the upper limit of Conditional Expression (30) to any of 2.5, 2.2, 2, and 1.8 instead of 3.

Alternatively, as illustrated in examples described later, the rear group GR may be configured to include at least the first subsequent lens group GR1 having a positive refractive power, the second subsequent lens group GR2 having a positive refractive power, the third subsequent lens group GR3 having a negative refractive power, and a fourth subsequent lens group GR4 having a positive refractive power consecutively in this order from its side closest to the object side to the image side. By including at least four lens groups in the rear group GR, it is facilitated to suppress fluctuations of aberrations during changing the magnification.

In the configuration in which the rear group GR includes at least the first subsequent lens group GR1 having a positive refractive power, the second subsequent lens group GR2 having a positive refractive power, the third subsequent lens group GR3 having a negative refractive power, and the fourth subsequent lens group GR4 having a positive refractive power consecutively in this order from its side closest to the object side to the image side, the variable magnification optical system preferably satisfies at least one of Conditional Expression (29A), (30A), (31), or (32) below. Symbols in Conditional Expressions (29A), (30A), (31), and (32) are defined as follows. The focal length of the first subsequent lens group GR1 is denoted by fR1. The focal length of the second subsequent lens group GR2 is denoted by fR2. The focal length of the third subsequent lens group GR3 is denoted by fR3. A focal length of the fourth subsequent lens group GR4 is denoted by fR4.

$$0.9 < fR 1 / ( - fR 3 ) < 10 \qquad ( 29 A )$$

$$0.1 < fR 2 / ( - fR 3 ) < 1.8 \qquad ( 30 A )$$

$$1.2 < fR 1 / fR 2 < 11 \qquad ( 31 )$$

$$0.1 < fR 2 / fR 4 < 1.5 \qquad ( 32 )$$

By not causing a corresponding value of Conditional Expression (29A) to be less than or equal to its lower limit, the refractive power of the third subsequent lens group GR3 is not excessively decreased. Thus, an advantage of suppressing fluctuations of aberrations during changing the magnification is achieved. By not causing the corresponding value of Conditional Expression (29A) to be greater than or equal to its upper limit, the refractive power of the first subsequent lens group GR1 is not excessively decreased. Thus, an advantage of suppressing the spherical aberration at the telephoto end is achieved.

In order to obtain more favorable characteristics, it is preferable to set the lower limit of Conditional Expression (29A) to any of 1, 1.1, 1.2, and 1.3 instead of 0.9. In addition, it is preferable to set the upper limit of Conditional Expression (29A) to any of 8, 6, 4.5, and 3 instead of 10.

By not causing a corresponding value of Conditional Expression (30A) to be less than or equal to its lower limit, the refractive power of the third subsequent lens group GR3 is not excessively decreased. Thus, an advantage of suppressing fluctuations of aberrations during changing the magnification is achieved. By not causing the corresponding value of Conditional Expression (30A) to be greater than or equal to its upper limit, the refractive power of the second subsequent lens group GR2 is not excessively decreased. Thus, an advantage of suppressing the spherical aberration at the telephoto end is achieved.

In order to obtain more favorable characteristics, it is preferable to set the lower limit of Conditional Expression (30A) to any of 0.2, 0.3, 0.35, and 0.4 instead of 0.1. In addition, it is preferable to set the upper limit of Conditional Expression (30A) to any of 1.5, 1.3, 1.1, and 0.95 instead of 1.8.

By not causing a corresponding value of Conditional Expression (31) to be less than or equal to its lower limit, the refractive power of the second subsequent lens group GR2 is not excessively decreased. Thus, an advantage of correcting the spherical aberration at the telephoto end is achieved. By not causing the corresponding value of Conditional Expression (31) to be greater than or equal to its upper limit, the refractive power of the first subsequent lens group GR1 is not excessively decreased. Thus, an advantage of suppressing fluctuations of aberrations during changing the magnification is achieved.

In order to obtain more favorable characteristics, it is preferable to set the lower limit of Conditional Expression (31) to any of 1.3, 1.4, 1.5, and 1.6 instead of 1.2. In addition, it is preferable to set the upper limit of Conditional Expression (31) to any of 9, 7, 5, and 3 instead of 11.

By not causing a corresponding value of Conditional Expression (32) to be less than or equal to its lower limit, the refractive power of the fourth subsequent lens group GR4 is not excessively decreased. Thus, an advantage of preventing insufficient correction of aberrations during changing the magnification is achieved. By not causing the corresponding value of Conditional Expression (32) to be greater than or equal to its upper limit, the refractive power of the fourth subsequent lens group GR4 is not excessively increased. Thus, excessive correction of aberrations during changing the magnification can be suppressed.

In order to obtain more favorable characteristics, it is preferable to set the lower limit of Conditional Expression (32) to any of 0.2, 0.3, 0.4, and 0.45 instead of 0.1. In addition, it is preferable to set the upper limit of Conditional Expression (32) to any of 1.3, 1.2, 1.1, and 1 instead of 1.5.

The rear group GR may be configured to include at least the first subsequent lens group GR1 having a positive refractive power, the second subsequent lens group GR2 having a negative refractive power, the third subsequent lens group GR3 having a positive refractive power, and the fourth subsequent lens group GR4 having a negative refractive power consecutively in this order from its side closest to the object side to the image side. By including at least four lens groups in the rear group GR, it is facilitated to suppress fluctuations of aberrations during changing the magnification.

In the configuration in which the rear group GR includes at least the first subsequent lens group GR1 having a positive refractive power, the second subsequent lens group GR2 having a negative refractive power, the third subsequent lens group GR3 having a positive refractive power, and the fourth subsequent lens group GR4 having a negative refractive power consecutively in this order from its side closest to the object side to the image side, the variable magnification optical system preferably satisfies at least one of Conditional Expression (27A) or (32A) below. Symbols in Conditional Expressions (27A) and (32A) are defined as follows. The focal length of the first subsequent lens group GR1 is denoted by fR1. The focal length of the second subsequent lens group GR2 is denoted by fR2. The focal length of the third subsequent lens group GR3 is denoted by fR3. The focal length of the fourth subsequent lens group GR4 is denoted by fR4.

$$0.25 < fR 1 / fR 3 < 6 \qquad ( 27 A )$$

$$0.4 < fR 2 / fR 4 < 18 \qquad ( 32 A )$$

By not causing a corresponding value of Conditional Expression (27A) to be less than or equal to its lower limit, the refractive power of the first subsequent lens group GR1 is not excessively increased. Thus, an advantage of suppressing excessive correction of the spherical aberration at the telephoto end is achieved. By not causing the corresponding value of Conditional Expression (27A) to be greater than or equal to its upper limit, the positive refractive power of the third subsequent lens group GR3 is not excessively increased. Thus, an advantage of securing an appropriate length of the back focus is achieved.

In order to obtain more favorable characteristics, it is preferable to set the lower limit of Conditional Expression (27A) to any of 0.4, 0.45, 0.5, and 0.55 instead of 0.25. In addition, it is preferable to set the upper limit of Conditional Expression (27A) to any of 5, 4, 3.4, and 2.9 instead of 6.

By not causing a corresponding value of Conditional Expression (32A) to be less than or equal to its lower limit, the refractive power of the fourth subsequent lens group GR4 is not excessively decreased. Thus, an advantage of preventing insufficient correction of aberrations during changing the magnification is achieved. By not causing the corresponding value of Conditional Expression (32A) to be greater than or equal to its upper limit, the refractive power of the fourth subsequent lens group GR4 is not excessively increased. Thus, excessive correction of aberrations during changing the magnification can be suppressed.

In order to obtain more favorable characteristics, it is preferable to set the lower limit of Conditional Expression (32A) to any of 0.6, 0.8, 0.85, 0.9, and 0.95 instead of 0.4. In addition, it is preferable to set the upper limit of Conditional Expression (32A) to any of 13, 8, 7, 6, and 5 instead of 18.

As illustrated in examples described later, the rear group GR may be configured to consist of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, a fifth subsequent lens group GR5 having a positive refractive power, and a sixth subsequent lens group GR6 having a negative refractive power in this order from the object side to the image side. By configuring the rear group GR to consist of six lens groups, it is facilitated to suppress fluctuations of aberrations during changing the magnification.

In the configuration in which the rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, the fifth subsequent lens group GR5 having a positive refractive power, and the sixth subsequent lens group GR6 having a negative refractive power in this order from the object side to the image side, the variable magnification optical system preferably satisfies at least one of Conditional Expression (33) or (34) below. Symbols in Conditional Expressions (33) and (34) are defined as follows. The focal length of the third subsequent lens group GR3 is denoted by fR3. The focal length of the fourth subsequent lens group GR4 is denoted by fR4. A focal length of the fifth subsequent lens group GR5 is denoted by fR5. A focal length of the sixth subsequent lens group GR6 is denoted by fR6.

$$0.2 < fR 3 / fR 5 < 2.5 \qquad ( 33 )$$

$$0.04 < fR 4 / fR 6 < 4 \qquad ( 34 )$$

By not causing a corresponding value of Conditional Expression (33) to be less than or equal to its lower limit, the refractive power of the fifth subsequent lens group GR5 is not excessively decreased. Thus, an advantage of correcting a distortion is achieved. By not causing the corresponding value of Conditional Expression (33) to be greater than or equal to its upper limit, the refractive power of the third subsequent lens group GR3 is not excessively decreased. Thus, an advantage of suppressing the spherical aberration at the wide angle end is achieved.

In order to obtain more favorable characteristics, it is preferable to set the lower limit of Conditional Expression (33) to any of 0.25, 0.32, and 0.35 instead of 0.2. In addition, it is preferable to set the upper limit of Conditional Expression (33) to any of 2.1, 1.7, and 1.5 instead of 2.5.

By not causing a corresponding value of Conditional Expression (34) to be less than or equal to its lower limit, the refractive power of the sixth subsequent lens group GR6 is not excessively decreased. Thus, an advantage of correcting the distortion is achieved. By not causing the corresponding value of Conditional Expression (34) to be greater than or equal to its upper limit, the refractive power of the fourth subsequent lens group GR4 is not excessively decreased. Thus, an advantage of correcting aberrations during changing the magnification is achieved.

In order to obtain more favorable characteristics, it is preferable to set the lower limit of Conditional Expression (34) to any of 0.2, 0.6, and 0.8 instead of 0.04. In addition, it is preferable to set the upper limit of Conditional Expression (34) to any of 3.4, 2.8, and 2.2 instead of 4.

The rear group GR may be configured to include at least the first subsequent lens group GR1 having a positive refractive power, the second subsequent lens group GR2 having a positive refractive power, the third subsequent lens group GR3 having a positive refractive power, and the fourth subsequent lens group GR4 having a negative refractive power consecutively in this order from its side closest to the object side to the image side. By including at least four lens groups in the rear group GR, it is facilitated to suppress fluctuations of aberrations during changing the magnification.

In the configuration in which the rear group GR includes at least the first subsequent lens group GR1 having a positive refractive power, the second subsequent lens group GR2 having a positive refractive power, the third subsequent lens group GR3 having a positive refractive power, and the fourth subsequent lens group GR4 having a negative refractive power consecutively in this order from its side closest to the object side to the image side, the variable magnification optical system preferably satisfies at least one of Conditional Expression (31A), (35), or (36) below. Symbols in Conditional Expressions (31A), (35), and (36) are defined as follows. The focal length of the first subsequent lens group GR1 is denoted by fR1. The focal length of the second subsequent lens group GR2 is denoted by fR2. The focal length of the third subsequent lens group GR3 is denoted by fR3. The focal length of the fourth subsequent lens group GR4 is denoted by fR4.

$$0.06 < fR 1 / fR 2 < 0.7 \qquad ( 31 A )$$

$$0.5 < fR 2 / fR 3 < 11 \qquad ( 35 )$$

$$0.2 < fR 3 / ( - fR 4 ) < 3 \qquad ( 36 )$$

By not causing a corresponding value of Conditional Expression (31A) to be less than or equal to its lower limit, the refractive power of the second subsequent lens group GR2 is not excessively decreased. Thus, an advantage of correcting the spherical aberration at the telephoto end is achieved. By not causing the corresponding value of Conditional Expression (31A) to be greater than or equal to its upper limit, the refractive power of the first subsequent lens group GR1 is not excessively decreased. Thus, an advantage of suppressing fluctuations of aberrations during changing the magnification is achieved.

In order to obtain more favorable characteristics, it is preferable to set the lower limit of Conditional Expression (31A) to any of 0.1, 0.12, 0.14, and 0.16 instead of 0.06. In addition, it is preferable to set the upper limit of Conditional Expression (31A) to any of 0.6, 0.5, 0.4, and 0.36 instead of 0.7.

By not causing a corresponding value of Conditional Expression (35) to be less than or equal to its lower limit, the refractive power of the third subsequent lens group GR3 is not excessively decreased. Thus, an advantage of correcting the spherical aberration at the telephoto end is achieved. By not causing the corresponding value of Conditional Expression (35) to be greater than or equal to its upper limit, the refractive power of the second subsequent lens group GR2 is not excessively decreased. Thus, an advantage of suppressing fluctuations of aberrations during changing the magnification is achieved.

In order to obtain more favorable characteristics, it is preferable to set the lower limit of Conditional Expression (35) to any of 1, 1.3, 1.6, and 1.7 instead of 0.5. In addition, it is preferable to set the upper limit of Conditional Expression (35) to any of 9, 8, 7, and 6.7 instead of 11.

By not causing a corresponding value of Conditional Expression (36) to be less than or equal to its lower limit, the refractive power of the fourth subsequent lens group GR4 is not excessively decreased. Thus, an advantage of suppressing fluctuations of aberrations during changing the magnification is achieved. By not causing the corresponding value of Conditional Expression (36) to be greater than or equal to its upper limit, the refractive power of the third subsequent lens group GR3 is not excessively decreased. Thus, an advantage of suppressing the spherical aberration at the telephoto end is achieved.

In order to obtain more favorable characteristics, it is preferable to set the lower limit of Conditional Expression (36) to any of 0.4, 0.6, 0.8, and 1 instead of 0.2. In addition, it is preferable to set the upper limit of Conditional Expression (36) to any of 2, 1.8, 1.4, and 1.3 instead of 3.

The rear group GR may be configured to consist of the first subsequent lens group GR1 having a positive refractive power, the second subsequent lens group GR2 having a positive refractive power, the third subsequent lens group GR3 having a negative refractive power, and the fourth subsequent lens group GR4 having a negative refractive power in this order from the object side to the image side. By configuring the rear group GR to consist of four lens groups, it is facilitated to suppress fluctuations of aberrations during changing the magnification.

In the configuration in which the rear group GR consists of the first subsequent lens group GR1 having a positive refractive power, the second subsequent lens group GR2 having a positive refractive power, the third subsequent lens group GR3 having a negative refractive power, and the fourth subsequent lens group GR4 having a negative refractive power in this order from the object side to the image side, the variable magnification optical system preferably satisfies at least one of Conditional Expression (31B) or (37) below. Symbols in Conditional Expressions (31B) and (37) are defined as follows. The focal length of the first subsequent lens group GR1 is denoted by fR1. The focal length of the second subsequent lens group GR2 is denoted by fR2. The focal length of the third subsequent lens group GR3 is denoted by fR3. The focal length of the fourth subsequent lens group GR4 is denoted by fR4.

$$0.6 < fR 1 / fR 2 < 4 \qquad ( 31 B )$$

$$0.05 < fR 3 / fR 4 < 1 \qquad ( 37 )$$

By not causing a corresponding value of Conditional Expression (31B) to be less than or equal to its lower limit, the refractive power of the second subsequent lens group GR2 is not excessively decreased. Thus, an advantage of correcting the spherical aberration at the telephoto end is achieved. By not causing the corresponding value of Conditional Expression (31B) to be greater than or equal to its upper limit, the refractive power of the first subsequent lens group GR1 is not excessively decreased. Thus, an advantage of suppressing fluctuations of aberrations during changing the magnification is achieved.

In order to obtain more favorable characteristics, it is preferable to set the lower limit of Conditional Expression (31B) to any of 0.9, 1.1, 1.3, and 1.4 instead of 0.6. In addition, it is preferable to set the upper limit of Conditional Expression (31B) to any of 3, 2.5, 2.2, and 1.9 instead of 4.

By not causing a corresponding value of Conditional Expression (37) to be less than or equal to its lower limit, the refractive power of the fourth subsequent lens group GR4 is not excessively decreased. Thus, an advantage of correcting the distortion is achieved. By not causing the corresponding value of Conditional Expression (37) to be greater than or equal to its upper limit, the refractive power of the third subsequent lens group GR3 is not excessively decreased. Thus, an advantage of correcting aberrations during changing the magnification is achieved.

In order to obtain more favorable characteristics, it is preferable to set the lower limit of Conditional Expression (37) to any of 0.1, 0.15, 0.18, and 0.2 instead of 0.05. In addition, it is preferable to set the upper limit of Conditional Expression (37) to any of 0.7, 0.5, 0.35, and 0.3 instead of 1.

The rear group GR may be configured to include at least the first subsequent lens group GR1 having a positive refractive power, the second subsequent lens group GR2 having a negative refractive power, and the third subsequent lens group GR3 having a negative refractive power consecutively in this order from its side closest to the object side to the image side. By including at least three lens groups in the rear group GR, it is facilitated to suppress fluctuations of aberrations during changing the magnification.

In the configuration in which the rear group GR includes at least the first subsequent lens group GR1 having a positive refractive power, the second subsequent lens group GR2 having a negative refractive power, and the third subsequent lens group GR3 having a negative refractive power consecutively in this order from its side closest to the object side to the image side, the variable magnification optical system preferably satisfies at least one of Conditional Expression (28A) or (35A) below. Symbols in Conditional Expressions (28A) and (35A) are defined as follows. The focal length of the first subsequent lens group GR1 is denoted by fR1. The focal length of the second subsequent lens group GR2 is denoted by fR2. The focal length of the third subsequent lens group GR3 is denoted by fR3.

$$0.2 < fR 1 / ( - fR 2 ) < 1 \qquad ( 28 A )$$

$$0.2 < fR 2 / fR 3 < 1 \qquad ( 35 A )$$

By not causing a corresponding value of Conditional Expression (28A) to be less than or equal to its lower limit, the refractive power of the second subsequent lens group GR2 is not excessively decreased. Thus, an advantage of suppressing fluctuations of aberrations during changing the magnification is achieved. By not causing the corresponding value of Conditional Expression (28A) to be greater than or equal to its upper limit, the refractive power of the first subsequent lens group GR1 is not excessively decreased. Thus, an advantage of suppressing the spherical aberration at the telephoto end is achieved.

In order to obtain more favorable characteristics, it is preferable to set the lower limit of Conditional Expression (28A) to any of 0.3, 0.4, 0.45, and 0.5 instead of 0.2. In addition, it is preferable to set the upper limit of Conditional Expression (28A) to any of 0.9, 0.8, 0.75, and 0.7 instead of 1.

By not causing a corresponding value of Conditional Expression (35A) to be less than or equal to its lower limit, the refractive power of the third subsequent lens group GR3 is not excessively decreased. Thus, an advantage of correcting the spherical aberration at the telephoto end is achieved. By not causing the corresponding value of Conditional Expression (35A) to be greater than or equal to its upper limit, the refractive power of the second subsequent lens group GR2 is not excessively decreased. Thus, an advantage of suppressing fluctuations of aberrations during changing the magnification is achieved.

In order to obtain more favorable characteristics, it is preferable to set the lower limit of Conditional Expression (35A) to any of 0.3, 0.4, 0.45, and 0.5 instead of 0.2. In addition, it is preferable to set the upper limit of Conditional Expression (35A) to any of 0.9, 0.8, 0.75, and 0.7 instead of 1.

The rear group GR may be configured to include an Lp1 lens having a positive refractive power and an Ln1 lens that is disposed adjacent to the image side of the Lp1 lens and that has a negative refractive power. A surface of the Lp1 lens on the image side may be configured to have an aspherical shape in which the refractive power at a position of a maximum effective diameter is shifted in a negative direction compared to the refractive power in the paraxial region. A surface of the Ln1 lens on the object side may be configured to have an aspherical shape in which the refractive power at the position of the maximum effective diameter is shifted in a positive direction compared to the refractive power in the paraxial region. By disposing the Lp1 lens and the Ln1 lens in the rear group GR, an advantage of suppressing fluctuations of an astigmatism during changing the magnification is achieved.

The rear group GR may be configured to include an Ln2 lens having a negative refractive power and an Lp2 lens that is disposed adjacent to the image side of the Ln2 lens and that has a positive refractive power. A surface of the Ln2 lens on the object side may be configured to have an aspherical shape in which the refractive power at the position of the maximum effective diameter is shifted in the negative direction compared to the refractive power in the paraxial region. A surface of the Ln2 lens on the image side may be configured to have an aspherical shape in which the refractive power at the position of the maximum effective diameter is shifted in the positive direction compared to the refractive power in the paraxial region. By disposing the Ln2 lens and the Lp2 lens in the rear group GR, an advantage of suppressing fluctuations of the astigmatism during changing the magnification is achieved.

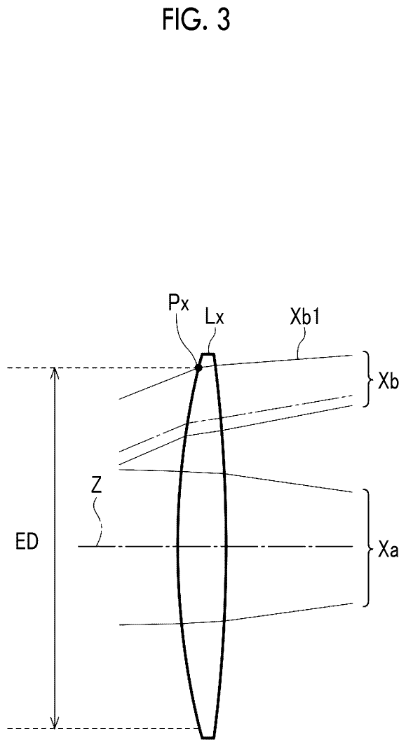

The term “position of the maximum effective diameter” will be described with reference to FIG. 3. FIG. 3 is a diagram for description. In FIG. 3, a left side is the object side, and a right side is the image side. FIG. 3 illustrates an on-axis luminous flux Xa and an off-axis luminous flux Xb passing through a lens Lx. In the example in FIG. 3, a ray Xb1 that is an upper ray of the off-axis luminous flux Xb is a ray passing through the outermost side. Here, the term “outer side” means an outer side in a diameter direction centered on the optical axis Z, that is, a side of separating from the optical axis Z. In the present specification, a position of an intersection between the ray passing through the outermost side and a lens surface is a position Px of the maximum effective diameter. In addition, double a distance from the position Px of the maximum effective diameter to the optical axis Z is an effective diameter ED of a surface of the lens Lx on the object side. While the upper ray of the off-axis luminous flux Xb is the ray passing through the outermost side in the example in FIG. 3, which ray is the ray passing through the outermost side varies depending on the optical system.

The expression “refractive power at the position of the maximum effective diameter is shifted in the negative direction compared to the refractive power in the paraxial region” has the following meanings based on a sign of the refractive power. In a case where the surface has a negative refractive power in both of the paraxial region and the position of the maximum effective diameter, this means that the negative refractive power is strong at the position of the maximum effective diameter compared to that in the paraxial region. In a case where the surface has a positive refractive power in both of the paraxial region and the position of the maximum effective diameter, this means that the positive refractive power is weak at the position of the maximum effective diameter compared to that in the paraxial region. In a case where the surface has refractive powers of different signs between the paraxial region and the position of the maximum effective diameter, this means that the refractive power is positive in the paraxial region, and the refractive power is negative at the position of the maximum effective diameter.

Similarly, the expression “refractive power at the position of the maximum effective diameter is shifted in the positive direction compared to the refractive power in the paraxial region” has the following meanings based on a sign of the refractive power. In a case where the surface has a positive refractive power in both of the paraxial region and the position of the maximum effective diameter, this means that the positive refractive power is strong at the position of the maximum effective diameter compared to that in the paraxial region. In a case where the surface has a negative refractive power in both of the paraxial region and the position of the maximum effective diameter, this means that the negative refractive power is weak at the position of the maximum effective diameter compared to that in the paraxial region. In a case where the surface has refractive powers of different signs between the paraxial region and the position of the maximum effective diameter, this means that the refractive power is negative in the paraxial region, and the refractive power is positive at the position of the maximum effective diameter.

The above preferable configurations and available configurations can be combined with each other in any manner without inconsistency and are preferably employed appropriately selectively in accordance with required specifications.

For example, one preferable aspect of the variable magnification optical system according to the present disclosure consists of the front group GF, the middle group GM, and the rear group GR in this order from the object side to the image side. The front group GF consists of two lens groups or less having a positive refractive power. The middle group GM consists of two lens groups or less having a negative refractive power. The rear group GR consists of a plurality of lens groups. The lens group of the rear group GR closest to the object side has a positive refractive power. During changing the magnification, the lens group of the front group GF closest to the object side moves, and spacings between all adjacent lens groups change. Conditional Expressions (1), (2), and (3) are satisfied.

Next, examples of the variable magnification optical system according to the present disclosure will be described with reference to the drawings. Reference numerals provided in each group in the cross-sectional view of each example are independently used for each example in order to avoid complication of description and the drawings caused by an increase in the number of digits of the reference numerals. Accordingly, even in a case where a common reference numeral is provided in the drawings of different examples, the common reference numeral does not necessarily indicate a common configuration.

### Example 1

A configuration and a moving path of the variable magnification optical system of Example 1 are illustrated in FIG. 1, and its illustration method and its configuration are described above. Thus, duplicate descriptions will be partially omitted here. The variable magnification optical system of Example 1 consists of the front group GF, the middle group GM, and the rear group GR in this order from the object side to the image side. The front group GF consists of one lens group having a positive refractive power. The middle group GM consists of one lens group having a negative refractive power. The rear group GR consists of the first subsequent lens group GR1 having a positive refractive power, the second subsequent lens group GR2 having a negative refractive power, and the third subsequent lens group GR3 having a positive refractive power in this order from the object side to the image side.

During changing the magnification from the wide angle end to the telephoto end, the third subsequent lens group GR3 is fixed with respect to the image plane Sim, and other lens groups move by changing the spacings with their adjacent lens groups. The variable magnification optical system includes only one focusing group. The focusing group consists of the second subsequent lens group GR2. During the focusing from the infinite distance object to the nearest object, the second subsequent lens group GR2 moves to the image side, and other lens groups are fixed with respect to the image plane Sim. The vibration-proof group consists of the middle group GM.

For the variable magnification optical system of Example 1, basic lens data is shown in Table 1, specifications and variable surface spacings are shown in Table 2, and aspherical coefficients are shown in Table 3.

The table of the basic lens data is described as follows. A column of Sn shows surface numbers in a case where the number is increased by one at a time toward the image side from the surface closest to the object side as a first surface. A column of R shows a curvature radius of each surface. A column of D shows a surface spacing on the optical axis between each surface and its adjacent surface on the image side. A column of Nd shows a refractive index of each lens with respect to the d line. A column of vd shows an Abbe number of each lens based on the d line. A column of θgF shows a partial dispersion ratio of each lens between a g line and an F line. A column of p shows a specific gravity of each lens of the front group GF, and specific gravities of other lenses are not described.

In a case where refractive indexes of a lens with respect to the g line, the F line, and a C line are denoted by Ng, NF, and NC, respectively, and a partial dispersion ratio of the lens between the g line and the F line is denoted by θgF, θgF is defined as the following expression.

$$θ gF = ( Ng - NF ) / ( NF - NC )$$

The terms “d line”, “C line”, “F line”, and “g line” described in the present specification mean bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

In the table of the basic lens data, a sign of the curvature radius of the surface having a convex shape toward the object side is positive, and a sign of the curvature radius of the surface having a convex shape toward the image side is negative. In Table 1, a field of the surface number of the surface corresponding to the aperture stop St has the surface number and a text (St). A value in the lowermost field of the column of D in the table is a spacing between a surface closest to the image side in the table and the image plane Sim. A symbol DD [ ] is used for the variable surface spacings during changing the magnification. A surface number on the object side of the spacing is provided inside [ ] and is described in the column of the surface spacings.

Table 2 shows a magnification ratio Zr, a focal length f, a back focus Bf, an open F-number FNo., a maximum full angle of view 2ω, and variable surface spacings based on the d line. In a case where the variable magnification optical system is a zoom lens, the magnification ratio is synonymous with a zoom magnification. In fields of 2ω, [°] indicates degree units. In Table 2, each value in the wide angle end state, a middle focal length state, and the telephoto end state is shown in columns denoted by “Wide”, “Middle”, and “Tele”, respectively.

In the basic lens data, surface numbers of aspherical surfaces are marked with *, and values of paraxial curvature radiuses are described in fields of the curvature radiuses of the aspherical surfaces. In Table 3, the column of Sn shows the surface numbers of the aspherical surfaces, and columns of KA and Am show numerical values of the aspherical coefficients for each aspherical surface. Here, m of Am is an integer greater than or equal to 3 and varies depending on the surface. For example, for the sixth surface of Example 1, m=3, 4, 5, . . . , 16 is established. In the numerical values of the aspherical coefficients in Table 3, “E±n” (n: integer) means “×10^{±n}”. KA and Am are aspherical coefficients in an aspheric equation represented by the following expression.

$$Zd = C \times {h}^{2} / \{ 1 + {( 1 - KA \times {C}^{2} \times {h}^{2} )}^{1 / 2} \} + \sum Am \times {h}^{m}$$

where
Zd: a depth of an aspherical surface (a length of a perpendicular line drawn from a point on the aspherical surface having a height h to a plane that is in contact with an aspherical surface apex and that is perpendicular to the optical axis Z)
h: a height (a distance from the optical axis Z to the lens surface)
C: a reciprocal of the paraxial curvature radius
KA and Am: aspherical coefficients
Σ in the aspheric equation means a total sum with respect to m.

In the data of each table, a degree unit is used for angles, and a millimeter unit is used for lengths. However, since the optical system can also be proportionally enlarged or proportionally reduced to be used, other appropriate units can also be used. In addition, numerical values rounded to predetermined digits are described in each table shown below.

TABLE 1
Example 1

| Sn | R | D | Nd | νd | θgF | ρ |
|---|---|---|---|---|---|---|
| 1 | 55.5534 | 1.5000 | 1.84666 | 23.78 | 0.62054 | 3.54 |
| 2 | 40.0897 | 11.3046 | 1.49700 | 81.54 | 0.53748 | 3.62 |
| 3 | −349.6824 | 0.1000 | | | | |
| 4 | 47.9336 | 4.8273 | 1.51680 | 64.20 | 0.53430 | 2.52 |
| 5 | 117.9072 | DD[5] | | | | |
| *6 | 136.2484 | 1.0000 | 1.85400 | 40.38 | 0.56890 | |
| *7 | 14.8432 | 5.2402 | | | | |
| 8 | −31.4167 | 0.4478 | 1.61772 | 49.81 | 0.56035 | |
| 9 | 18.0372 | 3.4606 | 1.92286 | 18.90 | 0.64960 | |
| 10 | −58.0571 | 1.3100 | | | | |
| 11 | −19.1053 | 1.0198 | 1.92286 | 18.90 | 0.64960 | |
| 12 | −43.3890 | DD[12] | | | | |
| 13 (St) | ∞ | 2.2110 | | | | |
| *14 | 36.8272 | 2.7948 | 1.76450 | 49.10 | 0.55289 | |
| *15 | −90.0800 | 1.7007 | | | | |
| 16 | 40.7013 | 0.8000 | 1.77535 | 50.31 | 0.55042 | |
| 17 | 16.5284 | 4.4338 | 1.49700 | 81.54 | 0.53748 | |
| 18 | −90.9026 | 2.6247 | | | | |
| 19 | 416.0968 | 2.4655 | 1.49700 | 81.54 | 0.53748 | |
| 20 | −33.2145 | 0.4917 | 1.80100 | 34.97 | 0.58642 | |
| 21 | 45.7661 | 8.2032 | | | | |
| *22 | 24.5246 | 5.4224 | 1.43875 | 94.66 | 0.53402 | |
| *23 | −19.8837 | DD[23] | | | | |
| 24 | 64.9478 | 0.7166 | 1.59349 | 67.00 | 0.53667 | |
| 25 | 19.1644 | DD[25] | | | | |
| *26 | 3922.5042 | 2.8352 | 1.59201 | 67.02 | 0.53589 | |
| *27 | −57.5374 | 19.3600 | | | | |

TABLE 2
Example 1

| | Wide | Middle | Tele |
|---|---|---|---|
| Zr | 1.0 | 2.2 | 4.2 |
| f | 30.35 | 66.83 | 127.48 |
| Bf | 19.36 | 19.36 | 19.36 |
| FNo. | 3.28 | 3.27 | 3.28 |
| 2ω[°] | 49.4 | 21.8 | 11.6 |
| DD[5] | 1.79 | 24.85 | 34.68 |
| DD[12] | 12.63 | 5.77 | 0.96 |
| DD[23] | 11.33 | 12.83 | 6.72 |
| DD[25] | 16.15 | 15.02 | 27.08 |

TABLE 3
Example 1

| Sn | 6 | 7 | 14 | 15 |
|---|---|---|---|---|
| KA | 1.0000000E+00 | −1.4212062E+00 | 1.0000000E+00 | 1.0000000E+00 |
| A3 | 0.0000000E+00 | 0.0000000E+00 | 0.0000000E+00 | 0.0000000E+00 |
| A4 | 1.7274393E−06 | 6.3505309E−05 | −6.9566048E−06 | 5.2394372E−06 |
| A5 | 3.4734057E−06 | 2.4185730E−05 | 4.7824941E−06 | −1.4270718E−06 |
| A6 | −4.2518997E−07 | −7.2019980E−06 | −3.5015495E−06 | 6.2739742E−07 |
| A7 | 2.6132343E−08 | 9.7638596E−07 | 1.3650002E−06 | −1.5194967E−07 |
| A8 | −1.4177316E−10 | −2.5338595E−09 | −2.8235297E−07 | 1.9675753E−08 |
| A9 | 1.3739006E−10 | −1.8039942E−08 | 2.3514308E−08 | −1.7143545E−09 |
| A10 | −3.0240654E−11 | 2.5390390E−09 | 2.0274465E−09 | 6.4840437E−10 |
| A11 | 1.6943480E−12 | −1.6419491E−10 | −5.9474474E−10 | −1.8041703E−10 |
| A12 | 1.7655243E−14 | 8.8596048E−12 | 2.1036723E−11 | 1.7819837E−11 |
| A13 | −7.4981812E−15 | −3.4491241E−13 | 6.6706478E−12 | 4.8796135E−13 |
| A14 | 1.8126092E−16 | −5.2390114E−14 | −9.6302064E−13 | −2.3021184E−13 |
| A15 | 1.0292348E−18 | 6.5552591E−15 | 5.2791930E−14 | 1.6693571E−14 |
| A16 | 8.6295616E−19 | −1.9259719E−16 | −1.0855400E−15 | −3.9891854E−16 |

| Sn | 22 | 23 | 26 | 27 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −2.7334208E−05 | 2.2424581E−05 | 6.9074863E−07 | −1.1411382E−04 |
| A5 | 5.4280614E−06 | −4.1464924E−07 | 1.2464530E−07 | 1.8209297E−04 |
| A6 | −3.3076124E−06 | 3.0107169E−06 | 4.0217724E−08 | −1.1610662E−04 |
| A7 | 9.1070858E−07 | −2.9541900E−06 | −1.7217014E−09 | 4.0589974E−05 |
| A8 | −9.1645096E−08 | 1.2187762E−06 | 5.0320822E−11 | −8.6479461E−06 |
| A9 | −4.1319717E−09 | −2.5000760E−07 | −4.1498897E−11 | 1.1607173E−06 |
| A10 | 2.9692592E−10 | 2.1960563E−08 | 6.3351611E−12 | −9.6496961E−08 |
| A11 | 3.9125262E−10 | 5.9251628E−10 | −7.4536569E−13 | 4.5971559E−09 |
| A12 | −4.9542030E−11 | −2.4231131E−10 | 8.3555815E−14 | −1.1157874E−10 |
| A13 | −4.6326061E−12 | 2.9953086E−12 | −4.2416341E−15 | 3.9400346E−12 |
| A14 | 1.4045523E−12 | 2.4833558E−12 | 2.4900182E−16 | −4.4638651E−13 |
| A15 | −1.0922478E−13 | −2.1985445E−13 | −6.9361201E−18 | 2.3626899E−14 |
| A16 | 2.9598634E−15 | 5.9782195E−15 | −2.6200649E−20 | −4.3013632E−16 |

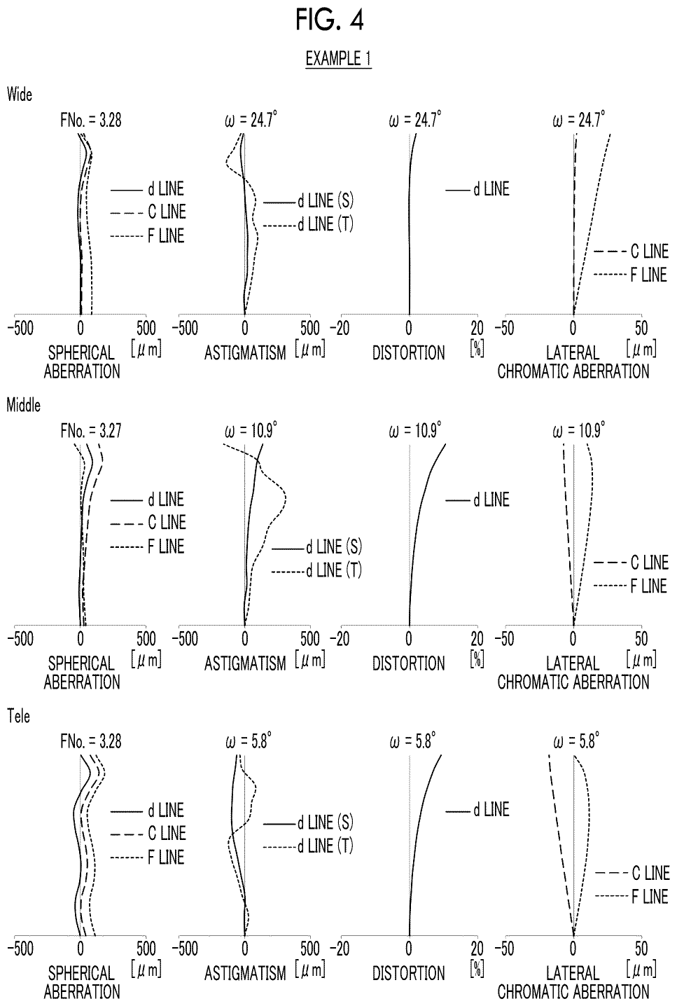

FIG. 4 illustrates each aberration diagram of the variable magnification optical system of Example 1 in the state where the infinite distance object is focused on. In FIG. 4, a spherical aberration, an astigmatism, a distortion, and a lateral chromatic aberration are illustrated in this order from the left. In FIG. 4, aberrations in the wide angle end state are illustrated in an upper part denoted by “Wide”, aberrations in the middle focal length state are illustrated in a middle part denoted by “Middle”, and aberrations in the telephoto end state are illustrated in a lower part denoted by “Tele”. In the spherical aberration diagram, aberrations on the d line, the C line, and the F line are illustrated by a solid line, a long broken line, and a short broken line, respectively. In the astigmatism diagram, an aberration on the d line in a sagittal direction is illustrated by a solid line, and an aberration on the d line in a tangential direction is illustrated by a short broken line. In the distortion diagram, an aberration on the d line is illustrated by a solid line. In the lateral chromatic aberration diagram, aberrations on the C line and the F line are illustrated by a long broken line and a short broken line, respectively. In the spherical aberration diagram, the value of the open F-number is shown after FNo. =. In other aberration diagrams, the value of the maximum half angle of view is shown after ω=.

Symbols, meanings, description methods, and illustration methods of each data related to Example 1 are basically the same for the following examples unless otherwise specified. Thus, duplicate descriptions will be omitted below.

### Example 2

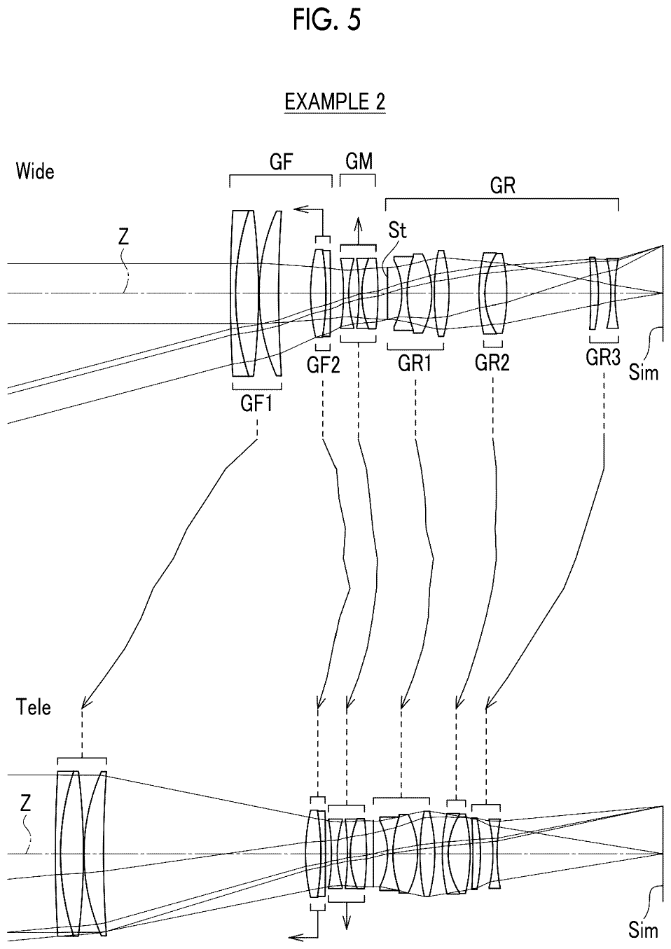

A configuration and a moving path of a variable magnification optical system of Example 2 are illustrated in FIG. 5. The variable magnification optical system of Example 2 consists of the front group GF, the middle group GM, and the rear group GR in this order from the object side to the image side. The front group GF consists of a first front side lens group GF1 having a positive refractive power and a second front side lens group GF2 having a positive refractive power in this order from the object side to the image side. The middle group GM consists of one lens group having a negative refractive power. The rear group GR consists of the first subsequent lens group GR1 having a positive refractive power, the second subsequent lens group GR2 having a positive refractive power, and the third subsequent lens group GR3 having a negative refractive power in this order from the object side to the image side.

During changing the magnification from the wide angle end to the telephoto end, all lens groups move by changing the spacings with their adjacent lens groups. The variable magnification optical system includes only one focusing group. The focusing group consists of the second front side lens group GF2. During the focusing from the infinite distance object to the nearest object, the second front side lens group GF2 moves to the object side, and other lens groups are fixed with respect to the image plane Sim. The vibration-proof group consists of the middle group GM.

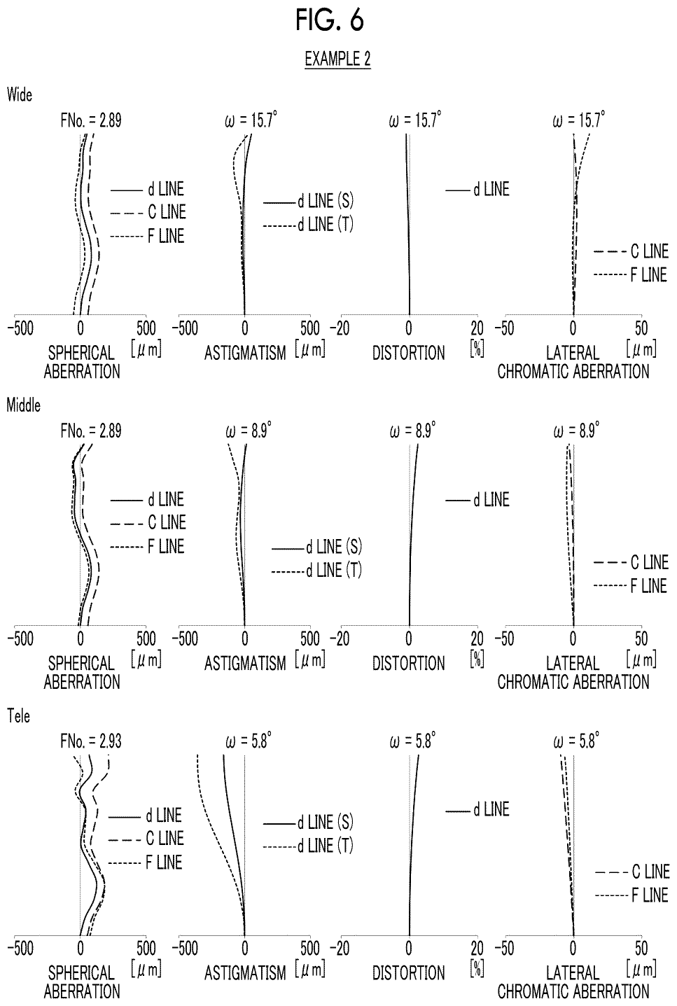

For the variable magnification optical system of Example 2, basic lens data is shown in Table 4, specifications and variable surface spacings are shown in Table 5, aspherical coefficients are shown in Table 6, and each aberration diagram is illustrated in FIG. 6.

TABLE 4
Example 2

| Sn | R | D | Nd | νd | θgF | ρ |
|---|---|---|---|---|---|---|
| 1 | 457.6576 | 1.4464 | 1.80100 | 34.97 | 0.58642 | 3.55 |
| 2 | 83.2872 | 6.4013 | 1.49700 | 81.61 | 0.53887 | 3.70 |
| 3 | −215.2210 | 0.1784 | | | | |
| 4 | 63.9962 | 5.4639 | 1.64000 | 60.08 | 0.53704 | 3.06 |
| 5 | 373.5993 | DD[5] | | | | |
| 6 | 60.5121 | 4.3052 | 1.67790 | 55.34 | 0.54726 | 4.01 |
| 7 | −85.2421 | 1.2591 | 1.96300 | 24.11 | 0.62126 | 4.20 |
| 8 | −815.1262 | DD[8] | | | | |
| *9 | −107.1261 | 1.4547 | 1.85400 | 40.38 | 0.56890 | |
| *10 | 28.3530 | 2.8829 | | | | |
| 11 | −85.0500 | 0.8289 | 1.72916 | 54.68 | 0.54451 | |
| 12 | 28.9550 | 4.5108 | 1.89286 | 20.36 | 0.63944 | |
| 13 | −92.8411 | DD[13] | | | | |
| 14 (St) | ∞ | 4.0038 | | | | |
| *15 | −24.4022 | 1.5000 | 1.89190 | 37.13 | 0.57813 | |
| 16 | 35.3320 | 6.8970 | 1.64000 | 60.08 | 0.53704 | |
| 17 | −27.4415 | 0.7011 | | | | |
| *18 | 82.5314 | 4.1236 | 1.85400 | 40.38 | 0.56890 | |
| *19 | −50.1936 | DD[19] | | | | |
| 20 | 55.5066 | 1.6549 | 1.96300 | 24.11 | 0.62126 | |
| 21 | 23.2399 | 6.1267 | 1.59522 | 67.73 | 0.54426 | |
| 22 | −54.4056 | DD[22] | | | | |
| 23 | −204.9164 | 2.1382 | 1.92286 | 18.90 | 0.64960 | |
| 24 | −58.4058 | 3.4889 | | | | |
| *25 | −49.6248 | 1.1592 | 1.83220 | 40.10 | 0.57151 | |
| *26 | 55.3801 | DD[26] | | | | |

TABLE 5
Example 2

| | Wide | Middle | Tele |
|---|---|---|---|
| Zr | 1.0 | 1.7 | 2.7 |
| f | 51.01 | 88.41 | 137.26 |
| Bf | 13.42 | 24.68 | 46.47 |
| FNo. | 2.89 | 2.89 | 2.93 |
| 2ω[°] | 31.4 | 17.8 | 11.6 |
| DD[5] | 8.97 | 45.55 | 56.61 |
| DD[8] | 3.48 | 1.18 | 1.67 |
| DD[13] | 2.66 | 1.46 | 1.93 |
| DD[19] | 8.41 | 4.32 | 2.11 |
| DD[22] | 23.53 | 12.42 | 0.76 |
| DD[26] | 13.42 | 24.68 | 46.47 |

TABLE 6
Example 2

| Sn | 9 | 10 | 15 | 18 |
|---|---|---|---|---|
| KA | 1.0000000E+00 | 1.0000000E+00 | 1.0000000E+00 | 1.0000000E+00 |
| A4 | −9.9756003E−05 | −1.1022639E−04 | −2.7928458E−05 | 1.4836938E−05 |
| A6 | 1.5669058E−06 | 1.6002720E−06 | 4.2802928E−07 | −7.5749043E−08 |
| A8 | −1.2106731E−08 | −1.0379660E−08 | −7.0947841E−09 | 2.6029470E−11 |
| A10 | 5.4060284E−12 | −3.2355583E−11 | 6.8905124E−11 | 3.1347347E−13 |
| A12 | 3.1014525E−13 | 4.6226298E−13 | −7.5111273E−15 | 8.3824776E−15 |
| A14 | 2.5449021E−15 | 1.4019800E−15 | −6.7742660E−15 | 4.4322600E−17 |
| A16 | −3.3215443E−17 | 4.3089884E−17 | 3.8260718E−17 | −5.0657473E−19 |
| A18 | −1.8321888E−20 | −9.7762124E−19 | 1.5961166E−19 | −9.9025122E−22 |
| A20 | 6.6287431E−22 | 4.2367533E−21 | −1.3188349E−21 | 1.1608603E−23 |

| Sn | 19 | 25 | 26 |
|---|---|---|---|
| KA | 1.0000000E+00 | 1.0000000E+00 | 1.0000000E+00 |
| A4 | 6.0185769E−06 | −1.6268755E−05 | −1.7262337E−05 |
| A6 | −1.7583141E−08 | 1.8875375E−07 | 2.0888080E−07 |
| A8 | 1.1033637E−11 | −7.7968992E−10 | −1.5212457E−10 |
| A10 | −1.8293138E−12 | 3.3025600E−12 | −2.0893335E−11 |
| A12 | 8.5192741E−15 | −1.5793413E−13 | 1.1145549E−13 |
| A14 | 9.7409188E−17 | 1.2092404E−15 | 1.0218325E−15 |
| A16 | 2.6490785E−19 | 1.6647106E−17 | −2.1596437E−18 |
| A18 | −9.5717165E−21 | −2.5355064E−19 | −1.0876752E−19 |
| A20 | 3.3580369E−23 | 9.2120906E−22 | 5.6420251E−22 |

### Example 3

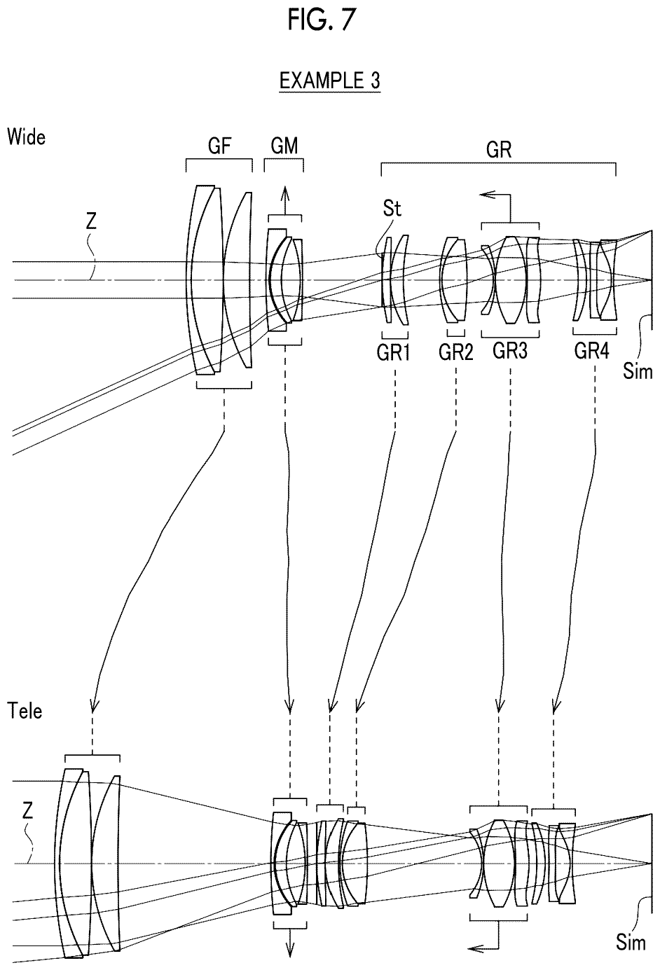

A configuration and a moving path of a variable magnification optical system of Example 3 are illustrated in FIG. 7. The variable magnification optical system of Example 3 consists of the front group GF, the middle group GM, and the rear group GR in this order from the object side to the image side. The front group GF consists of one lens group having a positive refractive power. The middle group GM consists of one lens group having a negative refractive power. The rear group GR consists of the first subsequent lens group GR1 having a positive refractive power, the second subsequent lens group GR2 having a positive refractive power, the third subsequent lens group GR3 having a positive refractive power, and the fourth subsequent lens group GR4 having a negative refractive power in this order from the object side to the image side.

During changing the magnification from the wide angle end to the telephoto end, all lens groups move by changing the spacings with their adjacent lens groups. The variable magnification optical system includes only one focusing group. The focusing group consists of the third subsequent lens group GR3. During the focusing from the infinite distance object to the nearest object, the third subsequent lens group GR3 moves to the object side, and other lens groups are fixed with respect to the image plane Sim. The vibration-proof group consists of the middle group GM.

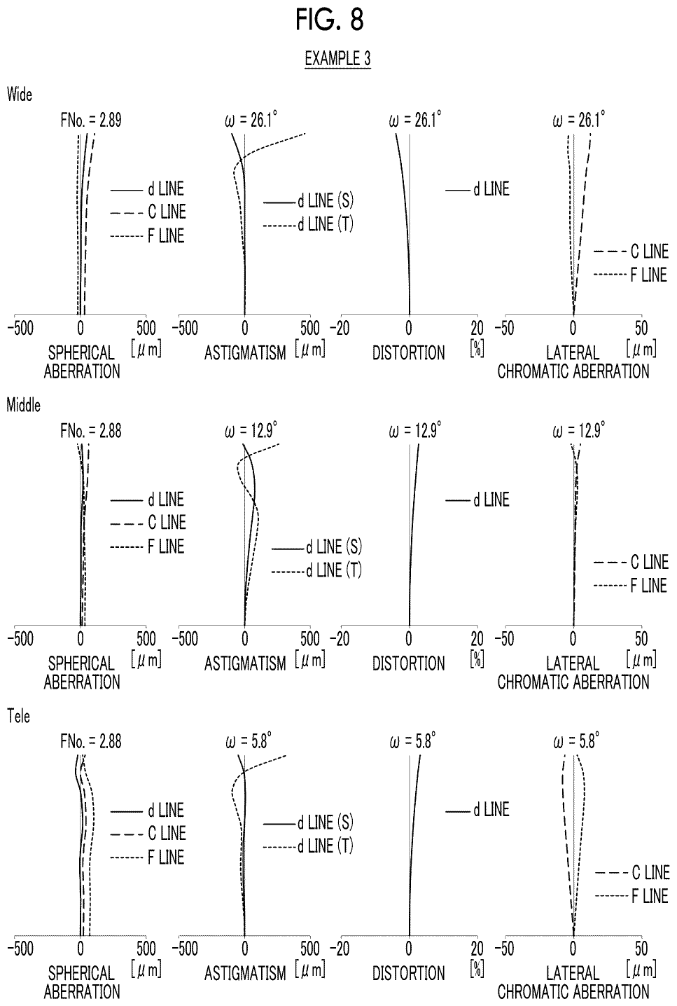

For the variable magnification optical system of Example 3, basic lens data is shown in Table 7, specifications and variable surface spacings are shown in Table 8, aspherical coefficients are shown in Table 9, and each aberration diagram is illustrated in FIG. 8.

TABLE 7
Example 3

| Sn | R | D | Nd | νd | θgF | ρ |
|---|---|---|---|---|---|---|
| 1 | 129.9837 | 1.3500 | 1.80610 | 33.34 | 0.59048 | 3.77 |
| 2 | 58.3690 | 8.5848 | 1.48749 | 70.32 | 0.52917 | 2.45 |
| 3 | −407.2413 | 0.0498 | | | | |
| 4 | 54.0178 | 7.0751 | 1.51680 | 64.20 | 0.53430 | 2.52 |
| 5 | 609.0956 | DD[5] | | | | |
| 6 | 151.2407 | 0.8847 | 1.81600 | 46.62 | 0.55682 | |
| 7 | 18.8560 | 0.2881 | | | | |
| 8 | 18.8908 | 2.9881 | 1.95906 | 17.47 | 0.65993 | |
| 9 | 26.2930 | 5.0625 | | | | |
| 10 | −35.8478 | 0.6025 | 1.77535 | 50.31 | 0.55042 | |
| 11 | −328.7179 | DD[11] | | | | |
| 12 (St) | ∞ | 0.0000 | | | | |
| *13 | 48.6461 | 2.2192 | 1.80610 | 40.73 | 0.56940 | |
| *14 | 189.2664 | 0.0493 | | | | |
| 15 | 25.5417 | 3.4322 | 1.55200 | 70.70 | 0.54219 | |
| 16 | 58.7118 | DD[16] | | | | |
| 17 | 36.9450 | 0.6314 | 2.00100 | 29.14 | 0.59974 | |
| 18 | 17.8548 | 6.7322 | 1.49700 | 81.54 | 0.53748 | |
| 19 | −98.8400 | DD[19] | | | | |
| 20 | −14.3196 | 0.5136 | 1.85150 | 40.78 | 0.56958 | |
| 21 | −27.4669 | 0.0483 | | | | |
| 22 | 27.0587 | 8.2655 | 1.49700 | 81.54 | 0.53748 | |
| 23 | −26.9071 | 0.3064 | | | | |
| *24 | −80.4852 | 3.6013 | 1.80610 | 40.73 | 0.56940 | |
| *25 | −31.5835 | DD[25] | | | | |
| 26 | −49.6997 | 2.2481 | 2.00069 | 25.46 | 0.61402 | |
| 27 | −30.3504 | 1.0339 | | | | |
| *28 | −115.8196 | 1.7428 | 1.80610 | 40.73 | 0.56940 | |
| *29 | −188.1213 | 3.9281 | | | | |
| *30 | −14.0662 | 0.5937 | 1.51633 | 64.06 | 0.53345 | |
| *31 | 82.1935 | DD[31] | | | | |

TABLE 8
Example 3

| | Wide | Middle | Tele |
|---|---|---|---|
| Zr | 1.0 | 2.0 | 4.5 |
| f | 30.15 | 60.29 | 135.65 |
| Bf | 10.30 | 15.26 | 21.42 |
| FNo. | 2.89 | 2.88 | 2.88 |
| 2ω[°] | 52.2 | 25.8 | 11.6 |
| DD[5] | 4.37 | 25.66 | 41.11 |
| DD[11] | 21.27 | 13.09 | 2.51 |
| DD[16] | 9.76 | 5.93 | 0.40 |
| DD[19] | 7.09 | 15.78 | 30.71 |
| DD[25] | 10.06 | 7.47 | 2.10 |
| DD[31] | 10.30 | 15.26 | 21.42 |

TABLE 9
Example 3

| Sn | 13 | 14 | 24 | 25 |
|---|---|---|---|---|
| KA | 1.0000000E+00 | 1.0000000E+00 | 1.0000000E+00 | 1.0000000E+00 |
| A4 | −1.5170200E−06 | −2.3266057E−07 | 3.1880390E−05 | 5.4784374E−05 |
| A6 | 4.9816730E−09 | −8.7657800E−09 | 2.0827333E−07 | 2.0306251E−07 |
| A8 | −1.4558870E−09 | −9.4028676E−10 | 1.7170188E−10 | 1.1634800E−09 |
| A10 | 2.6288852E−11 | 1.6670909E−11 | 6.9423303E−12 | 1.0854022E−12 |
| A12 | −2.6759755E−13 | −1.7580389E−13 | −1.2437506E−13 | −7.5516962E−14 |
| A14 | 1.3262899E−15 | 8.8258511E−16 | 6.4701617E−16 | 6.9162741E−16 |
| A16 | −2.6696476E−18 | −1.8028035E−18 | −1.4520852E−18 | −2.6682186E−18 |

| Sn | 28 | 29 | 30 | 31 |
|---|---|---|---|---|
| KA | 1.0000000E+00 | 1.0000000E+00 | 1.0000000E+00 | 1.0000000E+00 |
| A4 | 4.4695208E−05 | 4.3667350E−05 | 6.2541011E−05 | 1.7405814E−05 |
| A6 | 1.6885757E−07 | 4.0577596E−07 | 4.3086122E−07 | −3.5614138E−08 |
| A8 | 1.4397942E−10 | 4.2511459E−10 | 2.6057981E−09 | −1.4517531E−10 |
| A10 | −8.0001768E−12 | 8.6616542E−12 | −1.0997417E−11 | 1.2390218E−12 |
| A12 | 7.3914040E−15 | 2.7543636E−15 | 6.3068758E−14 | −1.0541448E−13 |
| A14 | −9.8529921E−16 | −5.5648698E−16 | −1.0283574E−16 | 6.8158346E−16 |
| A16 | 2.4317860E−18 | −5.9008895E−21 | 8.0068639E−18 | −1.4777319E−18 |

### Example 4

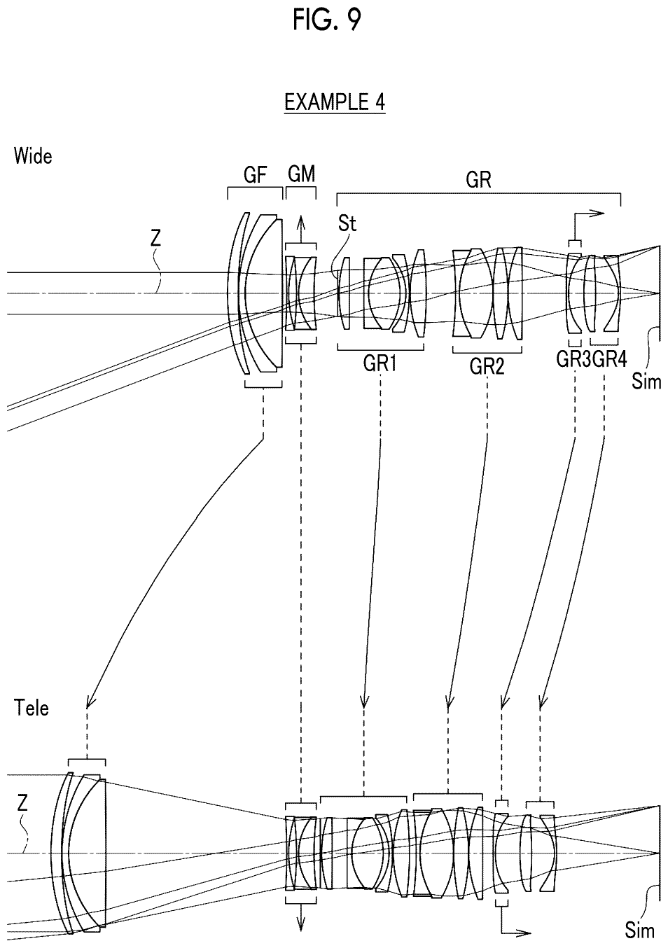

A configuration and a moving path of a variable magnification optical system of Example 4 are illustrated in FIG. 9. The variable magnification optical system of Example 4 consists of the front group GF, the middle group GM, and the rear group GR in this order from the object side to the image side. The front group GF consists of one lens group having a positive refractive power. The middle group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, and the fourth subsequent lens group GR4 having a negative refractive power in this order from the object side to the image side. The rear group GR includes the Lp1 lens and the Ln1 lens described above.

During changing the magnification from the wide angle end to the telephoto end, the middle group GM is fixed with respect to the image plane Sim, and other lens groups move by changing the spacings with their adjacent lens groups. The variable magnification optical system includes only one focusing group. The focusing group consists of the third subsequent lens group GR3. During the focusing from the infinite distance object to the nearest object, the third subsequent lens group GR3 moves to the image side, and other lens groups are fixed with respect to the image plane Sim. The vibration-proof group consists of the middle group GM.

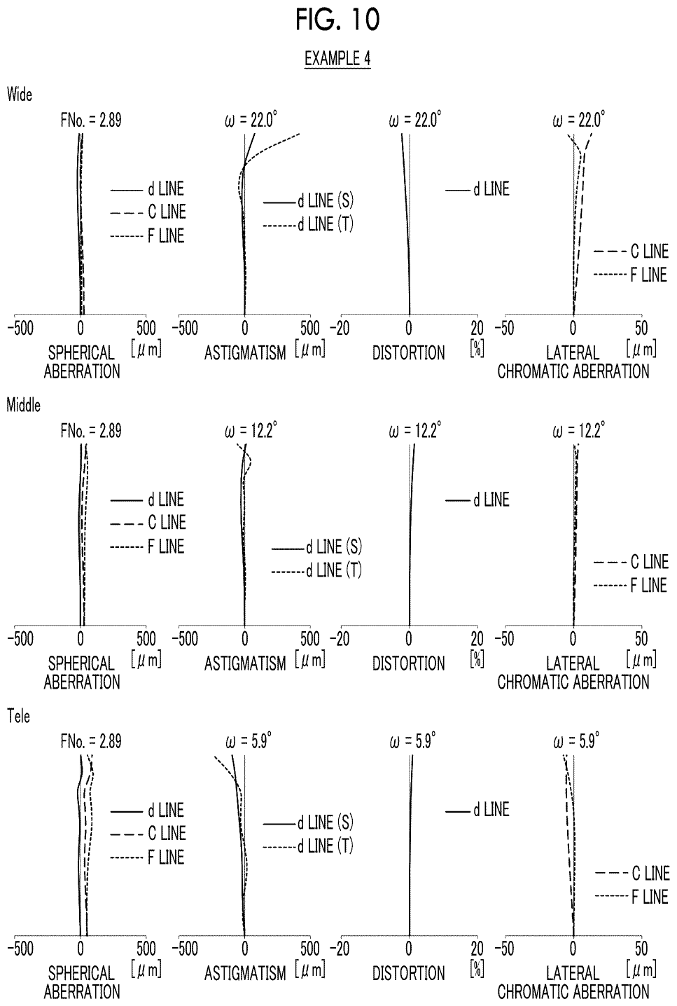

For the variable magnification optical system of Example 4, basic lens data is shown in Table 10, specifications and variable surface spacings are shown in Table 11, aspherical coefficients are shown in Table 12, and each aberration diagram is illustrated in FIG. 10. A column of ED in the table of the basic lens data shows an effective diameter of each surface of the Lp1 lens and the Ln1 lens, and effective diameters of other lenses are not described.

TABLE 10
Example 4

| Sn | R | D | Nd | νd | θgF | ρ | ED |
|---|---|---|---|---|---|---|---|
| *1 | 70.4088 | 2.9813 | 1.67003 | 47.14 | 0.56262 | 3.57 | |
| *2 | 110.7284 | 0.1000 | | | | | |
| 3 | 47.4123 | 1.8637 | 1.88300 | 40.69 | 0.56730 | 5.41 | |
| 4 | 31.9715 | 10.4305 | 1.45860 | 90.19 | 0.53516 | 3.63 | |
| 5 | −1927.1021 | DD[5] | | | | | |
| 6 | −180.2454 | 0.5500 | 1.75500 | 52.32 | 0.54757 | | |
| 7 | 35.6368 | 2.1775 | | | | | |
| 8 | −94.0825 | 0.6138 | 1.77535 | 50.31 | 0.55042 | | |
| 9 | 17.7690 | 4.2929 | 1.90366 | 31.34 | 0.59636 | | |
| 10 | 90.4141 | DD[10] | | | | | |
| 11 | ∞ | 0.3729 | | | | | |
| (St) | | | | | | | |
| 12 | 37.6338 | 2.9167 | 1.64000 | 60.08 | 0.53704 | | |
| 13 | −1877.5987 | 4.0594 | | | | | |
| 14 | 1376.9227 | 1.3121 | 1.88300 | 39.22 | 0.57288 | | |
| 15 | 16.5563 | 8.8110 | 1.54814 | 45.78 | 0.56859 | | |
| 16 | −20.1115 | 1.6497 | | | | | |
| 17 | −16.7555 | 0.9460 | 1.88300 | 39.22 | 0.57288 | | |
| 18 | −47.6528 | 0.2340 | | | | | |
| 19 | 37.1481 | 4.5177 | 1.85896 | 22.73 | 0.62844 | | |
| 20 | −114.4725 | DD[20] | | | | | |
| 21 | −110.4190 | 1.0756 | 1.96300 | 24.11 | 0.62126 | | |
| 22 | 26.4521 | 9.4176 | 1.49700 | 81.54 | 0.53748 | | |
| 23 | −27.4038 | 0.0497 | | | | | |
| 24 | 70.9933 | 4.1376 | 1.58913 | 61.13 | 0.54067 | | |
| 25 | −56.8211 | 0.0498 | | | | | |
| 26 | 37.1440 | 3.9309 | 1.49700 | 81.54 | 0.53748 | | |
| 27 | −1128.3931 | DD[27] | | | | | |
| *28 | −573.6576 | 0.6164 | 1.58913 | 61.15 | 0.53824 | | |
| *29 | 22.9722 | DD[29] | | | | | |
| *30 | 58.8544 | 3.2890 | 1.82165 | 24.04 | 0.62380 | | 22.763 |
| *31 | −114.5012 | 6.3879 | | | | | 22.046 |
| *32 | −12.8503 | 0.5903 | 1.58913 | 61.15 | 0.53824 | | 21.386 |
| *33 | −45.0261 | DD[33] | | | | | 22.687 |

TABLE 11
Example 4

| | Wide | Middle | Tele |
|---|---|---|---|
| Zr | 1.0 | 1.8 | 3.8 |
| f | 36.03 | 64.85 | 135.10 |
| Bf | 11.00 | 17.69 | 28.92 |
| FNo. | 2.89 | 2.89 | 2.89 |
| 2ω[°] | 44.0 | 24.4 | 11.8 |
| DD[5] | 1.24 | 27.96 | 50.71 |
| DD[10] | 6.48 | 4.41 | 1.77 |
| DD[20] | 8.21 | 5.89 | 1.89 |
| DD[27] | 12.40 | 8.68 | 2.91 |
| DD[29] | 4.30 | 5.71 | 6.90 |
| DD[33] | 11.00 | 17.69 | 28.92 |

TABLE 12
Example 4

| Sn | 1 | 2 | 30 | 31 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.4584819E−06 | 1.4377124E−06 | −1.8669221E−05 | −2.2241610E−05 |
| A5 | −3.8022467E−09 | 3.9300482E−09 | 2.1507405E−06 | 5.2485976E−07 |
| A6 | 6.6296947E−10 | −6.9968037E−11 | 4.3294360E−08 | 1.5572635E−07 |
| A7 | −3.0979746E−12 | 9.0412198E−12 | 6.3711776E−09 | −3.1983333E−09 |
| A8 | 3.3136968E−15 | 4.1605201E−13 | −1.7629091E−10 | −7.0842111E−10 |
| A9 | 2.1130859E−14 | 2.1693873E−14 | 6.6078467E−11 | 4.9364812E−11 |
| A10 | 6.2404406E−16 | −4.6431770E−17 | −1.7476338E−12 | 9.1036183E−12 |
| A11 | −1.2160709E−17 | −5.6619610E−17 | 1.9169576E−13 | 8.2909159E−13 |
| A12 | −4.5820174E−19 | 1.4263063E−18 | 1.1826884E−15 | −3.1379295E−14 |
| A13 | 1.8913404E−20 | 3.4579963E−21 | 3.5694170E−16 | −2.4702699E−15 |
| A14 | −4.0627476E−22 | 8.8426582E−23 | 6.6842866E−17 | −6.7083610E−17 |
| A15 | −2.8645950E−23 | 4.3045455E−23 | 1.2052030E−18 | −1.3372283E−17 |
| A16 | 3.5539631E−24 | 7.9649987E−25 | 8.1692474E−19 | 3.5574802E−18 |

| Sn | 28 | 29 | 32 | 33 |
|---|---|---|---|---|
| KA | 1.0000000E+00 | 1.0000000E+00 | −1.2051000E−01 | 1.0000000E+00 |
| A3 | 0.0000000E+00 | 0.0000000E+00 | 0.0000000E+00 | 0.0000000E+00 |
| A4 | 3.5374137E−05 | 1.7567268E−05 | 2.2693675E−05 | 3.8430366E−05 |
| A5 | 1.1632580E−06 | 1.8959462E−06 | −7.4031268E−06 | 1.1365804E−07 |
| A6 | 9.9028034E−09 | 7.8328617E−08 | 6.3358360E−07 | −4.0676931E−07 |
| A7 | −3.3464097E−09 | 4.8592610E−09 | −5.0403900E−09 | 7.7546804E−09 |
| A8 | −1.9144590E−10 | 3.3224539E−09 | 3.2732335E−09 | 1.0381769E−08 |
| A9 | −1.0966494E−10 | −3.1839250E−10 | 6.9558535E−10 | 1.9841248E−11 |
| A10 | 1.6799542E−11 | −4.6337870E−11 | −1.2846130E−10 | −6.2814206E−11 |
| A11 | −6.5265500E−14 | 5.1231538E−12 | 2.7019034E−12 | −1.1221915E−12 |
| A12 | −8.9618356E−14 | −1.3227679E−13 | 1.4303156E−12 | −2.8013555E−13 |
| A13 | −2.0102480E−15 | 4.3732179E−14 | −1.0270450E−13 | 7.9200723E−15 |
| A14 | −1.0776130E−15 | −2.1247865E−15 | −7.5356890E−15 | 5.2644365E−15 |
| A15 | 5.0892574E−17 | −3.4481646E−16 | −2.0937131E−16 | −2.3000527E−16 |
| A16 | 2.0334142E−17 | 1.6051371E−18 | 6.3987968E−17 | 2.2047115E−17 |
| A17 | −2.3883648E−19 | −1.3574846E−18 | 1.0920633E−18 | −3.9015864E−18 |
| A18 | −6.6898500E−20 | 2.5707043E−19 | 3.6682407E−19 | 3.7718700E−20 |
| A19 | −6.8582804E−21 | 3.6182669E−20 | −3.7614078E−20 | 1.8079430E−20 |
| A20 | 4.9072384E−22 | −3.1535500E−21 | 6.8505442E−24 | −6.8128749E−22 |

### Example 5

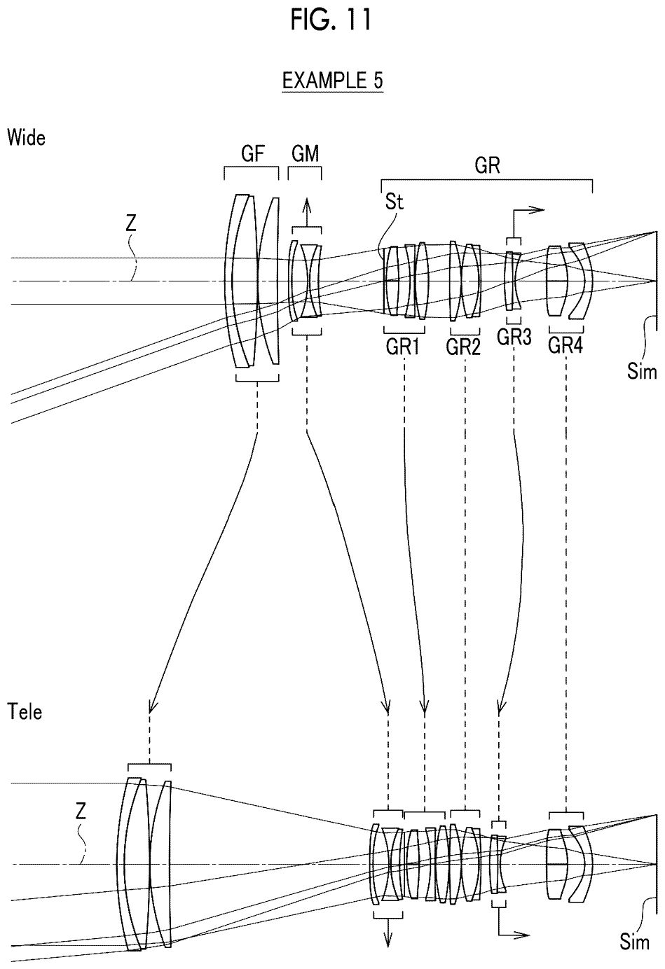

A configuration and a moving path of a variable magnification optical system of Example 5 are illustrated in FIG. 11. The variable magnification optical system of Example 5 consists of the front group GF, the middle group GM, and the rear group GR in this order from the object side to the image side. The front group GF consists of one lens group having a positive refractive power. The middle group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, and the fourth subsequent lens group GR4 having a positive refractive power in this order from the object side to the image side. The rear group GR includes the Lp1 lens and the Ln1 lens described above.

During changing the magnification from the wide angle end to the telephoto end, the second subsequent lens group GR2 and the fourth subsequent lens group GR4 are fixed with respect to the image plane Sim, and other lens groups move by changing the spacings with their adjacent lens groups. The variable magnification optical system includes only one focusing group. The focusing group consists of the third subsequent lens group GR3. During the focusing from the infinite distance object to the nearest object, the third subsequent lens group GR3 moves to the image side, and other lens groups are fixed with respect to the image plane Sim. The vibration-proof group consists of the middle group GM.

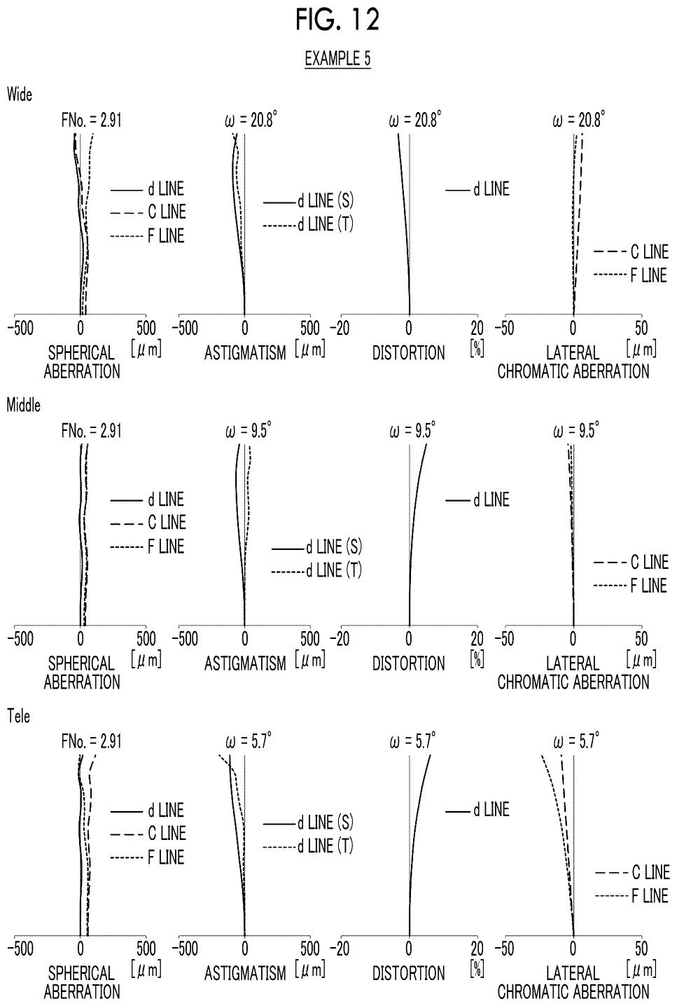

For the variable magnification optical system of Example 5, basic lens data is shown in Table 13, specifications and variable surface spacings are shown in Table 14, aspherical coefficients are shown in Table 15, and each aberration diagram is illustrated in FIG. 12. The column of ED in the table of the basic lens data shows the effective diameter of each surface of the Lp1 lens and the Ln1 lens.

TABLE 13
Example 5

| Sn | R | D | Nd | νd | θgF | ρ | ED |
|---|---|---|---|---|---|---|---|
| 1 | 100.7706 | 2.0000 | 2.00069 | 25.46 | 0.61364 | 4.73 | |
| 2 | 67.5894 | 6.7887 | 1.43700 | 95.10 | 0.53364 | 3.53 | |
| 3 | −282.0695 | 0.1000 | | | | | |
| 4 | 69.7347 | 5.2809 | 1.51680 | 64.20 | 0.53430 | 2.52 | |
| 5 | 759.3351 | DD[5] | | | | | |
| *6 | 236.8488 | 0.8681 | 1.58313 | 59.38 | 0.54237 | | |
| *7 | 60.5638 | 4.2596 | | | | | |
| 8 | −30.1803 | 0.5476 | 1.77535 | 50.31 | 0.55042 | | |
| 9 | 26.2585 | 2.3455 | 1.95906 | 17.47 | 0.65993 | | |
| 10 | 62.4645 | DD[10] | | | | | |
| 11 (St) | ∞ | 0.6458 | | | | | |
| *12 | 45.9460 | 3.3410 | 1.49710 | 81.56 | 0.53848 | | |
| *13 | −56.3991 | 3.0514 | | | | | |
| 14 | −39.3895 | 1.1930 | 1.71736 | 29.52 | 0.60483 | | |
| 15 | 478.7121 | 0.2000 | | | | | |
| 16 | 47.2813 | 3.5678 | 1.49700 | 81.61 | 0.53887 | | |
| 17 | −57.4508 | DD[17] | | | | | |
| 18 | 245.9989 | 3.1031 | 1.71736 | 29.52 | 0.60483 | | |
| 19 | −38.3884 | 0.0500 | | | | | |
| 20 | 38.3994 | 4.7413 | 1.57099 | 50.80 | 0.55887 | | |
| 21 | −27.9948 | 0.5325 | 1.92286 | 18.90 | 0.64960 | | |
| 22 | −128.7755 | DD[22] | | | | | |
| 23 | 60.9230 | 2.1928 | 1.95906 | 17.47 | 0.65993 | | |
| 24 | −232.5318 | 0.6654 | 1.88300 | 39.22 | 0.57288 | | |
| 25 | 19.2872 | DD[25] | | | | | |
| *26 | 263.5401 | 5.6625 | 1.49710 | 81.56 | 0.53848 | | 19.800 |
| *27 | −21.1873 | 4.6094 | | | | | 19.812 |
| *28 | −11.4085 | 2.0922 | 1.58913 | 61.15 | 0.53824 | | 19.814 |
| *29 | −22.1972 | 17.26 | | | | | 21.750 |

TABLE 14
Example 5

| | Wide | Middle | Tele |
|---|---|---|---|
| Zr | 1.0 | 2.1 | 3.5 |
| f | 38.58 | 81.01 | 135.02 |
| Bf | 17.26 | 17.26 | 17.26 |
| FNo. | 2.91 | 2.91 | 2.91 |
| 2ω[°] | 41.6 | 19.0 | 11.4 |
| DD[5] | 3.00 | 34.71 | 53.68 |
| DD[10] | 17.46 | 5.77 | 1.29 |
| DD[17] | 5.67 | 2.99 | 0.17 |
| DD[22] | 6.35 | 8.14 | 2.33 |
| DD[25] | 8.44 | 6.64 | 12.45 |

TABLE 15
Example 5

| Sn | 6 | 7 | 12 | 13 |
|---|---|---|---|---|
| KA | 1.0000000E+00 | 1.0000000E+00 | 1.0000000E+00 | 1.0000000E+00 |
| A4 | 3.1394087E−05 | 2.5539361E−05 | 7.6942284E−06 | 2.6061764E−05 |
| A6 | 8.6654240E−08 | 1.1099355E−07 | −1.6684332E−08 | 4.5324231E−08 |
| A8 | −1.1234866E−09 | −7.9163642E−10 | 6.6262928E−09 | 1.4737766E−09 |
| A10 | 2.0987593E−11 | 2.3383497E−12 | −1.4871752E−10 | 2.2380560E−11 |
| A12 | −2.9073176E−13 | 1.3267426E−13 | 1.9215822E−12 | −5.3932060E−13 |
| A14 | 3.2635484E−15 | −1.8945619E−15 | −1.1310589E−14 | −9.0191482E−16 |
| A16 | −2.2480154E−17 | 1.4770430E−17 | 1.6844548E−17 | 1.3744613E−16 |
| A18 | 8.3222743E−20 | −6.7229044E−20 | 8.1855078E−20 | −1.4045700E−18 |
| A20 | −1.1756161E−22 | 1.6891185E−22 | −6.9537914E−23 | 4.5691362E−21 |
| Sn | 26 | 27 | 28 | 29 |
| KA | 1.0000000E+00 | 1.0000000E+00 | 1.0000000E+00 | 1.0000000E+00 |
| A4 | 1.6556388E−05 | −1.2374354E−06 | −1.7077607E−05 | −5.2865387E−05 |
| A6 | 2.3518453E−07 | 3.1126444E−07 | 2.7004826E−06 | 1.8072675E−06 |
| A8 | −2.0272497E−09 | 4.6096229E−09 | −9.3978883E−09 | −1.4175369E−08 |
| A10 | 6.1173021E−11 | −7.3008066E−11 | −1.4878003E−10 | −7.8616661E−12 |
| A12 | −5.3941920E−13 | −5.7048188E−14 | 1.3234419E−12 | 6.1301675E−13 |
| A14 | 2.4779953E−15 | 1.6086783E−14 | 2.4487584E−15 | 1.2372806E−15 |
| A16 | 1.3908019E−17 | −1.3305736E−16 | 1.8824186E−16 | −5.3288630E−17 |
| A18 | −9.1050461E−20 | 1.5864089E−19 | −3.1938648E−18 | 3.0059070E−19 |
| A20 | −5.6326024E−23 | 2.0965300E−21 | 1.2930878E−20 | −6.4628137E−22 |

### Example 6

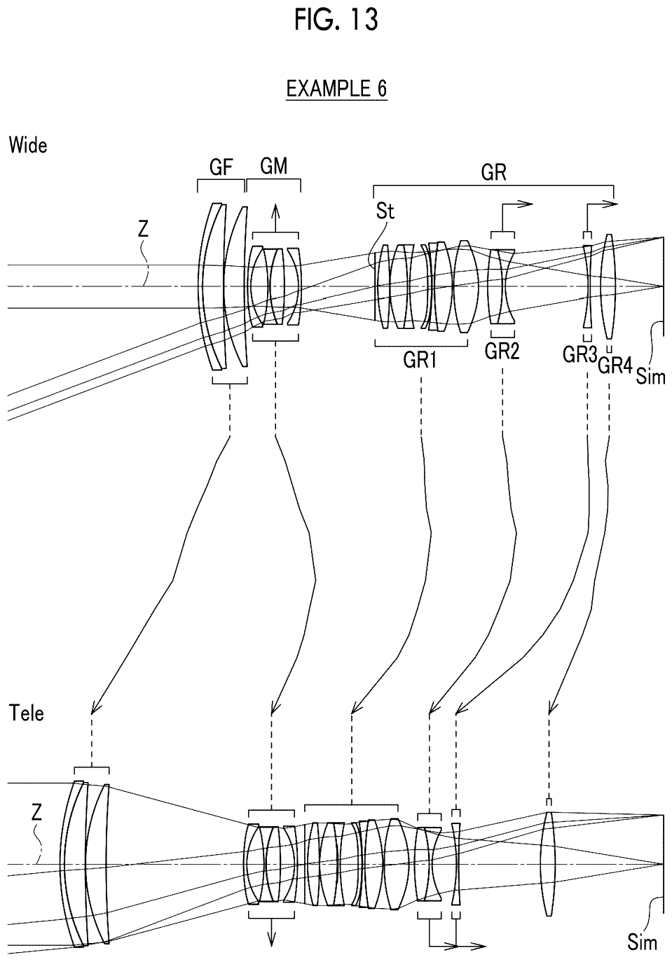

A configuration and a moving path of a variable magnification optical system of Example 6 are illustrated in FIG. 13. The variable magnification optical system of Example 6 consists of the front group GF, the middle group GM, and the rear group GR in this order from the object side to the image side. The front group GF consists of one lens group having a positive refractive power. The middle group GM consists of one lens group having a negative refractive power. The rear group GR consists of the first subsequent lens group GR1 having a positive refractive power, the second subsequent lens group GR2 having a negative refractive power, the third subsequent lens group GR3 having a negative refractive power, and the fourth subsequent lens group GR4 having a positive refractive power in this order from the object side to the image side.

During changing the magnification from the wide angle end to the telephoto end, all lens groups move by changing the spacings with their adjacent lens groups. The variable magnification optical system includes two focusing groups. The focusing group on the object side consists of the second subsequent lens group GR2, and the focusing group on the image side consists of the third subsequent lens group GR3. During the focusing from the infinite distance object to the nearest object, the second subsequent lens group GR2 and the third subsequent lens group GR3 move to the image side by changing the spacings with each other, and other lens groups are fixed with respect to the image plane Sim. The vibration-proof group consists of the middle group GM.

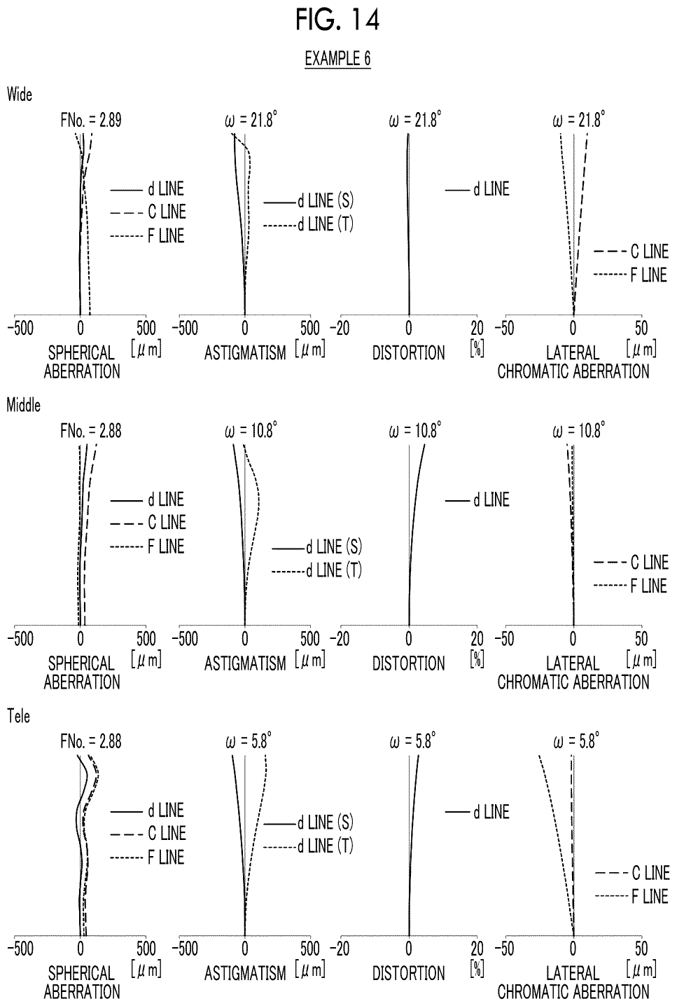

For the variable magnification optical system of Example 6, basic lens data is shown in Table 16, specifications and variable surface spacings are shown in Table 17, aspherical coefficients are shown in Table 18, and each aberration diagram is illustrated in FIG. 14.

TABLE 16
Example 6

| Sn | R | D | Nd | νd | θgF | ρ |
|---|---|---|---|---|---|---|
| 1 | 75.0456 | 1.2064 | 1.89286 | 20.36 | 0.63944 | 3.61 |
| 2 | 56.1044 | 5.6910 | 1.49700 | 81.54 | 0.53748 | 3.62 |
| 3 | 380.6415 | 0.0502 | | | | |
| 4 | 53.6120 | 5.5812 | 1.51680 | 64.20 | 0.53430 | 2.52 |
| 5 | 324.1823 | DD[5] | | | | |
| *6 | 68.6141 | 0.8751 | 1.58913 | 61.15 | 0.53824 | |
| *7 | 20.4793 | 4.6429 | | | | |
| 8 | −49.3682 | 0.5557 | 1.60342 | 38.03 | 0.58356 | |
| 9 | 30.4570 | 0.0491 | | | | |
| 10 | 30.1134 | 3.8758 | 1.89286 | 20.36 | 0.63944 | |
| 11 | −94.1195 | 3.8225 | | | | |
| 12 | −19.9105 | 0.8096 | 1.83481 | 42.74 | 0.56490 | |
| 13 | −74.3528 | DD[13] | | | | |
| 14 (St) | ∞ | 0.7500 | | | | |
| 15 | 48.2790 | 3.2286 | 1.53775 | 74.70 | 0.53936 | |
| 16 | −126.2166 | 0.0500 | | | | |
| 17 | 33.5996 | 4.8012 | 1.49700 | 81.54 | 0.53748 | |
| 18 | −69.4674 | 0.6105 | 1.85478 | 24.80 | 0.61232 | |
| 19 | 63.4200 | 4.8782 | | | | |
| *20 | −189.9858 | 1.0428 | 1.74320 | 49.29 | 0.55303 | |
| *21 | −73.4358 | 0.1081 | | | | |
| 22 | −85.6236 | 0.6807 | 1.67270 | 32.10 | 0.59891 | |
| 23 | 84.4065 | 4.8457 | 1.55200 | 70.70 | 0.54219 | |
| 24 | −38.0286 | 0.3979 | | | | |
| *25 | 55.5438 | 6.7176 | 1.61881 | 63.85 | 0.54182 | |
| *26 | −28.6845 | DD[26] | | | | |
| 27 | 64.7256 | 3.9890 | 1.89286 | 20.36 | 0.63944 | |
| 28 | −43.9046 | 0.8100 | 1.88300 | 39.22 | 0.57288 | |
| 29 | 20.6978 | DD[29] | | | | |
| *30 | −48.1952 | 0.6114 | 1.68948 | 31.02 | 0.59874 | |
| *31 | 370.6816 | DD[31] | | | | |
| 32 | 64.2691 | 4.0188 | 1.64000 | 60.08 | 0.53704 | |
| 33 | −106.0566 | DD[33] | | | | |

TABLE 17
Example 6

| | Wide | Middle | Tele |
|---|---|---|---|
| Zr | 1.0 | 2.0 | 3.8 |
| f | 35.55 | 71.10 | 135.08 |
| Bf | 13.10 | 17.08 | 29.47 |
| FNo. | 2.89 | 2.88 | 2.88 |
| 2ω[°] | 43.6 | 21.6 | 11.6 |
| DD[5] | 0.91 | 27.31 | 37.35 |
| DD[13] | 19.82 | 10.05 | 2.00 |
| DD[26] | 2.49 | 3.38 | 1.51 |
| DD[29] | 22.46 | 16.57 | 6.60 |
| DD[31] | 2.81 | 2.69 | 22.19 |
| DD[33] | 13.10 | 17.08 | 29.47 |

TABLE 18
Example 6

| Sn | 6 | 7 | 20 | 21 |
|---|---|---|---|---|
| KA | 1.0000000E+00 | 1.0000000E+00 | 1.0000000E+00 | 1.0000000E+00 |
| A4 | 1.3042174E−05 | 1.7501808E−06 | −4.4348786E−05 | −2.8370120E−06 |
| A6 | 5.3756621E−08 | 7.9468643E−08 | −1.5480643E−07 | −1.5792614E−07 |
| A8 | 1.2268976E−10 | −7.6860792E−10 | −7.1864602E−10 | −9.7454163E−10 |
| A10 | −4.4846512E−12 | 1.0280854E−11 | −5.5398100E−12 | −1.4701865E−12 |
| A12 | 6.3729927E−14 | −3.9921458E−14 | 6.2925673E−14 | 4.6344606E−14 |
| A14 | −3.1953923E−16 | 6.6615047E−17 | −8.2423520E−17 | −6.0550395E−17 |
| A16 | 6.1618239E−19 | 3.7832493E−19 | −4.9276754E−21 | −9.4596335E−20 |

| Sn | 25 | 26 | 30 | 31 |
|---|---|---|---|---|
| KA | 1.0000000E+00 | 1.0000000E+00 | 1.0000000E+00 | 1.0000000E+00 |
| A4 | 1.4958767E−05 | 3.9641497E−06 | 1.6588939E−05 | 1.8304604E−05 |
| A6 | −2.2806888E−08 | 2.1823341E−08 | −1.9192641E−08 | −4.6981010E−08 |
| A8 | −4.1917738E−11 | 3.5604266E−11 | −1.4992413E−09 | −9.2687813E−10 |
| A10 | 9.5622788E−14 | −1.1848617E−14 | 7.5910549E−12 | 3.5803625E−12 |
| A12 | −1.2631545E−15 | −1.5693499E−15 | 1.1077728E−13 | 9.5685182E−14 |
| A14 | 3.5215525E−18 | −3.2465504E−19 | −1.2737224E−15 | −9.2383417E−16 |
| A16 | 2.8343171E−21 | 1.4163251E−20 | 3.8054437E−18 | 2.5026463E−18 |

### Example 7

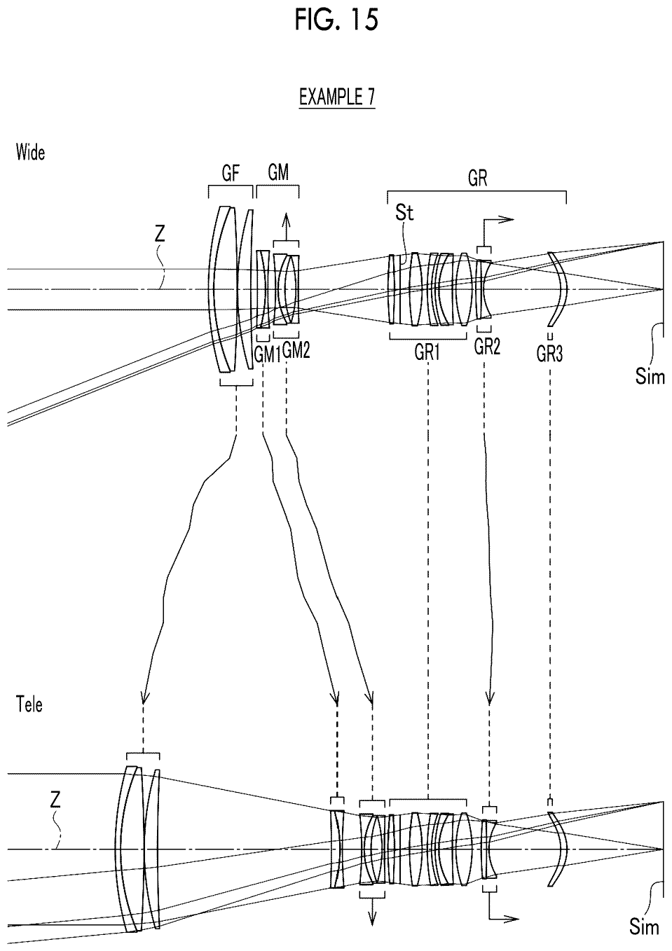

A configuration and a moving path of a variable magnification optical system of Example 7 are illustrated in FIG. 15. The variable magnification optical system of Example 7 consists of the front group GF, the middle group GM, and the rear group GR in this order from the object side to the image side. The front group GF consists of one lens group having a positive refractive power. The middle group GM consists of a first middle lens group GM1 having a negative refractive power and a second middle lens group GM2 having a negative refractive power in this order from the object side to the image side. The rear group GR consists of the first subsequent lens group GR1 having a positive refractive power, the second subsequent lens group GR2 having a negative refractive power, and the third subsequent lens group GR3 having a positive refractive power in this order from the object side to the image side.

During changing the magnification from the wide angle end to the telephoto end, the first subsequent lens group GR1 and the third subsequent lens group GR3 are fixed with respect to the image plane Sim, and other lens groups move by changing the spacings with their adjacent lens groups. The variable magnification optical system includes only one focusing group. The focusing group consists of the second subsequent lens group GR2. During the focusing from the infinite distance object to the nearest object, the second subsequent lens group GR2 moves to the image side, and other lens groups are fixed with respect to the image plane Sim. The vibration-proof group consists of the second middle lens group GM2.

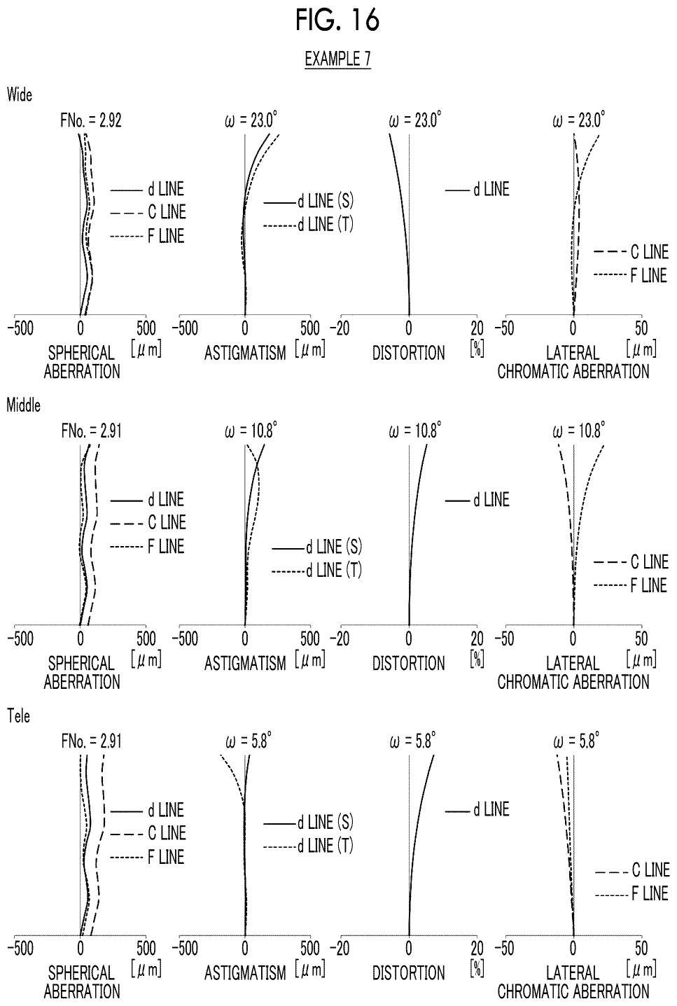

For the variable magnification optical system of Example 7, basic lens data is shown in Table 19, specifications and variable surface spacings are shown in Table 20, aspherical coefficients are shown in Table 21, and each aberration diagram is illustrated in FIG. 16.

TABLE 19
Example 7

| Sn | R | D | Nd | νd | θgF | ρ |
|---|---|---|---|---|---|---|
| 1 | 95.4955 | 1.5000 | 1.92286 | 20.88 | 0.63900 | 3.94 |
| 2 | 66.7408 | 6.5478 | 1.49782 | 82.57 | 0.53862 | 3.86 |
| 3 | −406.6091 | 0.1000 | | | | |
| 4 | 90.8471 | 3.7213 | 1.51680 | 64.20 | 0.53430 | 2.52 |
| 5 | 514.2870 | DD[5] | | | | |
| 6 | −283.7926 | 2.2257 | 1.92286 | 18.90 | 0.64960 | |
| 7 | −48.6857 | 0.6818 | 1.58313 | 59.37 | 0.54345 | |
| 8 | 152.4999 | DD[8] | | | | |
| 9 | −96.6295 | 0.6935 | 1.48749 | 70.24 | 0.53007 | |
| 10 | 21.9319 | 1.9213 | 1.75500 | 52.32 | 0.54757 | |
| 11 | 30.8958 | 3.0734 | | | | |
| 12 | −37.4814 | 0.6750 | 1.80400 | 46.53 | 0.55775 | |
| 13 | 341.6220 | DD[13] | | | | |
| *14 | 96.5405 | 1.7872 | 1.55332 | 71.68 | 0.54029 | |
| *15 | −113.8488 | 1.6142 | | | | |
| 16 (St) | ∞ | 2.6248 | | | | |
| *17 | 69.0958 | 3.5107 | 1.49710 | 81.56 | 0.53848 | |
| *18 | −45.5162 | 1.4579 | | | | |
| 19 | 62.0205 | 1.1839 | 1.85025 | 30.05 | 0.59797 | |
| 20 | 32.6156 | 0.9998 | | | | |
| 21 | 35.7565 | 1.0437 | 1.85478 | 24.80 | 0.61232 | |
| 22 | 21.2347 | 3.7923 | 1.43700 | 95.10 | 0.53364 | |
| 23 | 219.4700 | 1.0001 | | | | |
| 24 | 35.9408 | 4.5193 | 1.71299 | 53.87 | 0.54587 | |
| 25 | −37.7743 | DD[25] | | | | |
| 26 | 104.7504 | 1.4935 | 1.96300 | 24.11 | 0.62126 | |
| 27 | −507.6725 | 0.6814 | 1.62299 | 58.16 | 0.54589 | |
| 28 | 16.0222 | DD[28] | | | | |
| *29 | −15.2273 | 1.7598 | 1.51633 | 64.06 | 0.53345 | |
| *30 | −13.9010 | 26.9984 | | | | |

TABLE 20
Example 7

| | Wide | Middle | Tele |
|---|---|---|---|
| Zr | 1.0 | 2.0 | 3.7 |
| f | 35.50 | 70.99 | 131.34 |
| Bf | 27.00 | 27.00 | 27.00 |
| FNo. | 2.92 | 2.91 | 2.91 |
| 2ω[°] | 46.0 | 21.6 | 11.6 |
| DD[5] | 1.86 | 30.93 | 48.67 |
| DD[8] | 2.16 | 4.65 | 5.42 |
| DD[13] | 24.96 | 12.74 | 1.00 |
| DD[25] | 1.05 | 2.65 | 2.56 |
| DD[28] | 21.60 | 19.99 | 20.08 |

TABLE 21
Example 7

| Sn | 14 | 15 | 29 | 30 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −2.3363637E−05 | 4.6955662E−07 | 3.2316391E−06 | 1.9196817E−05 |
| A5 | 2.4262468E−06 | 4.5457660E−07 | 5.3182978E−06 | 1.2689040E−06 |
| A6 | 1.1837665E−07 | 1.6169208E−07 | −4.4518663E−07 | 2.5161225E−07 |
| A7 | −6.2617057E−08 | 1.1845921E−08 | 5.5193203E−08 | 6.2839394E−09 |
| A8 | 5.2672924E−09 | −1.1397345E−09 | −1.9841743E−09 | −1.9610591E−09 |
| A9 | −2.4426056E−10 | 1.6217495E−10 | −1.0409626E−10 | 6.2040825E−11 |
| A10 | 6.3958596E−11 | −4.3709329E−11 | 3.1956024E−11 | 1.1308261E−11 |
| A11 | 2.8041814E−12 | 2.8170842E−12 | −8.8568631E−13 | 1.6870518E−12 |
| A12 | −2.5574949E−13 | 4.9016069E−13 | 1.8296671E−13 | −4.9766377E−14 |
| A13 | −1.3087660E−13 | −5.4710184E−14 | −1.9721352E−14 | −1.1027670E−14 |
| A14 | 3.1372534E−15 | 3.8826374E−16 | 2.6256987E−16 | 1.1551430E−15 |
| A15 | 3.8625294E−16 | −5.4580865E−17 | 3.3976905E−17 | −6.7290724E−17 |
| A16 | −5.6153013E−18 | 1.2103784E−17 | −2.0401199E−18 | 1.5890013E−18 |
| A17 | 4.3371477E−18 | −5.9433000E−18 | | |
| A18 | −8.7886775E−20 | −1.3435497E−20 | | |
| A19 | −3.1278987E−20 | 1.0742356E−19 | | |
| A20 | 1.1916704E−21 | −5.6443042E−21 | | |

| Sn | 17 | 18 |
|---|---|---|
| KA | 1.0000000E+00 | 1.0000000E+00 |
| A4 | −1.5947866E−05 | −7.6602344E−06 |
| A6 | 1.8775474E−07 | 8.4855623E−08 |
| A8 | −6.6213346E−10 | −1.3674203E−10 |
| A10 | −3.7133566E−12 | −2.5692135E−12 |
| A12 | 2.3217689E−14 | 1.3565481E−14 |

### Example 8

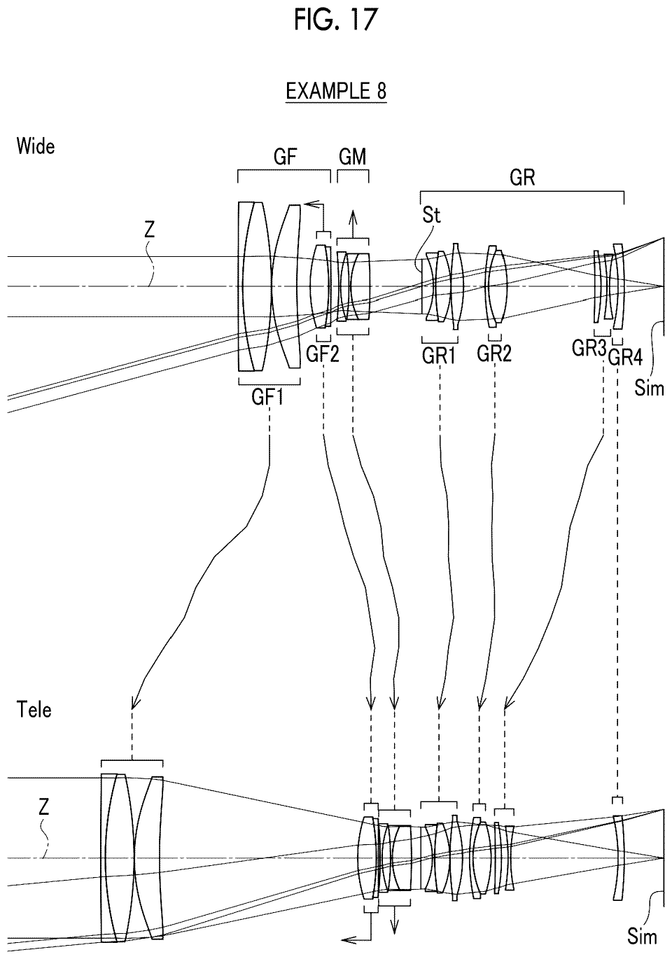

A configuration and a moving path of a variable magnification optical system of Example 8 are illustrated in FIG. 17. The variable magnification optical system of Example 8 consists of the front group GF, the middle group GM, and the rear group GR in this order from the object side to the image side. The front group GF consists of the first front side lens group GF1 having a positive refractive power and the second front side lens group GF2 having a positive refractive power in this order from the object side to the image side. The middle group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, and the fourth subsequent lens group GR4 having a negative refractive power in this order from the object side to the image side.

During changing the magnification from the wide angle end to the telephoto end, the fourth subsequent lens group GR4 is fixed with respect to the image plane Sim, and other lens groups move by changing the spacings with their adjacent lens groups. The variable magnification optical system includes only one focusing group. The focusing group consists of the second front side lens group GF2. During the focusing from the infinite distance object to the nearest object, the second front side lens group GF2 moves to the object side, and other lens groups are fixed with respect to the image plane Sim. The vibration-proof group consists of the middle group GM.

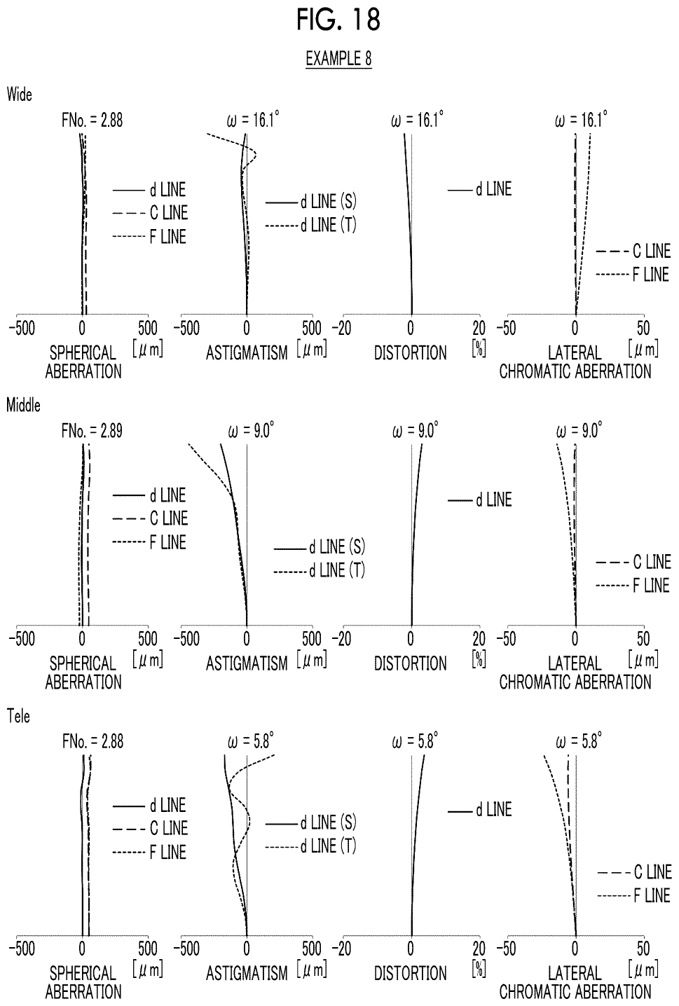

For the variable magnification optical system of Example 8, basic lens data is shown in Table 22, specifications and variable surface spacings are shown in Table 23, aspherical coefficients are shown in Table 24, and each aberration diagram is illustrated in FIG. 18.

TABLE 22
Example 8

| Sn | R | D | Nd | νd | θgF | ρ |
|---|---|---|---|---|---|---|
| 1 | 2014.0158 | 1.2518 | 1.72047 | 34.71 | 0.58350 | 3.19 |
| 2 | 95.5642 | 7.8808 | 1.49700 | 81.61 | 0.53887 | 3.70 |
| 3 | −120.8520 | 0.0878 | | | | |
| *4 | 53.9661 | 6.9111 | 1.51633 | 64.06 | 0.53345 | 2.38 |
| *5 | 185.3625 | DD[5] | | | | |
| 6 | 41.8754 | 5.1144 | 1.67790 | 55.35 | 0.54339 | 3.59 |
| 7 | −70.2179 | 0.6003 | 1.95906 | 17.47 | 0.65993 | 3.59 |
| 8 | −594.3315 | DD[8] | | | | |
| 9 | −115.0442 | 0.5243 | 1.83481 | 42.74 | 0.56490 | |
| 10 | 30.7331 | 2.3110 | | | | |
| 11 | −73.7789 | 0.5066 | 1.77535 | 50.31 | 0.55042 | |
| 12 | 22.4248 | 5.2554 | 1.89286 | 20.36 | 0.63944 | |
| 13 | −148.7079 | DD[13] | | | | |
| 14 (St) | ∞ | 3.1893 | | | | |
| 15 | −21.8675 | 0.6237 | 1.89190 | 37.13 | 0.57813 | |
| 16 | 65.2654 | 4.1534 | 1.55032 | 75.50 | 0.54001 | |
| 17 | −26.7239 | 0.0500 | | | | |
| *18 | 81.0257 | 3.4506 | 1.76450 | 49.10 | 0.55289 | |
| *19 | −38.6778 | DD[19] | | | | |
| 20 | 62.4339 | 0.9426 | 1.90366 | 31.34 | 0.59636 | |
| 21 | 27.7227 | 4.9585 | 1.59282 | 68.62 | 0.54414 | |
| 22 | −36.5796 | DD[22] | | | | |
| 23 | −256.3769 | 1.6804 | 1.89286 | 20.36 | 0.63944 | |
| 24 | −60.9168 | 1.6583 | | | | |
| *25 | −51.2784 | 0.7237 | 1.80835 | 40.55 | 0.56931 | |
| *26 | 56.3357 | DD[26] | | | | |
| 27 | −56.5322 | 1.6893 | 1.48749 | 70.32 | 0.52917 | |
| 28 | −122.9290 | 10.8900 | | | | |

TABLE 23
Example 8

| | Wide | Middle | Tele |
|---|---|---|---|
| Zr | 1.0 | 1.7 | 2.7 |
| f | 50.21 | 87.01 | 135.10 |
| Bf | 10.89 | 10.89 | 10.89 |
| FNo. | 2.88 | 2.89 | 2.88 |
| 2ω[°] | 32.2 | 18.0 | 11.6 |
| DD[5] | 3.66 | 35.34 | 54.31 |
| DD[8] | 2.12 | 1.51 | 0.47 |
| DD[13] | 14.26 | 5.39 | 2.56 |
| DD[19] | 5.93 | 2.66 | 1.93 |
| DD[22] | 24.08 | 12.67 | 1.18 |
| DD[26] | 2.33 | 13.88 | 29.51 |

TABLE 24
Example 8

| Sn | 4 | 5 | 18 | 19 |
|---|---|---|---|---|
| KA | 9.2111719E−01 | 1.0000000E+00 | 1.0000000E+00 | 1.0000000E+00 |
| A4 | −4.2307177E−07 | −4.8996533E−07 | −1.4939507E−06 | 4.3103917E−06 |
| A6 | −1.3542761E−09 | −1.8192791E−09 | −2.9590794E−08 | −1.8263042E−08 |
| A8 | 4.9579771E−13 | 3.4217165E−12 | 1.2966623E−09 | 9.1674282E−10 |
| A10 | −1.3901503E−15 | −9.3493540E−15 | −2.0718971E−11 | −1.3969530E−11 |
| A12 | −3.9536828E−18 | −5.7988290E−18 | 5.6424888E−14 | 1.6047769E−14 |
| A14 | −1.0202182E−20 | 1.6218112E−20 | 4.1006909E−16 | 3.5255759E−16 |
| A16 | 6.2926457E−24 | 1.0465632E−23 | 4.3816455E−18 | 4.5162287E−18 |
| A18 | 3.8885899E−26 | −4.2193166E−26 | −6.9395240E−20 | −5.7357582E−20 |
| A20 | −5.3417191E−29 | 1.2980363E−29 | 1.7652655E−22 | 1.2981241E−22 |

| Sn | 25 | 26 |
|---|---|---|
| KA | 1.0000000E+00 | 1.0000000E+00 |
| A4 | 3.5442917E−05 | 3.6671621E−05 |
| A6 | −1.6545886E−07 | −1.2359358E−07 |
| A8 | −1.9678137E−09 | −3.4634281E−09 |
| A10 | −1.1503234E−11 | 2.5396605E−11 |
| A12 | 3.8538100E−13 | −1.5492673E−14 |
| A14 | 2.7659304E−15 | 2.6202055E−15 |
| A16 | −3.0584127E−17 | −4.8341907E−18 |
| A18 | −3.5965238E−19 | −3.1955587E−19 |
| A20 | 2.7923543E−21 | 1.4144200E−21 |

### Example 9

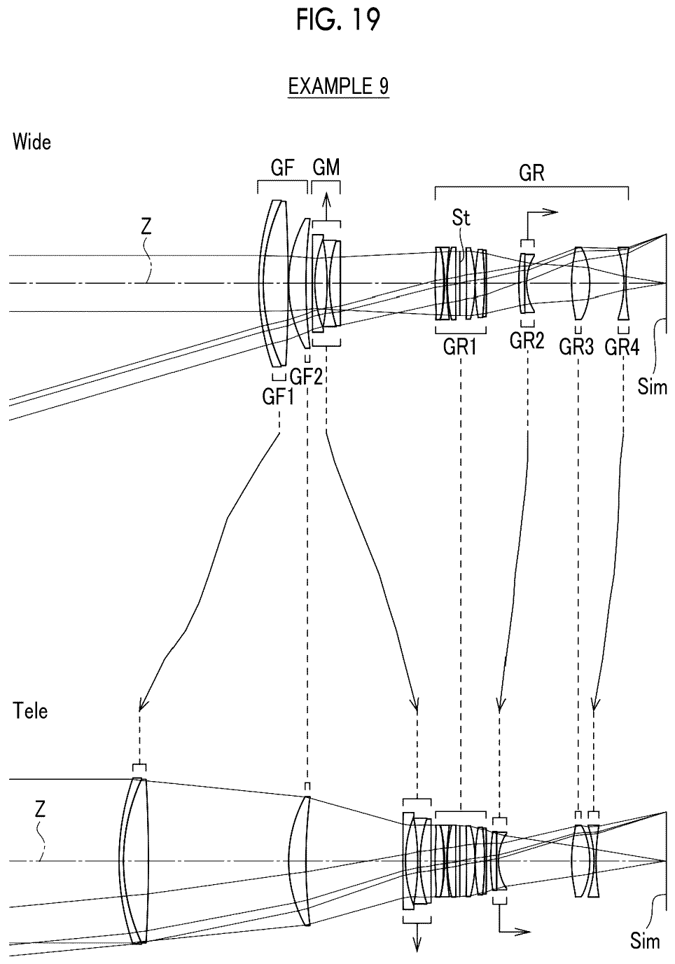

A configuration and a moving path of a variable magnification optical system of Example 9 are illustrated in FIG. 19. The variable magnification optical system of Example 9 consists of the front group GF, the middle group GM, and the rear group GR in this order from the object side to the image side. The front group GF consists of the first front side lens group GF1 having a positive refractive power and the second front side lens group GF2 having a positive refractive power in this order from the object side to the image side. The middle group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, and the fourth subsequent lens group GR4 having a negative refractive power in this order from the object side to the image side.

During changing the magnification from the wide angle end to the telephoto end, the second front side lens group GF2, the first subsequent lens group GR1, and the third subsequent lens group GR3 are fixed with respect to the image plane Sim, and other lens groups move by changing the spacings with their adjacent lens groups. The variable magnification optical system includes only one focusing group. The focusing group consists of the second subsequent lens group GR2. During the focusing from the infinite distance object to the nearest object, the second subsequent lens group GR2 moves to the image side, and other lens groups are fixed with respect to the image plane Sim. The vibration-proof group consists of the middle group GM.

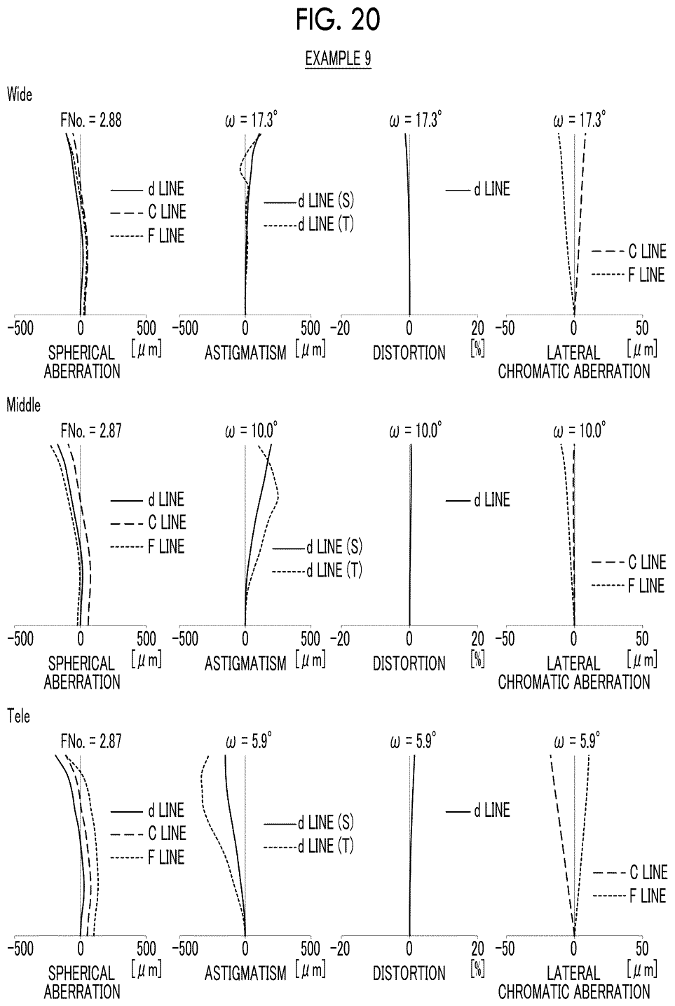

For the variable magnification optical system of Example 9, basic lens data is shown in Table 25, specifications and variable surface spacings are shown in Table 26, aspherical coefficients are shown in Table 27, and each aberration diagram is illustrated in FIG. 20.

TABLE 25
Example 9

| Sn | R | D | Nd | νd | θgF | ρ |
|---|---|---|---|---|---|---|
| 1 | 78.1634 | 1.2086 | 1.95375 | 32.32 | 0.59015 | 5.10 |
| 2 | 59.5997 | 6.7839 | 1.43700 | 95.10 | 0.53364 | 3.53 |
| 3 | −437.4503 | DD[3] | | | | |
| 4 | 40.8796 | 4.7108 | 1.49700 | 81.61 | 0.53887 | 3.70 |
| 5 | 157.9819 | DD[5] | | | | |
| *6 | 831.4671 | 0.6998 | 2.00330 | 28.27 | 0.59802 | |
| *7 | 37.5448 | 3.3306 | | | | |
| 8 | −72.4074 | 0.6758 | 1.49700 | 81.54 | 0.53748 | |
| 9 | 42.4461 | 2.9250 | 1.92286 | 18.90 | 0.64960 | |
| 10 | 2823.7559 | DD[10] | | | | |
| *11 | 81.6046 | 2.3103 | 1.76450 | 49.10 | 0.55289 | |
| *12 | −84.0371 | 0.2780 | | | | |
| 13 | −48.1357 | 0.5925 | 1.84666 | 23.78 | 0.62054 | |
| 14 | 76.2075 | 0.1365 | | | | |
| 15 | 46.2037 | 2.2728 | 1.83481 | 42.74 | 0.56490 | |
| 16 | 898.0126 | DD[16] | | | | |
| 17 (St) | ∞ | 1.8184 | | | | |
| 18 | −566.4844 | 2.3157 | 1.88300 | 39.22 | 0.57288 | |
| 19 | −41.8399 | 0.0517 | | | | |
| 20 | 58.8444 | 2.5450 | 1.59282 | 68.62 | 0.54414 | |
| 21 | −86.4576 | 0.5000 | 1.95906 | 17.47 | 0.65993 | |
| 22 | −658.4801 | DD[22] | | | | |
| 23 | 61.3052 | 1.6211 | 1.95906 | 17.47 | 0.65993 | |
| 24 | 941.2007 | 0.5130 | 1.72000 | 50.23 | 0.55214 | |
| *25 | 16.1643 | DD[25] | | | | |
| *26 | 42.1687 | 4.9534 | 1.59201 | 67.02 | 0.53589 | |
| *27 | −25.6861 | DD[27] | | | | |
| *28 | −30.3599 | 0.5412 | 1.83220 | 40.10 | 0.57151 | |
| 29 | 68.2344 | DD[29] | | | | |

TABLE 26
Example 9

| | Wide | Middle | Tele |
|---|---|---|---|
| Zr | 1.0 | 1.7 | 3.0 |
| f | 46.21 | 80.10 | 136.33 |
| Bf | 11.00 | 13.57 | 19.13 |
| FNo. | 2.88 | 2.87 | 2.87 |
| 2ω[°] | 34.6 | 20.0 | 11.8 |
| DD[3] | 0.13 | 19.22 | 37.99 |
| DD[5] | 1.72 | 16.06 | 26.37 |
| DD[10] | 25.78 | 11.43 | 1.14 |
| DD[16] | 1.13 | 1.13 | 1.13 |
| DD[22] | 8.66 | 5.27 | 1.16 |
| DD[25] | 12.22 | 15.61 | 19.72 |
| DD[27] | 9.30 | 6.73 | 1.16 |
| DD[29] | 11.00 | 13.57 | 19.13 |

TABLE 27
Example 9

| Sn | 6 | 7 | 11 | 12 |
|---|---|---|---|---|
| KA | 1.0000000E+00 | 1.0000000E+00 | 1.0000000E+00 | 1.0000000E+00 |
| A4 | −6.1941629E−06 | −6.2392940E−06 | −2.0870517E−05 | −1.0396099E−05 |
| A6 | 7.1809566E−08 | 6.1573283E−08 | −1.5566667E−08 | −5.0446544E−08 |
| A8 | −1.9528599E−10 | 2.0976691E−10 | −5.8450323E−09 | −4.2889959E−09 |
| A10 | −8.9429316E−13 | −6.7776353E−12 | 9.8173464E−11 | 5.9125676E−11 |
| A12 | −2.1438968E−14 | 2.1834325E−14 | −7.0097432E−13 | 1.5077417E−13 |
| A14 | 4.2156552E−16 | 2.7184262E−16 | 1.7941271E−15 | −1.1834038E−14 |
| A16 | −2.6089719E−18 | −2.4792488E−18 | −4.8953767E−17 | 9.1939637E−17 |
| A18 | 7.0946997E−21 | 7.4732223E−21 | 7.1881664E−19 | −9.6054487E−20 |
| A20 | −7.2178274E−24 | −7.7115271E−24 | −2.9085516E−21 | −9.0505428E−22 |

| Sn | 25 | 26 | 27 | 28 |
|---|---|---|---|---|
| KA | 1.0000000E+00 | 1.0000000E+00 | 1.0000000E+00 | 1.0000000E+00 |
| A4 | 1.6203794E−06 | −5.3720309E−07 | 6.4869417E−06 | 1.7568276E−05 |
| A6 | −9.1406039E−08 | −1.5269005E−07 | −8.0489487E−08 | −1.8423970E−07 |
| A8 | 3.3348603E−09 | 5.4018226E−09 | −4.9206847E−10 | 5.2507093E−09 |
| A10 | −3.0408977E−11 | −1.8098751E−10 | 4.1243541E−12 | −9.9209545E−11 |
| A12 | −3.4106884E−12 | 2.9888709E−12 | 2.5263892E−13 | 1.2714889E−12 |
| A14 | 1.6619848E−13 | −2.0523690E−14 | −8.9670257E−15 | −1.4993158E−14 |
| A16 | −3.4309662E−15 | −9.2449546E−17 | 8.4365062E−17 | 1.6014559E−16 |
| A18 | 3.4516349E−17 | 2.1292970E−18 | −2.1106381E−19 | −1.0655483E−18 |
| A20 | −1.3750002E−19 | −8.9487706E−21 | −6.9297266E−22 | 2.9319311E−21 |

### Example 10

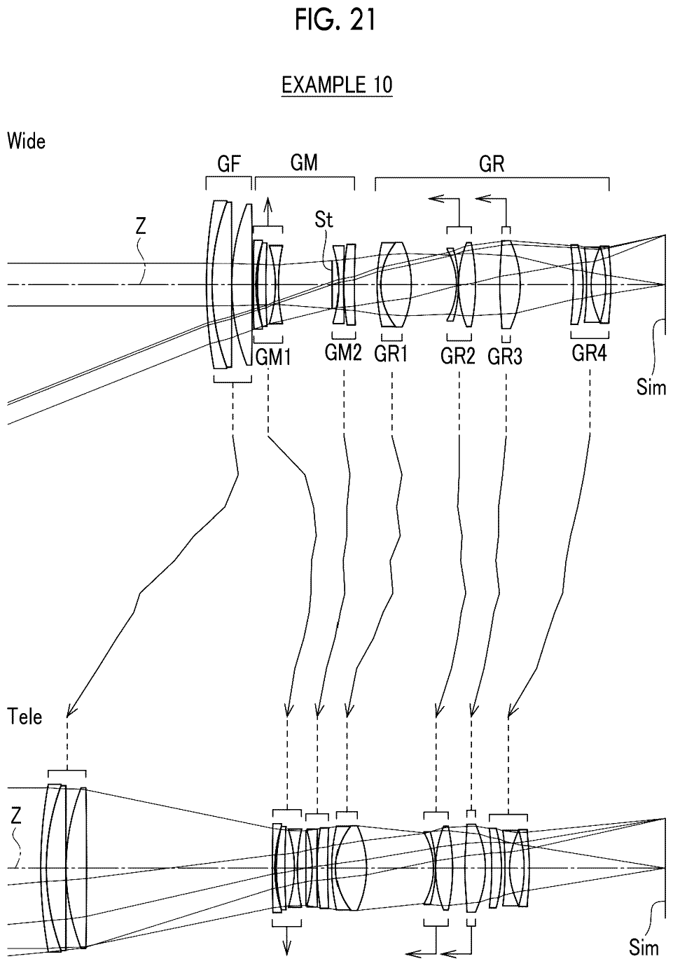

A configuration and a moving path of a variable magnification optical system of Example 10 are illustrated in FIG. 21. The variable magnification optical system of Example 10 consists of the front group GF, the middle group GM, and the rear group GR in this order from the object side to the image side. The front group GF consists of one lens group having a positive refractive power. The middle group GM consists of the first middle lens group GM1 having a negative refractive power and the second middle lens group GM2 having a negative refractive power in this order from the object side to the image side. The rear group GR consists of the first subsequent lens group GR1 having a positive refractive power, the second subsequent lens group GR2 having a positive refractive power, the third subsequent lens group GR3 having a positive refractive power, and the fourth subsequent lens group GR4 having a negative refractive power in this order from the object side to the image side.

During changing the magnification from the wide angle end to the telephoto end, all lens groups move by changing the spacings with their adjacent lens groups. The variable magnification optical system includes two focusing groups. The focusing group on the object side consists of the second subsequent lens group GR2, and the focusing group on the image side consists of the third subsequent lens group GR3. During the focusing from the infinite distance object to the nearest object, the second subsequent lens group GR2 and the third subsequent lens group GR3 move to the object side by changing the spacings with each other, and other lens groups are fixed with respect to the image plane Sim. The vibration-proof group consists of the first middle lens group GM1.

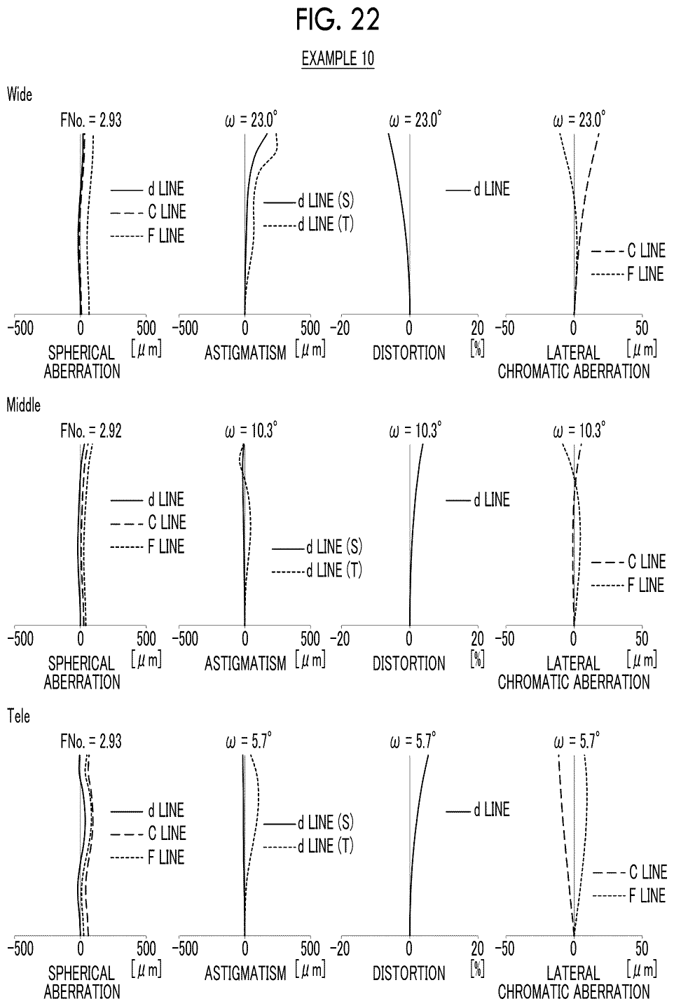

For the variable magnification optical system of Example 10, basic lens data is shown in Table 28, specifications and variable surface spacings are shown in Table 29, aspherical coefficients are shown in Table 30, and each aberration diagram is illustrated in FIG. 22.

TABLE 28
Example 10

| Sn | R | D | Nd | νd | θgF | ρ |
|---|---|---|---|---|---|---|
| 1 | 142.7075 | 1.5000 | 1.80518 | 25.42 | 0.61616 | 3.37 |
| 2 | 72.2315 | 5.2702 | 1.48749 | 70.32 | 0.52917 | 2.45 |
| 3 | −14260.7229 | 0.0491 | | | | |
| 4 | 67.5388 | 5.5102 | 1.51680 | 64.20 | 0.53430 | 2.52 |
| 5 | −1426.3732 | DD[5] | | | | |
| 6 | 531.0753 | 0.6591 | 1.71736 | 29.52 | 0.60483 | |
| 7 | 41.0076 | 0.4304 | | | | |
| 8 | 53.0601 | 2.2738 | 1.95906 | 17.47 | 0.65993 | |
| 9 | 241.1541 | 2.5723 | | | | |
| *10 | −34.2659 | 0.8000 | 1.49710 | 81.56 | 0.53848 | |
| *11 | 61.4776 | DD[11] | | | | |
| 12 (St) | ∞ | 1.6544 | | | | |
| *13 | −49.8643 | 1.2834 | 1.80610 | 40.73 | 0.56940 | |
| *14 | 223.3457 | 0.0480 | | | | |
| 15 | 73.2174 | 2.8419 | 1.95906 | 17.47 | 0.65993 | |
| 16 | 246.9599 | DD[16] | | | | |
| 17 | 56.6683 | 1.0100 | 1.57099 | 50.80 | 0.55887 | |
| 18 | 20.0692 | 8.2028 | 1.49700 | 81.54 | 0.53748 | |
| 19 | −30.7316 | DD[19] | | | | |
| 20 | −21.4459 | 0.5272 | 1.85478 | 24.80 | 0.61232 | |
| 21 | −39.0881 | 0.0485 | | | | |
| 22 | 34.2598 | 4.5644 | 1.43875 | 94.66 | 0.53402 | |
| 23 | −62.0134 | DD[23] | | | | |
| *24 | 81.7272 | 5.5187 | 1.51633 | 64.06 | 0.53345 | |
| *25 | −28.8989 | DD[25] | | | | |
| 26 | −97.4174 | 2.6197 | 2.00069 | 25.43 | 0.61417 | |
| 27 | −46.1348 | 0.9281 | | | | |
| *28 | −155.9970 | 1.2498 | 1.58313 | 59.38 | 0.54237 | |
| *29 | 23.0862 | 3.9272 | | | | |
| *30 | −44.1705 | 1.3748 | 1.58913 | 61.15 | 0.53824 | |
| *31 | −94.1655 | DD[31] | | | | |

TABLE 29
Example 10

| | Wide | Middle | Tele |
|---|---|---|---|
| Zr | 1.0 | 2.1 | 3.8 |
| f | 35.69 | 74.95 | 134.55 |
| Bf | 14.65 | 21.97 | 36.59 |
| FNo. | 2.93 | 2.92 | 2.93 |
| 2ω[°] | 46.0 | 20.6 | 11.4 |
| DD[5] | 0.30 | 36.75 | 49.97 |
| DD[11] | 14.45 | 3.18 | 2.30 |
| DD[16] | 6.11 | 6.14 | 1.10 |
| DD[19] | 12.12 | 13.66 | 18.01 |
| DD[23] | 6.51 | 2.92 | 3.30 |
| DD[25] | 14.26 | 8.74 | 1.71 |
| DD[31] | 14.65 | 21.97 | 36.59 |

TABLE 30
Example 10

| Sn | 10 | 11 | 13 | 14 |
|---|---|---|---|---|
| KA | 1.0000000E+00 | 1.0000000E+00 | 1.0000000E+00 | 1.0000000E+00 |
| A4 | 3.9289950E−05 | 3.1382281E−05 | −3.6715084E−05 | −3.1417356E−05 |
| A6 | −6.2222295E−07 | −6.9654970E−07 | 2.3131046E−07 | 3.2770274E−07 |
| A8 | 7.7485445E−09 | 9.4262320E−09 | 1.1006884E−09 | −1.2468833E−09 |
| A10 | −6.4359522E−11 | −8.4194127E−11 | −2.7014517E−11 | 2.6005545E−13 |
| A12 | 3.8811798E−13 | 5.3915794E−13 | 1.4539233E−13 | −3.2548240E−14 |
| A14 | −1.5973014E−15 | −2.2487350E−15 | −4.2782930E−16 | 3.1679074E−16 |
| A16 | 3.1363498E−18 | 4.1880391E−18 | 1.2563210E−18 | −5.0839274E−19 |

| Sn | 24 | 25 | 28 | 29 |
|---|---|---|---|---|
| KA | 1.0000000E+00 | 1.0000000E+00 | 1.0000000E+00 | 1.0000000E+00 |
| A4 | −1.6486615E−05 | 7.8506877E−06 | −1.5719287E−05 | −1.0611362E−05 |
| A6 | 1.9559879E−08 | 1.8205966E−08 | 1.2936027E−08 | −1.1544615E−08 |
| A8 | −4.4954513E−10 | −4.0656374E−10 | −1.7313330E−10 | −4.4072905E−10 |
| A10 | 3.8243491E−12 | 3.4161123E−12 | 1.9097988E−12 | −7.5715737E−13 |
| A12 | −1.4884728E−14 | −8.8640746E−15 | −8.7846804E−15 | 4.2707385E−14 |
| A14 | 6.7049084E−18 | −3.2691520E−17 | −7.6695115E−17 | −6.3924994E−16 |
| A16 | 1.4841271E−19 | 2.3302423E−19 | 1.4277240E−19 | 1.3766424E−18 |

| Sn | 30 | 31 |
|---|---|---|
| KA | 1.0000000E+00 | 1.0000000E+00 |
| A4 | −1.5730382E−05 | −9.1034702E−06 |
| A6 | −1.7728701E−08 | 2.4131899E−08 |
| A8 | 4.8161744E−10 | 2.8566976E−10 |
| A10 | −7.2130763E−12 | 1.8638775E−13 |
| A12 | 1.1182054E−13 | 4.8934190E−14 |
| A14 | −1.8668958E−16 | −1.6838289E−16 |
| A16 | 4.5673236E−19 | 1.4262558E−18 |

### Example 11

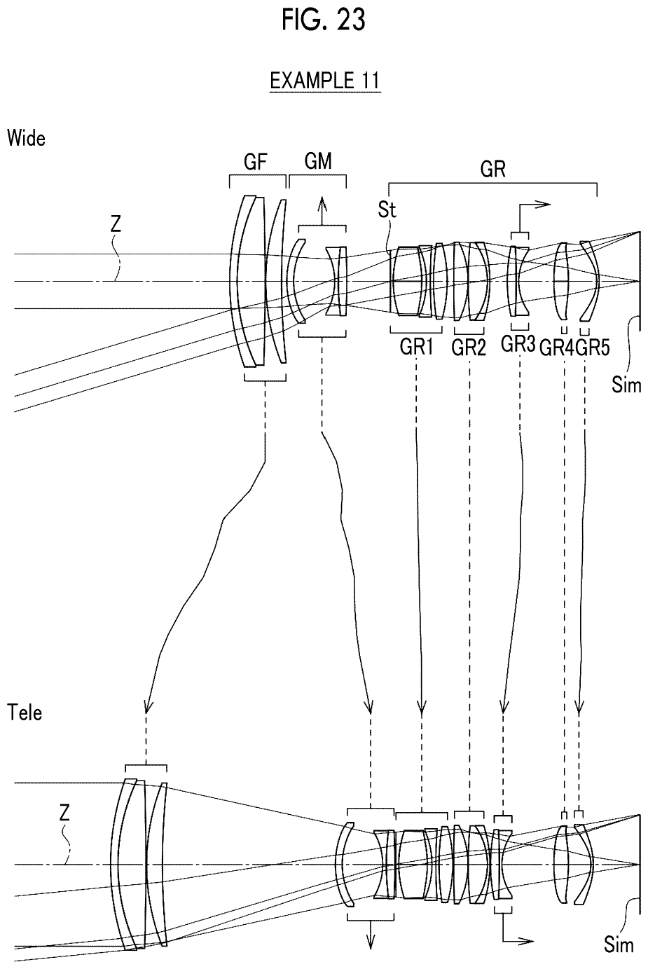

A configuration and a moving path of a variable magnification optical system of Example 11 are illustrated in FIG. 23. The variable magnification optical system of Example 11 consists of the front group GF, the middle group GM, and the rear group GR in this order from the object side to the image side. The front group GF consists of one lens group having a positive refractive power. The middle group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, the fourth subsequent lens group GR4 having a positive refractive power, and the fifth subsequent lens group GR5 having a negative refractive power in this order from the object side to the image side. The rear group GR includes the Lp1 lens and the Ln1 lens described above.

During changing the magnification from the wide angle end to the telephoto end, the second subsequent lens group GR2 and the fourth subsequent lens group GR4 are fixed with respect to the image plane Sim, and other lens groups move by changing the spacings with their adjacent lens groups. The variable magnification optical system includes only one focusing group. The focusing group consists of the third subsequent lens group GR3. During the focusing from the infinite distance object to the nearest object, the third subsequent lens group GR3 moves to the image side, and other lens groups are fixed with respect to the image plane Sim. The vibration-proof group consists of the middle group GM.

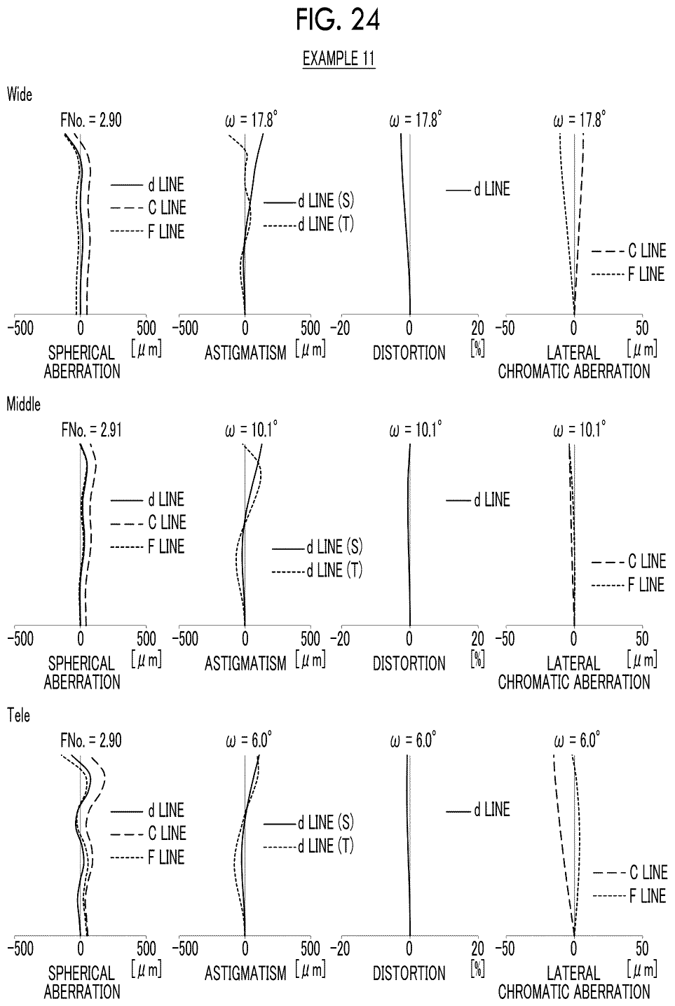

For the variable magnification optical system of Example 11, basic lens data is shown in Table 31, specifications and variable surface spacings are shown in Table 32, aspherical coefficients are shown in Table 33, and each aberration diagram is illustrated in FIG. 24. The column of ED in the table of the basic lens data shows the effective diameter of each surface of the Lp1 lens and the Ln1 lens.

TABLE 31
Example 11

| Sn | R | D | Nd | νd | θgF | ρ | ED |
|---|---|---|---|---|---|---|---|
| 1 | 77.5521 | 2.0000 | 2.00069 | 25.46 | 0.61364 | 4.73 | |
| 2 | 59.8054 | 7.4989 | 1.43700 | 95.10 | 0.53364 | 3.53 | |
| 3 | −868.7244 | 0.1905 | | | | | |
| 4 | 67.1585 | 4.2522 | 1.55032 | 75.50 | 0.54001 | 4.09 | |
| 5 | 223.0770 | DD[5] | | | | | |
| *6 | 27.7165 | 1.8354 | 1.48749 | 70.24 | 0.53007 | | |
| *7 | 21.5104 | 10.8890 | | | | | |
| 8 | −19.2347 | 0.9828 | 1.77535 | 50.31 | 0.55042 | | |
| 9 | 81.3320 | 2.2668 | 1.95906 | 17.47 | 0.65993 | | |
| 10 | −202.9038 | DD[10] | | | | | |
| 11 (St) | ∞ | 0.7667 | | | | | |
| *12 | 31.5964 | 7.6635 | 1.49710 | 81.56 | 0.53848 | | |
| *13 | −31.1110 | 1.2517 | | | | | |
| 14 | −25.8653 | 1.0464 | 1.71736 | 29.52 | 0.60483 | | |
| 15 | 150.9778 | 0.8638 | | | | | |
| 16 | 74.4502 | 3.6825 | 1.49700 | 81.61 | 0.53887 | | |
| 17 | −42.4474 | DD[17] | | | | | |
| 18 | 460.3245 | 3.8136 | 1.71736 | 29.52 | 0.60483 | | |
| 19 | −26.9803 | 0.0500 | | | | | |
| 20 | 119.6800 | 5.1868 | 1.57099 | 50.80 | 0.55887 | | |
| 21 | −20.0788 | 0.6411 | 1.92286 | 18.90 | 0.64960 | | |
| 22 | −38.6929 | DD[22] | | | | | |
| 23 | 50.2629 | 2.4092 | 1.95906 | 17.47 | 0.65993 | | |
| 24 | −205.5477 | 0.6692 | 1.88300 | 39.22 | 0.57288 | | |
| 25 | 16.0875 | DD[25] | | | | | |
| *26 | 58.0321 | 3.8716 | 1.49710 | 81.56 | 0.53848 | | 22.000 |
| *27 | −48.5964 | DD[27] | | | | | 21.468 |
| *28 | −11.3315 | 0.6494 | 1.85400 | 40.38 | 0.56890 | | 21.296 |
| *29 | −21.3474 | DD[29] | | | | | 22.819 |

TABLE 32
Example 11

| | Wide | Middle | Tele |
|---|---|---|---|
| Zr | 1.0 | 1.8 | 3.0 |
| f | 45.51 | 79.98 | 136.09 |
| Bf | 11.01 | 11.82 | 12.58 |
| FNo. | 2.90 | 2.91 | 2.90 |
| 2ω[°] | 35.6 | 20.2 | 12.0 |
| DD[5] | 1.40 | 26.61 | 46.37 |
| DD[10] | 11.73 | 3.99 | 0.30 |
| DD[17] | 1.78 | 1.00 | 0.29 |
| DD[22] | 4.69 | 4.55 | 0.17 |
| DD[25] | 9.48 | 9.61 | 14.00 |
| DD[27] | 7.62 | 6.80 | 6.04 |
| DD[29] | 11.01 | 11.82 | 12.58 |

TABLE 33
Example 11

| Sn | 6 | 7 | 12 | 13 |
|---|---|---|---|---|
| KA | 1.0000000E+00 | 1.0000000E+00 | 1.0000000E+00 | 1.0000000E+00 |
| A4 | −3.2877188E−06 | −2.0608309E−05 | −3.9525444E−06 | 4.6432360E−05 |
| A6 | 1.8182753E−07 | 3.0991317E−07 | −6.7231184E−08 | 7.6178826E−09 |
| A8 | −1.2243380E−09 | −5.5733828E−09 | 5.8820055E−09 | 5.7145938E−10 |
| A10 | 2.3905985E−11 | 7.5466705E−11 | −1.5186672E−10 | 2.2053326E−11 |
| A12 | −3.2572035E−13 | −3.4033354E−13 | 1.8725650E−12 | −5.4841139E−13 |
| A14 | 3.4108553E−15 | −1.5918245E−15 | −1.0538184E−14 | −7.6933989E−16 |
| A16 | −2.2193684E−17 | 1.7511910E−17 | 9.2985138E−18 | 1.2776851E−16 |
| A18 | 7.9824750E−20 | 6.8167748E−22 | 8.1650253E−20 | −1.3718102E−18 |
| A20 | −1.1435494E−22 | −2.1871338E−22 | 8.6482545E−23 | 4.6943000E−21 |

| Sn | 26 | 27 | 28 | 29 |
|---|---|---|---|---|
| KA | 1.0000000E+00 | 1.0000000E+00 | 1.0000000E+00 | 1.0000000E+00 |
| A4 | 3.2852987E−05 | 1.1642736E−05 | 4.9829467E−05 | −4.3866419E−05 |
| A6 | 1.0193523E−07 | −6.2115231E−09 | 2.0405955E−06 | 1.8233863E−06 |
| A8 | −2.1867674E−09 | 5.3053333E−09 | −2.4720135E−09 | −1.4467466E−08 |
| A10 | 6.0252094E−11 | −7.3764905E−11 | −1.5587437E−10 | −3.8722271E−12 |
| A12 | −6.0197791E−13 | −9.0242040E−14 | 1.0438246E−12 | 6.3168805E−13 |
| A14 | 2.5223425E−15 | 1.5082944E−14 | 2.8701869E−15 | 1.5964043E−15 |
| A16 | 1.0182084E−17 | −1.3004696E−16 | 1.8882739E−16 | −5.7816536E−17 |
| A18 | −1.1876260E−19 | 1.3724260E−19 | −3.2373528E−18 | 2.5207282E−19 |
| A20 | 6.1021612E−22 | 2.0473044E−21 | 1.3462582E−20 | −2.9110345E−22 |

### Example 12

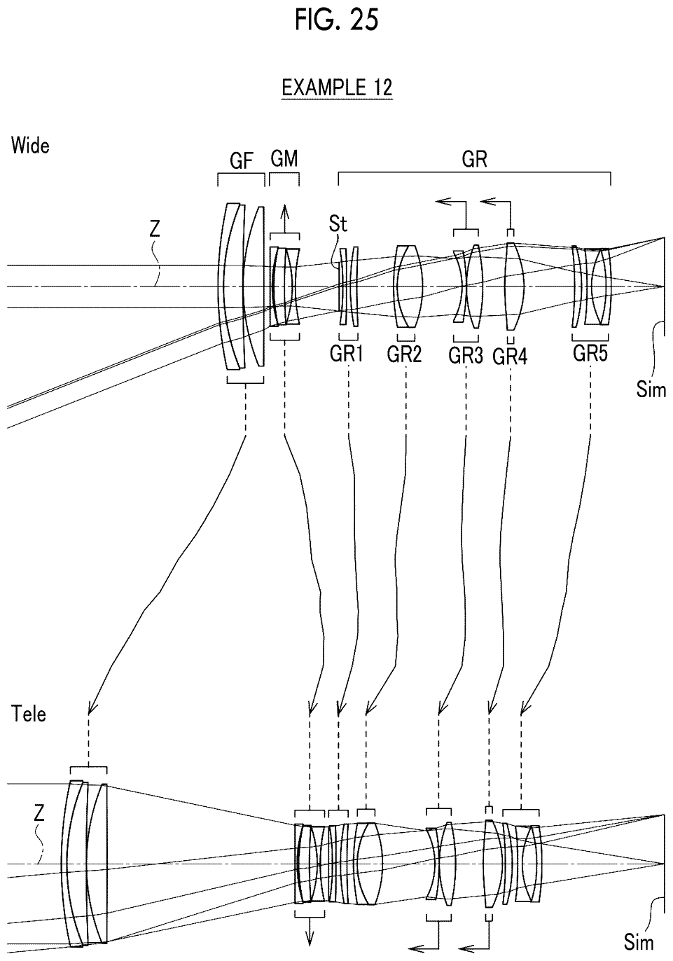

A configuration and a moving path of a variable magnification optical system of Example 12 are illustrated in FIG. 25. The variable magnification optical system of Example 12 consists of the front group GF, the middle group GM, and the rear group GR in this order from the object side to the image side. The front group GF consists of one lens group having a positive refractive power. The middle group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, the fourth subsequent lens group GR4 having a positive refractive power, and the fifth subsequent lens group GR5 having a negative refractive power in this order from the object side to the image side.

During changing the magnification from the wide angle end to the telephoto end, all lens groups move by changing the spacings with their adjacent lens groups. The variable magnification optical system includes two focusing groups. The focusing group on the object side consists of the third subsequent lens group GR3, and the focusing group on the image side consists of the fourth subsequent lens group GR4. During the focusing from the infinite distance object to the nearest object, the third subsequent lens group GR3 and the fourth subsequent lens group GR4 move to the object side by changing the spacings with each other, and other lens groups are fixed with respect to the image plane Sim. The vibration-proof group consists of the middle group GM.

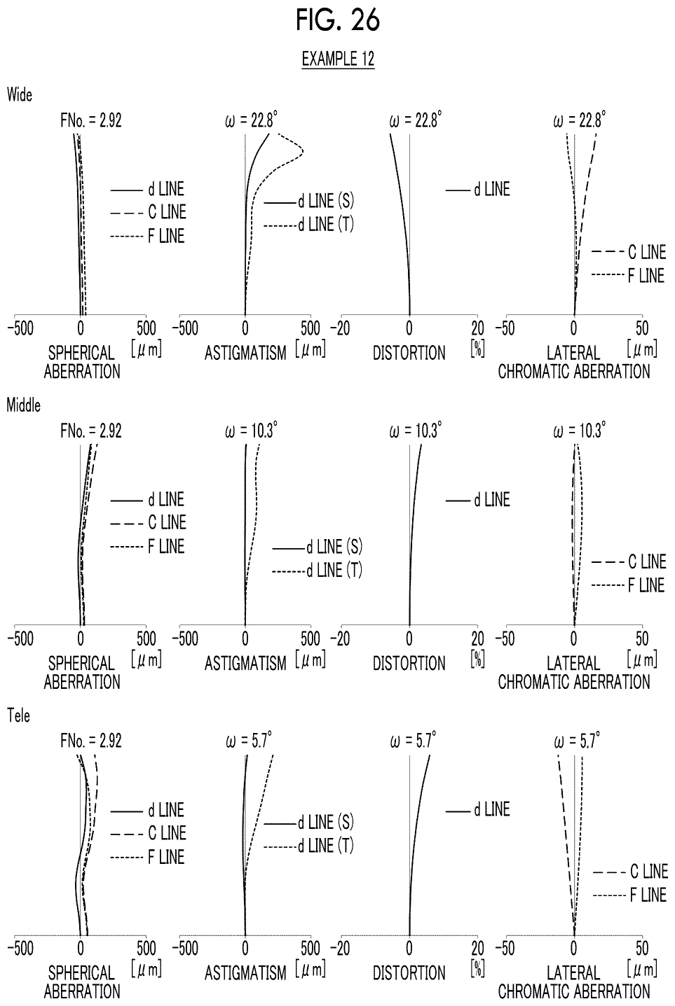

For the variable magnification optical system of Example 12, basic lens data is shown in Table 34, specifications and variable surface spacings are shown in Table 35, aspherical coefficients are shown in Table 36, and each aberration diagram is illustrated in FIG. 26.

TABLE 34
Example 12

| Sn | R | D | Nd | νd | θgF | ρ |
|---|---|---|---|---|---|---|
| 1 | 117.3622 | 1.5000 | 1.80518 | 25.42 | 0.61616 | 3.37 |
| 2 | 65.6842 | 5.2702 | 1.48749 | 70.32 | 0.52917 | 2.45 |
| 3 | 548.0815 | 0.0493 | | | | |
| 4 | 64.1342 | 5.6153 | 1.51680 | 64.20 | 0.53430 | 2.52 |
| 5 | −4942.5073 | DD[5] | | | | |
| 6 | −35000.3430 | 0.5966 | 1.71736 | 29.52 | 0.60483 | |
| 7 | 40.0960 | 0.4274 | | | | |
| 8 | 53.9629 | 2.8914 | 1.95906 | 17.47 | 0.65993 | |
| 9 | 150.7221 | 2.1387 | | | | |
| *10 | −31.2754 | 0.8000 | 1.49710 | 81.56 | 0.53848 | |
| *11 | 59.5564 | DD[111 | | | | |
| 12 (St) | ∞ | 0.9923 | | | | |
| *13 | −118.6312 | 0.9643 | 1.80610 | 40.73 | 0.56940 | |
| *14 | 494.1120 | 1.0867 | | | | |
| 15 | 67.2935 | 1.7744 | 1.95906 | 17.47 | 0.65993 | |
| 16 | 236.0749 | DD[16] | | | | |
| 17 | 65.5480 | 1.0100 | 1.57099 | 50.80 | 0.55887 | |
| 18 | 23.7682 | 6.8847 | 1.49700 | 81.54 | 0.53748 | |
| 19 | −34.1641 | DD[19] | | | | |
| 20 | −22.3379 | 1.1486 | 1.85478 | 24.80 | 0.61232 | |
| 21 | −59.9834 | 0.0486 | | | | |
| 22 | 34.8513 | 4.4256 | 1.43875 | 94.66 | 0.53402 | |
| 23 | −58.5986 | DD[23] | | | | |
| *24 | 71.8953 | 5.2176 | 1.51633 | 64.06 | 0.53345 | |
| *25 | −28.2276 | DD[25] | | | | |
| 26 | −101.1122 | 1.8800 | 2.00069 | 25.43 | 0.61417 | |
| 27 | −46.8376 | 1.4595 | | | | |
| *28 | −187.7066 | 1.2498 | 1.58313 | 59.38 | 0.54237 | |
| *29 | 23.6034 | 3.9527 | | | | |
| *30 | −44.3260 | 1.3749 | 1.58913 | 61.15 | 0.53824 | |
| *31 | −101.9111 | DD[31] | | | | |

TABLE 35
Example 12

| | Wide | Middle | Tele |
|---|---|---|---|
| Zr | 1.0 | 2.1 | 3.8 |
| f | 35.85 | 75.28 | 135.14 |
| Bf | 14.50 | 21.05 | 33.34 |
| FNo. | 2.92 | 2.92 | 2.92 |
| 2ω[°] | 45.6 | 20.6 | 11.4 |
| DD[5] | 1.70 | 34.59 | 51.07 |
| DD[11] | 11.76 | 4.37 | 2.30 |
| DD[16] | 9.97 | 5.15 | 1.77 |
| DD[19] | 10.72 | 12.87 | 14.22 |
| DD[23] | 5.98 | 3.86 | 7.50 |
| DD[25] | 13.78 | 9.71 | 0.80 |
| DD[31] | 14.50 | 21.05 | 33.34 |

TABLE 36
Example 12

| Sn | 10 | 11 | 13 | 14 |
|---|---|---|---|---|
| KA | 1.0000000E+00 | 1.0000000E+00 | 1.0000000E+00 | 1.0000000E+00 |
| A4 | 4.6912027E−05 | 3.6696804E−05 | −4.2458540E−05 | −3.7621521E−05 |
| A6 | −7.0169529E−07 | −6.7184855E−07 | 2.2152151E−07 | 2.5974703E−07 |
| A8 | 8.8605965E−09 | 9.2355734E−09 | 6.1675508E−10 | −6.0570731E−10 |
| A10 | −6.8829783E−11 | −9.2301282E−11 | −1.9508109E−11 | 4.8253700E−13 |
| A12 | 2.6621903E−13 | 6.4057363E−13 | 1.5913114E−13 | −2.4434819E−14 |
| A14 | −2.7940617E−16 | −2.8139915E−15 | −4.1724978E−16 | 3.8110289E−16 |
| A16 | −3.0874434E−19 | 5.9518752E−18 | −5.6227732E−19 | −1.6280529E−18 |

| Sn | 24 | 25 | 28 | 29 |
|---|---|---|---|---|
| KA | 1.0000000E+00 | 1.0000000E+00 | 1.0000000E+00 | 1.0000000E+00 |
| A4 | −1.6024640E−05 | 8.7677820E−06 | −2.1427371E−05 | −4.9151360E−06 |
| A6 | 1.5982304E−08 | 1.4001137E−08 | 8.8174829E−09 | 8.1406843E−09 |
| A8 | −4.7712019E−10 | −4.2214433E−10 | −1.3457216E−10 | −4.2250951E−10 |
| A10 | 3.7663482E−12 | 3.2983491E−12 | 1.6155946E−12 | 6.2882486E−14 |
| A12 | −1.4889593E−14 | −8.7172373E−15 | −9.3184320E−15 | 5.2252083E−14 |
| A14 | 3.3566874E−18 | −3.2666725E−17 | −6.3209109E−17 | −6.0832494E−16 |
| A16 | 1.5334625E−19 | 2.2056773E−19 | 2.0072035E−19 | 5.1426096E−19 |

| Sn | 30 | 31 |
|---|---|---|
| KA | 1.0000000E+00 | 1.0000000E+00 |
| A4 | −1.4427333E−05 | −1.9115898E−05 |
| A6 | −2.4418533E−08 | 8.9357651E−09 |
| A8 | 4.6604609E−10 | 1.6212053E−10 |
| A10 | −7.6470221E−12 | −1.1228120E−12 |
| A12 | 1.0294039E−13 | 4.2581204E−14 |
| A14 | −1.6779961E−16 | −1.9571902E−16 |
| A16 | −4.0113490E−19 | 1.3410147E−18 |

### Example 13

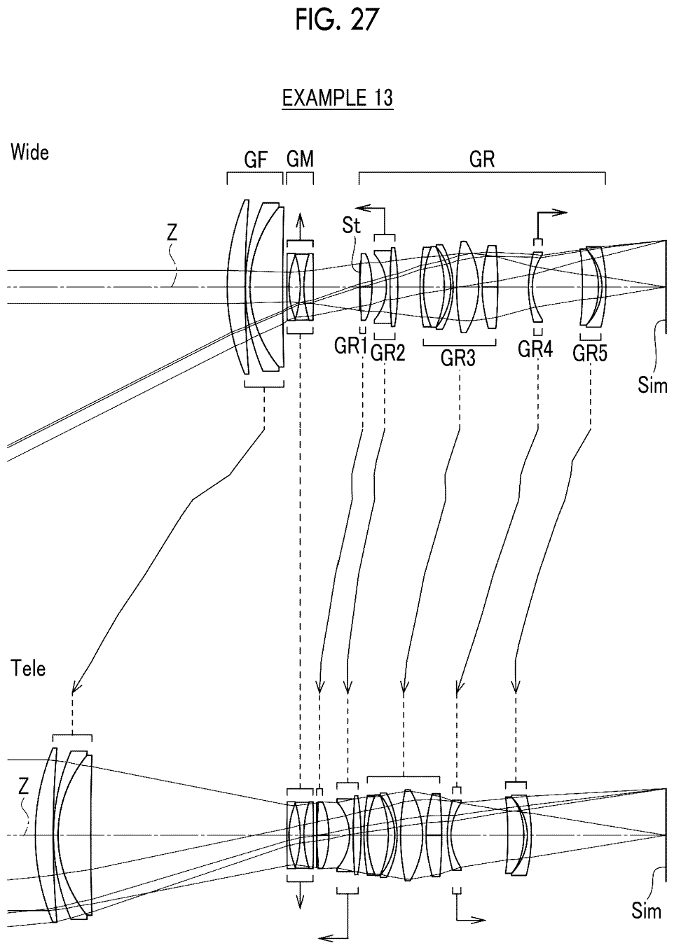

A configuration and a moving path of a variable magnification optical system of Example 13 are illustrated in FIG. 27. The variable magnification optical system of Example 13 consists of the front group GF, the middle group GM, and the rear group GR in this order from the object side to the image side. The front group GF consists of one lens group having a positive refractive power. The middle group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a positive refractive power in this order from the object side to the image side.

During changing the magnification from the wide angle end to the telephoto end, the middle group GM is fixed with respect to the image plane Sim, and other lens groups move by changing the spacings with their adjacent lens groups. The variable magnification optical system includes two focusing groups. The focusing group on the object side consists of the second subsequent lens group GR2, and the focusing group on the image side consists of the fourth subsequent lens group GR4. During the focusing from the infinite distance object to the nearest object, the second subsequent lens group GR2 moves to the object side, the fourth subsequent lens group GR4 moves to the image side, and other lens groups are fixed with respect to the image plane Sim. The vibration-proof group consists of the middle group GM.

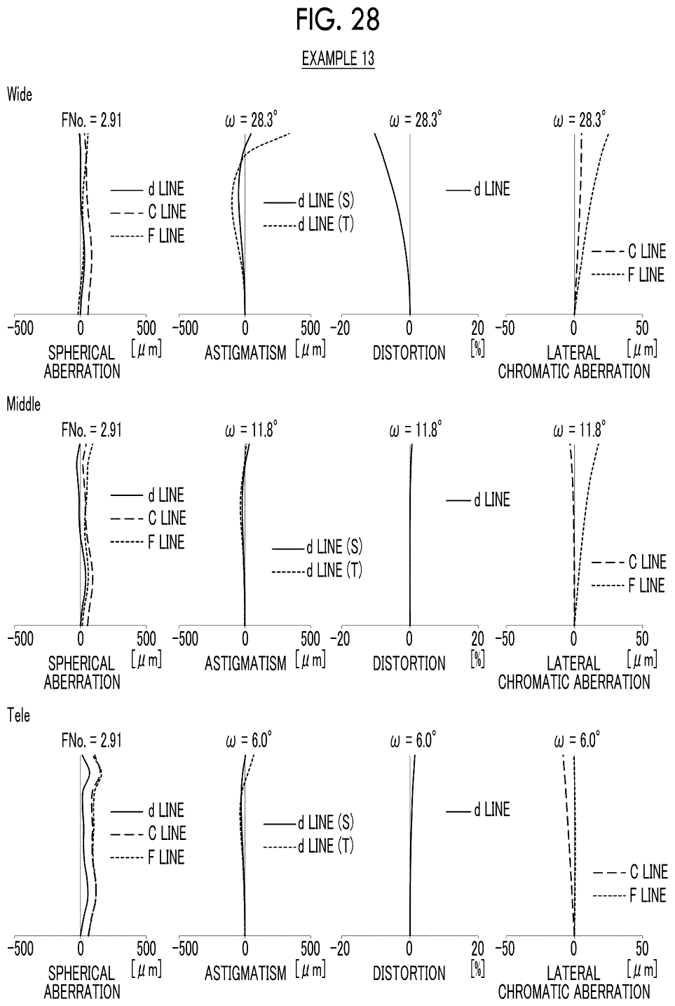

For the variable magnification optical system of Example 13, basic lens data is shown in Table 37, specifications and variable surface spacings are shown in Table 38, aspherical coefficients are shown in Table 39, and each aberration diagram is illustrated in FIG. 28.

TABLE 37
Example 13

| Sn | R | D | Nd | νd | θgF | ρ |
|---|---|---|---|---|---|---|
| 1 | 72.4142 | 5.0959 | 1.51680 | 64.20 | 0.53430 | 2.52 |
| 2 | 320.4037 | 0.1000 | | | | |
| 3 | 67.7988 | 1.3088 | 1.83400 | 37.18 | 0.57780 | 4.28 |
| 4 | 39.9692 | 9.3626 | 1.49700 | 81.54 | 0.53748 | 3.62 |
| 5 | 968.1377 | DD[5] | | | | |
| 6 | 566.4928 | 0.6000 | 1.75500 | 52.32 | 0.54757 | |
| 7 | 26.8701 | 3.1832 | | | | |
| 8 | −35.5930 | 1.0839 | 1.80400 | 46.53 | 0.55775 | |
| 9 | 34.7881 | 2.6865 | 1.92119 | 23.96 | 0.62025 | |
| 10 | −548.8014 | DD[10] | | | | |
| 11 (St) | ∞ | 0.0478 | | | | |
| *12 | 83.5272 | 3.4261 | 1.49710 | 81.56 | 0.53848 | |
| *13 | −36.0487 | DD[13] | | | | |
| 14 | −16.1745 | 1.0374 | 1.53775 | 74.70 | 0.53936 | |
| 15 | 152.3641 | 2.2255 | 1.95906 | 17.47 | 0.65993 | |
| 16 | −78.4138 | DD[16] | | | | |
| 17 | 76.2422 | 0.9769 | 1.95906 | 17.47 | 0.65993 | |
| 18 | 34.5132 | 5.9740 | 1.55200 | 70.70 | 0.54219 | |
| 19 | −32.6285 | 1.8388 | | | | |
| 20 | −20.1934 | 0.6643 | 1.96300 | 24.11 | 0.62126 | |
| 21 | −28.7922 | 0.9998 | | | | |
| 22 | 72.2790 | 6.2882 | 1.48749 | 70.24 | 0.53007 | |
| 23 | −28.6034 | 0.9998 | | | | |
| *24 | 40.3973 | 4.4561 | 1.49710 | 81.56 | 0.53848 | |
| *25 | −134.4035 | DD[25] | | | | |
| *26 | 35.3119 | 1.0562 | 1.61881 | 63.85 | 0.54182 | |
| *27 | 17.5308 | DD[27] | | | | |
| *28 | −170.4220 | 4.5863 | 1.58313 | 59.38 | 0.54237 | |
| *29 | −25.9011 | 1.0001 | | | | |
| 30 | −17.2334 | 1.1412 | 1.48749 | 70.24 | 0.53007 | |
| 31 | −52.7414 | DD[31] | | | | |

TABLE 38
Example 13

| | Wide | Middle | Tele |
|---|---|---|---|
| Zr | 1.0 | 2.3 | 4.6 |
| f | 29.36 | 67.54 | 133.60 |
| Bf | 17.18 | 32.12 | 38.51 |
| FNo. | 2.91 | 2.91 | 2.91 |
| 2ω[°] | 56.6 | 23.6 | 12.0 |
| DD[5] | 1.19 | 35.25 | 56.05 |
| DD[10] | 13.13 | 5.50 | 0.97 |
| DD[13] | 4.14 | 4.31 | 5.77 |
| DD[16] | 6.33 | 3.74 | 0.85 |
| DD[25] | 8.82 | 6.08 | 1.62 |
| DD[27] | 14.34 | 12.19 | 16.22 |
| DD[31] | 17.18 | 32.12 | 38.51 |

TABLE 39
Example 13

| Sn | 12 |
|---|---|
| KA | 0.0000000E+00 |
| A3 | 0.0000000E+00 |
| A4 | −1.4868534E−05 |
| A5 | 1.5378107E−06 |
| A6 | −1.6270224E−08 |
| A7 | −2.4989778E−08 |
| A8 | −7.6657570E−09 |
| A9 | 1.2062201E−09 |
| A10 | 7.0582853E−11 |
| A11 | −1.2612736E−11 |
| A12 | −1.1806454E−13 |
| A13 | 1.2360206E−15 |
| A14 | 8.0023796E−17 |
| A15 | 7.6197944E−16 |
| A16 | −2.2440695E−17 |
| A17 | −5.9466099E−18 |
| A18 | 7.9079387E−20 |
| A19 | 4.4185946E−20 |
| A20 | −2.0965218E−21 |

| Sn | 13 | 24 | 25 | 26 |
|---|---|---|---|---|
| KA | 1.0000000E+00 | 1.0000000E+00 | 1.0000000E+00 | 1.0000000E+00 |
| A4 | −2.0592897E−05 | −5.3228578E−06 | 6.7114504E−06 | −1.7346348E−05 |
| A6 | −9.3354978E−08 | −3.4492212E−09 | −1.6058889E−08 | 9.0699772E−08 |
| A8 | −1.5487163E−09 | −2.3158171E−10 | 2.5675586E−11 | −1.9057930E−10 |
| A10 | 2.7737017E−11 | 2.1125286E−12 | 2.8405095E−13 | −4.3673360E−12 |
| A12 | −2.0255493E−13 | −1.1004447E−14 | −6.6972267E−15 | 2.4165180E−14 |

| Sn | 27 | 28 | 29 |
|---|---|---|---|
| KA | 1.0000000E+00 | 1.0000000E+00 | 1.0000000E+00 |
| A4 | −2.2480936E−05 | −1.1390405E−05 | −2.9842643E−05 |
| A6 | 7.4887375E−08 | −4.9935111E−08 | −7.9230767E−08 |
| A8 | −1.8954224E−10 | 3.5902654E−10 | 6.6709210E−11 |
| A10 | −8.0300096E−12 | −3.5487477E−13 | 1.2023258E−12 |
| A12 | 4.4847230E−14 | −1.6235019E−14 | −2.0432561E−14 |

### Example 14

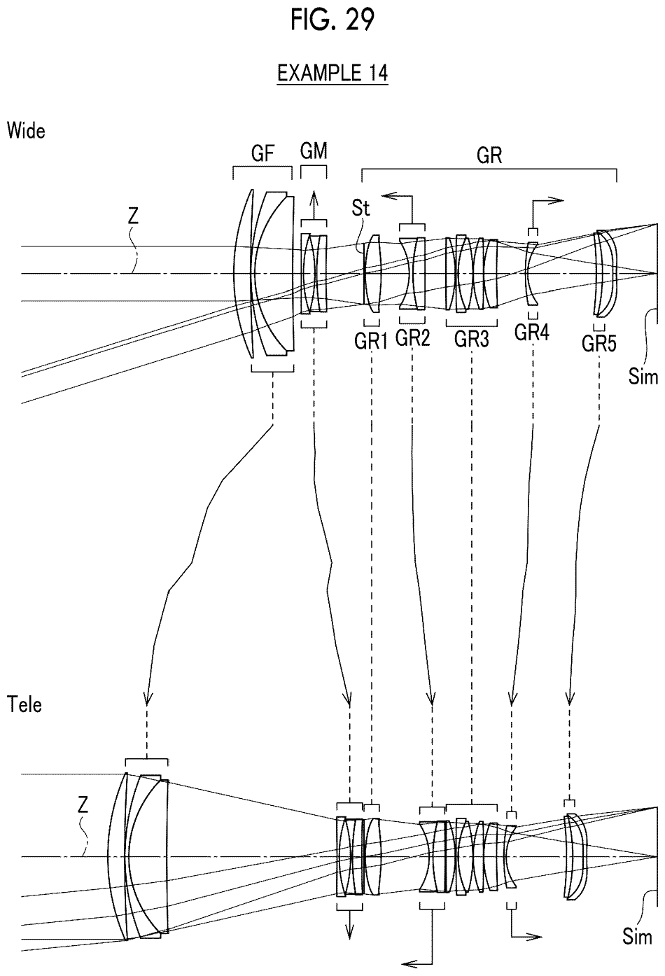

A configuration and a moving path of a variable magnification optical system of Example 14 are illustrated in FIG. 29. The variable magnification optical system of Example 14 consists of the front group GF, the middle group GM, and the rear group GR in this order from the object side to the image side. The front group GF consists of one lens group having a positive refractive power. The middle group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power in this order from the object side to the image side.

During changing the magnification from the wide angle end to the telephoto end, the first subsequent lens group GR1 and the third subsequent lens group GR3 are fixed with respect to the image plane Sim, and other lens groups move by changing the spacings with their adjacent lens groups. The variable magnification optical system includes two focusing groups. The focusing group on the object side consists of the second subsequent lens group GR2, and the focusing group on the image side consists of the fourth subsequent lens group GR4. During the focusing from the infinite distance object to the nearest object, the second subsequent lens group GR2 moves to the object side, the fourth subsequent lens group GR4 moves to the image side, and other lens groups are fixed with respect to the image plane Sim. The vibration-proof group consists of the middle group GM.

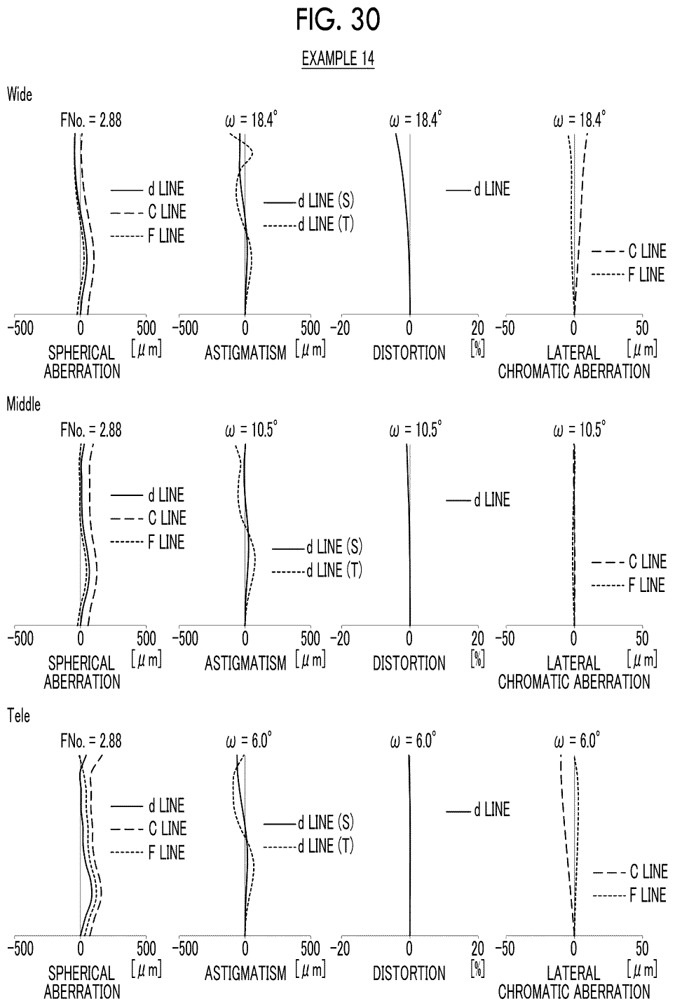

For the variable magnification optical system of Example 14, basic lens data is shown in Table 40, specifications and variable surface spacings are shown in Table 41, aspherical coefficients are shown in Table 42, and each aberration diagram is illustrated in FIG. 30.

TABLE 40
Example 14

| Sn | R | D | Nd | νd | θgF | ρ |
|---|---|---|---|---|---|---|
| 1 | 62.5508 | 4.5393 | 1.48749 | 70.24 | 0.53007 | 2.46 |
| 2 | 391.7698 | 0.0805 | | | | |
| 3 | 66.1629 | 1.0505 | 1.61340 | 44.27 | 0.56340 | 2.93 |
| 4 | 32.4954 | 10.2066 | 1.43700 | 95.10 | 0.53364 | 3.53 |
| 5 | 752.4278 | DD[5] | | | | |
| *6 | −289.0110 | 0.6033 | 1.76450 | 49.10 | 0.55289 | |
| *7 | 42.0001 | 3.0664 | | | | |
| 8 | −41.1513 | 0.5098 | 1.62280 | 57.05 | 0.54640 | |
| 9 | 67.5048 | 2.4998 | 1.95906 | 17.47 | 0.65993 | |
| 10 | 329.0009 | DD[10] | | | | |
| 11 (St) | ∞ | 0.3662 | | | | |
| *12 | 37.3980 | 4.2624 | 1.49710 | 81.56 | 0.53848 | |
| *13 | −55.7662 | DD[13] | | | | |
| 14 | −18.2795 | 1.0102 | 1.49700 | 81.54 | 0.53748 | |
| 15 | 42.1509 | 3.2502 | 1.85150 | 40.78 | 0.56958 | |
| 16 | −841.1824 | DD[16] | | | | |
| 17 | 1043.7510 | 2.4998 | 1.48749 | 70.24 | 0.53007 | |
| 18 | −32.8361 | 0.1748 | | | | |
| 19 | 331.1319 | 0.6248 | 1.95375 | 32.32 | 0.59056 | |
| 20 | 25.8165 | 3.9432 | 1.49700 | 81.61 | 0.53887 | |
| 21 | −42.0119 | 0.1000 | | | | |
| 22 | 30.7486 | 2.7978 | 1.48749 | 70.24 | 0.53007 | |
| 23 | −287.9050 | 0.0445 | | | | |
| 24 | 28.3848 | 3.4795 | 1.52841 | 76.45 | 0.53954 | |
| 25 | 246.6570 | DD[25] | | | | |
| *26 | 57.4136 | 0.6297 | 1.58913 | 61.15 | 0.53824 | |
| *27 | 15.0857 | DD[27] | | | | |
| 28 | −98.1949 | 1.6642 | 1.95906 | 17.47 | 0.65993 | |
| 29 | −53.1338 | 2.7836 | | | | |
| *30 | 209.9203 | 0.9735 | 1.61881 | 63.85 | 0.54182 | |
| *31 | 41.2080 | DD[31] | | | | |

TABLE 41
Example 14

| | Wide | Middle | Tele |
|---|---|---|---|
| Zr | 1.0 | 1.7 | 3.1 |
| f | 44.52 | 77.16 | 136.23 |
| Bf | 10.99 | 17.26 | 19.01 |
| FNo. | 2.88 | 2.88 | 2.88 |
| 2ω[°] | 36.8 | 21.0 | 12.0 |
| DD[5] | 2.31 | 28.91 | 45.70 |
| DD[10] | 10.20 | 5.39 | 0.59 |
| DD[13] | 7.57 | 8.41 | 12.96 |
| DD[16] | 5.63 | 4.79 | 0.25 |
| DD[25] | 7.57 | 6.01 | 1.77 |
| DD[27] | 18.48 | 13.78 | 16.27 |
| DD[31] | 10.99 | 17.26 | 19.01 |

TABLE 42
Example 14

| Sn | 6 | 7 | 26 | 27 |
|---|---|---|---|---|
| KA | 1.0000000E+00 | 1.0000000E+00 | 1.0000000E+00 | 1.0000000E+00 |
| A4 | 2.1010980E−05 | 2.0365034E−05 | 2.5486234E−05 | 2.3032737E−05 |
| A6 | −2.1824535E−07 | −3.1359622E−07 | 1.5205023E−07 | 1.2407713E−07 |
| A8 | 3.9670978E−09 | 8.6467178E−09 | −1.6424320E−08 | −1.5897006E−08 |
| A10 | −4.6370071E−11 | −1.4303806E−10 | 3.0996806E−10 | 2.9876676E−10 |
| A12 | 1.2472451E−13 | 1.0813385E−12 | −1.7583477E−12 | −1.4718029E−12 |
| A14 | 2.1934902E−15 | −6.9777393E−16 | −4.9333109E−15 | −1.1538990E−14 |
| A16 | −1.5186148E−17 | −3.7265751E−17 | −5.8895075E−17 | 1.7010441E−16 |
| A18 | −1.3810106E−20 | 1.7027002E−19 | 2.1159559E−18 | −2.1271975E−18 |
| A20 | 2.2430800E−22 | −1.2806315E−22 | −9.8089938E−21 | 1.6539767E−20 |

| Sn | 12 | 13 | 30 | 31 |
|---|---|---|---|---|
| KA | 0.0000000E+00 | 0.0000000E+00 | −1.5302500E+00 | 0.0000000E+00 |
| A3 | 0.0000000E+00 | 0.0000000E+00 | 0.0000000E+00 | 0.0000000E+00 |
| A4 | −8.3760244E−07 | 4.9170705E−06 | −6.0834676E−04 | −6.4494308E−04 |
| A5 | 1.8920491E−06 | 9.9493033E−07 | 5.0044317E−05 | 5.4110568E−05 |
| A6 | 2.7248528E−07 | 3.3010242E−08 | −2.2344594E−07 | 1.4666478E−07 |
| A7 | −1.0043292E−07 | −2.0252576E−10 | −1.5164509E−07 | −2.2559384E−07 |
| A8 | 9.0733896E−09 | −3.0437952E−09 | 7.8892754E−09 | 4.1454695E−09 |
| A9 | 3.1605671E−10 | 8.2278101E−10 | −3.8935769E−10 | 2.8393718E−10 |
| A10 | −1.7116266E−11 | −7.6410609E−11 | −2.0677785E−11 | 1.2556398E−12 |
| A11 | −1.0750874E−11 | 2.7568471E−12 | −6.4821042E−13 | 3.0849353E−13 |
| A12 | 8.1906117E−13 | 6.3225123E−13 | 3.8629669E−13 | −5.3264361E−14 |
| A13 | 6.3111431E−14 | −8.7422177E−14 | −3.3007955E−14 | 1.6624157E−15 |
| A14 | −6.1184530E−15 | −2.6415825E−15 | 7.0558952E−15 | −9.5747039E−16 |
| A15 | −5.8701344E−16 | 7.3737491E−16 | −5.0414203E−16 | 1.2870944E−16 |
| A16 | 4.7469469E−17 | −2.9157781E−17 | 1.9424853E−17 | 3.0764469E−18 |
| A17 | 3.7998425E−18 | 3.8861938E−18 | −9.3963629E−19 | −4.7990253E−19 |
| A18 | 1.7291422E−19 | 3.8024530E−19 | 2.0206781E−20 | −6.9319332E−20 |
| A19 | −8.1377344E−20 | −1.2734478E−19 | −3.0333849E−20 | 6.4353282E−22 |
| A20 | 3.7409388E−21 | 6.3495850E−21 | 2.2097747E−21 | 2.8517480E−22 |

### Example 15

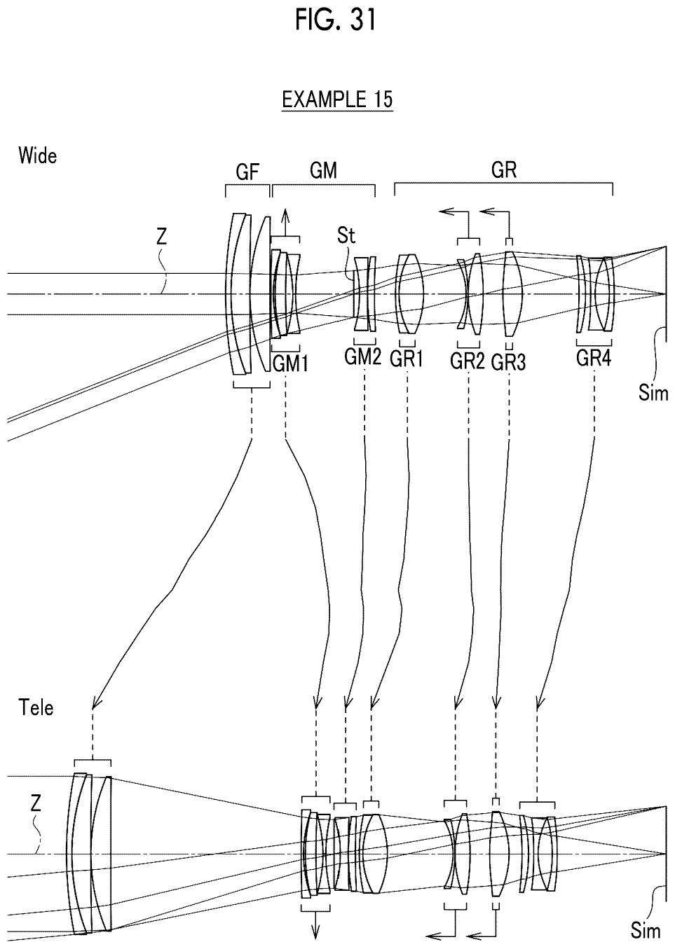

A configuration and a moving path of a variable magnification optical system of Example 15 are illustrated in FIG. 31. The variable magnification optical system of Example 15 consists of the front group GF, the middle group GM, and the rear group GR in this order from the object side to the image side. The front group GF consists of one lens group having a positive refractive power. The middle group GM consists of the first middle lens group GM1 having a negative refractive power and the second middle lens group GM2 having a negative refractive power in this order from the object side to the image side. The rear group GR consists of the first subsequent lens group GR1 having a positive refractive power, the second subsequent lens group GR2 having a negative refractive power, the third subsequent lens group GR3 having a positive refractive power, and the fourth subsequent lens group GR4 having a negative refractive power in this order from the object side to the image side.

During changing the magnification from the wide angle end to the telephoto end, all lens groups move by changing the spacings with their adjacent lens groups. The variable magnification optical system includes two focusing groups. The focusing group on the object side consists of the second subsequent lens group GR2, and the focusing group on the image side consists of the third subsequent lens group GR3. During the focusing from the infinite distance object to the nearest object, the second subsequent lens group GR2 and the third subsequent lens group GR3 move to the object side by changing the spacings with each other, and other lens groups are fixed with respect to the image plane Sim. The vibration-proof group consists of the first middle lens group GM1.

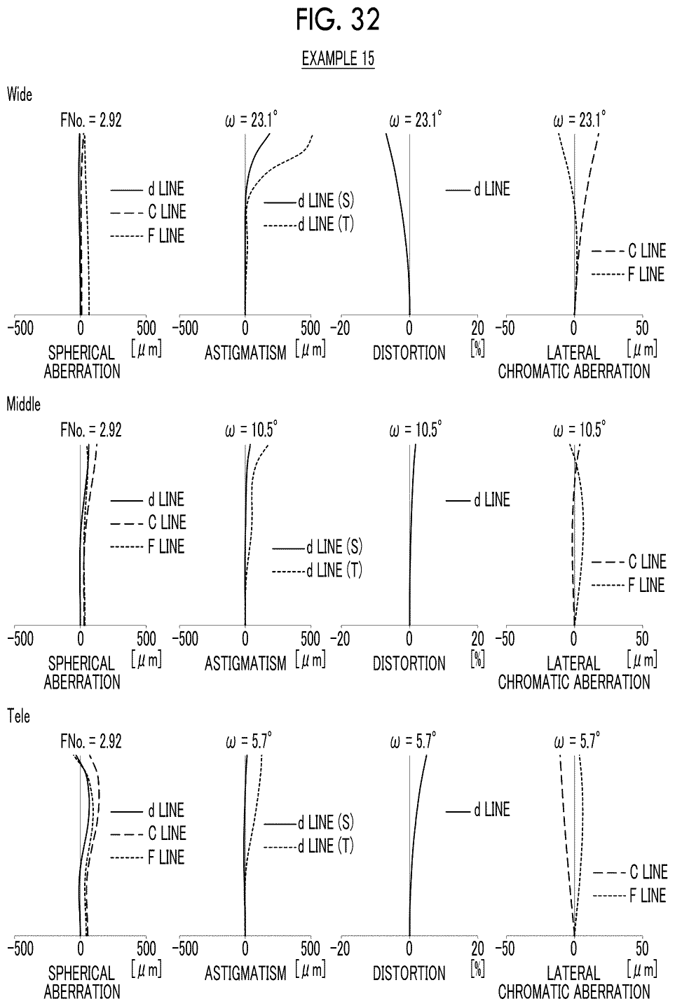

For the variable magnification optical system of Example 15, basic lens data is shown in Table 43, specifications and variable surface spacings are shown in Table 44, aspherical coefficients are shown in Table 45, and each aberration diagram is illustrated in FIG. 32.

TABLE 43
Example 15

| Sn | R | D | Nd | νd | θgF | ρ |
|---|---|---|---|---|---|---|
| 1 | 131.7942 | 1.5000 | 1.80518 | 25.42 | 0.61616 | 3.37 |
| 2 | 69.8925 | 5.2702 | 1.48749 | 70.32 | 0.52917 | 2.45 |
| 3 | 840.3981 | 0.0495 | | | | |
| 4 | 62.9650 | 5.5586 | 1.51680 | 64.20 | 0.53430 | 2.52 |
| 5 | 2983.2864 | DD[5] | | | | |
| 6 | 407.6438 | 0.6829 | 1.71736 | 29.52 | 0.60483 | |
| 7 | 40.0623 | 0.4933 | | | | |
| 8 | 52.4241 | 2.9547 | 1.95906 | 17.47 | 0.65993 | |
| 9 | 220.7333 | 1.9875 | | | | |
| *10 | −37.3981 | 0.8000 | 1.49710 | 81.56 | 0.53848 | |
| *11 | 59.0616 | DD[11] | | | | |
| 12 (St) | ∞ | 1.5751 | | | | |
| *13 | −51.5664 | 2.2209 | 1.80610 | 40.73 | 0.56940 | |
| *14 | 148.7836 | 0.0477 | | | | |
| 15 | 70.8063 | 1.9557 | 1.95906 | 17.47 | 0.65993 | |
| 16 | 214.3479 | DD[16] | | | | |
| 17 | 58.6756 | 1.0100 | 1.57099 | 50.80 | 0.55887 | |
| 18 | 25.7474 | 6.8451 | 1.49700 | 81.54 | 0.53748 | |
| 19 | −29.8045 | DD[19] | | | | |
| 20 | −21.6794 | 0.5219 | 1.85478 | 24.80 | 0.61232 | |
| 21 | −44.8419 | 0.0470 | | | | |
| 22 | 35.5769 | 4.2117 | 1.43875 | 94.66 | 0.53402 | |
| 23 | −71.8467 | DD[23] | | | | |
| *24 | 64.5425 | 5.4421 | 1.51633 | 64.06 | 0.53345 | |
| *25 | −28.3781 | DD[25] | | | | |
| 26 | −100.3150 | 1.8306 | 2.00069 | 25.43 | 0.61417 | |
| 27 | −47.0483 | 1.4316 | | | | |
| *28 | −176.4185 | 1.2501 | 1.58313 | 59.38 | 0.54237 | |
| *29 | 23.4774 | 3.9564 | | | | |
| *30 | −45.3341 | 1.3748 | 1.58913 | 61.15 | 0.53824 | |
| *31 | −112.5444 | DD[31] | | | | |

TABLE 44
Example 15

| | Wide | Middle | Tele |
|---|---|---|---|
| Zr | 1.0 | 2.1 | 3.8 |
| f | 35.85 | 75.28 | 135.15 |
| Bf | 14.58 | 21.52 | 30.53 |
| FNo. | 2.92 | 2.92 | 2.92 |
| 2ω[°] | 46.2 | 21.0 | 11.4 |
| DD[5] | 0.30 | 34.50 | 53.29 |
| DD[11] | 16.11 | 3.30 | 2.30 |
| DD[16] | 5.87 | 4.30 | 1.10 |
| DD[19] | 11.91 | 15.21 | 18.37 |
| DD[23] | 5.51 | 2.34 | 5.46 |
| DD[25] | 15.87 | 11.30 | 3.62 |
| DD[31] | 14.58 | 21.52 | 30.53 |

TABLE 45
Example 15

| Sn | 10 | 11 | 13 | 14 |
|---|---|---|---|---|
| KA | 1.0000000E+00 | 1.00000000+00 | 1.0000000E+00 | 1.0000000E+00 |
| A4 | 4.6363031E−05 | 3.8187923E−05 | −4.4185013E−05 | −3.5130922E−05 |
| A6 | −7.2426129E−07 | −7.1333242E−07 | 2.1890332E−07 | 2.6307592E−07 |
| A8 | 8.7603321E−09 | 9.3562852E−09 | 5.5443949E−10 | −6.8769494E−10 |
| A10 | −6.5699576E−11 | −9.1931099E−11 | −2.0172068E−11 | −1.3232448E−13 |
| A12 | 2.4814312E−13 | 6.4453508E−13 | 1.5610467E−13 | −2.7116432E−14 |
| A14 | −1.8062925E−16 | −2.8190461E−15 | −4.0853005E−16 | 3.8450106E−16 |
| A16 | −9.2720979E−19 | 5.6694109E−18 | −2.2585894E−19 | −1.3224119E−18 |

| Sn | 24 | 25 | 28 | 29 |
|---|---|---|---|---|
| KA | 1.0000000E+00 | 1.0000000E+00 | 1.0000000E+00 | 1.0000000E+00 |
| A4 | −1.6405555E−05 | 8.6357854E−06 | −2.1295440E−05 | −5.4210233E−06 |
| A6 | 1.7492705E−08 | 1.3457499E−08 | 8.6590697E−09 | 8.9742628E−09 |
| A8 | −4.7495680E−10 | −4.2082182E−10 | −1.3186159E−10 | −4.2210463E−10 |
| A10 | 3.7703145E−12 | 3.2997531E−12 | 1.6106738E−12 | −6.4485595E−14 |
| A12 | −1.4974919E−14 | −8.7629927E−15 | −9.8855418E−15 | 5.1415993E−14 |
| A14 | 2.7111451E−18 | −3.3536337E−17 | −6.7485555E−17 | −5.9796080E−16 |
| A16 | 1.5164340E−19 | 2.1734757E−19 | 1.5748930E−19 | 5.4160734E−19 |

| Sn | 30 | 31 |
|---|---|---|
| KA | 1.0000000E+00 | 1.0000000E+00 |
| A4 | −1.4195963E−05 | −2.0346967E−05 |
| A6 | −2.0103098E−08 | 5.6534017E−09 |
| A8 | 4.5732269E−10 | 1.5937426E−10 |
| A10 | −7.6550115E−12 | −1.1127867E−12 |
| A12 | 1.0280928E−13 | 4.1725612E−14 |
| A14 | −1.6394885E−16 | −1.9652310E−16 |
| A16 | −3.4044592E−19 | 1.2594197E−18 |

### Example 16

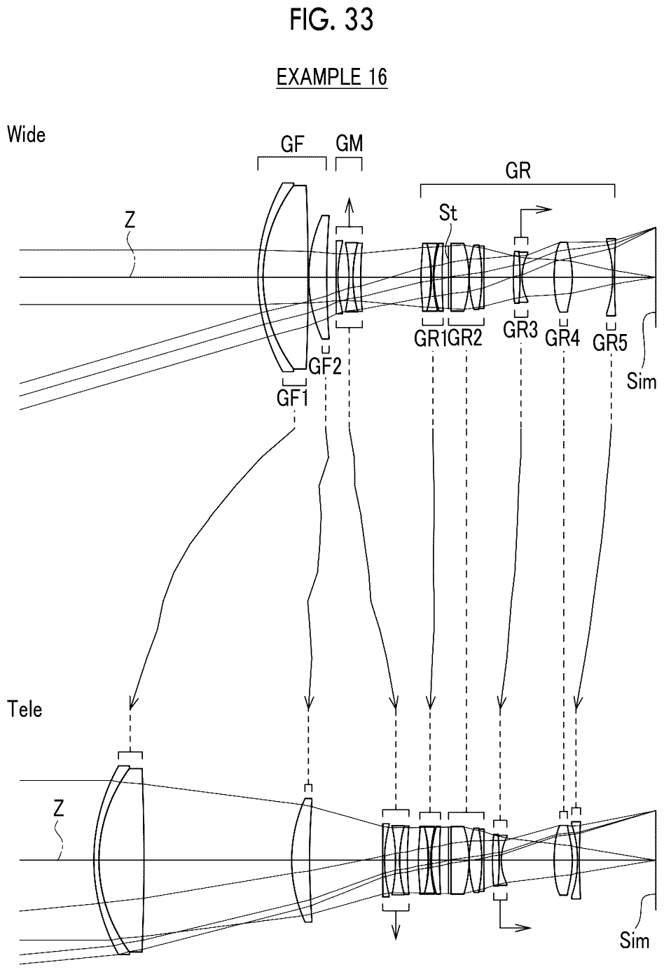

A configuration and a moving path of a variable magnification optical system of Example 16 are illustrated in FIG. 33. The variable magnification optical system of Example 16 consists of the front group GF, the middle group GM, and the rear group GR in this order from the object side to the image side. The front group GF consists of the first front side lens group GF1 having a positive refractive power and the second front side lens group GF2 having a positive refractive power in this order from the object side to the image side. The middle group GM consists of one lens group having a negative refractive power. The rear group GR consists of the first subsequent lens group GR1 having a positive refractive power, the second subsequent lens group GR2 having a positive refractive power, the third subsequent lens group GR3 having a negative refractive power, the fourth subsequent lens group GR4 having a positive refractive power, and the fifth subsequent lens group GR5 having a negative refractive power in this order from the object side to the image side.

During changing the magnification from the wide angle end to the telephoto end, the second subsequent lens group GR2 and the fourth subsequent lens group GR4 are fixed with respect to the image plane Sim, and other lens groups move by changing the spacings with their adjacent lens groups. The variable magnification optical system includes only one focusing group. The focusing group consists of the third subsequent lens group GR3. During the focusing from the infinite distance object to the nearest object, the third subsequent lens group GR3 moves to the image side, and other lens groups are fixed with respect to the image plane Sim. The vibration-proof group consists of the middle group GM.

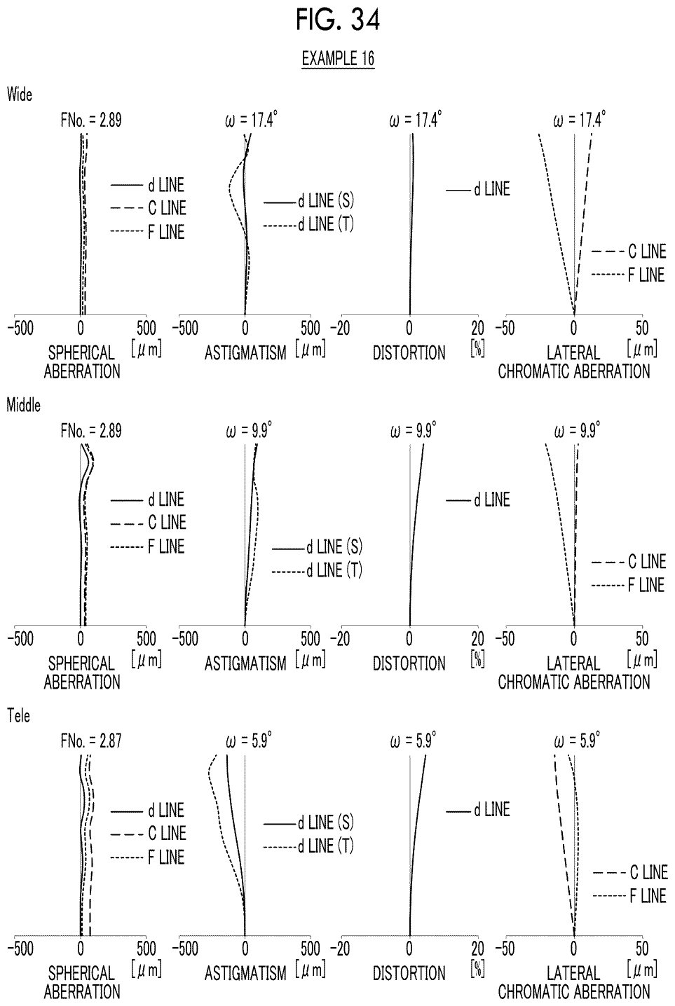

For the variable magnification optical system of Example 16, basic lens data is shown in Table 46, specifications and variable surface spacings are shown in Table 47, aspherical coefficients are shown in Table 48, and each aberration diagram is illustrated in FIG. 34.

TABLE 46
Example 16

| Sn | R | D | Nd | νd | θgF | ρ |
|---|---|---|---|---|---|---|
| 1 | 58.2421 | 1.3589 | 1.95375 | 32.32 | 0.59015 | 5.10 |
| 2 | 46.0991 | 12.1059 | 1.43700 | 95.10 | 0.53364 | 3.53 |
| 3 | −670.4470 | DD[3] | | | | |
| 4 | 45.4115 | 4.8177 | 1.51680 | 64.20 | 0.53430 | 2.52 |
| 5 | 238.0286 | DD[5] | | | | |
| *6 | 544.7036 | 0.5000 | 1.85400 | 40.38 | 0.56890 | |
| *7 | 38.9226 | 2.9654 | | | | |
| 8 | −51.4207 | 1.1069 | 1.62041 | 60.29 | 0.54266 | |
| 9 | 38.9561 | 2.0569 | 1.95906 | 17.47 | 0.65993 | |
| 10 | 109.5603 | DD[10] | | | | |
| *11 | 60.5786 | 2.6168 | 1.74320 | 49.29 | 0.55303 | |
| *12 | −54.2287 | 0.2100 | | | | |
| 13 | −38.5592 | 0.4999 | 1.80518 | 25.46 | 0.61572 | |
| 14 | 42.9798 | 0.1826 | | | | |
| 15 | 35.7332 | 2.1768 | 1.79952 | 42.22 | 0.56727 | |
| 16 | 179.1535 | DD[16] | | | | |
| 17 (St) | ∞ | 0.6647 | | | | |
| 18 | 26235.4794 | 4.8222 | 1.88300 | 39.22 | 0.57288 | |
| 19 | −34.2432 | 0.0582 | | | | |
| 20 | 34.0085 | 3.3906 | 1.59282 | 68.62 | 0.54414 | |
| 21 | −51.2023 | 0.5720 | 1.85478 | 24.80 | 0.61232 | |
| 22 | 1148.5202 | DD[22] | | | | |
| 23 | 80.5510 | 1.8113 | 1.89286 | 20.36 | 0.63944 | |
| 24 | −88.4076 | 0.5710 | 1.77535 | 50.31 | 0.55042 | |
| *25 | 16.1279 | DD[25] | | | | |
| *26 | 49.9889 | 4.8808 | 1.59201 | 67.02 | 0.53589 | |
| *27 | −28.7995 | DD[27] | | | | |
| *28 | −34.8500 | 0.5000 | 1.80625 | 40.91 | 0.56920 | |
| 29 | 198.4421 | DD[29] | | | | |

TABLE 47
Example 16

| | Wide | Middle | Tele |
|---|---|---|---|
| Zr | 1.0 | 1.7 | 2.9 |
| f | 45.07 | 78.11 | 131.82 |
| Bf | 11.11 | 14.87 | 20.53 |
| FNo. | 2.89 | 2.89 | 2.87 |
| 2ω[°] | 34.8 | 19.8 | 11.8 |
| DD[3] | 0.19 | 30.47 | 39.74 |
| DD[5] | 2.36 | 9.77 | 19.49 |
| DD[10] | 16.21 | 11.08 | 2.97 |
| DD[16] | 1.73 | 1.59 | 2.47 |
| DD[22] | 7.90 | 6.21 | 2.29 |
| DD[25] | 8.61 | 10.29 | 14.21 |
| DD[27] | 10.83 | 7.07 | 1.41 |
| DD[29] | 11.11 | 14.87 | 20.53 |

TABLE 48
Example 16

| Sn | 6 | 7 | 11 | 12 |
|---|---|---|---|---|
| KA | 1.0000000E+00 | 1.0000000E+00 | 1.0000000E+00 | 1.0000000E+00 |
| A4 | −7.7105810E−06 | −1.0080696E−05 | −2.6737398E−05 | −1.3177043E−05 |
| A6 | 7.1182377E−08 | 1.0110463E−07 | −1.9503372E−08 | −3.6461471E−09 |
| A8 | 1.1046704E−09 | −1.5653472E−10 | 1.0764886E−09 | 4.2575252E−10 |
| A10 | −3.9704959E−11 | −1.7423498E−11 | −4.4330148E−11 | −8.8761172E−12 |
| A12 | 1.4160432E−13 | 2.0636031E−13 | 4.5405701E−13 | −2.6295513E−13 |
| A14 | 3.7935480E−15 | −2.4705718E−15 | −1.0825245E−15 | 5.9045110E−15 |
| A16 | −1.7823483E−17 | 4.0335066E−17 | −3.3860551E−17 | −5.3550423E−17 |
| A18 | −2.5840683E−19 | −3.5782117E−19 | 3.7193362E−19 | 1.8586891E−19 |
| A20 | 1.5564831E−21 | 1.0010285E−21 | −2.4725591E−21 | −1.0682891E−21 |

| Sn | 25 | 26 | 27 | 28 |
|---|---|---|---|---|
| KA | 1.0000000E+00 | 1.0000000E+00 | 1.0000000E+00 | 1.0000000E+00 |
| A4 | 5.4160400E−06 | 2.8752525E−05 | 2.6492695E−05 | 2.0191383E−06 |
| A6 | 2.1037012E−07 | 4.0230048E−07 | −9.7495814E−08 | −1.9813107E−07 |
| A8 | −9.0175276E−09 | −8.2416896E−09 | 5.8990723E−09 | 1.8934932E−09 |
| A10 | −3.8266089E−10 | 1.0780792E−10 | −1.0486722E−10 | 7.6387375E−12 |
| A12 | 3.3311097E−11 | −2.7402774E−13 | 9.6155605E−13 | −1.9776236E−13 |
| A14 | −8.4080650E−13 | −5.2925220E−15 | 1.4912055E−15 | −4.3549424E−16 |
| A16 | 1.8795194E−15 | 4.5665704E−17 | −4.9979189E−17 | 1.0590233E−17 |
| A18 | 2.6203295E−16 | −5.4618654E−20 | −1.6864773E−19 | 9.7772989E−20 |
| A20 | −3.1362413E−18 | 1.7089185E−22 | 3.3426693E−21 | −9.3819791E−22 |

### Example 17

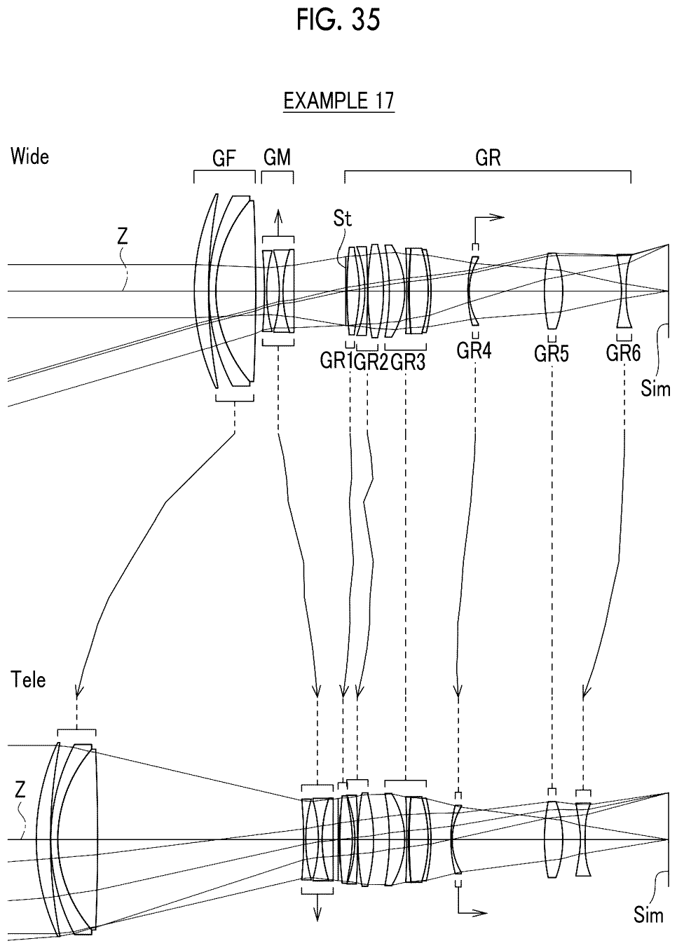

A configuration and a moving path of a variable magnification optical system of Example 17 are illustrated in FIG. 35. The variable magnification optical system of Example 17 consists of the front group GF, the middle group GM, and the rear group GR in this order from the object side to the image side. The front group GF consists of one lens group having a positive refractive power. The middle group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, the fifth subsequent lens group GR5 having a positive refractive power, and the sixth subsequent lens group GR6 having a negative refractive power in this order from the object side to the image side.

During changing the magnification from the wide angle end to the telephoto end, the third subsequent lens group GR3 and the fifth subsequent lens group GR5 are fixed with respect to the image plane Sim, and other lens groups move by changing the spacings with their adjacent lens groups. The variable magnification optical system includes only one focusing group. The focusing group consists of the fourth subsequent lens group GR4. During the focusing from the infinite distance object to the nearest object, the fourth subsequent lens group GR4 moves to the image side, and other lens groups are fixed with respect to the image plane Sim. The vibration-proof group consists of the middle group GM.

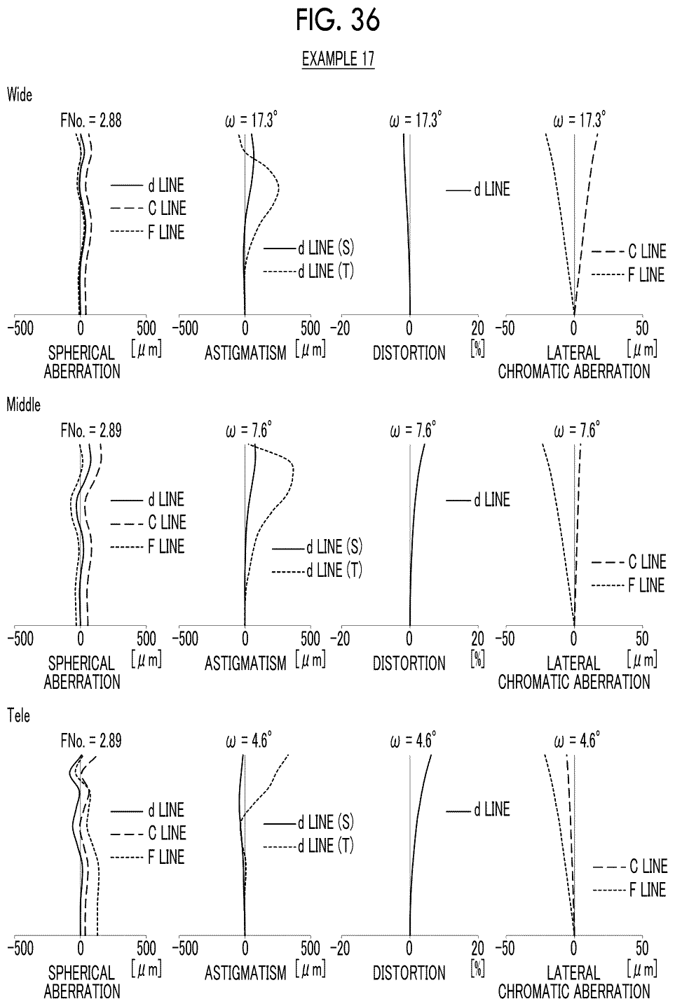

For the variable magnification optical system of Example 17, basic lens data is shown in Table 49, specifications and variable surface spacings are shown in Table 50, aspherical coefficients are shown in Table 51, and each aberration diagram is illustrated in FIG. 36.

TABLE 49
Example 17

| Sn | R | D | Nd | νd | θgF | ρ |
|---|---|---|---|---|---|---|
| 1 | 73.8202 | 4.0449 | 1.48749 | 70.24 | 0.53007 | 2.46 |
| 2 | 161.0715 | 0.1000 | | | | |
| 3 | 65.0133 | 2.0000 | 1.80100 | 34.97 | 0.58642 | 3.55 |
| 4 | 43.8333 | 11.3984 | 1.43700 | 95.10 | 0.53364 | 3.53 |
| 5 | −664.3426 | DD[5] | | | | |
| *6 | −169.3314 | 0.6230 | 1.80625 | 40.91 | 0.56920 | |
| *7 | 46.5902 | 3.6097 | | | | |
| 8 | −46.7768 | 1.0834 | 1.75500 | 52.32 | 0.54757 | |
| 9 | 41.9068 | 3.1222 | 1.95906 | 17.47 | 0.65993 | |
| 10 | 4919.1482 | DD[10] | | | | |
| 11 (St) | ∞ | 0.3236 | | | | |
| *12 | 123.4465 | 3.5216 | 1.69304 | 52.93 | 0.54673 | |
| *13 | −45.0546 | DD[13] | | | | |
| 14 | −40.7804 | 0.7637 | 1.96300 | 24.11 | 0.62126 | |
| 15 | −297.6944 | 0.1029 | | | | |
| 16 | 85.1359 | 4.4786 | 1.59522 | 67.73 | 0.54426 | |
| 17 | −58.4549 | DD[17] | | | | |
| 18 | −78.1913 | 4.3971 | 1.59522 | 67.73 | 0.54426 | |
| 19 | −28.1791 | 0.6006 | | | | |
| 20 | −292.7246 | 0.4998 | 1.75500 | 52.32 | 0.54757 | |
| 21 | 125.1551 | 0.2175 | | | | |
| 22 | 171.5028 | 5.4030 | 1.55032 | 75.50 | 0.54001 | |
| 23 | −45.3846 | 0.8000 | 1.91082 | 35.25 | 0.58224 | |
| 24 | −59.6936 | DD[24] | | | | |
| *25 | 53.7390 | 0.3569 | 1.43700 | 95.10 | 0.53364 | |
| *26 | 22.2719 | DD[26] | | | | |
| 27 | 63.4191 | 5.2284 | 1.48749 | 70.24 | 0.53007 | |
| 28 | −35.4053 | DD[28] | | | | |
| *29 | −25.1524 | 1.3182 | 1.51633 | 64.06 | 0.53345 | |
| *30 | 220.1715 | DD[30] | | | | |

TABLE 50
Example 17

| | Wide | Middle | Tele |
|---|---|---|---|
| Zr | 1.0 | 2.2 | 3.6 |
| f | 46.53 | 102.36 | 165.17 |
| Bf | 12.13 | 16.00 | 23.89 |
| FNo. | 2.88 | 2.89 | 2.89 |
| 2ω[°] | 34.6 | 15.2 | 9.2 |
| DD[5] | 2.50 | 46.00 | 58.91 |
| DD[10] | 14.69 | 7.09 | 1.48 |
| DD[13] | 1.58 | 2.46 | 0.76 |
| DD[17] | 1.68 | 0.91 | 4.51 |
| DD[24] | 10.58 | 6.42 | 5.70 |
| DD[26] | 21.51 | 25.63 | 26.39 |
| DD[28] | 16.81 | 12.98 | 5.07 |
| DD[30] | 12.13 | 16.00 | 23.89 |

TABLE 51
Example 17

| Sn | 6 | 7 |
|---|---|---|
| KA | 1.0000000E+00 | 1.0000000E+00 |
| A4 | −2.9418948E−05 | −2.9309869E−05 |
| A6 | 5.3550887E−07 | 4.8588739E−07 |
| A8 | −4.8147474E−09 | −2.9850094E−09 |
| A10 | 1.5970801E−11 | −1.5120065E−11 |
| A12 | 8.6485042E−14 | 3.7402476E−13 |
| A14 | −8.9085100E−16 | −2.2599041E−15 |
| A16 | 2.0910729E−18 | 4.7036931E−18 |

| Sn | 12 | 13 | 25 | 26 |
|---|---|---|---|---|
| KA | 1.0000000E+00 | 1.0000000E+00 | 1.0000000E+00 | 1.0000000E+00 |
| A4 | −4.8214562E−06 | 1.0767531E−05 | 7.5786397E−05 | 7.4302514E−05 |
| A6 | −1.3976123E−08 | 1.0024874E−08 | −1.0413654E−06 | −7.4525673E−07 |
| A8 | 1.3445569E−09 | 5.9101963E−10 | 6.4678108E−11 | −8.8167987E−09 |
| A10 | −2.5665053E−11 | −6.1385636E−12 | 1.7738967E−10 | 1.8368695E−10 |
| A12 | 2.2127072E−13 | −4.9888147E−14 | −1.9645064E−12 | 2.1154001E−12 |
| A14 | −2.3557760E−16 | 2.0051585E−15 | 1.8939927E−14 | −4.9144551E−14 |
| A16 | −9.4015144E−18 | −2.0353428E−17 | −3.6910421E−16 | −9.8007234E−17 |
| A18 | 6.2817439E−20 | 9.1891818E−20 | 3.7529149E−18 | 5.6184130E−18 |
| A20 | −1.2825725E−22 | −1.5990668E−22 | −1.2731671E−20 | −2.5607964E−20 |

| Sn | 29 | 30 |
|---|---|---|
| KA | 1.0000000E+00 | 1.0000000E+00 |
| A4 | 2.5147208E−04 | 2.4921917E−04 |
| A6 | −4.4013176E−06 | −3.9611257E−06 |
| A8 | 7.0430710E−08 | 5.2539854E−08 |
| A10 | −8.7243302E−10 | −4.6027985E−10 |
| A12 | 7.1872565E−12 | 1.7531297E−12 |
| A14 | −2.9379137E−14 | 1.0689208E−14 |
| A16 | −3.7984701E−17 | −1.7705119E−16 |
| A18 | 8.8184880E−19 | 9.2151377E−19 |
| A20 | −2.5169360E−21 | −1.8075372E−21 |

### Example 18

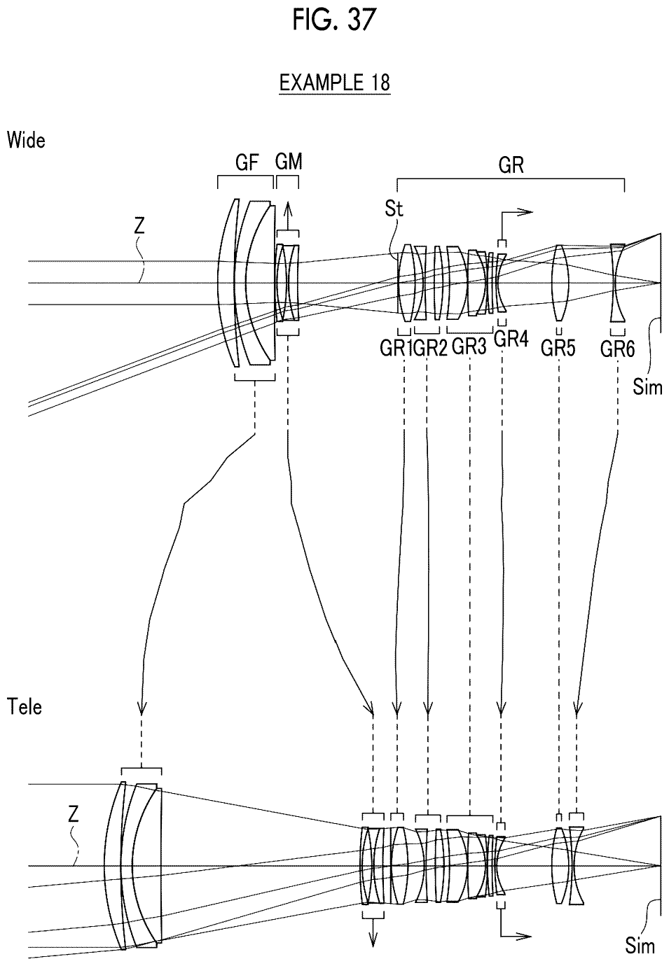

A configuration and a moving path of a variable magnification optical system of Example 18 are illustrated in FIG. 37. The variable magnification optical system of Example 18 consists of the front group GF, the middle group GM, and the rear group GR in this order from the object side to the image side. The front group GF consists of one lens group having a positive refractive power. The middle group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, the fifth subsequent lens group GR5 having a positive refractive power, and the sixth subsequent lens group GR6 having a negative refractive power in this order from the object side to the image side.

During changing the magnification from the wide angle end to the telephoto end, the third subsequent lens group GR3 and the fifth subsequent lens group GR5 are fixed with respect to the image plane Sim, and other lens groups move by changing the spacings with their adjacent lens groups. The variable magnification optical system includes only one focusing group. The focusing group consists of the fourth subsequent lens group GR4. During the focusing from the infinite distance object to the nearest object, the fourth subsequent lens group GR4 moves to the image side, and other lens groups are fixed with respect to the image plane Sim. The vibration-proof group consists of the middle group GM.

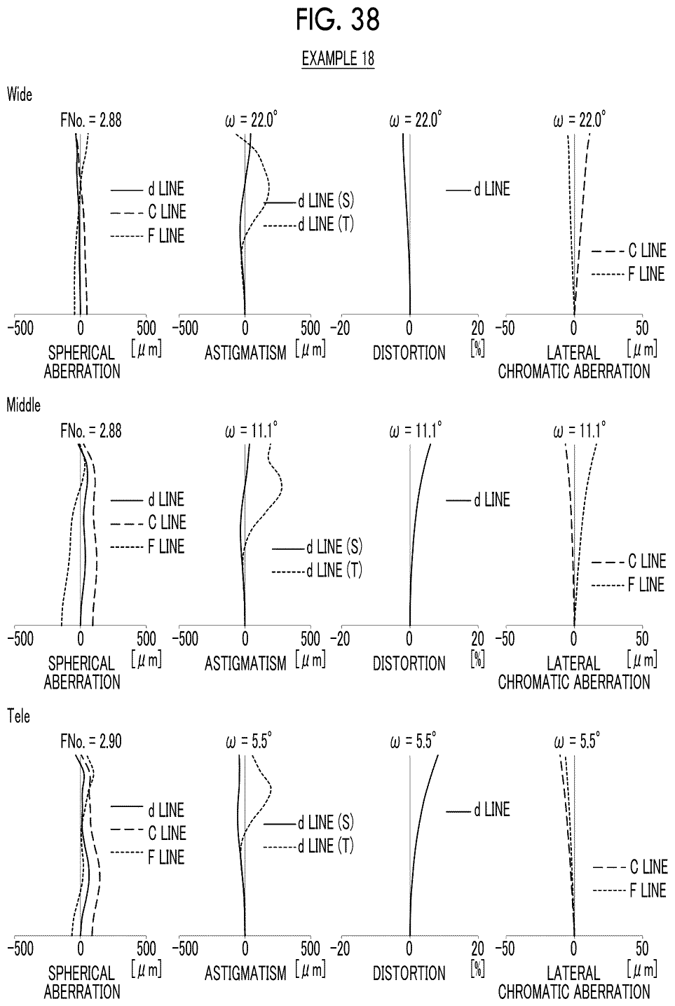

For the variable magnification optical system of Example 18, basic lens data is shown in Table 52, specifications and variable surface spacings are shown in Table 53, aspherical coefficients are shown in Table 54, and each aberration diagram is illustrated in FIG. 38.

TABLE 52
Example 18

| Sn | R | D | Nd | νd | θgF | ρ |
|---|---|---|---|---|---|---|
| 1 | 64.7492 | 4.4420 | 1.48749 | 70.24 | 0.53007 | 2.46 |
| 2 | 217.2501 | 0.0510 | | | | |
| 3 | 66.8292 | 3.0412 | 1.80100 | 34.97 | 0.58642 | 3.55 |
| 4 | 40.5736 | 7.7261 | 1.43700 | 95.10 | 0.53364 | 3.53 |
| 5 | 1475.9564 | DD[5] | | | | |
| *6 | 102.0071 | 0.5829 | 1.76450 | 49.10 | 0.55289 | |
| *7 | 36.6538 | 2.5725 | | | | |
| 8 | −56.5479 | 0.5637 | 1.79952 | 42.22 | 0.56727 | |
| 9 | 36.8397 | 2.4340 | 1.95906 | 17.47 | 0.65993 | |
| 10 | 201.4557 | DD[10] | | | | |
| 11 (St) | ∞ | 0.2001 | | | | |
| *12 | 34.9467 | 4.4406 | 1.76450 | 49.10 | 0.55289 | |
| *13 | −46.0105 | DD[13] | | | | |
| 14 | −24.7453 | 0.5241 | 1.92286 | 18.90 | 0.64960 | |
| 15 | 181.2637 | 2.4484 | | | | |
| 16 | 200.4639 | 2.3364 | 1.95906 | 17.47 | 0.65993 | |
| 17 | −57.0600 | DD[17] | | | | |
| 18 | −74.6940 | 4.7879 | 1.64000 | 60.08 | 0.53704 | |
| 19 | −22.9469 | 0.0895 | | | | |
| 20 | 180.4840 | 4.7709 | 1.55032 | 75.50 | 0.54001 | |
| 21 | −17.7913 | 0.4993 | 1.83481 | 42.74 | 0.56490 | |
| 22 | −73.0918 | 0.0497 | | | | |
| 23 | 82.1621 | 1.2263 | 1.49710 | 81.56 | 0.53848 | |
| 24 | 152.5057 | DD[24] | | | | |
| *25 | 60.8444 | 0.5085 | 1.43700 | 95.10 | 0.53364 | |
| *26 | 15.4433 | DD[26] | | | | |
| 27 | 44.3244 | 4.5548 | 1.48749 | 70.24 | 0.53007 | |
| 28 | −30.8503 | DD[28] | | | | |
| *29 | −83.4941 | 0.5466 | 1.51633 | 64.06 | 0.53345 | |
| *30 | 24.5946 | DD[30] | | | | |

TABLE 53
Example 18

| | Wide | Middle | Tele |
|---|---|---|---|
| Zr | 1.0 | 1.9 | 3.8 |
| f | 35.83 | 68.08 | 135.44 |
| Bf | 12.26 | 18.57 | 23.34 |
| FNo. | 2.88 | 2.88 | 2.90 |
| 2ω[°] | 44.0 | 22.2 | 11.0 |
| DD[5] | 0.10 | 30.42 | 53.36 |
| DD[10] | 26.78 | 19.52 | 2.11 |
| DD[13] | 2.16 | 4.04 | 4.37 |
| DD[17] | 1.80 | 1.30 | 1.51 |
| DD[24] | 1.07 | 1.45 | 0.75 |
| DD[26] | 14.48 | 14.10 | 14.80 |
| DD[28] | 11.97 | 5.66 | 0.90 |
| DD[30] | 12.26 | 18.57 | 23.34 |

TABLE 54
Example 18

| Sn | 6 | 7 |
|---|---|---|
| KA | 1.0000000E+00 | 1.0000000E+00 |
| A4 | −3.1592864E−07 | 3.0436714E−07 |
| A6 | 1.5182954E−08 | 8.2148672E−09 |
| A8 | −1.8829122E−11 | 2.8365227E−11 |
| A10 | 2.0905485E−14 | 4.3160364E−14 |
| A12 | 9.4794587E−17 | 1.9034624E−16 |

| Sn | 12 | 13 | 25 | 26 |
|---|---|---|---|---|
| KA | 1.0000000E+00 | 1.0000000E+00 | 1.0000000E+00 | 1.0000000E+00 |
| A4 | −9.7443122E−07 | 9.8994537E−06 | 5.5079673E−05 | 4.7817467E−05 |
| A6 | 3.6303160E−09 | −7.3015858E−08 | −1.8000128E−06 | −1.1846569E−06 |
| A8 | −4.7494904E−10 | 3.1386937E−10 | 1.7083705E−08 | −2.7660595E−09 |
| A10 | 1.3621083E−13 | 3.1410456E−12 | 7.5169742E−11 | 1.8049427E−10 |
| A12 | 9.0068040E−14 | −4.0194542E−15 | −2.7103770E−12 | 1.3833741E−12 |
| A14 | −3.7814678E−16 | −4.0323906E−16 | 3.5639401E−15 | −3.6180074E−14 |
| A16 | −7.7691246E−18 | 1.0180768E−18 | 3.6670036E−16 | −3.1849112E−16 |
| A18 | 7.1851767E−20 | 1.4801806E−20 | −3.9517856E−18 | 7.2382627E−18 |
| A20 | −1.6911638E−22 | −5.8447902E−23 | 1.4112414E−20 | −2.5203359E−20 |

| Sn | 29 | 30 |
|---|---|---|
| KA | 1.0000000E+00 | 1.0000000E+00 |
| A4 | 1.3138602E−05 | 2.4076222E−05 |
| A6 | −2.8843437E−07 | −4.8167133E−07 |
| A8 | 3.1204065E−09 | 5.6716717E−09 |
| A10 | −8.2694962E−12 | 2.6321563E−11 |
| A12 | 4.1193024E−13 | −1.1496311E−12 |
| A14 | −9.5789799E−15 | 9.0295212E−15 |
| A16 | 3.0185264E−17 | −3.7452221E−17 |
| A18 | 4.7632403E−19 | 2.2359969E−19 |
| A20 | −2.6539131E−21 | −8.8621451E−22 |

### Example 19

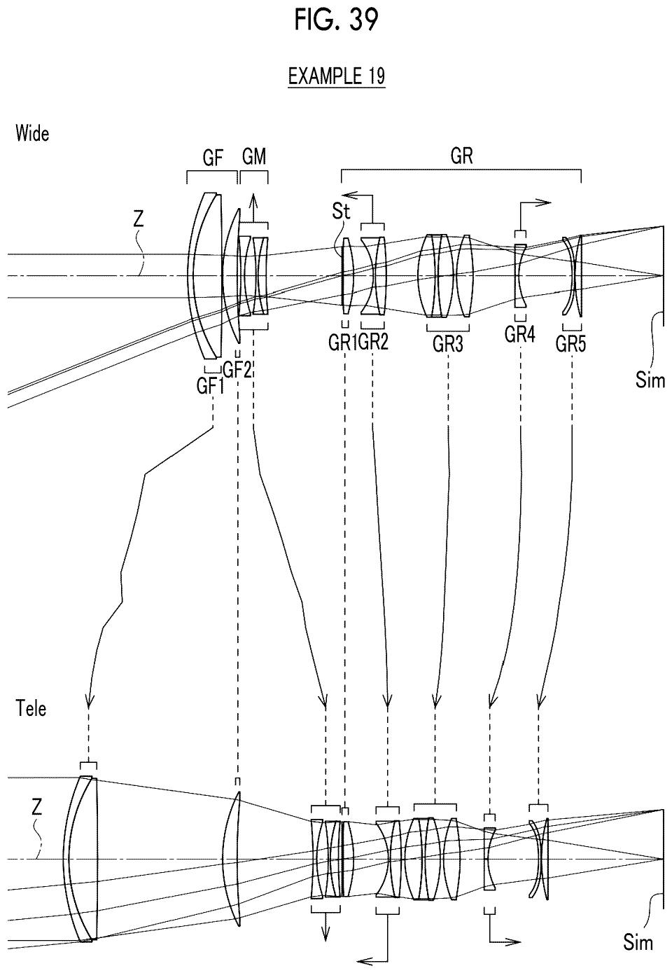

A configuration and a moving path of a variable magnification optical system of Example 19 are illustrated in FIG. 39. The variable magnification optical system of Example 19 consists of the front group GF, the middle group GM, and the rear group GR in this order from the object side to the image side. The front group GF consists of the first front side lens group GF1 having a positive refractive power and the second front side lens group GF2 having a positive refractive power in this order from the object side to the image side. The middle group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power in this order from the object side to the image side. The rear group GR includes the Lp1 lens, the Ln1 lens, the Ln2 lens, and the Lp2 lens described above.

During changing the magnification from the wide angle end to the telephoto end, the second front side lens group GF2 and the first subsequent lens group GR1 are fixed with respect to the image plane Sim, and other lens groups move by changing the spacings with their adjacent lens groups. The variable magnification optical system includes two focusing groups. The focusing group on the object side consists of the second subsequent lens group GR2, and the focusing group on the image side consists of the fourth subsequent lens group GR4. During the focusing from the infinite distance object to the nearest object, the second subsequent lens group GR2 moves to the object side, the fourth subsequent lens group GR4 moves to the image side, and other lens groups are fixed with respect to the image plane Sim. The vibration-proof group consists of the middle group GM.

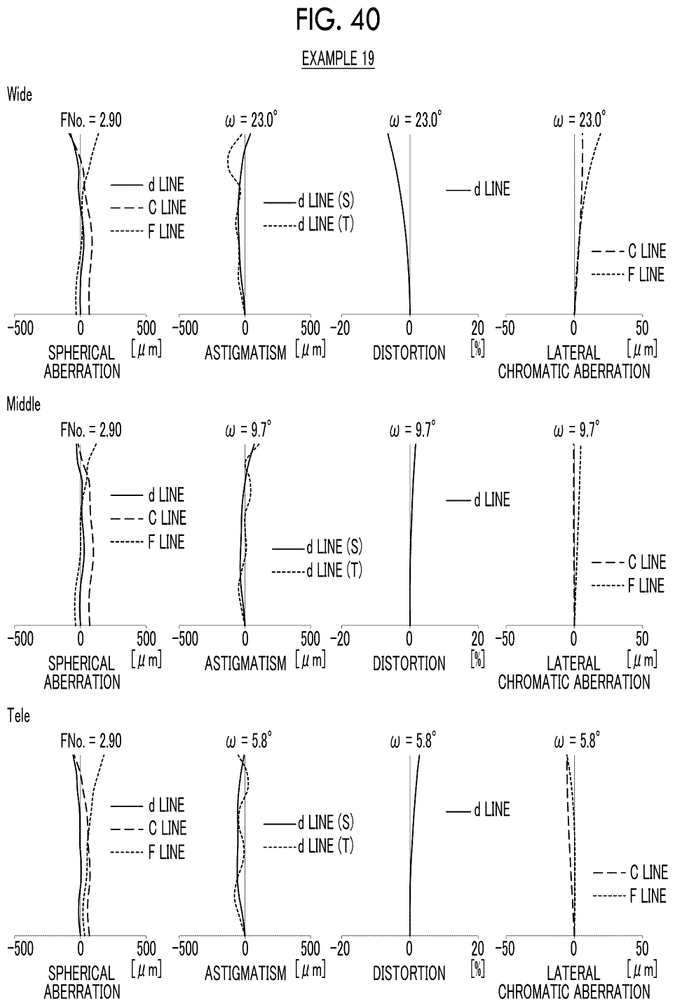

For the variable magnification optical system of Example 19, basic lens data is shown in Table 55, specifications and variable surface spacings are shown in Table 56, aspherical coefficients are shown in Table 57A and Table 57B, and each aberration diagram is illustrated in FIG. 40. The column of ED in the table of the basic lens data shows an effective diameter of each surface of the Lp1 lens, the Ln1 lens, the Ln2 lens, and the Lp2 lens.

TABLE 55
Example 19

| Sn | R | D | Nd | νd | θgF | ρ | ED |
|---|---|---|---|---|---|---|---|
| 1 | 63.6643 | 1.5000 | 1.85025 | 30.05 | 0.59797 | 4.00 | |
| 2 | 46.2727 | 7.7166 | 1.49782 | 82.57 | 0.53862 | 3.86 | |
| 3 | −1105.6823 | DD[3] | | | | | |
| 4 | 44.6687 | 3.9080 | 1.49782 | 82.57 | 0.53862 | 3.86 | |
| 5 | 198.4948 | DD[5] | | | | | |
| *6 | −118.0555 | 1.0000 | 1.83220 | 40.10 | 0.57151 | | |
| *7 | 36.0460 | 3.1043 | | | | | |
| 8 | −72.1032 | 0.5707 | 1.60300 | 65.44 | 0.54022 | | |
| 9 | 39.6678 | 2.1516 | 1.92286 | 20.88 | 0.63900 | | |
| 10 | 128.2158 | DD[10] | | | | | |
| 11 | ∞ | 0.3281 | | | | | |
| (St) | | | | | | | |
| *12 | −717.0050 | 2.7917 | 1.61881 | 63.85 | 0.54182 | | |
| *13 | −36.7800 | DD[13] | | | | | |
| 14 | −17.7129 | 0.5687 | 1.63930 | 44.87 | 0.56843 | | |
| 15 | 49.6688 | 2.9070 | 1.89286 | 20.36 | 0.63944 | | |
| 16 | −106.9286 | DD[16] | | | | | |
| 17 | 29.1250 | 4.6547 | 1.52841 | 76.45 | 0.53954 | | |
| 18 | −71.9444 | 0.8000 | 1.96300 | 24.11 | 0.62126 | | |
| 19 | 69.7790 | 4.0930 | 1.43875 | 94.66 | 0.53402 | | |
| 20 | −38.0547 | 0.8702 | | | | | |
| *21 | 31.0069 | 4.4552 | 1.61881 | 63.85 | 0.54182 | | 23.244 |
| *22 | −51.4873 | DD[22] | | | | | 22.800 |
| *23 | −544.6314 | 1.0000 | 1.55332 | 71.68 | 0.54029 | | 17.780 |
| *24 | 18.3643 | DD[24] | | | | | 16.600 |
| *25 | −44.7400 | 0.7086 | 1.58913 | 61.15 | 0.53824 | | 20.411 |
| *26 | −65.9629 | 0.1000 | | | | | 21.210 |
| 27 | 46.6687 | 1.7500 | 1.51633 | 64.14 | 0.53531 | | 23.156 |
| 28 | ∞ | DD[28] | | | | | 23.200 |

TABLE 56
Example 19

| | Wide | Middle | Tele |
|---|---|---|---|
| Zr | 1.0 | 2.3 | 3.8 |
| f | 35.70 | 82.11 | 135.65 |
| Bf | 22.10 | 25.52 | 31.13 |
| FNo. | 2.90 | 2.90 | 2.90 |
| 2ω[°] | 46.0 | 19.4 | 11.6 |
| DD[3] | 0.20 | 24.44 | 33.53 |
| DD[5] | 0.99 | 14.08 | 20.44 |
| DD[10] | 20.45 | 7.35 | 0.99 |
| DD[13] | 5.31 | 8.28 | 9.34 |
| DD[16] | 8.52 | 4.50 | 0.98 |
| DD[22] | 11.15 | 10.57 | 6.52 |
| DD[24] | 14.35 | 12.55 | 13.45 |
| DD[28] | 22.10 | 25.52 | 31.13 |

TABLE 57A
Example 19

| Sn | 6 | 7 |
|---|---|---|
| KA | 1.0000000E+00 | 1.0000000E+00 |
| A4 | 2.4503638E−06 | −1.3399069E−07 |
| A6 | −5.6706582E−09 | −2.1893698E−09 |
| A8 | −5.2426606E−12 | −4.4089817E−11 |
| A10 | 1.4033133E−13 | 3.5871218E−13 |

| Sn | 21 | 22 |
|---|---|---|
| KA | 1.0000000E+00 | 1.0000000E+00 |
| A4 | −1.0502198E−05 | 1.1786090E−05 |
| A6 | 1.2486938E−08 | 1.5795954E−08 |
| A8 | 3.1180167E−10 | 1.5664610E−10 |
| A10 | −2.8074570E−12 | −5.0269361E−13 |
| A12 | 3.8432368E−15 | −1.0465738E−14 |
| A14 | 3.6256731E−17 | −9.7926920E−18 |
| A16 | 6.7357837E−20 | 1.1425073E−18 |
| A18 | 8.4531996E−22 | −2.7860292E−21 |

TABLE 57B
Example 19

| Sn | 12 | 13 | 25 | 26 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 4.2883825E−06 | −5.5427938E−06 | −9.1710499E−05 | −1.0167302E−04 |
| A5 | 8.2140420E−07 | 2.7642317E−06 | −5.4817595E−06 | −1.4635602E−07 |
| A6 | −1.4325297E−07 | −4.9025439E−07 | 7.7206192E−07 | 2.5347364E−07 |
| A7 | −1.5168154E−08 | −2.0666587E−09 | −5.4986359E−08 | −9.5235166E−09 |
| A8 | 8.2894828E−09 | 7.8602516E−09 | 2.4407678E−09 | −4.7080772E−09 |
| A9 | −3.6923479E−10 | 5.2277005E−11 | −1.0829710E−10 | −7.6804479E−11 |
| A10 | 1.9478741E−11 | −4.1619193E−11 | −5.0448994E−11 | 3.8624454E−11 |
| A11 | −1.1061563E−11 | −2.7107838E−12 | −7.8921489E−12 | 1.5298531E−12 |
| A12 | 1.6479430E−13 | −7.3236347E−13 | 1.0679661E−12 | −2.8243810E−13 |
| A13 | 8.9162605E−14 | 8.7923330E−14 | 4.2160063E−14 | −5.9146937E−15 |
| A14 | −5.5033878E−15 | −3.0482386E−15 | 3.5907718E−15 | 2.6494679E−15 |
| A15 | 8.3731816E−16 | 1.5227788E−15 | 6.0690341E−17 | −7.1543058E−17 |
| A16 | 6.4278157E−17 | −5.9807287E−17 | −9.8534727E−17 | 2.1243333E−17 |
| A17 | −2.0985318E−17 | −1.2541068E−17 | 4.5356254E−18 | 2.5178688E−18 |
| A18 | 2.4057451E−19 | 7.0358482E−19 | 3.3544380E−19 | −5.4365800E−19 |
| A19 | 1.0310691E−19 | −6.4330501E−21 | −1.3452407E−19 | −2.6124421E−20 |
| A20 | −3.8603853E−21 | 5.8627205E−22 | 8.4337592E−21 | 3.3644774E−21 |

| Sn | 23 | 24 |
|---|---|---|
| KA | 1.0000000E+00 | 1.0000000E+00 |
| A3 | 0.0000000E+00 | 0.0000000E+00 |
| A4 | 3.0963867E−05 | 2.9872814E−05 |
| A5 | −2.2479310E−06 | −6.2052185E−06 |
| A6 | −4.0877355E−07 | 2.7991157E−07 |
| A7 | 2.4313112E−08 | −3.3356067E−08 |
| A8 | −2.8194986E−09 | 7.4861484E−11 |
| A9 | 1.0385896E−09 | −5.9663247E−11 |
| A10 | 2.3435761E−11 | 1.6814351E−10 |
| A11 | −9.2975905E−12 | −1.2088824E−11 |
| A12 | −4.8834535E−13 | −1.1892928E−13 |
| A13 | 4.8972337E−14 | −4.6583413E−14 |
| A14 | −4.2785946E−15 | 3.7386896E−15 |
| A15 | 1.2137864E−15 | 3.9717568E−16 |
| A16 | −6.9141332E−17 | −2.8629046E−17 |

### Example 20

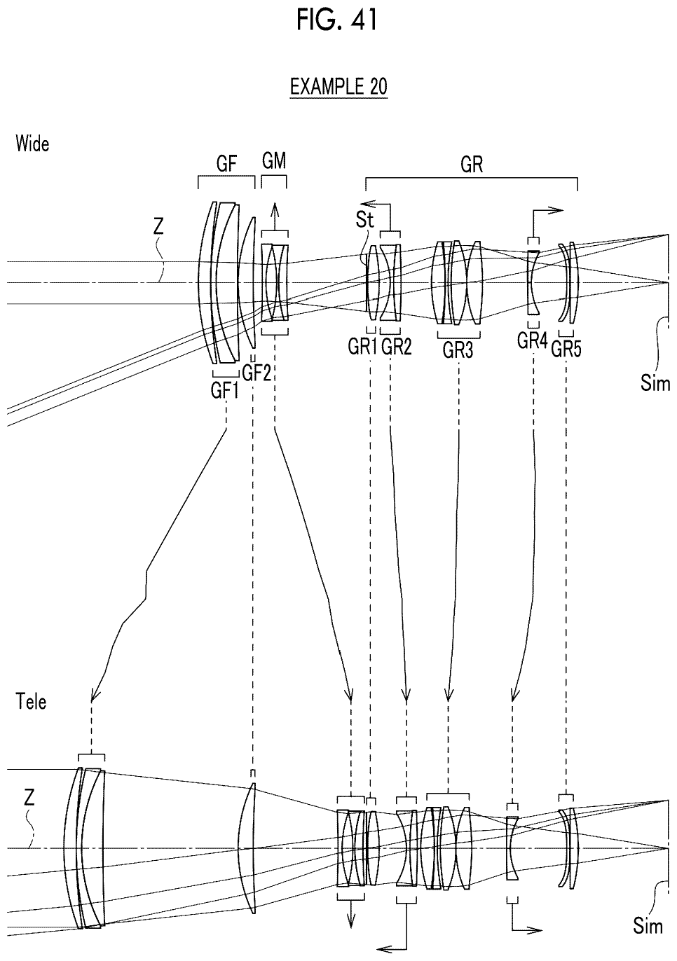

A configuration and a moving path of a variable magnification optical system of Example 20 are illustrated in FIG. 41. The variable magnification optical system of Example 20 consists of the front group GF, the middle group GM, and the rear group GR in this order from the object side to the image side. The front group GF consists of the first front side lens group GF1 having a positive refractive power and the second front side lens group GF2 having a positive refractive power in this order from the object side to the image side. The middle group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a positive refractive power in this order from the object side to the image side. The rear group GR includes the Ln2 lens and the Lp2 lens described above.

During changing the magnification from the wide angle end to the telephoto end, the second front side lens group GF2, the first subsequent lens group GR1, and the fifth subsequent lens group GR5 are fixed with respect to the image plane Sim, and other lens groups move by changing the spacings with their adjacent lens groups. The variable magnification optical system includes two focusing groups. The focusing group on the object side consists of the second subsequent lens group GR2, and the focusing group on the image side consists of the fourth subsequent lens group GR4. During the focusing from the infinite distance object to the nearest object, the second subsequent lens group GR2 moves to the object side, the fourth subsequent lens group GR4 moves to the image side, and other lens groups are fixed with respect to the image plane Sim. The vibration-proof group consists of the middle group GM.

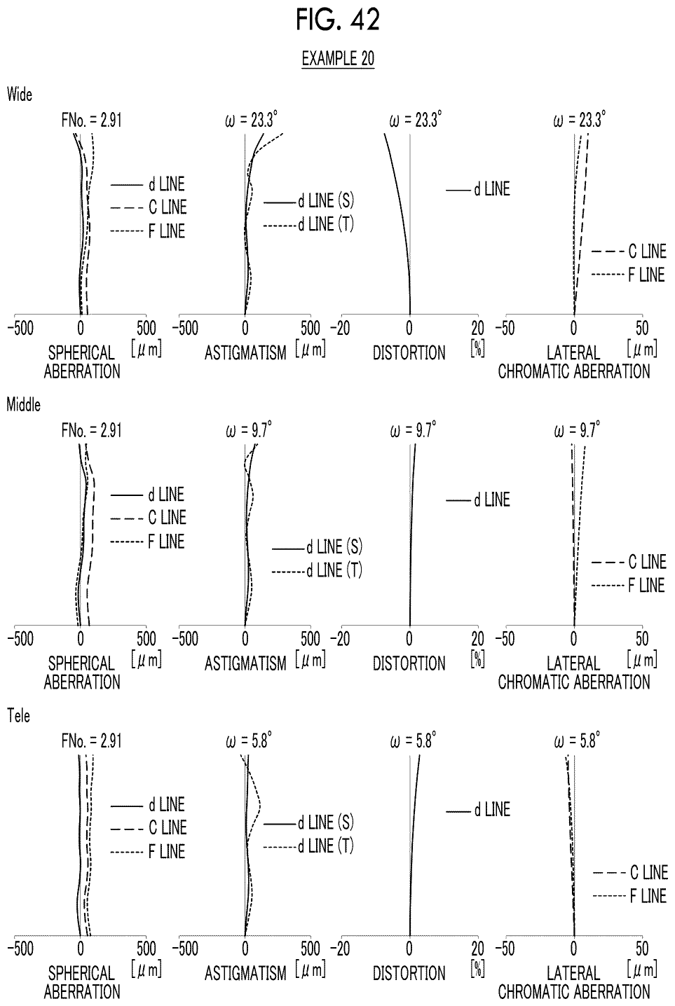

For the variable magnification optical system of Example 20, basic lens data is shown in Table 58, specifications and variable surface spacings are shown in Table 59, aspherical coefficients are shown in Table 60A and Table 60B, and each aberration diagram is illustrated in FIG. 42. The column of ED in the table of the basic lens data shows the effective diameter of each surface of the Ln2 lens and the Lp2 lens.

TABLE 58
Example 20

| Sn | R | D | Nd | νd | θgF | ρ | ED |
|---|---|---|---|---|---|---|---|
| 1 | 72.2134 | 3.4287 | 1.48749 | 70.32 | 0.52917 | 2.45 | |
| 2 | 167.8338 | 0.0322 | | | | | |
| 3 | 105.5580 | 1.5000 | 1.80100 | 34.97 | 0.58642 | 3.55 | |
| 4 | 52.8734 | 5.9222 | 1.49782 | 82.57 | 0.53862 | 3.86 | |
| 5 | 529.8762 | DD[5] | | | | | |
| 6 | 47.1072 | 4.2090 | 1.51680 | 64.20 | 0.53430 | 2.52 | |
| 7 | 308.8563 | DD[7] | | | | | |
| *8 | −321.9759 | 1.0000 | 1.83220 | 40.10 | 0.57151 | | |
| *9 | 33.3477 | 3.0831 | | | | | |
| 10 | −45.6742 | 0.5796 | 1.60300 | 65.44 | 0.54022 | | |
| 11 | 39.4989 | 2.3109 | 1.92286 | 20.88 | 0.63900 | | |
| 12 | 166.0650 | DD[12] | | | | | |
| 13 | ∞ | 0.3281 | | | | | |
| (St) | | | | | | | |
| *14 | 77.0433 | 3.2002 | 1.61881 | 63.85 | 0.54182 | | |
| *15 | −50.7660 | DD[15] | | | | | |
| 16 | −20.7351 | 0.8307 | 1.63930 | 44.87 | 0.56843 | | |
| 17 | 82.5328 | 2.0386 | 1.89286 | 20.36 | 0.63944 | | |
| 18 | −282.7252 | DD[18] | | | | | |
| 19 | 42.6512 | 3.7733 | 1.52841 | 76.45 | 0.53954 | | |
| 20 | −83.4665 | 0.0348 | | | | | |
| 21 | −141.3162 | 0.8000 | 1.96300 | 24.11 | 0.62126 | | |
| 22 | 71.6595 | 0.7317 | | | | | |
| 23 | 78.2930 | 4.3869 | 1.43875 | 94.66 | 0.53402 | | |
| 24 | −34.9580 | 0.0223 | | | | | |
| *25 | 31.6446 | 4.3531 | 1.61881 | 63.85 | 0.54182 | | |
| *26 | −72.9604 | DD[26] | | | | | |
| *27 | 668.1837 | 1.0000 | 1.55332 | 71.68 | 0.54029 | | |
| *28 | 19.1957 | DD[28] | | | | | |
| *29 | −127.1531 | 0.8958 | 1.58913 | 61.15 | 0.53824 | | 21.855 |
| *30 | −290.1611 | 0.1000 | | | | | 22.600 |
| 31 | −1338.4451 | 2.6014 | 1.51633 | 64.14 | 0.53531 | | 23.513 |
| 32 | −52.6676 | 24.9700 | | | | | 23.752 |

TABLE 59
Example 20

| | Wide | Middle | Tele |
|---|---|---|---|
| Zr | 1.0 | 2.3 | 3.8 |
| f | 35.70 | 82.11 | 135.66 |
| Bf | 24.97 | 24.97 | 24.97 |
| FNo. | 2.91 | 2.91 | 2.91 |
| 2ω[°] | 46.6 | 19.4 | 11.6 |
| DD[5] | 0.20 | 22.17 | 37.52 |
| DD[7] | 2.24 | 17.09 | 23.29 |
| DD[12] | 22.04 | 7.19 | 0.99 |
| DD[15] | 3.15 | 6.41 | 7.63 |
| DD[18] | 8.55 | 4.16 | 1.00 |
| DD[26] | 12.39 | 13.09 | 9.35 |
| DD[28] | 9.33 | 9.77 | 15.44 |

TABLE 60A
Example 20

| Sn | 8 | 9 |
|---|---|---|
| KA | 1.0000000E+00 | 1.0000000E+00 |
| A4 | −6.0717237E−08 | −1.7142088E−09 |
| A6 | −6.3603767E−11 | 7.9006256E−10 |
| A8 | −3.1416008E−13 | −2.8396798E−12 |
| A10 | 5.0835013E−15 | −5.1686117E−14 |

| Sn | 25 | 26 |
|---|---|---|
| KA | 1.0000000E+00 | 1.0000000E+00 |
| A4 | −5.5880608E−06 | 7.3477021E−06 |
| A6 | 1.6072187E−08 | 2.7265997E−08 |
| A8 | 3.2065171E−10 | 1.0932971E−10 |
| A10 | −2.8772914E−12 | −7.2865317E−13 |
| A12 | 3.2632890E−15 | −1.1077768E−14 |
| A14 | 2.7763631E−17 | −4.1514135E−18 |
| A16 | 1.1641822E−19 | 1.2548798E−18 |
| A18 | 1.4601927E−21 | −2.5377203E−21 |

TABLE 60B
Example 20

| Sn | 14 | 15 | 29 | 30 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 3.4693386E−06 | −8.0193487E−06 | −9.8004327E−05 | −9.4107754E−05 |
| A5 | 8.8549036E−07 | 3.2696328E−06 | −2.7923123E−06 | −4.9533800E−06 |
| A6 | −1.5596765E−07 | −5.2330311E−07 | 3.0554511E−07 | 5.7766640E−07 |
| A7 | −1.6352312E−08 | −3.3510239E−09 | −4.6279702E−08 | −1.4615413E−08 |
| A8 | 8.2756652E−09 | 7.8624431E−09 | 3.4174970E−09 | −3.3323603E−09 |
| A9 | −3.6941140E−10 | 5.4383546E−11 | 1.4916171E−10 | −1.0446073E−10 |
| A10 | 1.9707224E−11 | −4.1161445E−11 | −3.8992635E−11 | 4.3231049E−11 |
| A11 | −1.1046265E−11 | −2.6863675E−12 | −7.0332795E−12 | 1.0948081E−12 |
| A12 | 1.6656446E−13 | −7.3030971E−13 | 9.1655179E−13 | −2.2326761E−13 |
| A13 | 8.9307377E−14 | 8.8021747E−14 | 2.8934676E−14 | −6.3523636E−15 |
| A14 | −5.4936960E−15 | −3.0408636E−15 | 2.7481910E−15 | 1.3152342E−15 |
| A15 | 8.3763772E−16 | 1.5226694E−15 | 1.1447307E−16 | −5.5675510E−17 |
| A16 | 6.4292460E−17 | −5.9780650E−17 | −1.0875167E−16 | 2.2974773E−17 |
| A17 | −2.0988079E−17 | −1.2546188E−17 | 4.0359741E−18 | 2.4214660E−18 |
| A18 | 2.4027691E−19 | 7.0283641E−19 | 2.4775580E−19 | −6.2722023E−19 |
| A19 | 1.0311810E−19 | −6.4496657E−21 | −1.1230455E−19 | −2.4603751E−20 |
| A20 | −3.8702879E−21 | 5.8510430E−22 | 8.1019914E−21 | 3.9240041E−21 |

| Sn | 27 | 28 |
|---|---|---|
| KA | 1.0000000E+00 | 1.0000000E+00 |
| A3 | 0.0000000E+00 | 0.0000000E+00 |
| A4 | 3.1986726E−05 | 4.2869246E−05 |
| A5 | −2.4480244E−06 | −6.6731888E−06 |
| A6 | −4.1954190E−07 | 2.8016205E−07 |
| A7 | 2.4653131E−08 | −3.0641397E−08 |
| A8 | −3.1256153E−09 | 1.9123232E−11 |
| A9 | 9.7781326E−10 | −1.3537363E−10 |
| A10 | 1.3981291E−11 | 1.6004878E−10 |
| A11 | −9.5494948E−12 | −1.3943211E−11 |
| A12 | −4.7128278E−13 | −2.9912163E−14 |
| A13 | 5.5484602E−14 | −7.1583628E−14 |
| A14 | −2.3816955E−15 | 1.1948658E−14 |
| A15 | 1.3349881E−15 | 3.4916975E−16 |
| A16 | −9.3196945E−17 | −6.4873760E−17 |
| Sn | 27 | 28 |

### Example 21

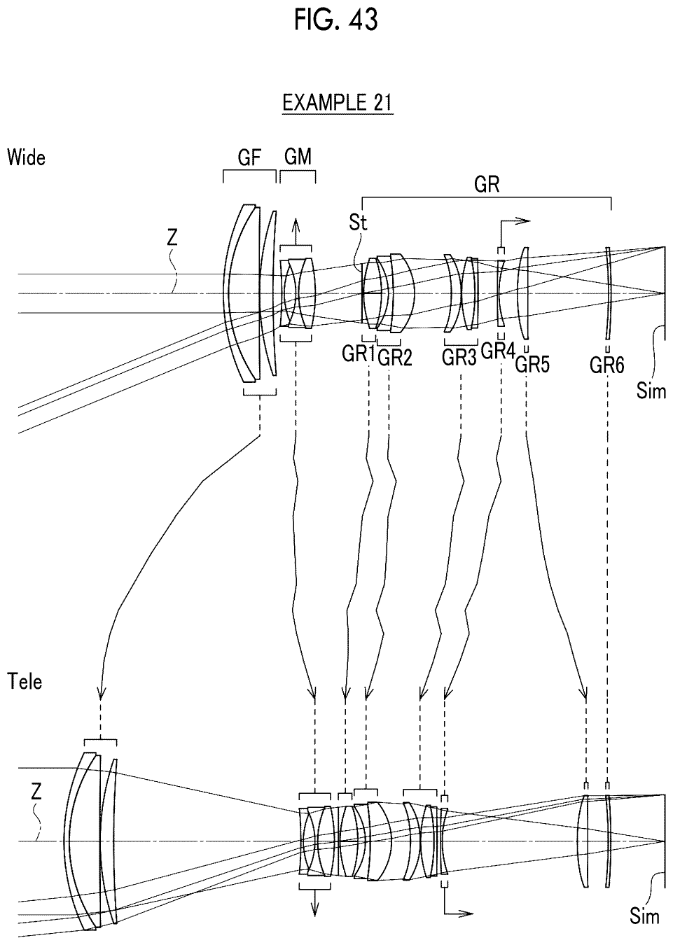

A configuration and a moving path of a variable magnification optical system of Example 21 are illustrated in FIG. 43. The variable magnification optical system of Example 21 consists of the front group GF, the middle group GM, and the rear group GR in this order from the object side to the image side. The front group GF consists of one lens group having a positive refractive power. The middle group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, the fifth subsequent lens group GR5 having a positive refractive power, and the sixth subsequent lens group GR6 having a negative refractive power in this order from the object side to the image side.

During changing the magnification from the wide angle end to the telephoto end, the sixth subsequent lens group GR6 is fixed with respect to the image plane Sim, and other lens groups move by changing the spacings with their adjacent lens groups. The variable magnification optical system includes only one focusing group. The focusing group consists of the fourth subsequent lens group GR4. During the focusing from the infinite distance object to the nearest object, the fourth subsequent lens group GR4 moves to the image side, and other lens groups are fixed with respect to the image plane Sim. The vibration-proof group consists of the middle group GM.

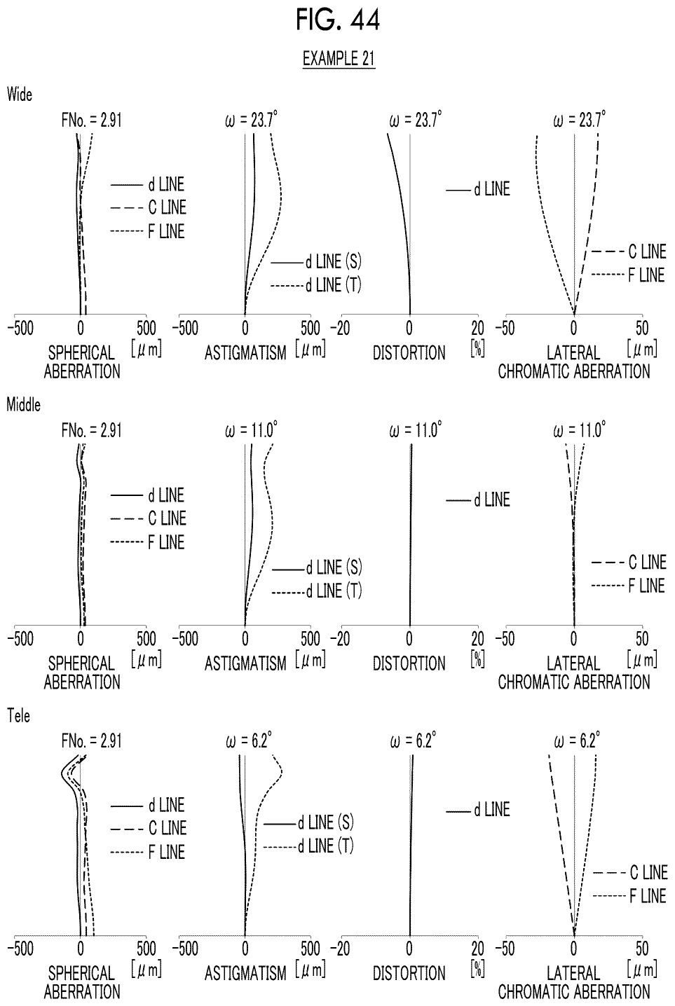

For the variable magnification optical system of Example 21, basic lens data is shown in Table 61, specifications and variable surface spacings are shown in Table 62, aspherical coefficients are shown in Table 63, and each aberration diagram is illustrated in FIG. 44.

TABLE 61
Example 21

| Sn | R | D | Nd | νd | θgF | ρ |
|---|---|---|---|---|---|---|
| 1 | 65.7982 | 1.5000 | 1.85026 | 32.35 | 0.59472 | 4.37 |
| 2 | 48.6483 | 8.7565 | 1.49782 | 82.57 | 0.53862 | 3.86 |
| 3 | 1884.3744 | 0.1000 | | | | |
| 4 | 82.2933 | 3.8449 | 1.51680 | 64.20 | 0.53430 | 2.52 |
| 5 | 342.2675 | DD[5] | | | | |
| 6 | −110.2202 | 0.7000 | 1.96300 | 24.11 | 0.62126 | |
| 7 | 22.9712 | 3.3076 | | | | |
| 8 | −22.4307 | 0.8100 | 1.59522 | 67.73 | 0.54426 | |
| 9 | 27.7898 | 4.7552 | 1.96300 | 24.11 | 0.62126 | |
| 10 | −51.0039 | DD[10] | | | | |
| 11 (St) | ∞ | 0.4700 | | | | |
| *12 | 31.5157 | 5.0814 | 1.49710 | 81.56 | 0.53848 | |
| *13 | −35.5646 | DD[13] | | | | |
| 14 | −19.1306 | 1.4002 | 1.85150 | 40.78 | 0.56958 | |
| 15 | −84.0917 | 6.0837 | 1.53775 | 74.70 | 0.53936 | |
| 16 | −19.7584 | DD[16] | | | | |
| *17 | −41.5474 | 2.8215 | 1.76450 | 49.10 | 0.55289 | |
| *18 | −24.9443 | 0.1000 | | | | |
| 19 | 37.6470 | 3.8310 | 1.59522 | 67.73 | 0.54426 | |
| 20 | −55.0879 | 0.8748 | 1.95375 | 32.32 | 0.59056 | |
| 21 | −509.5966 | DD[21] | | | | |
| 22 | 284.1274 | 0.4748 | 1.75500 | 52.32 | 0.54757 | |
| 23 | 31.9578 | DD[23] | | | | |
| *24 | 63.8598 | 3.0002 | 1.51633 | 64.06 | 0.53345 | |
| *25 | −472.4747 | DD[25] | | | | |
| 26 | −139.2708 | 0.7498 | 1.48749 | 70.24 | 0.53007 | |
| 27 | −192.3210 | DD[27] | | | | |

TABLE 62
Example 21

| | Wide | Middle | Tele |
|---|---|---|---|
| Zr | 1.0 | 2.1 | 3.8 |
| f | 34.66 | 72.78 | 129.96 |
| Bf | 15.40 | 15.40 | 15.40 |
| FNo. | 2.91 | 2.91 | 2.91 |
| 2ω[°] | 47.4 | 22.0 | 12.4 |
| DD[5] | 2.52 | 38.79 | 53.53 |
| DD[10] | 13.19 | 9.38 | 0.99 |
| DD[13] | 1.99 | 4.38 | 2.16 |
| DD[16] | 10.52 | 7.30 | 5.40 |
| DD[21] | 5.51 | 3.04 | 0.99 |
| DD[23] | 5.27 | 18.96 | 38.60 |
| DD[25] | 23.02 | 16.18 | 5.84 |
| DD[27] | 15.40 | 15.48 | 15.48 |

TABLE 63
Example 21

| Sn | 12 | 13 |
|---|---|---|
| KA | 1.0000000E+00 | 1.0000000E+00 |
| A3 | 0.0000000E+00 | 0.0000000E+00 |
| A4 | 1.3733527E−06 | 1.2381000E−05 |
| A5 | −8.5251559E−07 | −1.3600105E−06 |
| A6 | −8.9222982E−08 | 1.0037070E−07 |
| A7 | 1.6496490E−08 | 2.8522941E−09 |
| A8 | −2.2557348E−11 | −1.3862027E−10 |
| A9 | 7.2996958E−11 | −3.4975975E−10 |
| A10 | −3.4085610E−11 | 4.3869770E−11 |
| A11 | −4.9426960E−13 | 2.3118814E−12 |
| A12 | 7.3384867E−13 | −8.4567623E−13 |
| A13 | −7.7804427E−14 | 5.9443508E−14 |
| A14 | −7.1019095E−16 | −5.0012112E−15 |
| A15 | 7.0070534E−16 | 6.6685238E−16 |
| A16 | −3.6651572E−17 | −3.1994328E−17 |

| Sn | 17 | 18 | 24 | 25 |
|---|---|---|---|---|
| KA | 1.0000000E+00 | 1.0000000E+00 | 1.0000000E+00 | 1.0000000E+00 |
| A4 | −1.2791616E−05 | −3.8694694E−06 | 9.5778001E−06 | 5.3620321E−06 |
| A6 | −4.1074038E−08 | −4.3023237E−08 | 3.4834467E−09 | −1.4978239E−08 |
| A8 | −1.3959856E−10 | 5.9645573E−11 | 1.3984279E−10 | 2.8037324E−10 |
| A10 | −1.0881683E−14 | −1.0867216E−12 | −1.5716450E−12 | −2.0796147E−12 |
| A12 | −3.9704680E−15 | −3.6808952E−16 | 5.9081611E−15 | 6.7245992E−15 |

### Example 22

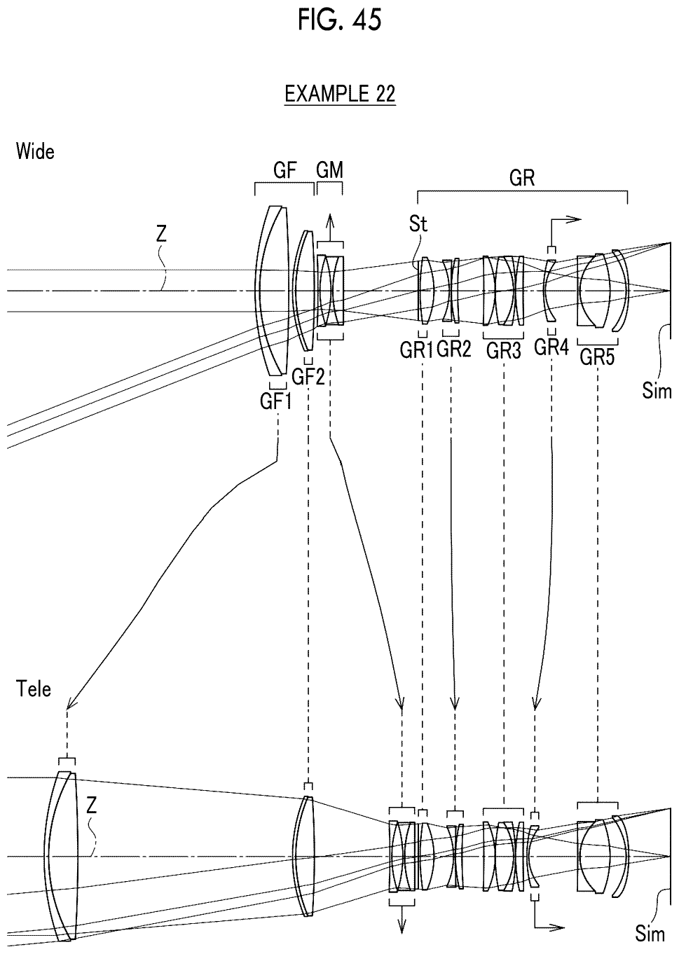

A configuration and a moving path of a variable magnification optical system of Example 22 are illustrated in FIG. 45. The variable magnification optical system of Example 22 consists of the front group GF, the middle group GM, and the rear group GR in this order from the object side to the image side. The front group GF consists of the first front side lens group GF1 having a positive refractive power and the second front side lens group GF2 having a positive refractive power in this order from the object side to the image side. The middle group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, and the fifth subsequent lens group GR5 having a negative refractive power in this order from the object side to the image side.

During changing the magnification from the wide angle end to the telephoto end, the second front side lens group GF2, the first subsequent lens group GR1, the third subsequent lens group GR3, and the fifth subsequent lens group GR5 are fixed with respect to the image plane Sim, and other lens groups move by changing the spacings with their adjacent lens groups. The variable magnification optical system includes only one focusing group. The focusing group consists of the fourth subsequent lens group GR4. During the focusing from the infinite distance object to the nearest object, the fourth subsequent lens group GR4 moves to the image side, and other lens groups are fixed with respect to the image plane Sim. The vibration-proof group consists of the middle group GM.

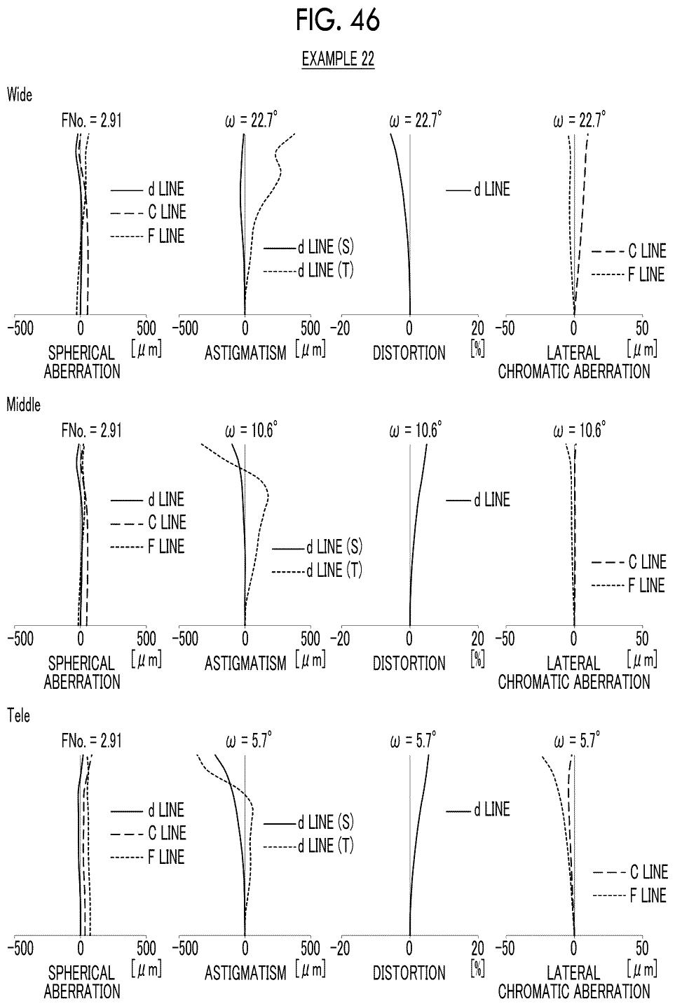

For the variable magnification optical system of Example 22, basic lens data is shown in Table 64, specifications and variable surface spacings are shown in Table 65, aspherical coefficients are shown in Table 66, and each aberration diagram is illustrated in FIG. 46.

TABLE 64
Example 22

| Sn | R | D | Nd | νd | θgF | ρ |
|---|---|---|---|---|---|---|
| 1 | 79.0584 | 1.2580 | 1.83400 | 37.18 | 0.57780 | 4.28 |
| 2 | 52.4167 | 8.0898 | 1.43700 | 95.10 | 0.53364 | 3.53 |
| 3 | −427.3565 | DD[3] | | | | |
| 4 | 48.9937 | 0.9118 | 1.95906 | 17.47 | 0.65993 | 3.59 |
| 5 | 47.4372 | 5.1355 | 1.53775 | 74.70 | 0.53936 | 3.64 |
| 6 | −277.8738 | DD[6] | | | | |
| 7 | −267.1905 | 0.5454 | 1.75500 | 52.32 | 0.54757 | |
| 8 | 33.2088 | 3.0346 | | | | |
| 9 | −36.0624 | 0.5328 | 1.80400 | 46.53 | 0.55775 | |
| 10 | 32.0405 | 2.7732 | 1.96300 | 24.11 | 0.62126 | |
| 11 | ∞ | DD[11] | | | | |
| 12 (St) | ∞ | 0.5000 | | | | |
| *13 | 61.9889 | 3.8559 | 1.61881 | 63.85 | 0.54182 | |
| *14 | −24.9073 | DD[14] | | | | |
| 15 | −21.8585 | 0.5037 | 1.95375 | 32.32 | 0.59056 | |
| 16 | 248.6479 | 0.0581 | | | | |
| 17 | 42.4899 | 1.7870 | 1.95906 | 17.47 | 0.65993 | |
| 18 | 129.3072 | DD[18] | | | | |
| 19 | −351.0226 | 3.1299 | 1.80400 | 46.53 | 0.55775 | |
| 20 | −26.1696 | 0.0328 | | | | |
| 21 | 52.3106 | 5.0752 | 1.59522 | 67.73 | 0.54426 | |
| 22 | −19.7439 | 0.5398 | 1.96300 | 24.11 | 0.62126 | |
| 23 | −55.5460 | 0.0328 | | | | |
| 24 | 48.3157 | 2.0911 | 1.77535 | 50.31 | 0.55042 | |
| 25 | 463.7302 | DD[25] | | | | |
| 26 | 36.5254 | 0.5304 | 1.80400 | 46.53 | 0.55775 | |
| 27 | 14.3154 | DD[27] | | | | |
| 28 | −445.3953 | 0.6166 | 1.88300 | 39.22 | 0.57288 | |
| 29 | 14.4436 | 8.3324 | 1.68893 | 31.07 | 0.60041 | |
| 30 | −31.4386 | 4.4755 | | | | |
| *31 | −18.6371 | 0.7212 | 1.51633 | 64.06 | 0.53345 | |
| *32 | −42.4235 | 11.6100 | | | | |

TABLE 65
Example 22

| | Wide | Middle | Tele |
|---|---|---|---|
| Zr | 1.0 | 2.0 | 3.8 |
| f | 36.00 | 72.00 | 135.36 |
| Bf | 11.61 | 11.61 | 11.61 |
| FNo. | 2.91 | 2.91 | 2.91 |
| 2ω[°] | 45.4 | 21.2 | 11.4 |
| DD[3] | 1.02 | 33.97 | 59.50 |
| DD[6] | 1.03 | 12.75 | 20.77 |
| DD[11] | 20.74 | 9.02 | 1.01 |
| DD[14] | 4.24 | 4.51 | 5.40 |
| DD[18] | 7.23 | 6.96 | 6.06 |
| DD[25] | 5.63 | 5.25 | 1.02 |
| DD[27] | 8.95 | 9.34 | 13.56 |

TABLE 66
Example 22

| Sn | 13 | 14 | 31 | 32 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −5.2945484E−06 | 1.6574170E−05 | 5.7547515E−05 | 8.4757151E−06 |
| A5 | 5.9920474E−08 | −1.3716303E−07 | −1.0322219E−05 | −6.6503110E−06 |
| A6 | −5.6377109E−08 | −3.2327311E−08 | 5.1695548E−07 | −1.4545709E−07 |
| A7 | 2.0741106E−09 | 1.6860024E−09 | 3.7175732E−08 | 1.0392871E−08 |
| A8 | −7.6825703E−11 | 2.5389737E−10 | −3.7887681E−09 | 5.6750053E−09 |
| A9 | −5.2180175E−11 | −6.8068162E−11 | 4.3957619E−10 | −2.7155366E−12 |
| A10 | 9.1653911E−12 | 1.5900141E−12 | −2.0322971E−11 | −3.0378906E−11 |
| A11 | −1.8486408E−13 | −1.7393117E−13 | −2.7608039E−12 | 2.5211527E−12 |
| A12 | −5.0857175E−14 | 5.0783371E−14 | 1.0313417E−13 | −5.3350166E−13 |
| A13 | −5.8026921E−16 | −1.0769529E−15 | 4.6193711E−14 | 6.4695020E−15 |
| A14 | −2.0119238E−16 | −2.2215401E−16 | −5.0749352E−15 | 2.1647127E−15 |
| A15 | 4.1221369E−17 | −2.8242486E−17 | −7.5458570E−17 | −1.0083533E−17 |
| A16 | 1.1271243E−18 | 4.5478861E−18 | 1.5649311E−17 | −3.9763506E−18 |

### Example 23

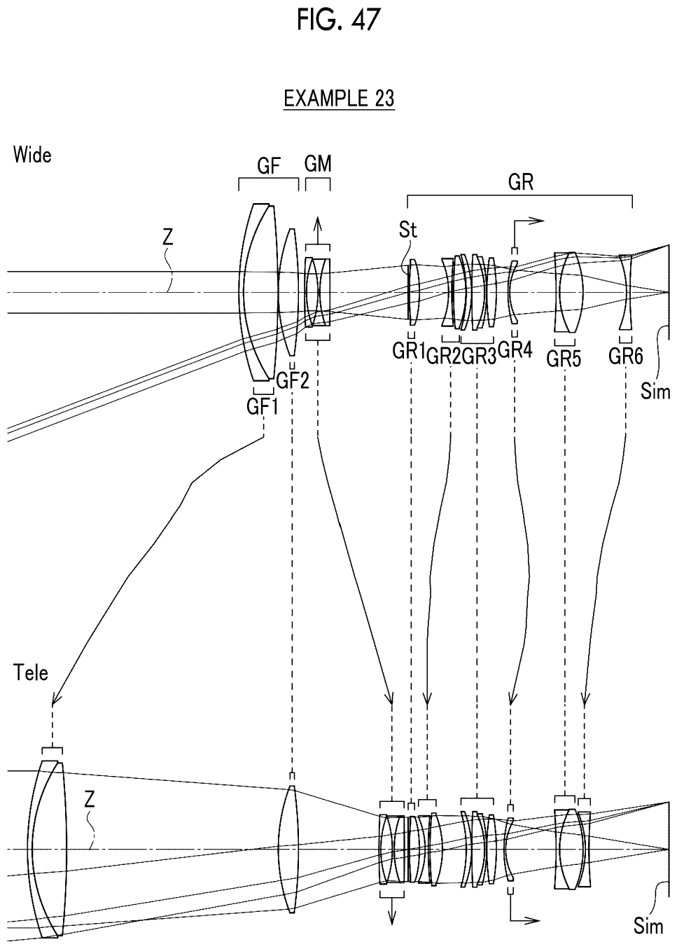

A configuration and a moving path of a variable magnification optical system of Example 23 are illustrated in FIG. 47. The variable magnification optical system of Example 23 consists of the front group GF, the middle group GM, and the rear group GR in this order from the object side to the image side. The front group GF consists of the first front side lens group GF1 having a positive refractive power and the second front side lens group GF2 having a positive refractive power in this order from the object side to the image side. The middle group GM consists of one lens group having a negative refractive power. The rear group GR consists of the first subsequent lens group GR1 having a positive refractive power, the second subsequent lens group GR2 having a negative refractive power, the third subsequent lens group GR3 having a positive refractive power, the fourth subsequent lens group GR4 having a negative refractive power, the fifth subsequent lens group GR5 having a positive refractive power, and the sixth subsequent lens group GR6 having a negative refractive power in this order from the object side to the image side.

During changing the magnification from the wide angle end to the telephoto end, the second front side lens group GF2, the first subsequent lens group GR1, the third subsequent lens group GR3, and the fifth subsequent lens group GR5 are fixed with respect to the image plane Sim, and other lens groups move by changing the spacings with their adjacent lens groups. The variable magnification optical system includes only one focusing group. The focusing group consists of the fourth subsequent lens group GR4. During the focusing from the infinite distance object to the nearest object, the fourth subsequent lens group GR4 moves to the image side, and other lens groups are fixed with respect to the image plane Sim. The vibration-proof group consists of the middle group GM.

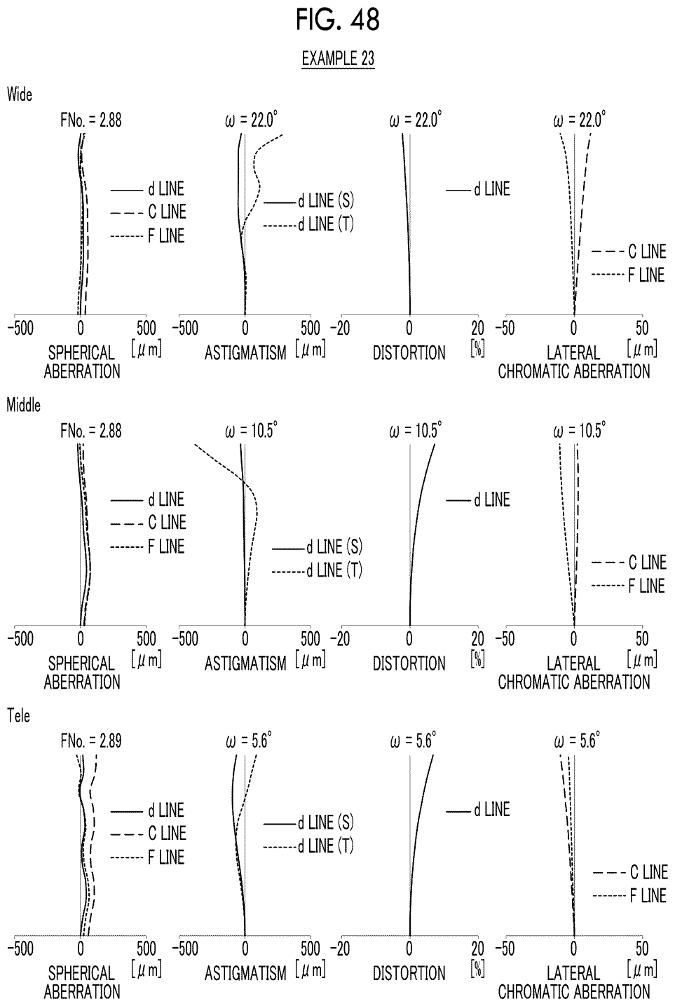

For the variable magnification optical system of Example 23, basic lens data is shown in Table 67, specifications and variable surface spacings are shown in Table 68, aspherical coefficients are shown in Table 69, and each aberration diagram is illustrated in FIG. 48.

TABLE 67
Example 23

| Sn | R | D | Nd | νd | θgF | ρ |
|---|---|---|---|---|---|---|
| 1 | 86.9279 | 1.3245 | 1.78590 | 44.20 | 0.56317 | 4.40 |
| 2 | 50.2681 | 9.6841 | 1.43700 | 95.10 | 0.53364 | 3.53 |
| 3 | −282.1839 | DD[3] | | | | |
| 4 | 56.7459 | 5.6826 | 1.51680 | 64.20 | 0.53430 | 2.52 |
| 5 | −151.2318 | DD[5] | | | | |
| *6 | 200.9343 | 0.5187 | 1.58913 | 61.15 | 0.53824 | |
| *7 | 30.2670 | 3.2424 | | | | |
| 8 | −32.7976 | 0.5273 | 1.77535 | 50.31 | 0.55042 | |
| 9 | 31.5129 | 2.8347 | 1.85896 | 22.73 | 0.62844 | |
| 10 | −1087.5270 | DD[10] | | | | |
| 11 (St) | ∞ | 0.3000 | | | | |
| *12 | 71.9890 | 2.8726 | 1.61881 | 63.85 | 0.54182 | |
| *13 | −41.7770 | DD[13] | | | | |
| 14 | −26.0862 | 0.9000 | 1.80518 | 25.42 | 0.61616 | |
| 15 | 118.1459 | 0.4794 | | | | |
| 16 | 118.7622 | 3.4857 | 1.58913 | 61.13 | 0.54067 | |
| 17 | −30.8289 | DD[17] | | | | |
| 18 | −43.1453 | 1.5011 | 1.89286 | 20.36 | 0.63944 | |
| 19 | −33.3882 | 0.0499 | | | | |
| 20 | 229.6273 | 3.6408 | 1.59282 | 68.62 | 0.54414 | |
| 21 | −27.3950 | 0.5555 | 1.80400 | 46.53 | 0.55775 | |
| 22 | −45.8614 | 0.0498 | | | | |
| 23 | 75.6986 | 2.6782 | 1.43700 | 95.10 | 0.53364 | |
| 24 | −64.0390 | DD[24] | | | | |
| *25 | 40.6533 | 0.4980 | 1.74320 | 49.29 | 0.55303 | |
| *26 | 18.6674 | DD[26] | | | | |
| 27 | −157.9359 | 1.0066 | 1.48749 | 70.24 | 0.53007 | |
| 28 | 27.1682 | 6.5947 | 1.71700 | 47.93 | 0.56062 | |
| 29 | −32.9392 | DD[29] | | | | |
| 30 | −30.5043 | 1.0000 | 1.77535 | 50.31 | 0.55042 | |
| 31 | 139.4621 | DD[31] | | | | |

TABLE 68
Example 23

| | Wide | Middle | Tele |
|---|---|---|---|
| Zr | 1.0 | 2.0 | 3.8 |
| f | 35.87 | 71.73 | 135.57 |
| Bf | 10.98 | 18.98 | 22.56 |
| FNo. | 2.88 | 2.88 | 2.89 |
| 2ω[°] | 44.0 | 21.0 | 11.2 |
| DD[3] | 0.10 | 38.31 | 59.63 |
| DD[5] | 1.73 | 12.02 | 22.52 |
| DD[10] | 21.90 | 11.60 | 1.11 |
| DD[13] | 8.22 | 2.42 | 1.60 |
| DD[17] | 0.10 | 5.89 | 6.71 |
| DD[24] | 3.27 | 7.47 | 2.15 |
| DD[26] | 13.06 | 8.86 | 14.18 |
| DD[29] | 12.23 | 4.24 | 0.65 |
| DD[31] | 10.98 | 18.98 | 22.56 |

TABLE 69
Example 23

| Sn | 6 | 7 | 12 | 13 |
|---|---|---|---|---|
| KA | 1.0000000E+00 | 1.0000000E+00 | 1.0000000E+00 | 1.0000000E+00 |
| A4 | −3.9661623E−05 | −4.1729047E−05 | −1.5303889E−05 | 2.9722423E−06 |
| A6 | 1.1811876E−06 | 1.0167806E−06 | −1.8251446E−07 | −2.6867519E−07 |
| A8 | −1.5149288E−08 | −7.6085442E−09 | 2.1740556E−09 | 4.9880841E−09 |
| A10 | 7.9732116E−11 | −6.1723058E−11 | −5.1029639E−11 | −1.0675988E−10 |
| A12 | 1.8869820E−13 | 1.4473347E−12 | 9.5331036E−15 | 6.1346869E−13 |
| A14 | −5.5754506E−16 | −8.3599906E−15 | 3.6852405E−15 | 2.2815153E−15 |
| A16 | −6.7655071E−17 | 4.3737141E−17 | 9.4539041E−18 | −2.1724495E−17 |
| A18 | 6.7015751E−19 | −5.7906178E−19 | −4.4782205E−19 | −2.0534774E−19 |
| A20 | −1.9464048E−21 | 2.8746323E−21 | 1.1862997E−21 | 9.8571684E−22 |

| Sn | 25 | 26 |
|---|---|---|
| KA | 1.0000000E+00 | 1.0000000E+00 |
| A4 | 5.4791213E−05 | 5.6189093E−05 |
| A6 | −1.4321947E−06 | −1.4743658E−06 |
| A8 | 1.5462404E−08 | 2.2898369E−08 |
| A10 | 1.7471214E−10 | −2.5565700E−10 |
| A12 | −7.2159875E−12 | 2.9438104E−12 |
| A14 | 5.8323172E−14 | −8.7543140E−15 |
| A16 | 4.5908244E−16 | −8.0053264E−16 |
| A18 | −9.8377935E−18 | 1.3745778E−17 |
| A20 | 4.3602138E−20 | −6.7048605E−20 |

### Example 24

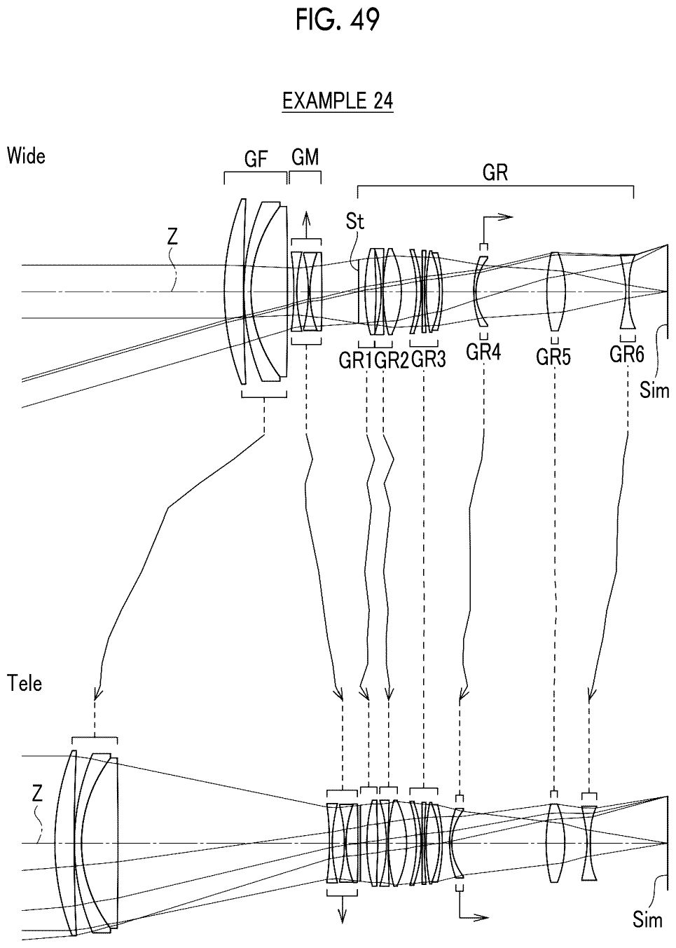

A configuration and a moving path of a variable magnification optical system of Example 24 are illustrated in FIG. 49. The variable magnification optical system of Example 24 consists of the front group GF, the middle group GM, and the rear group GR in this order from the object side to the image side. The front group GF consists of one lens group having a positive refractive power. The middle group GM consists of one lens group having a negative refractive power. The rear group GR consists of the first subsequent lens group GR1 having a positive refractive power, the second subsequent lens group GR2 having a positive refractive power, the third subsequent lens group GR3 having a positive refractive power, the fourth subsequent lens group GR4 having a negative refractive power, the fifth subsequent lens group GR5 having a positive refractive power, and the sixth subsequent lens group GR6 having a negative refractive power in this order from the object side to the image side.

During changing the magnification from the wide angle end to the telephoto end, the third subsequent lens group GR3 and the fifth subsequent lens group GR5 are fixed with respect to the image plane Sim, and other lens groups move by changing the spacings with their adjacent lens groups. The variable magnification optical system includes only one focusing group. The focusing group consists of the fourth subsequent lens group GR4. During the focusing from the infinite distance object to the nearest object, the fourth subsequent lens group GR4 moves to the image side, and other lens groups are fixed with respect to the image plane Sim. The vibration-proof group consists of the middle group GM.

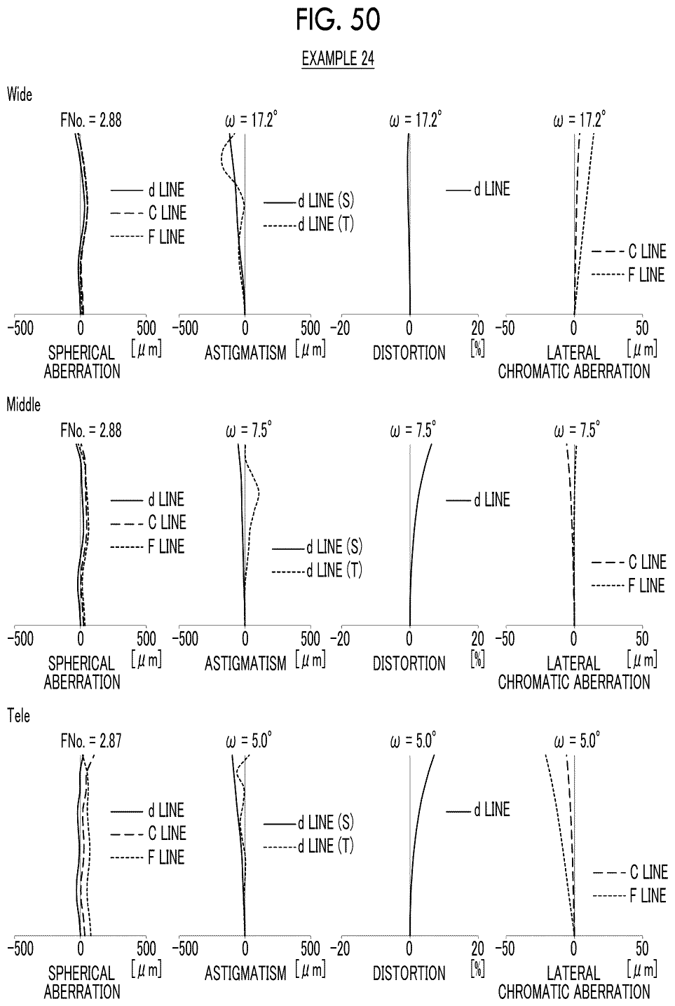

For the variable magnification optical system of Example 24, basic lens data is shown in Table 70, specifications and variable surface spacings are shown in Table 71, aspherical coefficients are shown in Table 72, and each aberration diagram is illustrated in FIG. 50.

TABLE 70
Example 24

| Sn | R | D | Nd | νd | θgF | ρ |
|---|---|---|---|---|---|---|
| 1 | 82.0658 | 5.4759 | 1.48749 | 70.24 | 0.53007 | 2.46 |
| 2 | 622.1894 | 0.1000 | | | | |
| 3 | 73.5391 | 2.0000 | 1.80100 | 34.97 | 0.58642 | 3.55 |
| 4 | 44.4637 | 10.3650 | 1.43700 | 95.10 | 0.53364 | 3.53 |
| 5 | −1529.4162 | DD[5] | | | | |
| *6 | −122.2773 | 0.8168 | 1.80625 | 40.91 | 0.56920 | |
| *7 | 43.0390 | 3.2988 | | | | |
| 8 | −47.8052 | 0.4793 | 1.75500 | 52.32 | 0.54757 | |
| 9 | 35.3057 | 3.3724 | 1.95906 | 17.47 | 0.65993 | |
| 10 | −446.1308 | DD[10] | | | | |
| 11 (St) | ∞ | 1.8505 | | | | |
| *12 | 61.6224 | 3.1101 | 1.69304 | 52.93 | 0.54673 | |
| *13 | −94.6842 | DD[13] | | | | |
| 14 | −45.3927 | 0.5029 | 1.96300 | 24.11 | 0.62126 | |
| 15 | 315.1619 | 0.0489 | | | | |
| 16 | 54.9999 | 5.1770 | 1.59522 | 67.73 | 0.54426 | |
| 17 | −31.8274 | DD[17] | | | | |
| 18 | −44.2682 | 1.2892 | 1.59522 | 67.73 | 0.54426 | |
| 19 | −38.9493 | 0.3515 | | | | |
| 20 | −3347.2260 | 0.6013 | 1.75500 | 52.32 | 0.54757 | |
| 21 | 157.7244 | 0.4913 | | | | |
| 22 | 72.8418 | 3.8172 | 1.55032 | 75.50 | 0.54001 | |
| 23 | −32.9560 | 0.8000 | 1.91082 | 35.25 | 0.58224 | |
| 24 | −52.1504 | DD[24] | | | | |
| *25 | 36.0836 | 0.6112 | 1.43700 | 95.10 | 0.53364 | |
| *26 | 17.5442 | DD[26] | | | | |
| 27 | 52.9720 | 5.3020 | 1.48749 | 70.24 | 0.53007 | |
| 28 | −34.4929 | DD[28] | | | | |
| *29 | −22.4953 | 0.9183 | 1.51633 | 64.06 | 0.53345 | |
| *30 | 198.6174 | DD[30] | | | | |

TABLE 71
Example 24

| | Wide | Middle | Tele |
|---|---|---|---|
| Zr | 1.0 | 2.2 | 3.3 |
| f | 46.15 | 101.53 | 152.29 |
| Bf | 10.99 | 16.99 | 22.01 |
| FNo. | 2.88 | 2.88 | 2.87 |
| 2ω[°] | 34.4 | 15.0 | 10.0 |
| DD[5] | 1.83 | 47.37 | 60.11 |
| DD[10] | 10.27 | 6.02 | 0.69 |
| DD[13] | 1.47 | 2.16 | 2.45 |
| DD[17] | 4.31 | 3.06 | 2.79 |
| DD[24] | 8.94 | 4.95 | 2.09 |
| DD[26] | 20.13 | 24.46 | 26.82 |
| DD[28] | 17.17 | 10.71 | 6.35 |
| DD[30] | 10.99 | 16.99 | 22.01 |

TABLE 72
Example 24

| Sn | 6 | 7 |
|---|---|---|
| KA | 1.0000000E+00 | 1.0000000E+00 |
| A4 | −3.3827595E−05 | −3.5263054E−05 |
| A6 | 5.2706852E−07 | 4.6472979E−07 |
| A8 | −4.8014137E−09 | −2.9780937E−09 |
| A10 | 1.5985679E−11 | −1.5148597E−11 |
| A12 | 8.6236712E−14 | 3.7394692E−13 |
| A14 | −8.9175808E−16 | −2.2566110E−15 |
| A16 | 2.1111652E−18 | 4.7143463E−18 |

| Sn | 12 | 13 | 25 | 26 |
|---|---|---|---|---|
| KA | 1.0000000E+00 | 1.0000000E+00 | 1.0000000E+00 | 1.0000000E+00 |
| A4 | 3.2187312E−06 | 1.8750831E−05 | 7.2292880E−05 | 6.4773524E−05 |
| A6 | −7.2312947E−09 | 1.5052470E−08 | −1.0464306E−06 | −7.2733824E−07 |
| A8 | 1.3604904E−09 | 5.6154798E−10 | 1.5830268E−10 | −8.8961983E−09 |
| A10 | −2.5821712E−11 | −6.0553164E−12 | 1.7747624E−10 | 1.8280454E−10 |
| A12 | 2.2107859E−13 | −5.0066002E−14 | −1.9663228E−12 | 2.1030732E−12 |
| A14 | −2.3688980E−16 | 2.0024263E−15 | 1.8933730E−14 | −4.9102420E−14 |
| A16 | −9.4067921E−18 | −2.0364515E−17 | −3.6909421E−16 | −9.7288912E−17 |
| A18 | 6.2727240E−20 | 9.1840653E−20 | 3.7534281E−18 | 5.6340811E−18 |
| A20 | −1.2879702E−22 | −1.6020780E−22 | −1.2697247E−20 | −2.5654207E−20 |

| Sn | 29 | 30 |
|---|---|---|
| KA | 1.0000000E+00 | 1.0000000E+00 |
| A4 | 2.6575748E−04 | 2.5651525E−04 |
| A6 | −4.4619315E−06 | −3.9315229E−06 |
| A8 | 7.0886125E−08 | 5.2695476E−08 |
| A10 | −8.7416057E−10 | −4.6758153E−10 |
| A12 | 7.1836680E−12 | 1.7915042E−12 |
| A14 | −2.9310466E−14 | 1.0815507E−14 |
| A16 | −3.9780870E−17 | −1.7842569E−16 |
| A18 | 8.8894836E−19 | 9.1412431E−19 |
| A20 | −2.4948124E−21 | −1.7446793E−21 |

Tables 73 to 82 show the corresponding values of Conditional Expressions (1) to (35A) of the variable magnification optical systems of Examples 1 to 24. Preferable ranges of the conditional expressions may be set using the corresponding values of the examples shown in Tables 73 to 82 as the upper limits and the lower limits of the conditional expressions.

TABLE 73

| Expression | | | | | | |
|---|---|---|---|---|---|---|
| Number | | Example 1 | Example 2 | Example 3 | Example 4 | Example 5 |
| (1) | TLw/(fw × tan ωw) | 9.0383 | 8.4386 | 8.4684 | 8.3124 | 7.9166 |
| (2) | Bfw/(fw × tan ωw) | 1.3869 | 0.9360 | 0.6973 | 0.7556 | 1.1777 |
| (3) | Fnot × (TLt/ft) | 3.9549 | 3.6305 | 3.4072 | 3.6467 | 3.1255 |
| (4) | (fw × TLw × Fnot)/ft² | 0.7729 | 0.9598 | 0.5902 | 0.6903 | 0.7145 |
| (5) | tan ωw/Fnow | 0.1402 | 0.0973 | 0.1695 | 0.1398 | 0.1305 |
| (6) | TLt/TLw | 1.2183 | 1.4056 | 1.2830 | 1.4088 | 1.2500 |
| (7) | fFw/(−fMw) | 4.8989 | 1.7362 | 4.1183 | 4.0391 | 4.3512 |
| (8) | TLw/ft | 0.9897 | 0.8815 | 0.9221 | 0.8957 | 0.8593 |
| (9) | ft/fw | 4.2003 | 2.6908 | 4.4992 | 3.7497 | 3.4997 |
| (10) | fF1/fw | 2.3195 | 2.2196 | 3.1177 | 2.9762 | 2.6374 |
| (11) | fF1/(−fMw) | 4.8989 | 3.3401 | 4.1183 | 4.0391 | 4.3512 |
| (12) | fF1/(fw × ft)^{1/2} | 1.1318 | 1.3531 | 1.4698 | 1.5370 | 1.4098 |
| (13) | (−fMw)/(fw × ft)^{1/2} | 0.2310 | 0.4051 | 0.3569 | 0.3805 | 0.3240 |
| (14) | fF1/(ft/Fnot) | 1.8113 | 2.4169 | 1.9957 | 2.2939 | 2.1930 |
| (15) | DDL1STw/fF1 | 0.6340 | 0.3872 | 0.5588 | 0.2866 | 0.4192 |
| (16) | DDL1STw/TLw | 0.3537 | 0.3623 | 0.4199 | 0.2540 | 0.3676 |
| (17) | fw/fRw | 0.9123 | 1.5421 | 1.2559 | 1.5160 | 1.4776 |
| (18) | ft/fRt | 3.1826 | 2.2147 | 4.6399 | 4.0196 | 4.6985 |
| (19) | fR1/(fw × ft)^{1/2} | 0.4422 | 0.6628 | 0.6242 | 0.6694 | 0.7428 |
| (20) | fw/fR1 | 1.1034 | 0.9198 | 0.7553 | 0.7714 | 0.7196 |
| (21) | \|fIS/ft\| | 0.1127 | 0.2470 | 0.1683 | 0.1965 | 0.1732 |
| (22) | Ndn + 0.01 × νdn | 2.08446 | 2.1507 | 2.1395 | 2.2899 | 2.25529 |
| (23) | Ndp + 0.01 × νdp | 2.31240 | 2.31310 | 2.19069 | 2.36050 | 2.38800 |

TABLE 74

| Expres- | | | | | | |
|---|---|---|---|---|---|---|
| sion | | Exam- | Exam- | Exam- | Exam- | Exam- |
| Number | | ple 1 | ple 2 | ple 3 | ple 4 | ple 5 |
| (24) | νdFp_ave | 72.87 | 70.85 | 67.26 | 68.67 | 79.65 |
| (25) | dF1/fF1 | 0.2519 | 0.1191 | 0.1815 | 0.1434 | 0.1393 |
| (26) | GFave | 3.23 | 3.70 | 2.91 | 4.20 | 3.59 |
| (27) | fR1/fR3 | 0.2871 | — | — | — | — |
| (28) | fR1/(−fR2) | 0.5970 | — | — | — | — |
| (29) | fR1/(−fR3) | — | 1.0739 | — | — | — |
| (30) | fR2/(−fR3) | — | 1.5538 | — | — | — |
| (29A) | fR1/(−fR3) | — | — | — | — | 1.5360 |
| (30A) | fR2/(−fR3) | — | — | — | — | 0.9109 |
| (31) | fR1/fR2 | — | — | — | — | 1.6862 |
| (32) | fR2/fR4 | — | — | — | — | 0.1233 |
| (27A) | fR1/fR3 | — | — | — | — | — |
| (32A) | fR2/fR4 | — | — | — | — | — |
| (33) | fR3/fR5 | — | — | — | — | — |
| (34) | fR4/fR6 | — | — | — | — | — |
| (31A) | fR1/fR2 | — | — | 0.1642 | — | — |
| (35) | fR2/fR3 | — | — | 6.5700 | — | — |
| (36) | fR3/(−fR4) | — | — | 1.1269 | — | — |
| (31B) | fR1/fR2 | — | — | — | 1.5194 | — |
| (37) | fR3/fR4 | — | — | — | 0.2439 | — |
| (28A) | fR1/(−fR2) | — | — | — | — | — |
| (35A) | fR2/fR3 | — | — | — | — | — |

TABLE 75

| Expression | | | | | | |
|---|---|---|---|---|---|---|
| Number | | Example 6 | Example 7 | Example 8 | Example 9 | Example 10 |
| (1) | TLw/(fw × tan ωw) | 8.8818 | 8.4437 | 8.0617 | 7.6930 | 8.1365 |
| (2) | Bfw/(fw × tan ωw) | 0.9213 | 1.7917 | 0.7514 | 0.7643 | 0.9670 |
| (3) | Fnot × (TLt/ft) | 3.4928 | 3.3974 | 3.2917 | 3.1280 | 3.6550 |
| (4) | (fw × TLw × Fnot)/ft² | 0.7086 | 0.7620 | 0.9256 | 0.7901 | 0.7120 |
| (5) | tan ωw/Fnow | 0.1384 | 0.1454 | 0.1002 | 0.1081 | 0.1449 |
| (6) | TLt/TLw | 1.2972 | 1.2051 | 1.3217 | 1.3419 | 1.3617 |
| (7) | fFw/(−fMw) | 4.1500 | 4.6230 | 1.4891 | 1.6359 | 4.3079 |
| (8) | TLw/ft | 0.9349 | 0.9688 | 0.8648 | 0.8122 | 0.9161 |
| (9) | ft/fw | 3.7997 | 3.6997 | 2.6907 | 2.9502 | 3.7700 |
| (10) | fF1/fw | 2.4390 | 3.0808 | 2.1709 | 4.7335 | 3.0367 |
| (11) | fF1/(−fMw) | 4.1500 | 4.6230 | 3.5820 | 4.8755 | 4.3079 |
| (12) | fF1/(fw × ft)^{1/2} | 1.2512 | 1.6017 | 1.3235 | 2.7559 | 1.5640 |
| (13) | (−fMw)/(fw × ft)^{1/2} | 0.3015 | 0.3465 | 0.3695 | 0.5652 | 0.3631 |
| (14) | fF1/(ft/Fnot) | 1.8486 | 2.4232 | 2.3237 | 4.6048 | 2.3601 |
| (15) | DDL1STw/fF1 | 0.5523 | 0.4894 | 0.4631 | 0.2500 | 0.3120 |
| (16) | DDL1STw/TLw | 0.3792 | 0.4206 | 0.4321 | 0.4939 | 0.2743 |
| (17) | fw/fRw | 1.1402 | 1.0412 | 1.4031 | 1.2928 | 1.3614 |
| (18) | ft/fRt | 2.9940 | 4.0655 | 1.7730 | 1.5288 | 3.6898 |
| (19) | fR1/(fw × ft)^{1/2} | 0.3292 | 0.3171 | 1.1022 | 0.3871 | 0.6586 |
| (20) | fw/fR1 | 1.5584 | 1.6395 | 0.5531 | 1.5040 | 0.7821 |
| (21) | \|fIS/ft\| | 0.1547 | 0.1809 | 0.2252 | 0.3291 | 0.2996 |
| (22) | Ndn + 0.01 × νdn | 2.09646 | 2.13166 | 2.06757 | 2.27695 | 2.05938 |
| (23) | Ndp + 0.01 × νdp | 2.31240 | 2.32352 | 2.31310 | 2.38800 | 2.19069 |

TABLE 76

| Expres- | | | | | | |
|---|---|---|---|---|---|---|
| sion | | Exam- | Exam- | Exam- | Exam- | Exam- |
| Number | | ple 6 | ple 7 | ple 8 | ple 9 | ple 10 |
| (24) | νdFp_ave | 72.87 | 73.39 | 72.84 | 88.36 | 67.26 |
| (25) | dF1/fF1 | 0.1445 | 0.1085 | 0.1480 | 0.0365 | 0.1138 |
| (26) | GFave | 3.25 | 3.44 | 3.29 | 4.11 | 2.78 |
| (27) | fR1/fR3 | — | 0.1017 | — | — | — |
| (28) | fR1/(−fR2) | — | 0.6191 | — | — | — |
| (29) | fR1/(−fR3) | — | — | — | — | — |
| (30) | fR2/(−fR3) | — | — | — | — | — |
| (29A) | fR1/(−fR3) | — | — | — | — | — |
| (30A) | fR2/(−fR3) | — | — | — | — | — |
| (31) | fR1/fR2 | — | — | — | — | — |
| (32) | fR2/fR4 | — | — | — | — | — |
| (27A) | fR1/fR3 | — | — | — | 1.1086 | — |
| (32A) | fR2/fR4 | — | — | — | 1.3997 | — |
| (33) | fR3/fR5 | — | — | — | — | — |
| (34) | fR4/fR6 | — | — | — | — | — |
| (31A) | fR1/fR2 | — | — | — | — | 0.1136 |
| (35) | fR2/fR3 | — | — | — | — | 9.5491 |
| (36) | fR3/(−fR4) | — | — | — | — | 1.0333 |
| (31B) | fR1/fR2 | — | — | 1.7487 | — | — |
| (37) | fR3/fR4 | — | — | 0.2503 | — | — |
| (28A) | fR1/(−fR2) | 0.6193 | — | — | — | — |
| (35A) | fR2/fR3 | 0.5958 | — | — | — | — |

TABLE 77

| Expression | | | | | | |
|---|---|---|---|---|---|---|
| Number | | Example 11 | Example 12 | Example 13 | Example 14 | Example 15 |
| (1) | TLw/(fw × tan ωw) | 7.5413 | 8.0404 | 7.9241 | 7.6916 | 8.0547 |
| (2) | Bfw/(fw × tan ωw) | 0.7535 | 0.9622 | 1.0867 | 0.7421 | 0.9535 |
| (3) | Fnot × (TLt/ft) | 3.0309 | 3.5384 | 3.9235 | 3.1227 | 3.6230 |
| (4) | (fw × TLw × Fnot)/ft² | 0.7852 | 0.6945 | 0.5996 | 0.7870 | 0.7059 |
| (5) | tan ωw/Fnow | 0.1107 | 0.1440 | 0.1850 | 0.1155 | 0.1461 |
| (6) | TLt/TLw | 1.2908 | 1.3515 | 1.4379 | 1.2967 | 1.3615 |
| (7) | fFw/(−fMw) | 3.9579 | 3.3898 | 5.0685 | 3.5350 | 2.6785 |
| (8) | TLw/ft | 0.8097 | 0.8966 | 0.9376 | 0.8362 | 0.9113 |
| (9) | ft/fw | 2.9903 | 3.7696 | 4.5504 | 3.0600 | 3.7699 |
| (10) | fF1/fw | 2.2631 | 3.0233 | 3.7933 | 2.2769 | 3.1107 |
| (11) | fF1/(−fMw) | 3.9579 | 3.3898 | 5.0685 | 3.5350 | 2.6785 |
| (12) | fF1/(fw × ft)^{1/2} | 1.3087 | 1.5572 | 1.7783 | 1.3016 | 1.6021 |
| (13) | (−fMw)/(fw × ft)^{1/2} | 0.3306 | 0.4594 | 0.3508 | 0.3682 | 0.5981 |
| (14) | fF1/(ft/Fnot) | 2.1947 | 2.3419 | 2.4258 | 2.1430 | 2.4095 |
| (15) | DDL1STw/fF1 | 0.4180 | 0.3022 | 0.3389 | 0.3459 | 0.3202 |
| (16) | DDL1STw/TLw | 0.3906 | 0.2703 | 0.3013 | 0.3078 | 0.2899 |
| (17) | fw/fRw | 2.2564 | 1.2029 | 0.9778 | 1.5666 | 1.4197 |
| (18) | ft/fRt | 5.0687 | 3.2393 | 3.8301 | 3.7412 | 3.8932 |
| (19) | fR1/(fw × ft)^{1/2} | 0.7180 | 7.5241 | 0.8166 | 0.5872 | 0.6267 |
| (20) | fw/fR1 | 0.8054 | 0.0685 | 0.5741 | 0.9736 | 0.8218 |
| (21) | \|fIS/ft\| | 0.1912 | 0.2366 | 0.1645 | 0.2105 | 0.3081 |
| (22) | Ndn + 0.01 × νdn | 2.25529 | 2.05938 | 2.2058 | 2.0561 | 2.05938 |
| (23) | Ndp + 0.01 × νdp | 2.38800 | 2.19069 | 2.31240 | 2.38800 | 2.19069 |

TABLE 78

| Expres- | | | | | | |
|---|---|---|---|---|---|---|
| sion | | Exam- | Exam- | Exam- | Exam- | Exam- |
| Number | | ple 11 | ple 12 | ple 13 | ple 14 | ple 15 |
| (24) | νdFp_ave | 85.30 | 67.26 | 72.87 | 82.67 | 67.26 |
| (25) | dF1/fF1 | 0.1354 | 0.1147 | 0.1425 | 0.1566 | 0.1110 |
| (26) | GFave | 4.12 | 2.78 | 3.47 | 2.97 | 2.78 |
| (27) | fR1/fR3 | — | — | — | — | — |
| (28) | fR1/(−fR2) | — | — | — | — | — |
| (29) | fR1/(−fR3) | — | — | — | — | — |
| (30) | fR2/(−fR3) | — | — | — | — | — |
| (29A) | fR1/(−fR3) | 1.9087 | 1.4948 | — | — | — |
| (30A) | fR2/(−fR3) | 0.8825 | 0.1448 | — | — | — |
| (31) | fR1/fR2 | 2.1629 | 10.3200 | — | — | — |
| (32) | fR2/fR4 | 0.4851 | 1.2697 | — | — | — |
| (27A) | fR1/fR3 | — | — | 2.0598 | 2.0668 | 1.1200 |
| (32A) | fR2/fR4 | — | — | 0.9931 | 1.6305 | 17.9223 |
| (33) | fR3/fR5 | — | — | — | — | — |
| (34) | fR4/fR6 | — | — | — | — | — |
| (31A) | fR1/fR2 | — | — | — | — | — |
| (35) | fR2/fR3 | — | — | — | — | — |
| (36) | fR3/(−fR4) | — | — | — | — | — |
| (31B) | fR1/fR2 | — | — | — | — | — |
| (37) | fR3/fR4 | — | — | — | — | — |
| (28A) | fR1/(−fR2) | — | — | — | — | — |
| (35A) | fR2/fR3 | — | — | — | — | — |

TABLE 79

| Expression | | | | | | |
|---|---|---|---|---|---|---|
| Number | | Example 16 | Example 17 | Example 18 | Example 19 | Example 20 |
| (1) | TLw/(fw × tan ωw) | 7.5622 | 9.3478 | 8.2215 | 8.4499 | 8.4575 |
| (2) | Bfw/(fw × tan ωw) | 0.7866 | 0.8370 | 0.8469 | 1.4584 | 1.6241 |
| (3) | Fnot × (TLt/ft) | 3.2871 | 3.1618 | 3.2018 | 3.4496 | 3.5898 |
| (4) | (fw × TLw × Fnot)/ft² | 0.7951 | 0.6678 | 0.6742 | 0.7204 | 0.7340 |
| (5) | tan ωw/Fnow | 0.1084 | 0.1081 | 0.1403 | 0.1464 | 0.1480 |
| (6) | TLt/TLw | 1.4135 | 1.3339 | 1.2564 | 1.2601 | 1.2870 |
| (7) | fFw/(−fMw) | 2.1206 | 4.1364 | 3.4431 | 2.6431 | 2.8771 |
| (8) | TLw/ft | 0.8103 | 0.8202 | 0.8787 | 0.9440 | 0.9585 |
| (9) | ft/fw | 2.9248 | 3.5498 | 3.7801 | 3.7997 | 3.8000 |
| (10) | fF1/fw | 3.7547 | 2.5851 | 3.3737 | 4.4795 | 5.7521 |
| (11) | fF1/(−fMw) | 5.6583 | 4.1364 | 3.4431 | 6.1868 | 8.1546 |
| (12) | fF1/(fw × ft)^{1/2} | 2.1955 | 1.3721 | 1.7352 | 2.2980 | 2.9508 |
| (13) | (−fMw)/(fw × ft)^{1/2} | 0.3880 | 0.3317 | 0.5040 | 0.3714 | 0.3619 |
| (14) | fF1/(ft/Fnot) | 3.6844 | 2.1046 | 2.5883 | 3.4188 | 4.4049 |
| (15) | DDL1STw/fF1 | 0.2581 | 0.3589 | 0.3995 | 0.2601 | 0.2267 |
| (16) | DDL1STw/TLw | 0.4089 | 0.3187 | 0.4058 | 0.3248 | 0.3580 |
| (17) | fw/fRw | 1.6183 | 1.5997 | 1.2071 | 0.9915 | 1.0217 |
| (18) | ft/fRt | 2.7474 | 4.3747 | 3.5509 | 3.0401 | 3.2723 |
| (19) | fR1/(fw × ft)^{1/2} | 2.8047 | 0.5480 | 0.3820 | 0.8989 | 0.7184 |
| (20) | fw/fR1 | 0.2085 | 0.9686 | 1.3464 | 0.5707 | 0.7140 |
| (21) | \|fIS/ft\| | 0.2269 | 0.1761 | 0.2592 | 0.1905 | 0.1856 |
| (22) | Ndn + 0.01 × νdn | 2.27695 | 2.1507 | 2.1507 | 2.15075 | 2.1507 |
| (23) | Ndp + 0.01 × νdp | 2.38800 | 2.38800 | 2.38800 | 2.32352 | 2.32352 |

TABLE 80

| Expres- | | | | | | |
|---|---|---|---|---|---|---|
| sion | | Exam- | Exam- | Exam- | Exam- | Exam- |
| Number | | ple 16 | ple 17 | ple 18 | ple 19 | ple 20 |
| (24) | νdFp_ave | 79.65 | 82.67 | 82.67 | 82.57 | 76.45 |
| (25) | dF1/fF1 | 0.0796 | 0.1459 | 0.1262 | 0.0576 | 0.0530 |
| (26) | GFave | 3.72 | 3.18 | 3.18 | 3.91 | 3.10 |
| (27) | fR1/fR3 | — | — | — | — | — |
| (28) | fR1/(−fR2) | — | — | — | — | — |
| (29) | fR1/(−fR3) | — | — | — | — | — |
| (30) | fR2/(−fR3) | — | — | — | — | — |
| (29A) | fR1/(−fR3) | 7.5606 | — | — | — | — |
| (30A) | fR2/(−fR3) | 0.9223 | — | — | — | — |
| (31) | fR1/fR2 | 8.1973 | — | — | — | — |
| (32) | fR2/fR4 | 0.8348 | — | — | — | — |
| (27A) | fR1/fR3 | — | 0.7514 | 0.5716 | 2.7532 | 2.1074 |
| (32A) | fR2/fR4 | — | 4.3996 | 1.1930 | 1.4120 | 1.1445 |
| (33) | fR3/fR5 | — | 1.3478 | 1.2229 | — | — |
| (34) | fR4/fR6 | — | 2.0014 | 1.2938 | — | — |
| (31A) | fR1/fR2 | — | — | — | — | — |
| (35) | fR2/fR3 | — | — | — | — | — |
| (36) | fR3/(−fR4) | — | — | — | — | — |
| (31B) | fR1/fR2 | — | — | — | — | — |
| (37) | fR3/fR4 | — | — | — | — | — |
| (28A) | fR1/(−fR2) | — | — | — | — | — |
| (35A) | fR2/fR3 | — | — | — | — | — |

TABLE 81

| Expression | | | | | |
|---|---|---|---|---|---|
| Number | | Example 21 | Example 22 | Example 23 | Example 24 |
| (1) | TLw/(fw × tan ωw) | 8.2868 | 7.6375 | 8.3503 | 8.8122 |
| (2) | Bfw/(fw × tan ωw) | 1.0122 | 0.7710 | 0.7576 | 0.7693 |
| (3) | Fnot × (TLt/ft) | 3.8435 | 3.7298 | 3.8486 | 3.2808 |
| (4) | (fw × TLw × Fnot)/ft² | 0.7529 | 0.6576 | 0.6826 | 0.7190 |
| (5) | tan ωw/Fnow | 0.1508 | 0.1437 | 0.1403 | 0.1075 |
| (6) | TLt/TLw | 1.3614 | 1.5085 | 1.4918 | 1.3829 |
| (7) | fFw/(−fMw) | 3.9506 | 2.7154 | 2.3917 | 4.0992 |
| (8) | TLw/ft | 0.9702 | 0.8497 | 0.8927 | 0.8266 |
| (9) | ft/fw | 3.7496 | 3.7600 | 3.7795 | 3.2999 |
| (10) | fF1/fw | 2.8560 | 6.8963 | 7.6118 | 2.6357 |
| (11) | fF1/(−fMw) | 3.9506 | 10.9740 | 10.2890 | 4.0992 |
| (12) | fF1/(fw × ft)^{1/2} | 1.4749 | 3.5565 | 3.9154 | 1.4509 |
| (13) | (−fMw)/(fw × ft)^{1/2} | 0.3733 | 0.3241 | 0.3805 | 0.3540 |
| (14) | fF1/(ft/Fnot) | 2.2165 | 5.3373 | 5.8204 | 2.2923 |
| (15) | DDL1STw/fF1 | 0.3989 | 0.815 | 0.1741 | 0.3125 |
| (16) | DDL1STw/TLw | 0.3132 | 0.3919 | 0.3929 | 0.3019 |
| (17) | fw/fRw | 1.0214 | 1.3287 | 1.2547 | 1.7030 |
| (18) | ft/fRt | 2.8212 | 3.9515 | 3.0933 | 4.1924 |
| (19) | fR1/(fw × ft)^{1/2} | 0.5137 | 0.4184 | 0.6186 | 0.6478 |
| (20) | fw/fR1 | 1.0052 | 1.2325 | 0.8315 | 0.8498 |
| (21) | \|fIS/ft\| | 0.1928 | 0.1672 | 0.1957 | 0.1949 |
| (22) | Ndn + 0.01 × νdn | 2.17376 | 2.2058 | 2.2279 | 2.1507 |
| (23) | Ndp + 0.01 × νdp | 2.32352 | 2.38800 | 2.38800 | 2.38800 |

TABLE 82

| Expression | | | | | |
|---|---|---|---|---|---|
| Number | | Example 21 | Example 22 | Example 23 | Example 24 |
| (24) | νdFp_ave | 73.39 | 84.90 | 79.65 | 82.67 |
| (25) | dF1/fF1 | 0.1435 | 0.0377 | 0.0403 | 0.1475 |
| (26) | GFave | 3.58 | 3.76 | 3.48 | 3.18 |
| (27) | fR1/fR3 | — | — | — | — |
| (28) | fR1/(−fR2) | — | — | — | — |
| (29) | fR1/(−fR3) | — | — | — | — |
| (30) | fR2/(−fR3) | — | — | — | — |
| (29A) | fR1/(−fR3) | — | — | — | — |
| (30A) | fR2/(−fR3) | — | — | — | — |
| (31) | fR1/fR2 | — | — | — | — |
| (32) | fR2/fR4 | — | — | — | — |
| (27A) | fR1/fR3 | 0.8601 | 1.4986 | 1.3409 | — |
| (32A) | fR2/fR4 | 2.5727 | 1.0457 | 1.8477 | — |
| (33) | fR3/fR5 | 0.3672 | — | 0.8603 | — |
| (34) | fR4/fR6 | 0.0459 | — | 1.4565 | — |
| (31A) | fR1/fR2 | — | — | — | 0.3391 |
| (35) | fR2/fR3 | — | — | — | 1.7857 |
| (36) | fR3/(−fR4) | — | — | — | 1.1361 |
| (31B) | fR1/fR2 | — | — | — | — |
| (37) | fR3/fR4 | — | — | — | — |
| (28A) | fR1/(−fR2) | — | — | — | — |
| (35A) | fR2/fR3 | — | — | — | — |

The variable magnification optical systems of Examples 1 to 24 are configured to have a small size and implements a small F-number such that the F-number is less than or equal to 3.3 in the entire magnification range. Particularly, in a part of the examples, the F-number is less than or equal to 3 in the entire magnification range. In addition, in the variable magnification optical systems of Examples 1 to 24, high optical performance is maintained by favorably correcting various aberrations in the entire magnification range.

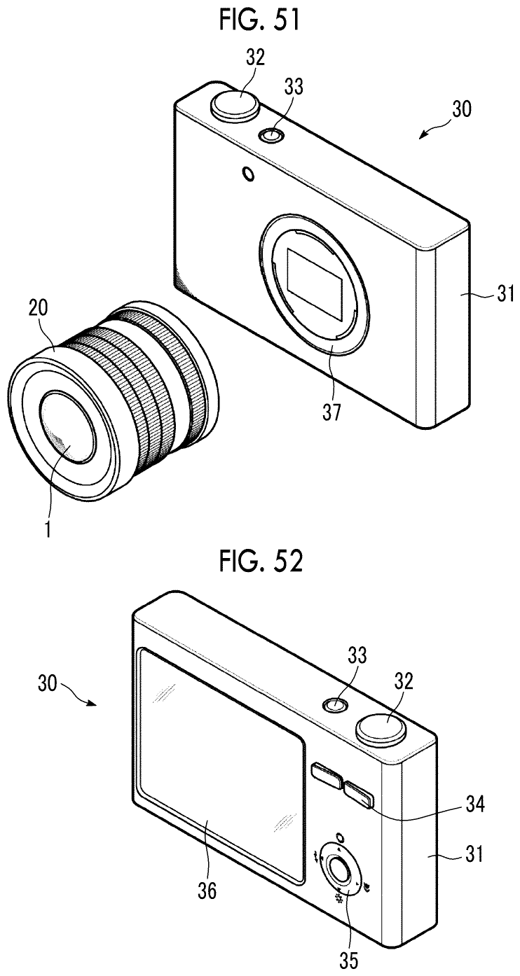

Next, an imaging apparatus according to the embodiment of the present disclosure will be described. FIGS. 51 and 52 illustrate external views of a camera 30 that is the imaging apparatus according to one embodiment of the present disclosure. FIG. 51 illustrates a perspective view of the camera 30 seen from a front surface side, and FIG. 52 illustrates a perspective view of the camera 30 seen from a rear surface side. The camera 30 is a so-called mirrorless type digital camera on which an interchangeable lens 20 can be attachably and detachably mounted. The interchangeable lens 20 is configured to include a variable magnification optical system 1 according to one embodiment of the present disclosure accommodated in a lens barrel.

The camera 30 comprises a camera body 31, and a shutter button 32 and a power button 33 are provided on an upper surface of the camera body 31. In addition, an operating part 34, an operating part 35, and a display unit 36 are provided on a rear surface of the camera body 31. The display unit 36 can display a captured image and an image within an angle of view before being captured.

An imaging opening on which light from an imaging target is incident is provided in a center portion of a front surface of the camera body 31, and a mount 37 is provided at a position corresponding to the imaging opening. The interchangeable lens 20 is mounted on the camera body 31 through the mount 37.

An imaging element such as a charge coupled device (CCD) or a complementary metal oxide semiconductor (CMOS) that outputs an imaging signal corresponding to a subject image formed by the interchangeable lens 20, a signal processing circuit that processes the imaging signal output from the imaging element to generate an image, a recording medium for recording the generated image, and the like are provided in the camera body 31. In the camera 30, a static image or a video can be captured by pressing the shutter button 32, and image data obtained by this capturing is recorded on the recording medium.

While the disclosed technology has been described above using the embodiment and the examples, the disclosed technology is not limited to the embodiment and the examples, and various modifications can be made. For example, the curvature radius, the surface spacing, the refractive index, the Abbe number, and the aspherical coefficient of each lens are not limited to the values shown in each example and may have other values.

In addition, the imaging apparatus according to the embodiment of the present disclosure is not limited to the above example and can have various aspects of, for example, a camera of a type other than a mirrorless type, a film camera, a video camera, and a security camera.

The following appendixes are further disclosed with respect to the embodiment and the examples described above.

### Appendix 1

A variable magnification optical system consisting of a front group, a middle group, and a rear group in this order from an object side to an image side, in which the front group consists of two lens groups or less having a positive refractive power, the middle group consists of two lens groups or less having a negative refractive power, the rear group consists of a plurality of lens groups, a lens group of the rear group closest to the object side has a positive refractive power, during changing magnification, a lens group of the front group closest to the object side moves, and spacings between all adjacent lens groups change, and in a case where a sum of a back focus of an entire system as an air conversion distance and a distance on an optical axis from a lens surface of the front group closest to the object side to a lens surface of the rear group closest to the image side in a state where an infinite distance object is focused on at a wide angle end is denoted by TLw, a focal length of the entire system in the state where the infinite distance object is focused on at the wide angle end is denoted by fw, a maximum half angle of view in the state where the infinite distance object is focused on at the wide angle end is denoted by ow, the back focus of the entire system as the air conversion distance in the state where the infinite distance object is focused on at the wide angle end is denoted by Bfw, an open F-number in a state where the infinite distance object is focused on at a telephoto end is denoted by Fnot, a sum of the back focus of the entire system as the air conversion distance and the distance on the optical axis from the lens surface of the front group closest to the object side to the lens surface of the rear group closest to the image side in the state where the infinite distance object is focused on at the telephoto end is denoted by TLt, and the focal length of the entire system in the state where the infinite distance object is focused on at the telephoto end is denoted by ft, Conditional Expressions (1), (2), and (3) are satisfied, which are represented by

$$5 < TLw / ( fw \times tan ω w ) < 12 \qquad ( 1 )$$

$$0.5 < Bfw / ( fw \times tan ω w ) < 2.5 \qquad ( 2 )$$

$$1.8 < Fnot \times ( TLt / ft ) < 5. \qquad ( 3 )$$

### Appendix 2

The variable magnification optical system according to Appendix 1, in which Conditional Expression (3-1) is satisfied, which is represented by

$$1.9 < Fnot \times ( TLt / ft ) < 4.6 . \qquad ( 3 - 1 )$$

### Appendix 3

The variable magnification optical system according to Appendix 2, in which Conditional Expression (3-2) is satisfied, which is represented by

$$2 < Fnot \times ( TLt / ft ) < 4.3 . \qquad ( 3 - 2 )$$

### Appendix 4

The variable magnification optical system according to Appendix 3, in which Conditional Expression (3-3) is satisfied, which is represented by

$$2.2 < Fnot \times ( TLt / ft ) < 4. \qquad ( 3 - 3 )$$

### Appendix 5

The variable magnification optical system according to any one of Appendixes 1 to 4, in which Conditional Expression (4) is satisfied, which is represented by

$$0.34 < ( fw \times TLw \times Fnot ) / {ft}^{2} < 0 \text{.97} . \qquad ( 4 )$$

### Appendix 6

The variable magnification optical system according to Appendix 5, in which Conditional Expression (4-1) is satisfied, which is represented by

$$0.36 < ( fw \times TLw \times Fnot ) / {ft}^{2} < 0 \text{.92} . \qquad ( 4 - 1 )$$

### Appendix 7

The variable magnification optical system according to Appendix 6, in which Conditional Expression (4-2) is satisfied, which is represented by

$$0.38 < ( fw \times TLw \times Fnot ) / {ft}^{2} < 0.87 . \qquad ( 4 - 2 )$$

### Appendix 8

The variable magnification optical system according to Appendix 7, in which Conditional Expression (4-3) is satisfied, which is represented by

$$0.41 < ( fw \times TLw \times Fnot ) / {ft}^{2} < 0.8 . \qquad ( 4 - 3 )$$

### Appendix 9

The variable magnification optical system according to any one of Appendixes 1 to 8, in which in a case where the open F-number in the state where the infinite distance object is focused on at the wide angle end is denoted by Fnow, Conditional Expression (5) is satisfied, which is represented by

$$0.075 < tan ω w / Fnow < 0.3 . \qquad ( 5 )$$

### Appendix 10

The variable magnification optical system according to Appendix 9, in which Conditional Expression (5-1) is satisfied, which is represented by

$$0.092 < tan ω w / Fnow < 0.27 . \qquad ( 5 - 1 )$$

### Appendix 11

The variable magnification optical system according to Appendix 10, in which Conditional Expression (5-2) is satisfied, which is represented by

$$0.105 < tan ω w / Fnow < 0.25 . \qquad ( 5 - 2 )$$

### Appendix 12

The variable magnification optical system according to any one of Appendixes 1 to 11, in which Conditional Expression (6) is satisfied, which is represented by

$$1.1 < TLt / TLw < 1.9 . \qquad ( 6 )$$

### Appendix 13

The variable magnification optical system according to Appendix 12, in which Conditional Expression (6-1) is satisfied, which is represented by

$$1.15 < TLt / TLw < 1.48 . \qquad ( 6 - 1 )$$

### Appendix 14

The variable magnification optical system according to any one of Appendixes 1 to 13, in which in a case where a focal length of the front group in the state where the infinite distance object is focused on at the wide angle end is denoted by fFw, and a focal length of the middle group in the state where the infinite distance object is focused on at the wide angle end is denoted by fMw, Conditional Expression (7) is satisfied, which is denoted by

$$0.8 < fFw / ( - fMw ) < 8. \qquad ( 7 )$$

### Appendix 15

The variable magnification optical system according to Appendix 14, in which Conditional Expression (7-1) is satisfied, which is represented by

$$1.1 < fFw / ( - fMw ) < 5.3 . \qquad ( 7 - 1 )$$

### Appendix 16

The variable magnification optical system according to any one of Appendixes 1 to 15, in which Conditional Expression (8) is satisfied, which is represented by

$$0.8 < TLw / f t < 1.5 . \qquad ( 8 )$$

### Appendix 17

The variable magnification optical system according to any one of Appendixes 1 to 16, in which the rear group includes an Lp1 lens having a positive refractive power and an Ln1 lens that is disposed adjacent to the image side of the Lp1 lens and that has a negative refractive power, a surface of the Lp1 lens on the image side has an aspherical shape in which a refractive power at a position of a maximum effective diameter is shifted in a negative direction compared to a refractive power in a paraxial region, and a surface of the Ln1 lens on the object side has an aspherical shape in which a refractive power at a position of a maximum effective diameter is shifted in a positive direction compared to a refractive power in the paraxial region.

### Appendix 18

The variable magnification optical system according to any one of Appendixes 1 to 17, in which the rear group includes an Ln2 lens having a negative refractive power and an Lp2 lens that is disposed adjacent to the image side of the Ln2 lens and that has a positive refractive power, a surface of the Ln2 lens on the object side has an aspherical shape in which a refractive power at a position of a maximum effective diameter is shifted in a negative direction compared to a refractive power in a paraxial region, and a surface of the Ln2 lens on the image side has an aspherical shape in which a refractive power at a position of a maximum effective diameter is shifted in a positive direction compared to a refractive power in the paraxial region.

### Appendix 19

The variable magnification optical system according to any one of Appendixes 1 to 18, in which Conditional Expression (9) is satisfied, which is represented by

$$2.1 < f t / fw < 6. \qquad ( 9 )$$

### Appendix 20

The variable magnification optical system according to any one of Appendixes 1 to 19, in which in a case where a focal length of the lens group of the front group closest to the object side is denoted by fF1, Conditional Expression (10) is satisfied, which is represented by

$$1. 5 < fF 1 / fw < 12. \qquad ( 10 )$$

### Appendix 21

The variable magnification optical system according to any one of Appendixes 1 to 20, in which in a case where a focal length of the lens group of the front group closest to the object side is denoted by fF1, and a focal length of the middle group in the state where the infinite distance object is focused on at the wide angle end is denoted by fMw, Conditional Expression (11) is satisfied, which is denoted by

$$2 < fF 1 / ( - fMw ) < 13. \qquad ( 11 )$$

### Appendix 22

The variable magnification optical system according to any one of Appendixes 1 to 21, in which in a case where a focal length of the lens group of the front group closest to the object side is denoted by fF1, Conditional Expression (12) is satisfied, which is represented by

$$0.7 < fF 1 / {( fw \times f t )}^{1 / 2} < 4.7 . \qquad ( 12 )$$

### Appendix 23

The variable magnification optical system according to any one of Appendixes 1 to 22, in which in a case where a focal length of the middle group in the state where the infinite distance object is focused on at the wide angle end is denoted by fMw, Conditional Expression (13) is satisfied, which is denoted by

$$0.18 < ( - f Mw ) / {( fw \times f t )}^{1 / 2} < 0.8 . \qquad ( 13 )$$

### Appendix 24

The variable magnification optical system according to any one of Appendixes 1 to 23, in which in a case where a focal length of the lens group of the front group closest to the object side is denoted by fF1, Conditional Expression (14) is satisfied, which is represented by

$$1.3 < fF 1 / ( f t / Fnot ) < 8. \qquad ( 14 )$$

### Appendix 25

The variable magnification optical system according to Appendix 24, in which Conditional Expression (14-1) is satisfied, which is represented by

$$1.75 < fF 1 / ( f t / Fnot ) < 2.7 . \qquad ( 14 - 1 )$$

### Appendix 26

The variable magnification optical system according to any one of Appendixes 1 to 25, in which the variable magnification optical system includes an aperture stop disposed on the image side with respect to a lens surface of the middle group closest to the image side, and in a case where a distance on the optical axis from the lens surface of the front group closest to the object side to the aperture stop in the state where the infinite distance object is focused on at the wide angle end is denoted by DDL1STw, and a focal length of the lens group of the front group closest to the object side is denoted by fF1, Conditional Expression (15) is satisfied, which is represented by

$$0.1 < DDL 1 STw / fF 1 < 0.9 . \qquad ( 15 )$$

### Appendix 27

The variable magnification optical system according to any one of Appendixes 1 to 26, in which the variable magnification optical system includes an aperture stop, and in a case where a distance on the optical axis from the lens surface of the front group closest to the object side to the aperture stop in the state where the infinite distance object is focused on at the wide angle end is denoted by DDL1STw, Conditional Expression (16) is satisfied, which is represented by

$$0.18 < DDL 1 STw / TLw < 0.75 . \qquad ( 16 )$$

### Appendix 28

The variable magnification optical system according to any one of Appendixes 1 to 27, in which in a case where a focal length of the rear group in the state where the infinite distance object is focused on at the wide angle end is denoted by fRw, Conditional Expression (17) is satisfied, which is represented by

$$0.7 < fw / fRw < 3. \qquad ( 17 )$$

### Appendix 29

The variable magnification optical system according to any one of Appendixes 1 to 28, in which in a case where a focal length of the rear group in the state where the infinite distance object is focused on at the telephoto end is denoted by fRt, Conditional Expression (18) is satisfied, which is represented by

$$1 < f t / fRt < 7. \qquad ( 18 )$$

### Appendix 30

The variable magnification optical system according to any one of Appendixes 1 to 29, in which in a case where a focal length of the lens group of the rear group closest to the object side is denoted by fR1, Conditional Expression (19) is satisfied, which is represented by

$$0.05 < fR 1 / {( fw \times f t )}^{1 / 2} < 3. \qquad ( 19 )$$

### Appendix 31

The variable magnification optical system according to any one of Appendixes 1 to 30, in which in a case where a focal length of the lens group of the rear group closest to the object side is denoted by fR1, Conditional Expression (20) is satisfied, which is represented by

$$0.05 < fw / fR 1 < 2.5 . \qquad ( 20 )$$

### Appendix 32

The variable magnification optical system according to any one of Appendixes 1 to 31, in which at least one lens group that does not move during changing the magnification is disposed between the front group and a lens group of the rear group closest to the image side.

### Appendix 33

The variable magnification optical system according to any one of Appendixes 1 to 32, in which a vibration-proof group that moves in a direction intersecting with the optical axis during image shake correction is disposed on the image side with respect to the front group, and in a case where a focal length of the vibration-proof group is denoted by fIS, Conditional Expression (21) is satisfied, which is represented by

$$0.07 < \vert fIS / f t \vert < 0.5 . \qquad ( 21 )$$

### Appendix 34

The variable magnification optical system according to Appendix 33, in which the vibration-proof group is disposed in the middle group.

### Appendix 35

The variable magnification optical system according to Appendix 1, in which a focusing group that moves along the optical axis during focusing is disposed in only the rear group.

### Appendix 36

The variable magnification optical system according to Appendix 35, in which two of the focusing groups are disposed in the rear group.

### Appendix 37

The variable magnification optical system according to any one of Appendixes 1 to 36, in which the front group includes a cemented lens obtained by bonding a negative meniscus lens having a convex surface toward the object side and a positive lens having a convex surface toward the object side to each other in this order from the object side, and in a case where a refractive index of the negative meniscus lens with respect to a d line is denoted by Ndn, and an Abbe number of the negative meniscus lens based on the d line is denoted by vdn, Conditional Expression (22) is satisfied, which is represented by

$$1.94 < N d n + 0.01 \times v d n < 2.5 . \qquad ( 22 )$$

### Appendix 38

The variable magnification optical system according to Appendix 37, in which in a case where a refractive index of the positive lens with respect to the d line is denoted by Ndp, and an Abbe number of the positive lens based on the d line is denoted by vdp, Conditional Expression (23) is satisfied, which is represented by

$$2 < N d p + 0.01 \times v d p < 2.6 . \qquad ( 23 )$$

### Appendix 39

The variable magnification optical system according to any one of Appendixes 1 to 38, in which in a case where an average value of Abbe numbers of all positive lenses in the front group based on a d line is denoted by vdFp_ave, Conditional Expression (24) is satisfied, which is represented by

$$55 < vdFp\_ave < 95. \qquad ( 24 )$$

### Appendix 40

The variable magnification optical system according to any one of Appendixes 1 to 39, in which in a case where a thickness of the lens group of the front group closest to the object side on the optical axis is denoted by dF1, and a focal length of the lens group of the front group closest to the object side is denoted by fF1, Conditional Expression (25) is satisfied, which is represented by

$$0.03 < dF 1 / fF 1 < 0.35 . \qquad ( 25 )$$

### Appendix 41

The variable magnification optical system according to any one of Appendixes 1 to 40, in which in a case where an average value of specific gravities of all lenses in the front group is denoted by GFave, Conditional Expression (26) is satisfied, which is represented by

$$2 < GFave < 4.3 . \qquad ( 26 )$$

### Appendix 42

The variable magnification optical system according to any one of Appendixes 1 to 41, in which the rear group consists of a first subsequent lens group having a positive refractive power, a second subsequent lens group having a negative refractive power, and a third subsequent lens group having a positive refractive power in this order from the object side to the image side.

### Appendix 43

The variable magnification optical system according to Appendix 42, in which in a case where a focal length of the first subsequent lens group is denoted by fR1, and a focal length of the third subsequent lens group is denoted by fR3, Conditional Expression (27) is satisfied, which is represented by

$$0.05 < fR 1 / fR 3 < 0.6 . \qquad ( 27 )$$

### Appendix 44

The variable magnification optical system according to Appendix 42 or 43, in which in a case where a focal length of the first subsequent lens group is denoted by fR1, and a focal length of the second subsequent lens group is denoted by fR2, Conditional Expression (28) is satisfied, which is represented by

$$0.2 < fR 1 / ( - fR 2 ) < 1. \qquad ( 28 )$$

### Appendix 45

The variable magnification optical system according to any one of Appendixes 1 to 41, in which the rear group consists of a first subsequent lens group having a positive refractive power, a second subsequent lens group having a positive refractive power, and a third subsequent lens group having a negative refractive power in this order from the object side to the image side.

### Appendix 46

The variable magnification optical system according to Appendix 45, in which in a case where a focal length of the first subsequent lens group is denoted by fR1, and a focal length of the third subsequent lens group is denoted by fR3, Conditional Expression (29) is satisfied, which is represented by

$$0.5 < fR 1 / ( - fR 3 ) < 1.6 . \qquad ( 29 )$$

### Appendix 47

The variable magnification optical system according to Appendix 45 or 46, in which in a case where a focal length of the second subsequent lens group is denoted by fR2, and a focal length of the third subsequent lens group is denoted by fR3, Conditional Expression (30) is satisfied, which is represented by

$$0 \text{.8} < fR 2 / ( - fR 3 ) < 3. \qquad ( 30 )$$

### Appendix 48

The variable magnification optical system according to any one of Appendixes 1 to 41, in which the rear group includes at least a first subsequent lens group having a positive refractive power, a second subsequent lens group having a positive refractive power, a third subsequent lens group having a negative refractive power, and a fourth subsequent lens group having a positive refractive power consecutively in this order from a side closest to the object side to the image side.

### Appendix 49

The variable magnification optical system according to Appendix 48, in which in a case where a focal length of the first subsequent lens group is denoted by fR1, and a focal length of the third subsequent lens group is denoted by fR3, Conditional Expression (29A) is satisfied, which is represented by

$$0.9 < fR 1 / ( - fR 3 ) < 10. \qquad ( 29 A )$$

### Appendix 50

The variable magnification optical system according to Appendix 48 or 49, in which in a case where a focal length of the second subsequent lens group is denoted by fR2, and a focal length of the third subsequent lens group is denoted by fR3, Conditional Expression (30A) is satisfied, which is represented by

$$0 \text{.1} < fR 2 / ( - fR 3 ) < 1.8 . \qquad ( 30 A )$$

### Appendix 51

The variable magnification optical system according to any one of Appendixes 48 to 50, in which in a case where a focal length of the first subsequent lens group is denoted by fR1, and a focal length of the second subsequent lens group is denoted by fR2, Conditional Expression (31) is satisfied, which is represented by

$$1. 2 < fR 1 / fR 2 < 11. \qquad ( 31 )$$

### Appendix 52

The variable magnification optical system according to any one of Appendixes 48 to 51, in which in a case where a focal length of the second subsequent lens group is denoted by fR2, and a focal length of the fourth subsequent lens group is denoted by fR4, Conditional Expression (32) is satisfied, which is represented by

$$0 \text{.1} < fR 2 / fR 4 < 1.5 . \qquad ( 32 )$$

### Appendix 53

The variable magnification optical system according to any one of Appendixes 1 to 41, in which the rear group includes at least a first subsequent lens group having a positive refractive power, a second subsequent lens group having a negative refractive power, a third subsequent lens group having a positive refractive power, and a fourth subsequent lens group having a negative refractive power consecutively in this order from a side closest to the object side to the image side.

### Appendix 54

The variable magnification optical system according to Appendix 53, in which in a case where a focal length of the first subsequent lens group is denoted by fR1, and a focal length of the third subsequent lens group is denoted by fR3, Conditional Expression (27A) is satisfied, which is represented by

$$0.25 < fR 1 / fR 3 < 6. \qquad ( 27 A )$$

### Appendix 55

The variable magnification optical system according to Appendix 53 or 54, in which in a case where a focal length of the second subsequent lens group is denoted by fR2, and a focal length of the fourth subsequent lens group is denoted by fR4, Conditional Expression (32A) is satisfied, which is represented by

$$0.4 < fR 2 / fR 4 < 18. \qquad ( 32 A )$$

### Appendix 56

The variable magnification optical system according to any one of Appendixes 53 to 55, in which the rear group consists of the first subsequent lens group having a positive refractive power, the second subsequent lens group having a negative refractive power, the third subsequent lens group having a positive refractive power, the fourth subsequent lens group having a negative refractive power, a fifth subsequent lens group having a positive refractive power, and a sixth subsequent lens group having a negative refractive power in this order from the object side to the image side.

### Appendix 57

The variable magnification optical system according to Appendix 56, in which in a case where a focal length of the third subsequent lens group is denoted by fR3, and a focal length of the fifth subsequent lens group is denoted by fR5, Conditional Expression (33) is satisfied, which is represented by

$$0.2 < fR 3 / fR 5 < 2.5 . \qquad ( 33 )$$

### Appendix 58

The variable magnification optical system according to Appendix 56 or 57, in which in a case where a focal length of the fourth subsequent lens group is denoted by fR4, and a focal length of the sixth subsequent lens group is denoted by fR6, Conditional Expression (34) is satisfied, which is represented by

$$0.04 < fR 4 / fR 6 < 4. \qquad ( 34 )$$

### Appendix 59

The variable magnification optical system according to any one of Appendixes 1 to 41, in which the rear group includes at least a first subsequent lens group having a positive refractive power, a second subsequent lens group having a positive refractive power, a third subsequent lens group having a positive refractive power, and a fourth subsequent lens group having a negative refractive power consecutively in this order from a side closest to the object side to the image side.

### Appendix 60

The variable magnification optical system according to Appendix 59, in which in a case where a focal length of the first subsequent lens group is denoted by fR1, and a focal length of the second subsequent lens group is denoted by fR2, Conditional Expression (31A) is satisfied, which is represented by

$$0.06 < fR 1 / fR 2 < 0.7 . \qquad ( 31 A )$$

### Appendix 61

The variable magnification optical system according to Appendix 59 or 60, in which in a case where a focal length of the second subsequent lens group is denoted by fR2, and a focal length of the third subsequent lens group is denoted by fR3, Conditional Expression (35) is satisfied, which is represented by

$$0 \text{.5} < fR 2 / fR 3 < 11. \qquad ( 35 )$$

### Appendix 62

The variable magnification optical system according to any one of Appendixes 59 to 61, in which in a case where a focal length of the third subsequent lens group is denoted by fR3, and a focal length of the fourth subsequent lens group is denoted by fR4, Conditional Expression (36) is satisfied, which is represented by

$$0.2 < fR 3 / ( - fR 4 ) < 3. \qquad ( 36 )$$

### Appendix 63

The variable magnification optical system according to any one of Appendixes 1 to 41, in which the rear group consists of a first subsequent lens group having a positive refractive power, a second subsequent lens group having a positive refractive power, a third subsequent lens group having a negative refractive power, and a fourth subsequent lens group having a negative refractive power in this order from the object side to the image side.

### Appendix 64

The variable magnification optical system according to Appendix 63, in which in a case where a focal length of the first subsequent lens group is denoted by fR1, and a focal length of the second subsequent lens group is denoted by fR2, Conditional Expression (31B) is satisfied, which is represented by

$$0.6 < fR 1 / fR 2 < 4. \qquad ( 31 B )$$

### Appendix 65

The variable magnification optical system according to Appendix 63 or 64, in which in a case where a focal length of the third subsequent lens group is denoted by fR3, and a focal length of the fourth subsequent lens group is denoted by fR4, Conditional Expression (37) is satisfied, which is represented by

$$0.05 < fR 3 / fR 4 < 1. \qquad ( 37 )$$

### Appendix 66

The variable magnification optical system according to any one of Appendixes 1 to 41, in which the rear group includes at least a first subsequent lens group having a positive refractive power, a second subsequent lens group having a negative refractive power, and a third subsequent lens group having a negative refractive power consecutively in this order from a side closest to the object side to the image side.

### Appendix 67

The variable magnification optical system according to Appendix 66, in which in a case where a focal length of the first subsequent lens group is denoted by fR1, and a focal length of the second subsequent lens group is denoted by fR2, Conditional Expression (28A) is satisfied, which is represented by

$$0.2 < fR 1 / ( - fR 2 ) < 1. \qquad ( 28 A )$$

### Appendix 68

The variable magnification optical system according to Appendix 66 or 67, in which in a case where a focal length of the second subsequent lens group is denoted by fR2, and a focal length of the third subsequent lens group is denoted by fR3, Conditional Expression (35A) is satisfied, which is represented by

$$0.2 < fR 2 / fR 3 < 1. \qquad ( 35 A )$$

### Appendix 69

An imaging apparatus comprising the variable magnification optical system according to any one of Appendixes 1 to 68.

What is claimed is:

1. A variable magnification optical system consisting of a front group, a middle group, and a rear group in this order from an object side to an image side,
wherein the front group consists of two lens groups or less having a positive refractive power,
the middle group consists of two lens groups or less having a negative refractive power,
the rear group consists of a plurality of lens groups,
a lens group of the rear group closest to the object side has a positive refractive power,
during changing magnification, a lens group of the front group closest to the object side moves, and spacings between all adjacent lens groups change, and
in a case where a sum of a back focus of the variable magnification optical system as an air conversion distance and a distance on an optical axis from a lens surface of the front group closest to the object side to a lens surface of the rear group closest to the image side in a state where an infinite distance object is focused on at a wide angle end is denoted by TLw, a focal length of the variable magnification optical system in the state where the infinite distance object is focused on at the wide angle end is denoted by fw, a maximum half angle of view in the state where the infinite distance object is focused on at the wide angle end is denoted by ww, the back focus of the variable magnification optical system as the air conversion distance in the state where the infinite distance object is focused on at the wide angle end is denoted by Bfw, an open F-number in a state where the infinite distance object is focused on at a telephoto end is denoted by Fnot, a sum of the back focus of the variable magnification optical system as the air conversion distance and the distance on the optical axis from the lens surface of the front group closest to the object side to the lens surface of the rear group closest to the image side in the state where the infinite distance object is focused on at the telephoto end is denoted by TLt, and the focal length of the variable magnification optical system in the state where the infinite distance object is focused on at the telephoto end is denoted by ft, Conditional Expressions (1), (2), and (3) are satisfied, which are represented by
$$5 < TLw / ( fw \times tan ω w ) < 12 \qquad ( 1 )$$
$$0.5 < Bfw / ( fw \times tan ω w ) < 2.5 \qquad ( 2 )$$
$$1.8 < Fnot \times ( TLt / ft ) < 5. \qquad ( 3 )$$

2. The variable magnification optical system according to claim 1,
wherein Conditional Expression (3-1) is satisfied, which is represented by
$$1. 9 < Fnot \times ( TLt / ft ) < 4.6 . \qquad ( 3 - 1 )$$

3. The variable magnification optical system according to claim 2,
wherein Conditional Expression (3-2) is satisfied, which is represented by
$$2 < Fnot \times ( TLt / ft ) < 4.3 . \qquad ( 3 - 2 )$$

4. The variable magnification optical system according to claim 3,
wherein Conditional Expression (3-3) is satisfied, which is represented by
$$2.2 < Fnot \times ( TLt / ft ) < 4. \qquad ( 3 - 3 )$$

5. The variable magnification optical system according to claim 1,
wherein Conditional Expression (4) is satisfied, which is represented by
$$0.34 < ( fw \times TLw \times Fnot ) / {ft}^{2} < 0.97 . \qquad ( 4 )$$

6. The variable magnification optical system according to claim 5,
wherein Conditional Expression (4-1) is satisfied, which is represented by
$$0.36 < ( fw \times TLw \times Fnot ) / {ft}^{2} < 0.92 . \qquad ( 4 - 1 )$$

7. The variable magnification optical system according to claim 6,
wherein Conditional Expression (4-2) is satisfied, which is represented by
$$0.38 < ( fw \times TLw \times Fnot ) / {ft}^{2} < 0.87 . \qquad ( 4 - 2 )$$

8. The variable magnification optical system according to claim 7,
wherein Conditional Expression (4-3) is satisfied, which is represented by
$$0.41 < ( fw \times TLw \times Fnot ) / {ft}^{2} < 0.8 . \qquad ( 4 - 3 )$$

9. The variable magnification optical system according to claim 1,
wherein in a case where the open F-number in the state where the infinite distance object is focused on at the wide angle end is denoted by Fnow, Conditional Expression (5) is satisfied, which is represented by
$$0.075 < tan ω w / Fnow < 0.3 . \qquad ( 5 )$$

10. The variable magnification optical system according to claim 9,
wherein Conditional Expression (5-1) is satisfied, which is represented by
$$0.092 < tan ω w / Fnow < 0.27 . \qquad ( 5 - 1 )$$

11. The variable magnification optical system according to claim 10,
wherein Conditional Expression (5-2) is satisfied, which is represented by
$$0.105 < tan ω w / Fnow < 0.25 . \qquad ( 5 - 2 )$$

12. The variable magnification optical system according to claim 1,
wherein Conditional Expression (6) is satisfied, which is represented by
$$1.1 < TLt / TLw < 1.9 . \qquad ( 6 )$$

13. The variable magnification optical system according to claim 12,
wherein Conditional Expression (6-1) is satisfied, which is represented by
$$1.15 < TLt / TLw < 1.48 . \qquad ( 6 - 1 )$$

14. The variable magnification optical system according to claim 12,
wherein Conditional Expression (3-3) is satisfied, which is represented by
$$2. 2 < Fnot \times ( TLt / ft ) < 4. \qquad ( 3 - 3 )$$

15. The variable magnification optical system according to claim 14,
wherein Conditional Expression (4-3) is satisfied, which is represented by
$$0.41 < ( fw \times TLw \times Fnot ) / {ft}^{2} < 0.8 . \qquad ( 4 - 3 )$$

16. The variable magnification optical system according to claim 15,
wherein Conditional Expression (5-2) is satisfied, which is represented by
$$0.105 < tan ω w / Fnow < 0.25 . \qquad ( 5 - 2 )$$

17. The variable magnification optical system according to claim 3,
wherein in a case where a focal length of the front group in the state where the infinite distance object is focused on at the wide angle end is denoted by fFw, and a focal length of the middle group in the state where the infinite distance object is focused on at the wide angle end is denoted by fMw, Conditional Expression (7) is satisfied, which is denoted by
$$0.8 < fFw / ( - fMw ) < 8. \qquad ( 7 )$$

18. The variable magnification optical system according to claim 17,
wherein Conditional Expression (7-1) is satisfied, which is represented by
$$1.1 < fFw / ( - fMw ) < 5.3 . \qquad ( 7 - 1 )$$

19. The variable magnification optical system according to claim 18,
wherein Conditional Expression (8) is satisfied, which is represented by
$$0.8 < TLw / ft < 1.5 . \qquad ( 8 )$$

20. The variable magnification optical system according to claim 19,
wherein Conditional Expression (6-1) is satisfied, which is represented by
$$1.15 < TLt / TLw < 1.48 . \qquad ( 6 - 1 )$$

21. The variable magnification optical system according to claim 20,
wherein Conditional Expression (4-2) is satisfied, which is represented by
$$0.38 < ( fw \times TLw \times Fnot ) / {ft}^{2} < 0.87 . \qquad ( 4 - 2 )$$

22. The variable magnification optical system according to claim 21,
wherein Conditional Expression (5-1) is satisfied, which is represented by
$$0.092 < tan ω w / Fnow < 0.27 . \qquad ( 5 - 1 )$$

23. The variable magnification optical system according to claim 2,
wherein Conditional Expression (4-1) is satisfied, which is represented by
$$0.36 < ( fw \times TLw \times Fnot ) / {ft}^{2} < 0.92 . \qquad ( 4 - 1 )$$

24. The variable magnification optical system according to claim 23,
wherein Conditional Expression (5-1) is satisfied, which is represented by
$$0.092 < tan ω w / Fnow < 0.27 . \qquad ( 5 - 1 )$$

25. The variable magnification optical system according to claim 23,
wherein Conditional Expression (5-2) is satisfied, which is represented by
$$0.105 < tan ω w / Fnow < 0.25 . \qquad ( 5 - 2 )$$

26. The variable magnification optical system according to claim 25,
wherein the rear group includes an Lp1 lens having a positive refractive power and an Ln1 lens that is disposed adjacent to the image side of the Lp1 lens and that has a negative refractive power,
a surface of the Lp1 lens on the image side has an aspherical shape in which a refractive power at a position of a maximum effective diameter is shifted in a negative direction compared to a refractive power in a paraxial region, and
a surface of the Ln1 lens on the object side has an aspherical shape in which a refractive power at a position of a maximum effective diameter is shifted in a positive direction compared to a refractive power in the paraxial region.

27. The variable magnification optical system according to claim 24,
wherein the rear group includes an Ln2 lens having a negative refractive power and an Lp2 lens that is disposed adjacent to the image side of the Ln2 lens and that has a positive refractive power,
a surface of the Ln2 lens on the object side has an aspherical shape in which a refractive power at a position of a maximum effective diameter is shifted in a negative direction compared to a refractive power in a paraxial region, and
a surface of the Ln2 lens on the image side has an aspherical shape in which a refractive power at a position of a maximum effective diameter is shifted in a positive direction compared to a refractive power in the paraxial region.

28. The variable magnification optical system according to claim 5,
wherein in a case where a focal length of the lens group of the front group closest to the object side is denoted by fF1, Conditional Expression (14) is satisfied, which is represented by
$$1.3 < fF 1 / ( ft / Fnot ) < 8. \qquad ( 14 )$$

29. The variable magnification optical system according to claim 28,
wherein Conditional Expression (14-1) is satisfied, which is represented by
$$1.75 < fF 1 / ( ft / Fnot ) < 2.7 . \qquad ( 14 - 1 )$$

30. The variable magnification optical system according to claim 29,
wherein Conditional Expression (2-1) is satisfied, which is represented by
$$0.75 < Bfw / ( fw \times tan ω w ) < 1.84 . \qquad ( 2 - 1 )$$

31. The variable magnification optical system according to claim 30,
wherein Conditional Expression (5-1) is satisfied, which is represented by
$$0.092 < tan ω w / Fnow < 0.27 . \qquad ( 5 - 1 )$$

32. The variable magnification optical system according to claim 31,
wherein Conditional Expression (6) is satisfied, which is represented by
$$1.1 < TLt / TLw < 1.9 . \qquad ( 6 )$$

33. The variable magnification optical system according to claim 32,
wherein Conditional Expression (8) is satisfied, which is represented by
$$0.8 < TLw / ft < 1.5 . \qquad ( 8 )$$

34. An imaging apparatus comprising:
the variable magnification optical system according to claim 1.
